(19) United States
(12) Patent Application Publication
(10) Pub. No.: US 2026/0006183 A1
(43) Pub. Date: Jan. 1, 2026

(54) Methods and Devices for Intra Block Copy and Intra Template Matching

(71) Applicant: BEIJING DAJIA INTERNET INFORMATION TECHNOLOGY CO., LTD., Beijing (CN)

(72) Inventors: CHANGYUE MA, San Diego, CA (US); XIAOYU XIU, San Diego, CA (US); WEI CHEN, San Diego, CA (US); HONG-JHENG JHU, San Diego, CA (US); CHE-WEI KUO, San Diego, CA (US); NING YAN, San Diego, CA (US); XIANGLIN WANG, San Diego, CA (US); BING YU, Beijing (CN)

(73) Assignee: BEIJING DAJIA INTERNET INFORMATION TECHNOLOGY CO., LTD., Beijing (CN)

(21) Appl. No.: 19/318,076

(22) Filed: Sep. 3, 2025

Related U.S. Application Data
(63) Continuation-in-part of application No. PCT/US2024/018442, filed on Mar. 4, 2024.
(63) Continuation-in-part of application No. PCT/US2024/025301, filed on Apr. 18, 2024.
(63) Continuation-in-part of application No. PCT/US2024/032666, filed on Jun. 5, 2024.
(60) Provisional application No. 63/449,952, filed on Mar. 3, 2023.
(60) Provisional application No. 63/460,297, filed on Apr. 18, 2023.
(60) Provisional application No. 63/472,250, filed on Jun. 9, 2023.

(51) Int. Cl. H04N 19/105; H04N 19/129; H04N 19/176; H04N 19/70

(52) U.S. Cl. CPC H04N 19/105; H04N 19/129; H04N 19/176; H04N 19/70

(57) ABSTRACT

Methods for video decoding and encoding, apparatuses and non-transitory computer-readable storage media thereof are provided. In one method for video decoding, a decoder may obtain one or more intra-block copy (IBC) candidates from a plurality of non-adjacent neighboring blocks, where the one or more IBC candidates are coded based on an IBC merge mode or an IBC Advanced Motion Vector Prediction (AMVP) mode, and where the plurality of non-adjacent neighboring blocks are distanced from a current block by at least one block. Additionally, the decoder may obtain a prediction for the current block based on the one or more IBC candidates.

### CROSS-REFERENCE TO RELATED APPLICATION

This application is a continuation-in-part application of International Application No. PCT/US2024/018442, PCT/US2024/025301, and PCT/US2024/032666. International Application No. PCT/US2024/018442 was filed on Mar. 4, 2024 and claimed priority to U.S. Provisional Application No. 63/449,952 which was filed on Mar. 3, 2023. International Application No. PCT/US2024/025301 was filed on Apr. 18, 2024 and claimed priority to U.S. Provisional Application No. 63/460,297 which was filed on Apr. 18, 2023. International Application No. PCT/US2024/032666 was filed on Jun. 5, 2024 and claimed priority to U.S. Provisional Application No. 63/472,250 which was filed on Jun. 9, 2023. The entirety of all the aforementioned patent applications is incorporated herein by reference for all purposes.

### FIELD

The present disclosure is related to video coding and compression, and in particular but not limited to, methods and apparatus on improving the coding efficiency of intra block copy (IBC) and intra template matching prediction (Intra TMP).

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. For example, video coding standards include Versatile Video Coding (VVC), Joint Exploration test Model (JEM), High-Efficiency Video Coding (HEVC/H.265), Advanced Video Coding (AVC/H.264), Moving Picture Expert Group (MPEG) coding, or the like. Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality.

### SUMMARY

The present disclosure provides examples of techniques relating to improving the Intra Block Copy method in a video encoding or decoding process.

According to a first aspect of the present disclosure, there is provided a method for video decoding. In the method, a decoder may obtain one or more intra-block copy (IBC) candidates from a plurality of non-adjacent neighboring blocks, where the one or more IBC candidates are coded based on an IBC merge mode or an IBC Advanced Motion Vector Prediction (AMVP) mode, and where the plurality of non-adjacent neighboring blocks are distanced from a current block by at least one block. Additionally, the decoder may obtain a prediction for the current block based on the one or more IBC candidates.

According to a second aspect of the present disclosure, there is provided a method for video encoding. In the method, an encoder may obtain one or more intra-block copy (IBC) candidates from a plurality of non-adjacent neighboring blocks, where the one or more IBC candidates are coded based on an IBC merge mode or an IBC Advanced Motion Vector Prediction (AMVP) mode, and where the plurality of non-adjacent neighboring blocks are distanced from a current block by at least one block. Furthermore, the encoder may obtain a prediction for the current block based on the one or more IBC candidates. Additionally, the encoder may generate a bitstream based on the prediction.

According to a third aspect of the present disclosure, there is provided a method for video decoding. In the method, a decoder may obtain one or more subblocks of a current block, where the current block is coded in an intra block copy (IBC) mode. Furthermore, the decoder may obtain one or more block vectors (BVs) of the one or more subblocks. Additionally, the decoder may perform motion compensation based on the one or more subblocks and the one or more BVs.

According to a fourth aspect of the present disclosure, there is provided a method for video encoding. In the method, an encoder may obtain one or more subblocks of a current block, where the current block is coded in an intra block copy (IBC) mode. Furthermore, the encoder may obtain one or more block vectors (BVs) of the one or more subblocks. Moreover, the encoder may perform motion compensation based on the one or more subblocks and the one or more BVs. Additionally, the encoder may generate a bitstream based on the motion compensation.

According to a fifth aspect of the present disclosure, there is provided a method for video decoding. In the method, a decoder may obtain a plurality of template patterns. Furthermore, the decoder may obtain a current block coded in one of template matching intra block copy (TM IBC) mode or TM regular mode. Additionally, the decoder may obtain a prediction for the current block based on a selected one of the plurality of template patterns.

According to a sixth aspect of the present disclosure, there is provided a method for video encoding. In the method, an encoder may obtain a plurality of template patterns. Furthermore, the encoder may obtain a current block coded in one of template matching intra block copy (TM IBC) mode or TM regular mode. Moreover, the encoder may obtain a prediction for the current block based on a selected one of the plurality of template patterns. Additionally, the encoder may generate a bitstream based on the prediction.

According to a seventh aspect of the present disclosure, there is provided a method for video decoding. In the method, a decoder may obtain a first block and a second block, where the first block is coded based on one of an intra block copy (IBC) mode, an intra template matching prediction (TMP) mode, or an inter mode, and where the second block is coded based on an intra mode. Further, the decoder may determine whether to use a method of template matching. In response to determination that the method of template matching is used, the decoder may determine a kind of template pattern to be used. Furthermore, the decoder may obtain, based on the method of template matching corresponding to the kind of template pattern, a first weight corresponding to the first block and a second weight corresponding to the second block. Moreover, the decoder may obtain a final prediction for a current block based on the first block, the first weight, the second block, and the second weight.

According to an eighth aspect of the present disclosure, there is provided a method for video encoding. In the method, an encoder may obtain a first block and a second block, where the first block is coded based on one of an intra block copy (IBC) mode, an intra template matching prediction (TMP) mode, or an inter mode, and where the second block is coded based on an intra mode. Further, the encoder may determine whether to use a method of template matching. In response to determination that the method of template matching is used, the encoder may determine a kind of template pattern to be used. Furthermore, the encoder may obtain, based on the method of template matching corresponding to the kind of template pattern, a first weight corresponding to the first block and a second weight corresponding to the second block. Moreover, the encoder may obtain a final prediction for a current block based on the first block, the first weight, the second block, and the second weight. Additionally, the encoder may generate a bitstream based on the final prediction.

According to a ninth aspect of the present disclosure, there is provided an apparatus for video decoding. The apparatus may include one or more processors and a memory coupled to the one or more processors and configured to store instructions executable by the one or more processors. Furthermore, the one or more processors, upon execution of the instructions, are configured to perform the method according to the first aspect, the third aspect, the fifth aspect, the seventh aspect.

According to a tenth aspect of the present disclosure, there is provided an apparatus for video encoding. The apparatus may include one or more processors and a memory coupled to the one or more processors and configured to store instructions executable by the one or more processors. Furthermore, the one or more processors, upon execution of the instructions, are configured to perform the method according to the second aspect, the fourth aspect, the sixth aspect, the eighth aspect.

According to an eleventh aspect of the present disclosure, there is provided a non-transitory computer-readable storage medium for storing computer-executable instructions that, when executed by one or more computer processors, cause the one or more computer processors to perform the method according to the first aspect, the third aspect, the fifth aspect, the seventh aspect.

According to a twelfth aspect of the present disclosure, there is provided a non-transitory computer-readable storage medium for storing computer-executable instructions that, when executed by one or more computer processors, cause the one or more computer processors to perform the method according to the second aspect, the fourth aspect, the sixth aspect, the eighth aspect.

According to a thirteenth aspect of the present disclosure, there is provided a non-transitory computer-readable storage medium for storing a bitstream to be decoded by the method according to the first aspect, the third aspect, the fifth aspect, the seventh aspect.

According to a fourteenth aspect of the present disclosure, there is provided a non-transitory computer-readable storage medium for storing a bitstream generated by the method according to the second aspect, the fourth aspect, the sixth aspect, the eighth aspect.

According to a fifteenth aspect of the present disclosure, there is provided a method for video decoding. The method includes: obtaining, by a decoder for applying an intra-block copy (IBC) mode to a current block, one or more IBC candidates from a plurality of non-adjacent neighboring blocks according to a scanning rule corresponding to the IBC mode, wherein the plurality of non-adjacent neighboring blocks are distanced from the current block by at least one block; and obtaining, by the decoder, a prediction for the current block by applying the IBC mode based on the one or more IBC candidates.

According to a sixteenth aspect of the present disclosure, there is provided a method for video decoding. The method includes obtaining, by a decoder for applying an intra-block copy (IBC) mode to a current block, one or more IBC candidates from a plurality of neighboring blocks according to a size of the current block; and obtaining, by the decoder, a prediction for the current block by applying the IBC mode based on the one or more IBC candidates.

According to a seventeenth aspect of the present disclosure, there is provided a method for video decoding. The method includes obtaining, by a decoder, a History-based Motion Vector Predictor (HMVP) list based on at least one block attribution of a current block; and obtaining, by the decoder, a prediction for the current block by applying an intra-block copy (IBC) mode based on the HMVP list.

According to an eighteenth aspect of the present disclosure, there is provided a method for video decoding. The method includes in response to determining that a neighboring block of a current block is coded in one of an IBC mode or an intra template matching prediction (TMP) mode, obtaining, by a decoder, an intra prediction mode which is associated with a block vector of the neighboring block; and constructing, by the decoder, an intra Most Probable Mode (MPM) list of the current block based on the intra prediction mode.

According to a nineteenth aspect of the present disclosure, there is provided a method for video encoding. The method includes: obtaining, by an encoder for applying an intra-block copy (IBC) mode to a current block, one or more IBC candidates from a plurality of non-adjacent neighboring blocks according to a scanning rule corresponding to the IBC mode, wherein the plurality of non-adjacent neighboring blocks are distanced from the current block by at least one block; and obtaining, by the encoder, a prediction for the current block by applying the IBC mode based on the one or more IBC candidates.

According to a twentieth aspect of the present disclosure, there is provided a method for video encoding. The method includes obtaining, by an encoder for applying an intra-block copy (IBC) mode to a current block, one or more IBC candidates from a plurality of neighboring blocks according to a size of the current block; and obtaining, by the encoder, a prediction for the current block by applying the IBC mode based on the one or more IBC candidates.

According to a twentieth-first aspect of the present disclosure, there is provided a method for video encoding. The method includes obtaining, by an encoder, a History-based Motion Vector Predictor (HMVP) list based on at least one block attribution of a current block; and obtaining, by the encoder, a prediction for the current block by applying an intra-block copy (IBC) mode based on the HMVP list.

According to a twentieth-second aspect of the present disclosure, there is provided a method for video encoding. The method includes in response to determining that a neighboring block of a current block is coded in one of an IBC mode or an intra template matching prediction (TMP) mode, obtaining, by an encoder, an intra prediction mode which is associated with a block vector of the neighboring block; and constructing, by the encoder, an intra Most Probable Mode (MPM) list of the current block based on the intra prediction mode.

According to a twentieth-third aspect of the present disclosure, there is provided an apparatus for video decoding. The apparatus may include one or more processors and a memory coupled to the one or more processors and configured to store instructions executable by the one or more processors. Furthermore, the one or more processors, upon execution of the instructions, are configured to perform the method according to the fifteenth, sixteenth, seventeenth, or eighteenth aspect.

According to a twentieth-fourth aspect of the present disclosure, there is provided an apparatus for video encoding. The apparatus may include one or more processors and a memory coupled to the one or more processors and configured to store instructions executable by the one or more processors. Furthermore, the one or more processors, upon execution of the instructions, are configured to perform the method according to the nineteenth, twentieth, twentieth-first, or twentieth-second aspect.

According to a twentieth-fifth aspect of the present disclosure, there is provided a non-transitory computer-readable storage medium for storing computer-executable instructions that, when executed by one or more computer processors, cause the one or more computer processors to perform the method according to the fifteenth, sixteenth, seventeenth, or eighteenth aspect.

According to a twentieth-sixth aspect of the present disclosure, there is provided a non-transitory computer-readable storage medium for storing computer-executable instructions that, when executed by one or more computer processors, cause the one or more computer processors to perform the method according to the nineteenth, twentieth, twentieth-first, or twentieth-second aspect.

According to a twentieth-seventh aspect of the present disclosure, there is provided a non-transitory computer-readable storage medium for storing a bitstream to be decoded by the method according to the fifteenth, sixteenth, seventeenth, or eighteenth aspect.

According to a twentieth-eighth aspect of the present disclosure, there is provided a non-transitory computer-readable storage medium for storing a bitstream generated by the method according to the nineteenth, twentieth, twentieth-first, or twentieth-second aspect.

According to a twentieth-nineth aspect of the present disclosure, there is provided a method for video decoding. The method includes: obtaining, by a decoder, a current block coded with Geometric Partition Mode (GPM); obtaining, by the decoder, a twentieth-nineth Intra Block Copy (IBC) prediction and a thirtieth IBC prediction based on partitions using GPM for the current block; receiving, by the decoder, coding modes of the current block; and obtaining, by the decoder, a final prediction for the current block using the twentieth-nineth IBC prediction, the thirtieth IBC prediction, and the coding modes of the current block.

According to a thirtieth aspect of the present disclosure, there is provided a method for video encoding. The method includes: obtaining, by an encoder, a current block coded with Geometric Partition Mode (GPM); obtaining, by the encoder, a twentieth-nineth Intra Block Copy (IBC) prediction and a thirtieth IBC prediction based on partitions using GPM for the current block; setting, by the encoder, coding modes of the current block; obtaining, by the encoder, a final prediction for the current block using the twentieth-nineth IBC prediction, the thirtieth IBC prediction, and the coding modes of the current block; and generating, by the encoder, a bitstream based on the final prediction.

According to a thirty-first aspect of the present disclosure, there is provided a method for video decoding. The method includes: obtaining, by a decoder for applying an intra-block copy (IBC) merge mode or an IBC Adaptive Motion Vector Prediction (AMVP) mode to a current block, IBC candidates from non-adjacent neighboring blocks according to a scanning rule corresponding to the IBC merge mode or the IBC AMVP mode, wherein the non-adjacent neighboring blocks have distances from the current block by at least one block and are positioned in a plurality of directions relative to the current block, and the scanning rule is obtained based on the distances and the directions; and obtaining, by the decoder, a prediction for the current block by applying the IBC merge mode or the IBC AMVP mode based on the IBC candidates.

According to a thirty-second aspect of the present disclosure, there is provided a method for video encoding. The method includes: obtaining, by an encoder for applying an intra-block copy (IBC) merge mode or an IBC Adaptive Motion Vector Prediction (AMVP) mode to a current block, IBC candidates from non-adjacent neighboring blocks according to a scanning rule corresponding to the IBC merge mode or the IBC AMVP mode, wherein the non-adjacent neighboring blocks have distances from the current block by at least one block and are positioned in a plurality of directions relative to the current block, and the scanning rule is obtained based on the distances and the directions; obtaining, by the encoder, a prediction for the current block by applying the IBC merge mode or the IBC AMVP mode based on the IBC candidates; and generating, by the encoder, a bitstream based on the prediction.

According to a thirty-third aspect of the present disclosure, there is provided a method for video decoding. The method includes: obtaining, by a decoder for applying an intra-block copy (IBC) merge mode or an IBC Adaptive Motion Vector Prediction (AMVP) mode to a current block, an ordered list of IBC candidates; inserting, by the decoder, non-adjacent spatial candidates into the ordered list of IBC candidates after adjacent spatial candidates or history-based Block Vector Prediction (BVP) candidates; and obtaining, by the decoder, a prediction for the current block by applying the IBC merge mode or the IBC AMVP mode based on the ordered list of IBC candidates.

According to a thirty-fourth aspect of the present disclosure, there is provided a method for video encoding. The method includes: obtaining, by an encoder for applying an intra-block copy (IBC) merge mode or an IBC Adaptive Motion Vector Prediction (AMVP) mode to a current block, an ordered list of IBC candidates; inserting, by the encoder, non-adjacent spatial candidates into the ordered list of IBC candidates after adjacent spatial candidates or history-based Block Vector Prediction (BVP) candidates; obtaining, by the encoder, a prediction for the current block by applying the IBC merge mode or the IBC AMVP mode based on the ordered list of IBC candidates; and generating, by the encoder, a bitstream based on the prediction.

According to a thirty-fifth aspect of the present disclosure, there is provided an apparatus for video decoding. The apparatus may include one or more processors and a memory coupled to the one or more processors and configured to store instructions executable by the one or more processors. Furthermore, the one or more processors, upon execution of the instructions, are configured to perform the method according to the twentieth-nineth, thirty-first, or thirty-third aspect.

According to a thirty-sixth aspect of the present disclosure, there is provided an apparatus for video encoding. The apparatus may include one or more processors and a memory coupled to the one or more processors and configured to store instructions executable by the one or more processors. Furthermore, the one or more processors, upon execution of the instructions, are configured to perform the method according to the thirtieth, thirty-second, or thirty-fourth aspect.

According to a thirty-seventh aspect of the present disclosure, there is provided a non-transitory computer-readable storage medium for storing computer-executable instructions that, when executed by one or more computer processors, cause the one or more computer processors to perform the method according to the twentieth-nineth, thirty-first, or thirty-third aspect.

According to a thirty-eighth aspect of the present disclosure, there is provided a non-transitory computer-readable storage medium for storing computer-executable instructions that, when executed by one or more computer processors, cause the one or more computer processors to perform the method according to the thirtieth, thirty-second, or thirty-fourth aspect.

According to a thirty-nineth aspect of the present disclosure, there is provided a non-transitory computer-readable storage medium for storing a bitstream to be decoded by the method according to the twentieth-nineth, thirty-first, or thirty-third aspect.

According to a fortieth aspect of the present disclosure, there is provided a non-transitory computer-readable storage medium for storing a bitstream generated by the method according to the thirtieth, thirty-second, or thirty-fourth aspect.

### BRIEF DESCRIPTION OF THE DRAWINGS

A more particular description of the examples of the present disclosure will be rendered by reference to specific examples illustrated in the appended drawings. Given that these drawings depict only some examples and are not therefore considered to be limiting in scope, the examples will be described and explained with additional specificity and details through the use of the accompanying drawings.

FIG. 1 is a block diagram illustrating an exemplary system for encoding and decoding video blocks in accordance with some examples of the present disclosure.

FIG. 2 is a block diagram illustrating an exemplary video encoder in accordance with some examples of the present disclosure.

FIG. 3 is a block diagram illustrating an exemplary video decoder in accordance with some examples of the present disclosure.

FIGS. 4A through 4E are block diagrams illustrating how a frame is recursively partitioned into multiple video blocks of different sizes and shapes in accordance with some examples of the present disclosure.

FIG. 5 illustrates a diagram of positions of spatial candidates in accordance with some examples of the present disclosure.

FIG. 6 illustrates a diagram of candidate pairs considered for redundancy check of spatial candidates in accordance with some examples of the present disclosure.

FIG. 7 illustrates a diagram of scaling of a motion vector for a temporal candidate in accordance with some examples of the present disclosure.

FIG. 8 illustrates a diagram of candidate positions for a temporal candidate in accordance with some examples of the present disclosure.

FIG. 9 illustrates a diagram of Merge mode with Motion Vector Difference (MMVD) search points in accordance with some examples of the present disclosure.

FIG. 10 illustrates uni-prediction motion vector selection for Geometric Partitioning Mode (GPM) in accordance with some examples of the present disclosure.

FIG. 11 illustrates top and left neighboring blocks used in CIIP weight derivation in accordance with some examples of the present disclosure.

FIG. 12 illustrates current CTU processing order and its available reference samples in current and left CTU in accordance with some examples of the present disclosure.

FIG. 13 illustrates padding candidates for the replacement of the zero-vector in the IBC list in accordance with some examples of the present disclosure.

FIG. 14 illustrates reference area for IBC when CTU (m, n) is coded. The block (m, n) shaded with dots denotes the current CTU; blocks shaded with “/” denote the reference area; and the unshaded blocks denote invalid reference area in accordance with some examples of the present disclosure.

FIG. 15 illustrates IBC reference area for camera-captured content in accordance with some examples of the present disclosure.

FIGS. 16A-16B illustrate the division method for angular modes in accordance with some examples of the present disclosure.

FIGS. 17A-17D illustrate GPM with inter and intra prediction. FIGS. 17A-17C shows available IPM candidates. FIG. 17D shows an example of GPM with intra and intra prediction in accordance with some examples of the present disclosure.

FIG. 18 illustrates the edge on templates in accordance with some examples of the present disclosure.

FIG. 19 illustrates the intra template matching search area used in accordance with some examples of the present disclosure.

FIG. 20 illustrates the template used for template matching based OBMC in accordance with some examples of the present disclosure.

FIG. 21 illustrates the division method and corresponding weights for intra coded block for angular and planar modes in accordance with some examples of the present disclosure.

FIG. 22 illustrates the template and its reference samples used for intra coded block according to some examples of the present disclosure.

FIG. 23 illustrates the template and its reference samples used for IBC coded block according to some examples of the present disclosure.

FIG. 24 illustrates exemplary non-adjacent neighboring blocks for IBC AMVP or merge candidates according to some examples of the present disclosure.

FIGS. 25A-25B illustrate different sizes of non-adjacent neighbor blocks: FIG. 25A illustrates neighbor blocks with the same size as the current block according to some examples of the present disclosure, and FIG. 25B illustrates neighbor blocks with a difference size as the current block (e.g., 4×4 or 8×8) according to some examples of the present disclosure.

FIG. 26 illustrates one example of spatial neighboring blocks used to derive the non-adjacent spatial candidates for IBC mode, where the number in the non-adjacent neighboring block represents the scanning order according to some examples of the present disclosure.

FIG. 27 illustrates another example of spatial neighboring blocks used to derive the non-adjacent spatial candidates for IBC mode, where the number in the non-adjacent neighboring block represents the scanning order, the number after the arrow represents the degree value of angle according to some examples of the present disclosure.

FIG. 28 illustrates an example where the non-adjacent spatial area is restricted to be within half CTU size on the above and left of the current CTU according to some examples of the present disclosure.

FIGS. 29A-29B illustrate motion storage for non-adjacent spatial neighbors (either IBC neighbor CUs or non-IBC neighbor CUs): FIG. 29A illustrates the allowable non-adjacent spatial area beyond the current CTU according to some examples of the present disclosure, and FIG. 29B illustrates motion storage in line buffer (2902 is an IBC CU; 2903 is a non-IBC CU) according to some examples of the present disclosure.

FIG. 30 illustrates projected/clipped non-adjacent neighbor position if the scanned non-adjacent neighbor position is beyond the allowable spatial area according to some examples of the present disclosure.

FIG. 31 illustrates another example of projected/clipped non-adjacent neighbor position if the scanned non-adjacent neighbor position is beyond the allowed spatial area (e.g., beyond current CTU and available line buffer) according to some examples of the present disclosure.

FIG. 32 illustrates the granularity of IBC motion storage is different from the minimum IBC block size according to some examples of the present disclosure.

FIG. 33 illustrates one example of subblock based IBC mode where the BV of sub-block in current block is obtained by reusing the BV of sub-block of the collocated block in the collocated picture according to some examples of the present disclosure.

FIG. 34 illustrates one example of subblock based IBC mode where the BV of left or above sub-block in current block is obtained by refining the BV of current block with template matching methods.

FIG. 35 is a diagram illustrating a computing environment coupled with a user interface, according to some examples of the present disclosure.

FIG. 36 is a diagram illustrating the ramp function for the weights for GPM blending based on the displacement (d) from a predicted sample position to the GPM partitioning boundary and the blending area size (τ) according to some examples of the present disclosure.

FIGS. 37A-37C are diagrams illustrating spatial GPM candidates according to some examples of the present disclosure.

FIG. 38 is a diagram illustrating GPM templates according to some examples of the present disclosure.

FIG. 39 is a diagram illustrating GPM blending according to some examples of the present disclosure.

FIG. 40 illustrates additional directions along k×π/8 diagonal angles (positions 4010 are used in the anchor) according to some examples of the present disclosure.

FIG. 41 illustrates another example of spatial neighboring blocks used to derive the non-adjacent spatial candidates for IBC mode, where the number in the non-adjacent neighboring block represents the scanning order according to some examples of the present disclosure.

FIG. 42A and FIG. 42B respectively illustrate BV adjustment for horizontal flip and vertical flip in accordance with some implementations of the present disclosure.

FIG. 43 illustrates an example of GPM applied block in accordance with some implementations of the present disclosure.

FIG. 44 illustrates another example of spatial neighboring blocks used to derive the non-adjacent spatial candidates for IBC mode, where the number in the non-adjacent neighboring block represents the scanning order. The example is in accordance with some implementations of the present disclosure.

FIG. 45 illustrates another example of spatial neighboring blocks used to derive the non-adjacent spatial candidates for IBC mode, where the number in the non-adjacent neighboring block represents the scanning order. The example is in accordance with some implementations of the present disclosure.

FIG. 46 illustrates another example of spatial neighboring blocks used to derive the non-adjacent spatial candidates for IBC mode, where the number in the non-adjacent neighboring block represents the scanning order. The example is in accordance with some implementations of the present disclosure.

FIG. 47 illustrates another example of spatial neighboring blocks used to derive the non-adjacent spatial candidates for IBC mode, where the number in the non-adjacent neighboring block represents the scanning order. The example is in accordance with some implementations of the present disclosure.

FIG. 48 illustrates another example of spatial neighboring blocks used to derive the non-adjacent spatial candidates for IBC mode, where the number in the non-adjacent neighboring block represents the scanning order. The example is in accordance with some implementations of the present disclosure.

FIG. 49 illustrates another example of spatial neighboring blocks used to derive the non-adjacent spatial candidates for IBC mode, where the number in the non-adjacent neighboring block represents the scanning order. The example is in accordance with some implementations of the present disclosure.

FIG. 50 is a flow chart illustrating a method for video decoding in accordance with some examples of the present disclosure.

FIG. 51 is a flow chart illustrating a method for video encoding corresponding to the method for video decoding as shown in FIG. 50 in accordance with some examples of the present disclosure.

FIG. 52 is a flow chart illustrating a method for video decoding in accordance with some examples of the present disclosure.

FIG. 53 is a flow chart illustrating a method for video encoding corresponding to the method for video decoding as shown in FIG. 52 in accordance with some examples of the present disclosure.

FIG. 54 is a flow chart illustrating a method for video decoding in accordance with some examples of the present disclosure.

FIG. 55 is a flow chart illustrating a method for video encoding corresponding to the method for video decoding as shown in FIG. 54 in accordance with some examples of the present disclosure.

FIG. 56 is a flow chart illustrating a method for video decoding in accordance with some examples of the present disclosure.

FIG. 57 is a flow chart illustrating a method for video encoding corresponding to the method for video decoding as shown in FIG. 56 in accordance with some examples of the present disclosure.

FIG. 58 is a flow chart illustrating a method for video decoding in accordance with some examples of the present disclosure.

FIG. 59 is a flow chart illustrating a method for video encoding corresponding to the method for video decoding as shown in FIG. 58 in accordance with some examples of the present disclosure.

FIG. 60 is a flow chart illustrating a method for video decoding in accordance with some examples of the present disclosure.

FIG. 61 is a flow chart illustrating a method for video encoding corresponding to the method for video decoding as shown in FIG. 60 in accordance with some examples of the present disclosure.

FIG. 62 is a flow chart illustrating a method for video decoding in accordance with some examples of the present disclosure.

FIG. 63 is a flow chart illustrating a method for video encoding corresponding to the method for video decoding as shown in FIG. 62 in accordance with some examples of the present disclosure.

FIG. 64 is a flow chart illustrating a method for video decoding in accordance with some examples of the present disclosure.

FIG. 65 is a flow chart illustrating a method for video encoding corresponding to the method for video decoding as shown in FIG. 64 in accordance with some examples of the present disclosure.

FIG. 66 is a flow chart illustrating a method for video decoding in accordance with some examples of the present disclosure.

FIG. 67 is a flow chart illustrating a method for video encoding corresponding to the method for video decoding as shown in FIG. 44 in accordance with some examples of the present disclosure.

FIG. 68 is a flow chart illustrating a method for video decoding in accordance with some examples of the present disclosure.

FIG. 69 is a flow chart illustrating a method for video encoding corresponding to the method for video decoding as shown in FIG. 46 in accordance with some examples of the present disclosure.

FIG. 70 is a flow chart illustrating a method for video decoding in accordance with some examples of the present disclosure.

FIG. 71 is a flow chart illustrating a method for video encoding corresponding to the method for video decoding as shown in FIG. 48 in accordance with some examples of the present disclosure

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But various alternatives may be used without departing from the scope of claims and the subject matter may be practiced without these specific details. For example, the subject matter presented herein can be implemented on many types of electronic devices with digital video capabilities.

Terms used in the disclosure are only adopted for the purpose of describing specific embodiments and not intended to limit the disclosure. “A/an,” “said,” and “the” in a singular form in the disclosure and the appended claims are also intended to include a plural form, unless other meanings are clearly denoted throughout the disclosure. It is also to be understood that term “and/or” used in the disclosure refers to and includes one or any or all possible combinations of multiple associated items that are listed.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

Throughout the disclosure, the terms “first,” “second,” “third,” etc. are all used as nomenclature only for references to relevant elements, e.g., devices, components, compositions, steps, etc., without implying any spatial or chronological orders, unless expressly specified otherwise. For example, a “first device” and a “second device” may refer to two separately formed devices, or two parts, components, or operational states of a same device, and may be named arbitrarily.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

As used herein, the term “if” or “when” may be understood to mean “upon” or “in response to” depending on the context. These terms, if appear in a claim, may not indicate that the relevant limitations or features are conditional or optional. For example, a method may comprise steps of: i) when or if condition X is present, function or action X′ is performed, and ii) when or if condition Y is present, function or action Y′ is performed. The method may be implemented with both the capability of performing function or action X′, and the capability of performing function or action Y′. Thus, the functions X′ and Y′ may both be performed, at different times, on multiple executions of the method.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

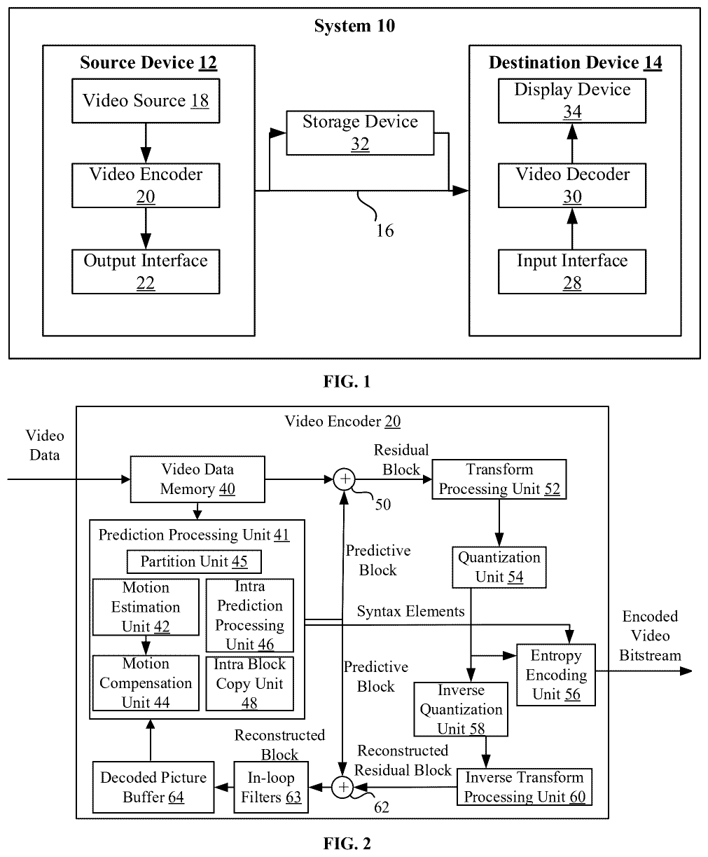

FIG. 1 is a block diagram illustrating an exemplary system 10 for encoding and decoding video blocks in parallel in accordance with some implementations of the present disclosure. As shown in FIG. 1, the system 10 includes a source device 12 that generates and encodes video data to be decoded at a later time by a destination device 14. The source device 12 and the destination device 14 may include any of a wide variety of electronic devices, including cloud servers, server computers, desktop or laptop computers, tablet computers, smart phones, set-top boxes, digital televisions, cameras, display devices, digital media players, video gaming consoles, video streaming device, or the like. In some implementations, the source device 12 and the destination device 14 are equipped with wireless communication capabilities.

In some implementations, the destination device 14 may receive the encoded video data to be decoded via a link 16. The link 16 may include any type of communication medium or device capable of moving the encoded video data from the source device 12 to the destination device 14. In one example, the link 16 may include a communication medium to enable the source device 12 to transmit the encoded video data directly to the destination device 14 in real time. The encoded video data may be modulated according to a communication standard, such as a wireless communication protocol, and transmitted to the destination device 14. The communication medium may include any wireless or wired communication medium, such as a Radio Frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 12 to the destination device 14.

In some other implementations, the encoded video data may be transmitted from an output interface 22 to a storage device 32. Subsequently, the encoded video data in the storage device 32 may be accessed by the destination device 14 via an input interface 28. The storage device 32 may include any of a variety of distributed or locally accessed data storage media such as a hard drive, Blu-ray discs, Digital Versatile Disks (DVDs), Compact Disc Read-Only Memories (CD-ROMs), flash memory, volatile or non-volatile memory, or any other suitable digital storage media for storing the encoded video data. In a further example, the storage device 32 may correspond to a file server or another intermediate storage device that may hold the encoded video data generated by the source device 12. The destination device 14 may access the stored video data from the storage device 32 via streaming or downloading. The file server may be any type of computer capable of storing the encoded video data and transmitting the encoded video data to the destination device 14. Exemplary file servers include a web server (e.g., for a website), a File Transfer Protocol (FTP) server, Network Attached Storage (NAS) devices, or a local disk drive. The destination device 14 may access the encoded video data through any standard data connection, including a wireless channel (e.g., a Wireless Fidelity (Wi-Fi) connection), a wired connection (e.g., Digital Subscriber Line (DSL), cable modem, etc.), or a combination of both that is suitable for accessing encoded video data stored on a file server. The transmission of the encoded video data from the storage device 32 may be a streaming transmission, a download transmission, or a combination of both.

As shown in FIG. 1, the source device 12 includes a video source 18, a video encoder 20 and the output interface 22. The video source 18 may include a source such as a video capturing device, e.g., a video camera, a video archive containing previously captured video, a video feeding interface to receive video from a video content provider, and/or a computer graphics system for generating computer graphics data as the source video, or a combination of such sources. As one example, if the video source 18 is a video camera of a security surveillance system, the source device 12 and the destination device 14 may form camera phones or video phones. However, the implementations described in the present application may be applicable to video coding in general, and may be applied to wireless and/or wired applications.

The captured, pre-captured, or computer-generated video may be encoded by the video encoder 20. The encoded video data may be transmitted directly to the destination device 14 via the output interface 22 of the source device 12. The encoded video data may also (or alternatively) be stored onto the storage device 32 for later access by the destination device 14 or other devices, for decoding and/or playback. The output interface 22 may further include a modem and/or a transmitter.

The destination device 14 includes the input interface 28, a video decoder 30, and a display device 34. The input interface 28 may include a receiver and/or a modem and receive the encoded video data over the link 16. The encoded video data communicated over the link 16, or provided on the storage device 32, may include a variety of syntax elements generated by the video encoder 20 for use by the video decoder 30 in decoding the video data. Such syntax elements may be included within the encoded video data transmitted on a communication medium, stored on a storage medium, or stored on a file server.

In some implementations, the destination device 14 may include the display device 34, which can be an integrated display device and an external display device that is configured to communicate with the destination device 14. The display device 34 displays the decoded video data to a user, and may include any of a variety of display devices such as a Liquid Crystal Display (LCD), a plasma display, an Organic Light Emitting Diode (OLED) display, or another type of display device.

The video encoder 20 and the video decoder 30 may operate according to proprietary or industry standards, such as VVC, HEVC, MPEG-4, Part 10, AVC, or extensions of such standards. It should be understood that the present application is not limited to a specific video encoding/decoding standard and may be applicable to other video encoding/decoding standards. It is generally contemplated that the video encoder 20 of the source device 12 may be configured to encode video data according to any of these current or future standards. Similarly, it is also generally contemplated that the video decoder 30 of the destination device 14 may be configured to decode video data according to any of these current or future standards.

The video encoder 20 and the video decoder 30 each may be implemented as any of a variety of suitable encoder and/or decoder circuitry, such as one or more microprocessors, Digital Signal Processors (DSPs), Application Specific Integrated Circuits (ASICs), Field Programmable Gate Arrays (FPGAs), discrete logic, software, hardware, firmware or any combinations thereof. When implemented partially in software, an electronic device may store instructions for the software in a suitable, non-transitory computer-readable medium and execute the instructions in hardware using one or more processors to perform the video encoding/decoding operations disclosed in the present disclosure. Each of the video encoder 20 and the video decoder 30 may be included in one or more encoders or decoders, either of which may be integrated as part of a combined encoder/decoder (CODEC) in a respective device.

In some implementations, at least a part of components of the source device 12 (for example, the video source 18, the video encoder 20 or components included in the video encoder 20 as described below with reference to FIG. 1, and the output interface 22) and/or at least a part of components of the destination device 14 (for example, the input interface 28, the video decoder 30 or components included in the video decoder 30 as described below with reference to FIG. 3, and the display device 34) may operate in a cloud computing service network which may provide software, platforms, and/or infrastructure, such as Software as a Service (SaaS), Platform as a Service (PaaS), or Infrastructure as a Service (IaaS). In some implementations, one or more components in the source device 12 and/or the destination device 14 which are not included in the cloud computing service network may be provided in one or more client devices, and the one or more client devices may communicate with server computers in the cloud computing service network through a wireless communication network (for example, a cellular communication network, a short-range wireless communication network, or a global navigation satellite system (GNSS) communication network) or a wired communication network (e.g., a local area network (LAN) communication network or a power line communication (PLC) network). In an embodiment, at least a part of operations described herein may be implemented as cloud-based services provided by one or more server computers which are implemented by the at least a part of the components of the source device 12 and/or the at least a part of the components of the destination device 14 in the cloud computing service network; and one or more other operations described herein may be implemented by the one or more client devices. In some implementations, the cloud computing service network may be a private cloud, a public cloud, or a hybrid cloud. The terms such as “cloud,” “cloud computing,” “cloud-based” etc. herein may be used interchangeably as appropriate without departing from the scope of the present disclosure. It should be understood that the present disclosure is not limited to being implemented in the cloud computing service network described above. Instead, the present disclosure may also be implemented in any other type of computing environments currently known or developed in the future.

FIG. 2 is a block diagram illustrating another exemplary video encoder 20 in accordance with some implementations described in the present application. The video encoder 20 may perform intra and inter predictive coding of video blocks within video frames. Intra predictive coding relies on spatial prediction to reduce or remove spatial redundancy in video data within a given video frame or picture. Inter predictive coding relies on temporal prediction to reduce or remove temporal redundancy in video data within adjacent video frames or pictures of a video sequence. It should be noted that the term “frame” may be used as synonyms for the term “image” or “picture” in the field of video coding.

As shown in FIG. 2, the video encoder 20 includes a video data memory 40, a prediction processing unit 41, a Decoded Picture Buffer (DPB) 64, a summer 50, a transform processing unit 52, a quantization unit 54, and an entropy encoding unit 56. The prediction processing unit 41 further includes a motion estimation unit 42, a motion compensation unit 44, a partition unit 45, an intra prediction processing unit 46, and an intra Block Copy (BC) unit 48. In some implementations, the video encoder 20 also includes an inverse quantization unit 58, an inverse transform processing unit 60, and a summer 62 for video block reconstruction. An in-loop filter 63, such as a deblocking filter, may be positioned between the summer 62 and the DPB 64 to filter block boundaries to remove blockiness artifacts from reconstructed video. Another in-loop filter, such as Sample Adaptive Offset (SAO) filter, Cross Component Sample Adaptive Offset (CCSAO) filter and/or Adaptive in-Loop Filter (ALF), may also be used in addition to the deblocking filter to filter an output of the summer 62. It should be illustrated that for the CCSAO technique, the present application is not limited to the embodiments described herein, and instead, the application may be applied to a situation where an offset is selected for any of a luma component, a Cb chroma component and a Cr chroma component according to any other of the luma component, the Cb chroma component and the Cr chroma component to modify said any component based on the selected offset. Further, it should also be illustrated that a first component mentioned herein may be any of the luma component, the Cb chroma component and the Cr chroma component, a second component mentioned herein may be any other of the luma component, the Cb chroma component and the Cr chroma component, and a third component mentioned herein may be a remaining one of the luma component, the Cb chroma component and the Cr chroma component. In some examples, the in-loop filters may be omitted, and the decoded video block may be directly provided by the summer 62 to the DPB 64. The video encoder 20 may take the form of a fixed or programmable hardware unit or may be divided among one or more of the illustrated fixed or programmable hardware units.

The video data memory 40 may store video data to be encoded by the components of the video encoder 20. The video data in the video data memory 40 may be obtained, for example, from the video source 18 as shown in FIG. 1. The DPB 64 is a buffer that stores reference video data (for example, reference frames or pictures) for use in encoding video data by the video encoder 20 (e.g., in intra or inter predictive coding modes). The video data memory 40 and the DPB 64 may be formed by any of a variety of memory devices. In various examples, the video data memory 40 may be on-chip with other components of the video encoder 20, or off-chip relative to those components.

As shown in FIG. 2, after receiving the video data, the partition unit 45 within the prediction processing unit 41 partitions the video data into video blocks. This partitioning may also include partitioning a video frame into slices, tiles (for example, sets of video blocks), or other larger Coding Units (CUs) according to predefined splitting structures such as a Quad-Tree (QT) structure associated with the video data. The video frame is or may be regarded as a two-dimensional array or matrix of samples with sample values. A sample in the array may also be referred to as a pixel or a pel. A number of samples in horizontal and vertical directions (or axes) of the array or picture define a size and/or a resolution of the video frame. The video frame may be divided into multiple video blocks by, for example, using QT partitioning. The video block again is or may be regarded as a two-dimensional array or matrix of samples with sample values, although of smaller dimension than the video frame. A number of samples in horizontal and vertical directions (or axes) of the video block define a size of the video block. The video block may further be partitioned into one or more block partitions or sub-blocks (which may form again blocks) by, for example, iteratively using QT partitioning, Binary-Tree (BT) partitioning or Triple-Tree (TT) partitioning or any combination thereof. It should be noted that the term “block” or “video block” as used herein may be a portion, in particular a rectangular (square or non-square) portion, of a frame or a picture. With reference, for example, to HEVC and VVC, the block or video block may be or correspond to a Coding Tree Unit (CTU), a CU, a Prediction Unit (PU) or a Transform Unit (TU) and/or may be or correspond to a corresponding block, e.g., a Coding Tree Block (CTB), a Coding Block (CB), a Prediction Block (PB) or a Transform Block (TB) and/or to a sub-block.

The prediction processing unit 41 may select one of a plurality of possible predictive coding modes, such as one of a plurality of intra predictive coding modes or one of a plurality of inter predictive coding modes, for the current video block based on error results (e.g., coding rate and the level of distortion). The prediction processing unit 41 may provide the resulting intra or inter prediction coded block to the summer 50 to generate a residual block and to the summer 62 to reconstruct the encoded block for use as part of a reference frame subsequently. The prediction processing unit 41 also provides syntax elements, such as motion vectors, intra-mode indicators, partition information, and other such syntax information, to the entropy encoding unit 56.

In order to select an appropriate intra predictive coding mode for the current video block, the intra prediction processing unit 46 within the prediction processing unit 41 may perform intra predictive coding of the current video block relative to one or more neighbor blocks in the same frame as the current block to be coded to provide spatial prediction. The motion estimation unit 42 and the motion compensation unit 44 within the prediction processing unit 41 perform inter predictive coding of the current video block relative to one or more predictive blocks in one or more reference frames to provide temporal prediction. The video encoder 20 may perform multiple coding passes, e.g., to select an appropriate coding mode for each block of video data.

In some implementations, the motion estimation unit 42 determines the inter prediction mode for a current video frame by generating a motion vector, which indicates the displacement of a video block within the current video frame relative to a predictive block within a reference video frame, according to a predetermined pattern within a sequence of video frames. Motion estimation, performed by the motion estimation unit 42, is the process of generating motion vectors, which estimate motion for video blocks. A motion vector, for example, may indicate the displacement of a video block within a current video frame or picture relative to a predictive block within a reference frame relative to the current block being coded within the current frame. The predetermined pattern may designate video frames in the sequence as P frames or B frames. The intra BC unit 48 may determine vectors, e.g., block vectors, for intra BC coding in a manner similar to the determination of motion vectors by the motion estimation unit 42 for inter prediction, or may utilize the motion estimation unit 42 to determine the block vector.

A predictive block for the video block may be or may correspond to a block or a reference block of a reference frame that is deemed as closely matching the video block to be coded in terms of pixel difference, which may be determined by Sum of Absolute Difference (SAD), Sum of Square Difference (SSD), or other difference metrics. In some implementations, the video encoder 20 may calculate values for sub-integer pixel positions of reference frames stored in the DPB 64. For example, the video encoder 20 may interpolate values of one-quarter pixel positions, one-eighth pixel positions, or other fractional pixel positions of the reference frame. Therefore, the motion estimation unit 42 may perform a motion search relative to the full pixel positions and fractional pixel positions and output a motion vector with fractional pixel precision.

The motion estimation unit 42 calculates a motion vector for a video block in an inter prediction coded frame by comparing the position of the video block to the position of a predictive block of a reference frame selected from a first reference frame list (List 0) or a second reference frame list (List 1), each of which identifies one or more reference frames stored in the DPB 64. The motion estimation unit 42 sends the calculated motion vector to the motion compensation unit 44 and then to the entropy encoding unit 56.

Motion compensation, performed by the motion compensation unit 44, may involve fetching or generating the predictive block based on the motion vector determined by the motion estimation unit 42. Upon receiving the motion vector for the current video block, the motion compensation unit 44 may locate a predictive block to which the motion vector points in one of the reference frame lists, retrieve the predictive block from the DPB 64, and forward the predictive block to the summer 50. The summer 50 then forms a residual video block of pixel difference values by subtracting pixel values of the predictive block provided by the motion compensation unit 44 from the pixel values of the current video block being coded. The pixel difference values forming the residual video block may include luma or chroma component differences or both. The motion compensation unit 44 may also generate syntax elements associated with the video blocks of a video frame for use by the video decoder 30 in decoding the video blocks of the video frame. The syntax elements may include, for example, syntax elements defining the motion vector used to identify the predictive block, any flags indicating the prediction mode, or any other syntax information described herein. Note that the motion estimation unit 42 and the motion compensation unit 44 may be highly integrated, but are illustrated separately for conceptual purposes.

In some implementations, the intra BC unit 48 may generate vectors and fetch predictive blocks in a manner similar to that described above in connection with the motion estimation unit 42 and the motion compensation unit 44, but with the predictive blocks being in the same frame as the current block being coded and with the vectors being referred to as block vectors as opposed to motion vectors. In particular, the intra BC unit 48 may determine an intra-prediction mode to use to encode a current block. In some examples, the intra BC unit 48 may encode a current block using various intra-prediction modes, e.g., during separate encoding passes, and test their performance through rate-distortion analysis. Next, the intra BC unit 48 may select, among the various tested intra-prediction modes, an appropriate intra-prediction mode to use and generate an intra-mode indicator accordingly. For example, the intra BC unit 48 may calculate rate-distortion values using a rate-distortion analysis for the various tested intra-prediction modes, and select the intra-prediction mode having the best rate-distortion characteristics among the tested modes as the appropriate intra-prediction mode to use. Rate-distortion analysis generally determines an amount of distortion (or error) between an encoded block and an original, unencoded block that was encoded to produce the encoded block, as well as a bitrate (i.e., a number of bits) used to produce the encoded block. Intra BC unit 48 may calculate ratios from the distortions and rates for the various encoded blocks to determine which intra-prediction mode exhibits the best rate-distortion value for the block.

In other examples, the intra BC unit 48 may use the motion estimation unit 42 and the motion compensation unit 44, in whole or in part, to perform such functions for Intra BC prediction according to the implementations described herein. In either case, for Intra block copy, a predictive block may be a block that is deemed as closely matching the block to be coded, in terms of pixel difference, which may be determined by SAD, SSD, or other difference metrics, and identification of the predictive block may include calculation of values for sub-integer pixel positions.

Whether the predictive block is from the same frame according to intra prediction, or a different frame according to inter prediction, the video encoder 20 may form a residual video block by subtracting pixel values of the predictive block from the pixel values of the current video block being coded, forming pixel difference values. The pixel difference values forming the residual video block may include both luma and chroma component differences.

The intra prediction processing unit 46 may intra-predict a current video block, as an alternative to the inter-prediction performed by the motion estimation unit 42 and the motion compensation unit 44, or the intra block copy prediction performed by the intra BC unit 48, as described above. In particular, the intra prediction processing unit 46 may determine an intra prediction mode to use to encode a current block. To do so, the intra prediction processing unit 46 may encode a current block using various intra prediction modes, e.g., during separate encoding passes, and the intra prediction processing unit 46 (or a mode selection unit, in some examples) may select an appropriate intra prediction mode to use from the tested intra prediction modes. The intra prediction processing unit 46 may provide information indicative of the selected intra-prediction mode for the block to the entropy encoding unit 56. The entropy encoding unit 56 may encode the information indicating the selected intra-prediction mode in the bitstream.

After the prediction processing unit 41 determines the predictive block for the current video block via either inter prediction or intra prediction, the summer 50 forms a residual video block by subtracting the predictive block from the current video block. The residual video data in the residual block may be included in one or more TUs and is provided to the transform processing unit 52. The transform processing unit 52 transforms the residual video data into residual transform coefficients using a transform, such as a Discrete Cosine Transform (DCT) or a conceptually similar transform.

The transform processing unit 52 may send the resulting transform coefficients to the quantization unit 54. The quantization unit 54 quantizes the transform coefficients to further reduce the bit rate. The quantization process may also reduce the bit depth associated with some or all of the coefficients. The degree of quantization may be modified by adjusting a quantization parameter. In some examples, the quantization unit 54 may then perform a scan of a matrix including the quantized transform coefficients. Alternatively, the entropy encoding unit 56 may perform the scan.

Following quantization, the entropy encoding unit 56 entropy encodes the quantized transform coefficients into a video bitstream using, e.g., Context Adaptive Variable Length Coding (CAVLC), Context Adaptive Binary Arithmetic Coding (CABAC), Syntax-based context-adaptive Binary Arithmetic Coding (SBAC), Probability Interval Partitioning Entropy (PIPE) coding or another entropy encoding methodology or technique. The encoded bitstream may then be transmitted to the video decoder 30 as shown in FIG. 1, or archived in the storage device 32 as shown in FIG. 1 for later transmission to or retrieval by the video decoder 30. The entropy encoding unit 56 may also entropy encode the motion vectors and the other syntax elements for the current video frame being coded.

The inverse quantization unit 58 and the inverse transform processing unit 60 apply inverse quantization and inverse transformation, respectively, to reconstruct the residual video block in the pixel domain for generating a reference block for prediction of other video blocks. As noted above, the motion compensation unit 44 may generate a motion compensated predictive block from one or more reference blocks of the frames stored in the DPB 64. The motion compensation unit 44 may also apply one or more interpolation filters to the predictive block to calculate sub-integer pixel values for use in motion estimation.

The summer 62 adds the reconstructed residual block to the motion compensated predictive block produced by the motion compensation unit 44 to produce a reference block for storage in the DPB 64. The reference block may then be used by the intra BC unit 48, the motion estimation unit 42 and the motion compensation unit 44 as a predictive block to inter predict another video block in a subsequent video frame.

FIG. 3 is a block diagram illustrating another exemplary video decoder 30 in accordance with some implementations of the present application. The video decoder 30 includes a video data memory 79, an entropy decoding unit 80, a prediction processing unit 81, an inverse quantization unit 86, an inverse transform processing unit 88, a summer 90, and a DPB 92. The prediction processing unit 81 further includes a motion compensation unit 82, an intra prediction unit 84, and an intra BC unit 85. The video decoder 30 may perform a decoding process generally reciprocal to the encoding process described above with respect to the video encoder 20 in connection with FIG. 2. For example, the motion compensation unit 82 may generate prediction data based on motion vectors received from the entropy decoding unit 80, while the intra-prediction unit 84 may generate prediction data based on intra-prediction mode indicators received from the entropy decoding unit 80.

In some examples, a unit of the video decoder 30 may be tasked to perform the implementations of the present application. Also, in some examples, the implementations of the present disclosure may be divided among one or more of the units of the video decoder 30. For example, the intra BC unit 85 may perform the implementations of the present application, alone, or in combination with other units of the video decoder 30, such as the motion compensation unit 82, the intra prediction unit 84, and the entropy decoding unit 80. In some examples, the video decoder 30 may not include the intra BC unit 85 and the functionality of intra BC unit 85 may be performed by other components of the prediction processing unit 81, such as the motion compensation unit 82.

The video data memory 79 may store video data, such as an encoded video bitstream, to be decoded by the other components of the video decoder 30. The video data stored in the video data memory 79 may be obtained, for example, from the storage device 32, from a local video source, such as a camera, via wired or wireless network communication of video data, or by accessing physical data storage media (e.g., a flash drive or hard disk). The video data memory 79 may include a Coded Picture Buffer (CPB) that stores encoded video data from an encoded video bitstream. The DPB 92 of the video decoder 30 stores reference video data for use in decoding video data by the video decoder 30 (e.g., in intra or inter predictive coding modes). The video data memory 79 and the DPB 92 may be formed by any of a variety of memory devices, such as dynamic random access memory (DRAM), including Synchronous DRAM (SDRAM), Magneto-resistive RAM (MRAM), Resistive RAM (RRAM), or other types of memory devices. For illustrative purpose, the video data memory 79 and the DPB 92 are depicted as two distinct components of the video decoder 30 in FIG. 3. But it will be apparent to one skilled in the art that the video data memory 79 and the DPB 92 may be provided by the same memory device or separate memory devices. In some examples, the video data memory 79 may be on-chip with other components of the video decoder 30, or off-chip relative to those components.

During the decoding process, the video decoder 30 receives an encoded video bitstream that represents video blocks of an encoded video frame and associated syntax elements. The video decoder 30 may receive the syntax elements at the video frame level and/or the video block level. The entropy decoding unit 80 of the video decoder 30 entropy decodes the bitstream to generate quantized coefficients, motion vectors or intra-prediction mode indicators, and other syntax elements. The entropy decoding unit 80 then forwards the motion vectors or intra-prediction mode indicators and other syntax elements to the prediction processing unit 81.

When the video frame is coded as an intra predictive coded (I) frame or for intra coded predictive blocks in other types of frames, the intra prediction unit 84 of the prediction processing unit 81 may generate prediction data for a video block of the current video frame based on a signaled intra prediction mode and reference data from previously decoded blocks of the current frame.

When the video frame is coded as an inter-predictive coded (i.e., B or P) frame, the motion compensation unit 82 of the prediction processing unit 81 produces one or more predictive blocks for a video block of the current video frame based on the motion vectors and other syntax elements received from the entropy decoding unit 80. Each of the predictive blocks may be produced from a reference frame within one of the reference frame lists. The video decoder 30 may construct the reference frame lists, List 0 and List 1, using default construction techniques based on reference frames stored in the DPB 92.

In some examples, when the video block is coded according to the intra BC mode described herein, the intra BC unit 85 of the prediction processing unit 81 produces predictive blocks for the current video block based on block vectors and other syntax elements received from the entropy decoding unit 80. The predictive blocks may be within a reconstructed region of the same picture as the current video block defined by the video encoder 20.

The motion compensation unit 82 and/or the intra BC unit 85 determines prediction information for a video block of the current video frame by parsing the motion vectors and other syntax elements, and then uses the prediction information to produce the predictive blocks for the current video block being decoded. For example, the motion compensation unit 82 uses some of the received syntax elements to determine a prediction mode (e.g., intra or inter prediction) used to code video blocks of the video frame, an inter prediction frame type (e.g., B or P), construction information for one or more of the reference frame lists for the frame, motion vectors for each inter predictive encoded video block of the frame, inter prediction status for each inter predictive coded video block of the frame, and other information to decode the video blocks in the current video frame.

Similarly, the intra BC unit 85 may use some of the received syntax elements, e.g., a flag, to determine that the current video block was predicted using the intra BC mode, construction information of which video blocks of the frame are within the reconstructed region and should be stored in the DPB 92, block vectors for each intra BC predicted video block of the frame, intra BC prediction status for each intra BC predicted video block of the frame, and other information to decode the video blocks in the current video frame.

The motion compensation unit 82 may also perform interpolation using the interpolation filters as used by the video encoder 20 during encoding of the video blocks to calculate interpolated values for sub-integer pixels of reference blocks. In this case, the motion compensation unit 82 may determine the interpolation filters used by the video encoder 20 from the received syntax elements and use the interpolation filters to produce predictive blocks.

The inverse quantization unit 86 inverse quantizes the quantized transform coefficients provided in the bitstream and entropy decoded by the entropy decoding unit 80 using the same quantization parameter calculated by the video encoder 20 for each video block in the video frame to determine a degree of quantization. The inverse transform processing unit 88 applies an inverse transform, e.g., an inverse DCT, an inverse integer transform, or a conceptually similar inverse transform process, to the transform coefficients in order to reconstruct the residual blocks in the pixel domain.

After the motion compensation unit 82 or the intra BC unit 85 generates the predictive block for the current video block based on the vectors and other syntax elements, the summer 90 reconstructs decoded video block for the current video block by summing the residual block from the inverse transform processing unit 88 and a corresponding predictive block generated by the motion compensation unit 82 and the intra BC unit 85. An in-loop filter 91 such as deblocking filter, SAO filter, CCSAO filter and/or ALF may be positioned between the summer 90 and the DPB 92 to further process the decoded video block. In some examples, the in-loop filter 91 may be omitted, and the decoded video block may be directly provided by the summer 90 to the DPB 92. The decoded video blocks in a given frame are then stored in the DPB 92, which stores reference frames used for subsequent motion compensation of next video blocks. The DPB 92, or a memory device separate from the DPB 92, may also store decoded video for later presentation on a display device, such as the display device 34 of FIG. 1.

In a typical video coding process, a video sequence typically includes an ordered set of frames or pictures. Each frame may include three sample arrays, denoted SL, SCb, and SCr. SL is a two-dimensional array of luma samples. SCb is a two-dimensional array of Cb chroma samples. SCr is a two-dimensional array of Cr chroma samples. In other instances, a frame may be monochrome and therefore includes only one two-dimensional array of luma samples.

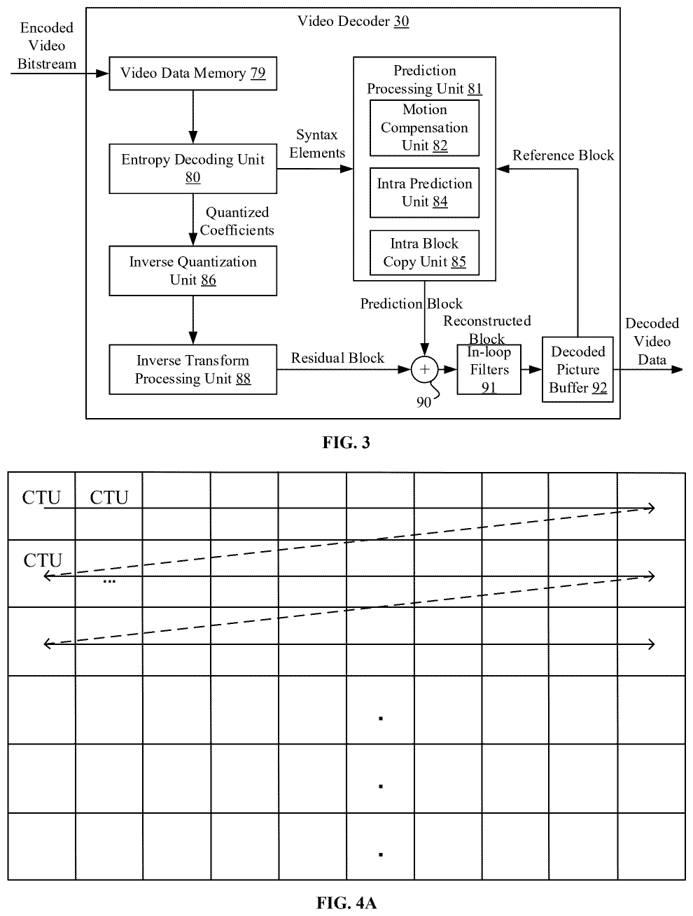

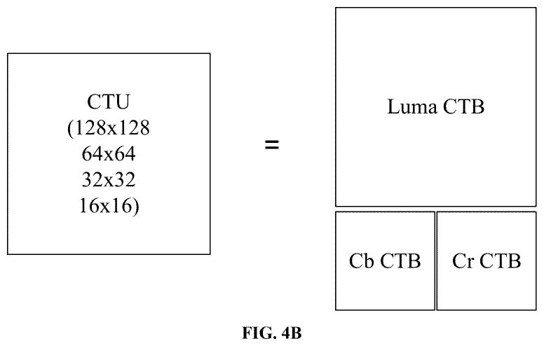

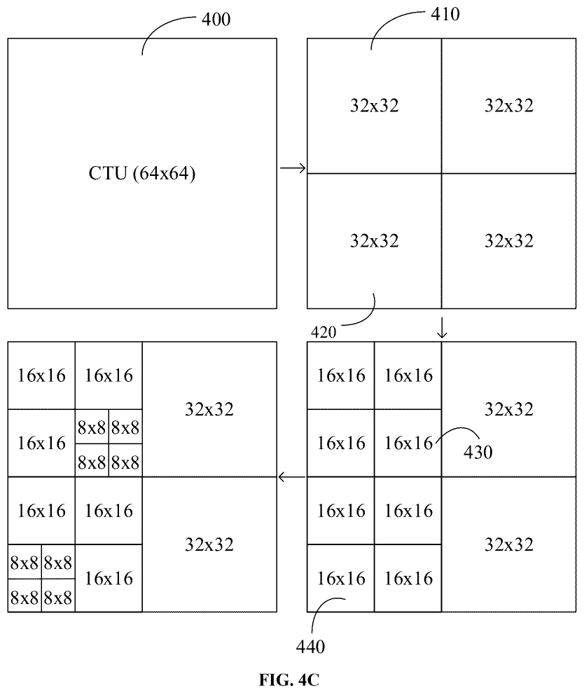

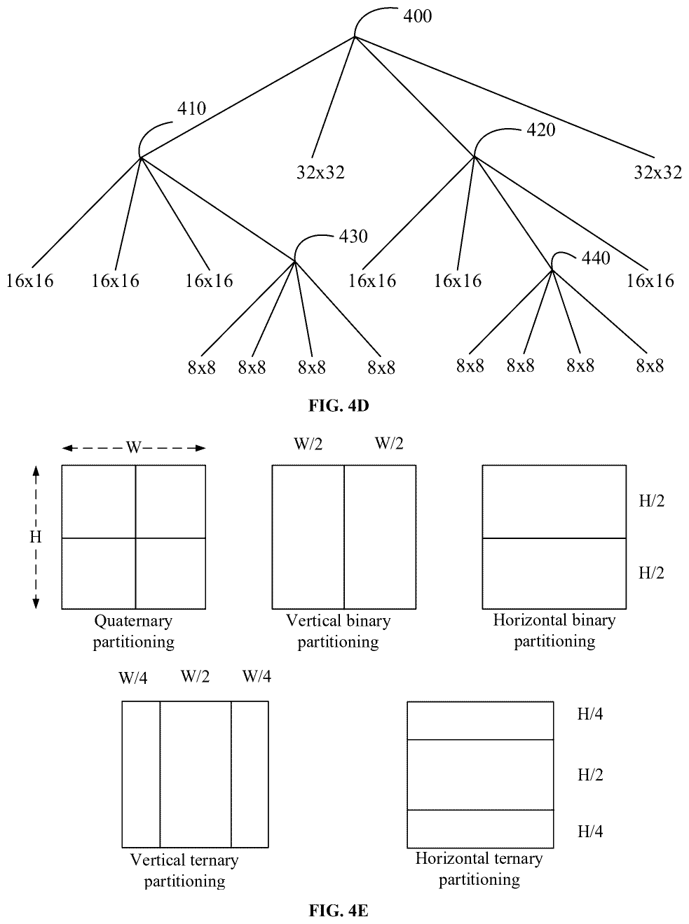

As shown in FIG. 4A, the video encoder 20 (or more specifically a partition unit in a prediction processing unit of the video encoder 20) generates an encoded representation of a frame by first partitioning the frame into a set of CTUs. A video frame may include an integer number of CTUs ordered consecutively in a raster scan order from left to right and from top to bottom. Each CTU is a largest logical coding unit and the width and height of the CTU are signaled by the video encoder 20 in a sequence parameter set, such that all the CTUs in a video sequence have the same size being one of 128×128, 64×64, 32×32, and 16×16. But it should be noted that the present application is not necessarily limited to a particular size. As shown in FIG. 4B, each CTU may include one CTB of luma samples, two corresponding coding tree blocks of chroma samples, and syntax elements used to code the samples of the coding tree blocks. The syntax elements describe properties of different types of units of a coded block of pixels and how the video sequence can be reconstructed at the video decoder 30, including inter or intra prediction, intra prediction mode, motion vectors, and other parameters. In monochrome pictures or pictures having three separate color planes, a CTU may include a single coding tree block and syntax elements used to code the samples of the coding tree block. A coding tree block may be an N×N block of samples.

To achieve a better performance, the video encoder 20 may recursively perform tree partitioning such as binary-tree partitioning, ternary-tree partitioning, quad-tree partitioning or a combination thereof on the coding tree blocks of the CTU and divide the CTU into smaller CUs. FIGS. 4B-4E are block diagrams illustrating how a frame is recursively partitioned into multiple video blocks of different sizes and shapes in accordance with some implementations of the present disclosure. As depicted in FIG. 4C, the 64×64 CTU 400 is first divided into four smaller CUs, each having a block size of 32×32. Among the four smaller CUs, CU 410 and CU 420 are each divided into four CUs of 16×16 by block size. The two 16×16 CUs 430 and 440 are each further divided into four CUs of 8×8 by block size. FIG. 4D depicts a quad-tree data structure illustrating the end result of the partition process of the CTU 400 as depicted in FIG. 4C, each leaf node of the quad-tree corresponding to one CU of a respective size ranging from 32×32 to 8×8. Like the CTU depicted in FIG. 4B, each CU may include a CB of luma samples and two corresponding coding blocks of chroma samples of a frame of the same size, and syntax elements used to code the samples of the coding blocks. In monochrome pictures or pictures having three separate color planes, a CU may include a single coding block and syntax structures used to code the samples of the coding block. It should be noted that the quad-tree partitioning depicted in FIGS. 4C and 4D is only for illustrative purposes and one CTU can be split into CUs to adapt to varying local characteristics based on quad/ternary/binary-tree partitions. In the multi-type tree structure, one CTU is partitioned by a quad-tree structure and each quad-tree leaf CU can be further partitioned by a binary and ternary tree structure. As shown in FIG. 4E, there are five possible partitioning types of a coding block having a width W and a height H, i.e., quaternary partitioning, horizontal binary partitioning, vertical binary partitioning, horizontal ternary partitioning, and vertical ternary partitioning.

In some implementations, the video encoder 20 may further partition a coding block of a CU into one or more M×N PBs. APB is a rectangular (square or non-square) block of samples on which the same prediction, inter or intra, is applied. A PU of a CU may include a PB of luma samples, two corresponding PBs of chroma samples, and syntax elements used to predict the PBs. In monochrome pictures or pictures having three separate color planes, a PU may include a single PB and syntax structures used to predict the PB. The video encoder 20 may generate predictive luma, Cb, and Cr blocks for luma, Cb, and Cr PBs of each PU of the CU.

The video encoder 20 may use intra prediction or inter prediction to generate the predictive blocks for a PU. If the video encoder 20 uses intra prediction to generate the predictive blocks of a PU, the video encoder 20 may generate the predictive blocks of the PU based on decoded samples of the frame associated with the PU. If the video encoder 20 uses inter prediction to generate the predictive blocks of a PU, the video encoder 20 may generate the predictive blocks of the PU based on decoded samples of one or more frames other than the frame associated with the PU.

After the video encoder 20 generates predictive luma, Cb, and Cr blocks for one or more PUs of a CU, the video encoder 20 may generate a luma residual block for the CU by subtracting the CU's predictive luma blocks from its original luma coding block such that each sample in the CU's luma residual block indicates a difference between a luma sample in one of the CU's predictive luma blocks and a corresponding sample in the CU's original luma coding block. Similarly, the video encoder 20 may generate a Cb residual block and a Cr residual block for the CU, respectively, such that each sample in the CU's Cb residual block indicates a difference between a Cb sample in one of the CU's predictive Cb blocks and a corresponding sample in the CU's original Cb coding block and each sample in the CU's Cr residual block may indicate a difference between a Cr sample in one of the CU's predictive Cr blocks and a corresponding sample in the CU's original Cr coding block.

Furthermore, as illustrated in FIG. 4C, the video encoder 20 may use quad-tree partitioning to decompose the luma, Cb, and Cr residual blocks of a CU into one or more luma, Cb, and Cr transform blocks respectively. A transform block is a rectangular (square or non-square) block of samples on which the same transform is applied. A TU of a CU may include a transform block of luma samples, two corresponding transform blocks of chroma samples, and syntax elements used to transform the transform block samples. Thus, each TU of a CU may be associated with a luma transform block, a Cb transform block, and a Cr transform block. In some examples, the luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may include a single transform block and syntax structures used to transform the samples of the transform block.

The video encoder 20 may apply one or more transforms to a luma transform block of a TU to generate a luma coefficient block for the TU. A coefficient block may be a two-dimensional array of transform coefficients. A transform coefficient may be a scalar quantity. The video encoder 20 may apply one or more transforms to a Cb transform block of a TU to generate a Cb coefficient block for the TU. The video encoder 20 may apply one or more transforms to a Cr transform block of a TU to generate a Cr coefficient block for the TU.

After generating a coefficient block (e.g., a luma coefficient block, a Cb coefficient block or a Cr coefficient block), the video encoder 20 may quantize the coefficient block. Quantization generally refers to a process in which transform coefficients are quantized to possibly reduce the amount of data used to represent the transform coefficients, providing further compression. After the video encoder 20 quantizes a coefficient block, the video encoder 20 may entropy encode syntax elements indicating the quantized transform coefficients. For example, the video encoder 20 may perform CABAC on the syntax elements indicating the quantized transform coefficients. Finally, the video encoder 20 may output a bitstream that includes a sequence of bits that forms a representation of coded frames and associated data, which is either saved in the storage device 32 or transmitted to the destination device 14.

After receiving a bitstream generated by the video encoder 20, the video decoder 30 may parse the bitstream to obtain syntax elements from the bitstream. The video decoder 30 may reconstruct the frames of the video data based at least in part on the syntax elements obtained from the bitstream. The process of reconstructing the video data is generally reciprocal to the encoding process performed by the video encoder 20. For example, the video decoder 30 may perform inverse transforms on the coefficient blocks associated with TUs of a current CU to reconstruct residual blocks associated with the TUs of the current CU. The video decoder 30 also reconstructs the coding blocks of the current CU by adding the samples of the predictive blocks for PUs of the current CU to corresponding samples of the transform blocks of the TUs of the current CU. After reconstructing the coding blocks for each CU of a frame, video decoder 30 may reconstruct the frame.

As noted above, video coding achieves video compression using primarily two modes, i.e., intra-frame prediction (or intra-prediction) and inter-frame prediction (or inter-prediction). It is noted that IBC could be regarded as either intra-frame prediction or a third mode. Between the two modes, inter-frame prediction contributes more to the coding efficiency than intra-frame prediction because of the use of motion vectors for predicting a current video block from a reference video block.

But with the ever improving video data capturing technology and more refined video block size for preserving details in the video data, the amount of data required for representing motion vectors for a current frame also increases substantially. One way of overcoming this challenge is to benefit from the fact that not only a group of neighboring CUs in both the spatial and temporal domains have similar video data for predicting purpose but the motion vectors between these neighboring CUs are also similar. Therefore, it is possible to use the motion information of spatially neighboring CUs and/or temporally co-located CUs as an approximation of the motion information (e.g., motion vector) of a current CU by exploring their spatial and temporal correlation, which is also referred to as “Motion Vector Predictor (MVP)” of the current CU.

Instead of encoding, into the video bitstream, an actual motion vector of the current CU determined by the motion estimation unit 42 as described above in connection with FIG. 2, the motion vector predictor of the current CU is subtracted from the actual motion vector of the current CU to produce a Motion Vector Difference (MVD) for the current CU. By doing so, there is no need to encode the motion vector determined by the motion estimation unit 42 for each CU of a frame into the video bitstream and the amount of data used for representing motion information in the video bitstream can be significantly decreased.

Like the process of choosing a predictive block in a reference frame during inter-frame prediction of a code block, a set of rules need to be adopted by both the video encoder 20 and the video decoder 30 for constructing a motion vector candidate list (also known as a “merge list”) for a current CU using those potential candidate motion vectors associated with spatially neighboring CUs and/or temporally co-located CUs of the current CU and then selecting one member from the motion vector candidate list as a motion vector predictor for the current CU. By doing so, there is no need to transmit the motion vector candidate list itself from the video encoder 20 to the video decoder 30 and an index of the selected motion vector predictor within the motion vector candidate list is sufficient for the video encoder 20 and the video decoder 30 to use the same motion vector predictor within the motion vector candidate list for encoding and decoding the current CU.

In general, the basic inter prediction scheme applied in VVC is almost kept the same as that of HEVC, except that several prediction tools are further extended, added and/or improved, e.g., extended merge prediction, MMVD, and GPM.

### Extended Merge Prediction

With the ever improving video data capturing technology and more refined video block size for preserving details in the video data, an amount of data required for representing motion vectors for a current picture also increases substantially. One way of overcoming this challenge is to use motion information (e.g., a motion vector) of a spatially neighboring CU, a temporally collocated CU etc. of a current CU as an approximation (e.g., prediction) of motion information of the current CU, which is also referred to as “Motion Vector Predictor (MVP)” of the current Cu.

Like a process of choosing a predictive block in a reference picture during inter-prediction of a coding block, a set of rules need to be adopted by both the video encoder 20 and the video decoder 30 for constructing an MVP candidate list for a current CU and then selecting one MVP candidate from the MVP candidate list as an MVP for the current CU. By doing so, there is no need to transmit the MVP candidate list itself between the video encoder 20 and the video decoder 30, and an index of the MVP candidate selected from the MVP candidate list is sufficient for the video encoder 20 and the video decoder 30 to use the same MVP candidate selected from the MVP candidate list for encoding and decoding the current Cu.

In VVC, the MVP candidate list is constructed by including the following five types of MVPs in order:
Spatial MVP from spatially neighboring CUs (i.e., spatial candidates);
Temporal MVP from temporally collocated CUs (i.e., temporal candidates);
History-based MVP (HMVP) from a First-In-First-Out (FIFO) table;
Pairwise average MVP; and
Zero MVPs.

A size of the MVP candidate list is signalled in a sequence parameter set header and a maximum allowed size of the MVP candidate list is 6. For each CU coded in merge mode, an index of the best MVP candidate is encoded using truncated unary binarization. A first bin of the index is coded with contexts and bypass coding is used for other bins of the index.

A derivation process of each type of MVPs is provided as follows. As in HEVC, VVC also supports parallel derivation of MVP candidate lists for all CUs within a certain size of area.

Derivation of MVPs from Spatial Candidates

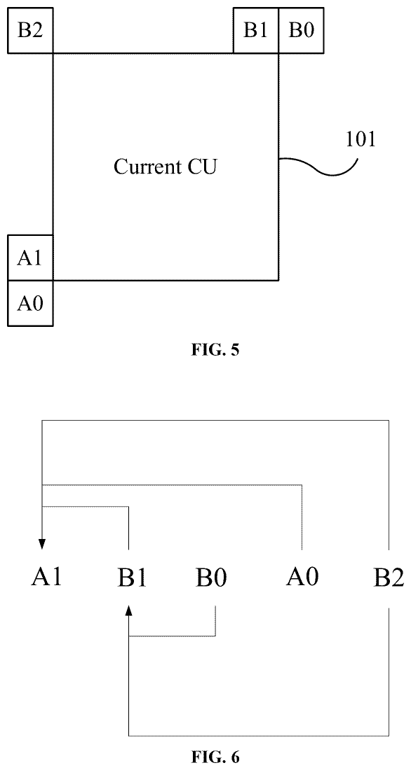

The derivation of MVPs from spatial candidates (for example, CUs neighboring a current CU 101 in FIG. 5) in VVC is the same as that in HEVC except that positions of first two spatial candidates are swapped. A maximum of four spatial candidates are selected from spatial candidates located at positions depicted in FIG. 5, that is, a top position B0, a left position A0, a top-right position B1, a bottom-left position A1 and a top-left position B2. The derivation is performed in an order of CUs at the positions B0, A0, B1, A1 and B2. A CU at the position B2 is considered only when one or more CUs at the positions B0, A0, B1 and A1 are not available (for example, because said one or more CUs belong to other slices or tiles) or is intra coded.

After a CU at the position B0 is added as a candidate to a merge candidate list, the addition of the remaining candidates to the merge candidate list is subject to redundancy check, which ensures that candidates with the same motion information are excluded from the merge candidate list, so that coding efficiency is improved. To reduce computational complexity, not all possible candidate pairs are considered in the redundancy check. Instead, only pairs linked using a line with an arrow in FIG. 6 are considered and a candidate is added to the merge candidate list only if a candidate in a corresponding pair used for the redundancy check has not the same motion information as that of the candidate to be added. Spatial MVPs derived from the candidates in the merge candidate list are added to the MVP candidate list.

Derivation of MVPs from Temporal Candidates

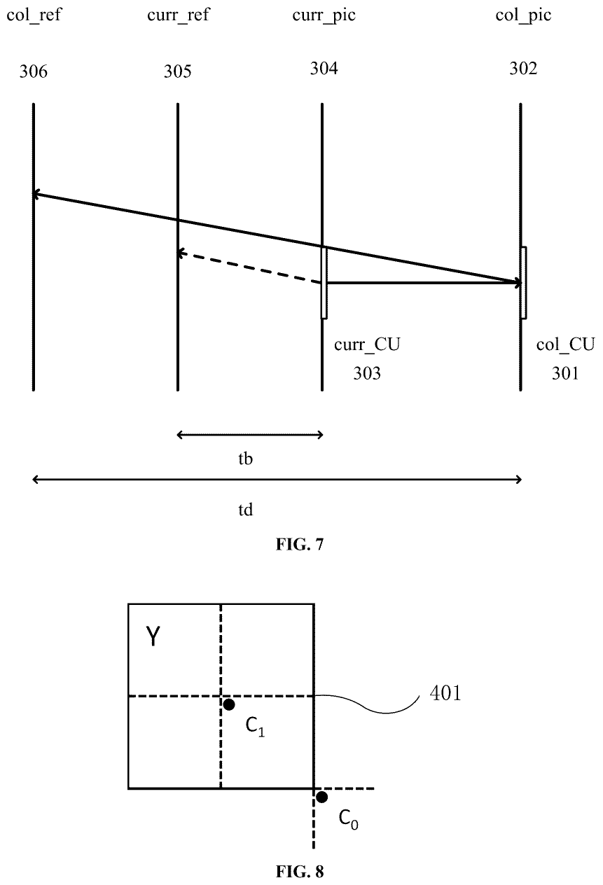

During the derivation of MVPs from temporal candidates, only one temporal candidate is added to the merge candidate list. Particularly, in the derivation of an MVP from this temporal candidate, a scaled motion vector is derived based on a collocated CU (for example, col_CU 301 in FIG. 7) as the temporal candidate belonging to a collocated picture (for example, col_pic 302 in FIG. 7) for a current CU (for example, curr_CU 303 in FIG. 7), and is added as a temporal MVP candidate to the MVP candidate list. A reference picture list and a reference picture index to be used for derivation of the collocated CU are explicitly signalled in a slice header. The scaled motion vector is obtained (i.e., scaled) from a motion vector of the collocated CU using Picture Order Count (POC) distances, i.e., tb and td, as illustrated in FIG. 7, where tb is defined to be a POC difference between a reference picture (for example, curr_ref 305 in FIG. 7) of the current picture (for example, curr_pic 304 in FIG. 7) and the current picture and td is defined to be a POC difference between a reference picture (for example, col_ref 306 in FIG. 7) of the collocated picture and the collocated picture. A reference picture index of the temporal candidate is set equal to zero.

A position for the temporal candidate (i.e., the collocated CU) in the current CU 401 is selected between positions C0 and C1, as depicted in FIG. 8. If a CU at position C0 in the collocated picture is not available, is intra coded, or is outside of a current row of CTUs, a CU at position C1 is used as the collocated CU for the derivation of the temporal MVP candidate. Otherwise, a CU at position C0 is used as the collocated CU for the derivation of the temporal MVP candidate.

### Derivation of HMVP Candidates

HMVP candidates are added to the MVP candidate list after the spatial MVPs and the temporal MVP. Motion information of a previously coded block is stored in an HMVP table and used as an MVP for the current CU. The table with multiple HMVP candidates is maintained during the encoding/decoding process. The table is reset (emptied) when a new row of CTUs is encountered. Whenever there is a non-subblock inter-coded CU, associated motion information is added to a last entry of the HMVP table as a new HMVP candidate.

A size of the HMVP table is set to 6. When a new HMVP candidate is inserted into the HMVP table, a constrained FIFO rule is utilized, wherein redundancy check is firstly applied to find whether there is an identical HMVP in the HMVP table. If found, the identical HMVP is removed from the HMVP table and all the HMVP candidates afterwards are moved forward, and the identical HMVP is added to the last entry of the HMVP table.

HMVP candidates may be used in the MVP candidate list construction process. The latest several HMVP candidates in the HMVP table are checked in order and inserted into the MVP candidate list after the temporal MVP candidate. Redundancy check is applied on the HMVP candidates relative to the spatial candidates and/or temporal MVP candidate.

To reduce a number of redundancy check operations, the following simplifications are introduced:
Last two entries in the HMVP table are redundancy checked relative to spatial MVP candidates derived from the spatial candidates at the positions A1 and B1, respectively; and
Once a total number of available MVP candidates reaches the maximum allowed size of the MVP candidate list minus 1, the MVP candidate list construction process from HMVP candidates is terminated.

### Derivation of Pairwise Average MVP Candidates

Pairwise average MVP candidates are generated by averaging MVPs derived using a predefined pair of first two merge candidates in the existing merge candidate list. A first merge candidate in the predefined pair may be defined as p0Cand and a second merge candidate in the predefined pair may be defined as p1Cand. Averaged motion vectors are calculated according to availability of motion vectors of p0Cand and p1Cand separately for each reference picture list. If both motion vectors are available for one reference picture list, these two motion vectors are averaged even when they point to different reference pictures, and a reference picture of the averaged motion vector is set to a reference picture of p0Cand; if only one motion vector is available for one reference picture list, the motion vector is used directly; if no motion vector is available for one reference picture list, the motion vector and the reference picture index for this reference picture list are kept invalid.

### Zero MVPs

When the MVP candidate list is not full after the pairwise average MVP candidates are added, zero MVPs are inserted at the end of the MVP candidate list until the maximum allowed size of the MVP candidate list is reached.

### MMVD

As described above, in the merge mode, motion information (i.e., an MVP candidate) is implicitly derived from an MVP candidate list constructed for a current CU and is directly used as an MV of the current CU for generation of prediction samples of the current CU, which may result in a certain error between an actual MV of the current CU and the implicitly derived MVP. In order to increase the accuracy of an MV of the current CU, MMVD is introduced in VVC where a Motion Vector Difference (MVD) of the current CU is added to the implicitly derived MVP to obtain the MV of the current CU. An MMVD flag is signalled after a regular merge flag is transmitted to specify whether an MMVD mode is used for the current CU.

In the MMVD mode, after an MVP candidate is selected from first two MVP candidates in the MVP candidate list, MMVD information is signalled, wherein the MMVD information includes an MMVD candidate flag which is used to specify which one of the first two MVP candidates is selected to be used as an MV basis, a distance index for indication of motion magnitude information of the MVD, and a direction index for indication of motion direction information of the MVD.

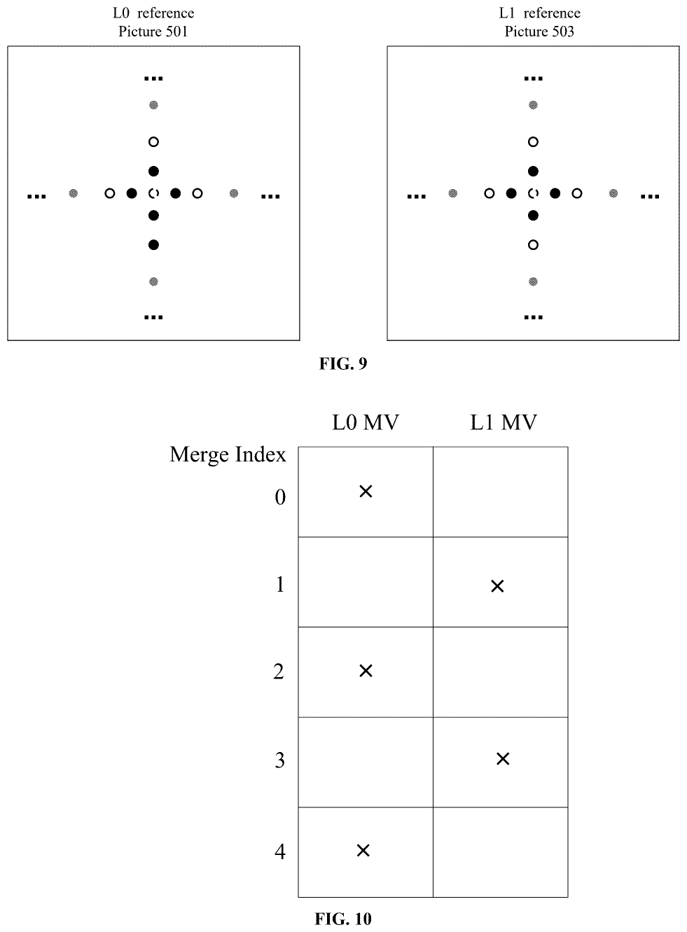

The distance index, which specifies the motion magnitude information of the MVD, indicates a pre-defined offset from a starting point (represented by, for example, a dotted circle in FIG. 9) in a reference picture (for example, L0 reference picture 501 or L1 reference picture 503 in FIG. 9) of the current CU to which the selected MVP candidate points, and the MVD may be derived from the offset and may be added to the selected MVP candidate. A relation between distance indexes and pre-defined offsets is specified in Table 1 below.

TABLE 1

| Distance index | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma samples) | | | | | | | | |

The direction index specifies a sign of the MVD, which represents a direction of the MVD relative to the starting point. Table 2 specifies a relation between direction indexes and pre-defined signs. In some examples, the meaning of a sign of the MVD may be variant according to information of the selected MVP candidate. When the selected MVP candidate is an un-prediction MV or bi-prediction MVs with both MVs pointing to the same side of the current picture (i.e., POCs of two reference pictures (for example, reference pictures of list 0 and list 1, which are also referred to as L0 reference picture and L1 reference picture respectively) of the current picture are both greater than a POC of the current picture, or are both less than the POC of the current picture), the sign in Table 2 specifies the sign of the MVD added to the selected MVP candidate. When the selected MVP candidate is bi-prediction MVs with both MVs pointing to different sides of the current picture (i.e. a POC of one reference picture of the current picture is greater than the POC of the current picture, and a POC of the other reference picture of the current picture is less than the POC of the current picture), if a POC distance for L0 reference picture (i.e., a POC distance between the L0 reference picture and the current picture) is greater than a POC distance for L1 reference picture (i.e., a POC distance between the L1 reference picture and the current picture), the sign in Table 2 specifies a sign of an MVD for list 0 MVD0 added to an MVP for list 0 MVP0 of the selected MVP candidate and a sign of an MVD for list 1 MVD1 added to an MVP for list 1 MVP1 of the selected MVP candidate is opposite to the sign in Table 2; otherwise, if the POC distance for L1 reference picture is greater than the POC distance for L0 reference picture, the sign in Table 2 specifies the sign of MVD1 added to MVP1 and the sign of MVD0 added to MVP0 is opposite to the sign in Table 2.

TABLE 2

| Direction indexes | 00 | 01 | 10 | 11 |
|---|---|---|---|---|
| x-axis | + | − | N/A | N/A |
| y-axis | N/A | N/A | + | − |

The MVD is scaled according to the POC distances. If the POC distances for both L0 reference picture and L1 reference picture are the same, no scaling is needed for the MVD. Otherwise, if the POC distance for L0 reference picture is greater than the POC distance for L1 reference picture, MVD1 is scaled. If the POC distance for L1 reference picture is greater than the POC distance for L0 reference picture, MVD0 is scaled.

### GPM

In VVC, GPM is supported for inter prediction. The GPM is signalled using a CU-level flag as one kind of merge mode, with other merge modes including the regular merge mode, the MMVD mode, the CIIP mode and the subblock merge mode. A total of 64 partitions are supported by GPM for each possible CU size W×H (W=2^{m} and H=2ⁿ, with m, nϵ{3, 4, 5, 6}) excluding 8×64 and 64×8.

When the GPM is used, a CU is split into two parts by a geometrically located straight line. The position of the splitting line is mathematically derived from angle and offset parameters of a specific partition. Each part of the CU obtained by the geometrical partitioning is inter-predicted using its own motion; and only uni-prediction is allowed for each partition, that is, each part has one motion vector and one reference index. The uni-prediction motion constraint is applied to ensure that like the conventional bi-prediction, only two motion compensated predictions are needed for each CU.

If the GPM is used for the current CU, then a geometric partition index indicating a partition mode of the geometric partitioning (indicating an angle and an offset of the geometric partitioning), and two merge indexes (one for each partition) are further signalled.

A uni-prediction candidate list is derived directly from a merge candidate list constructed according to the extended merge prediction process described above. Denote n as an index of a uni-prediction motion vector in the uni-prediction candidate list. An LX motion vector of an n^{th} merge candidate in the merge candidate list, with X equal to a parity of n, is used as the n^{th} uni-prediction motion vector for the GPM. These motion vectors are marked with “x” in FIG. 10. In a case that a corresponding LX motion vector of the n^{th} merge candidate in the merge candidate list does not exist, an L(1−X) motion vector of the same merge candidate is used instead as the uni-prediction motion vector for the GPM.

### CIIP

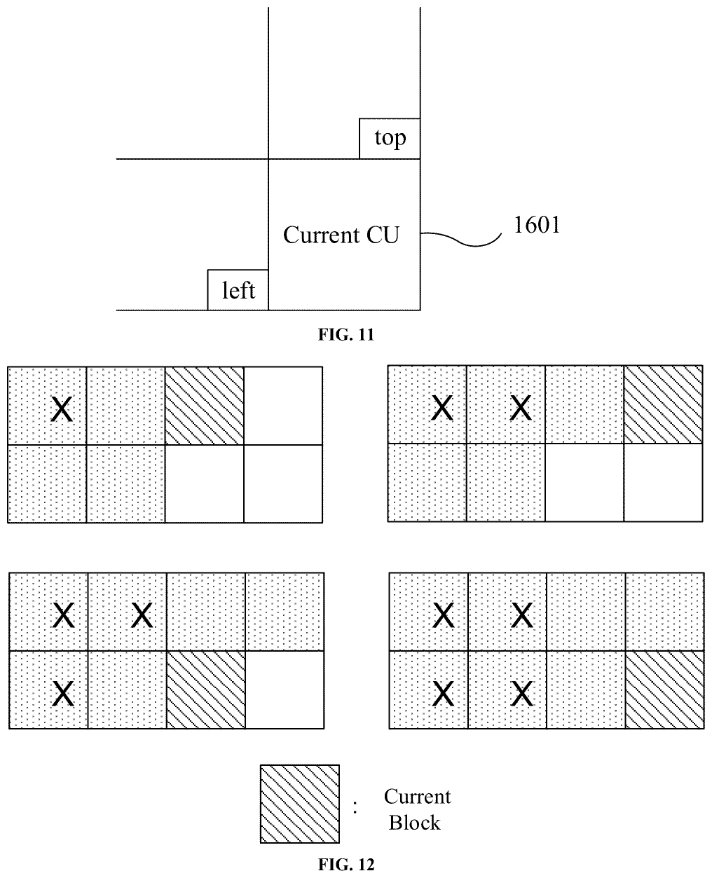

In VVC, when a CU is coded in a merge mode, if the CU contains at least 64 luma samples (that is, a width of CU times a height of the CU is equal to or larger than 64), and if both the width and the height of the CU are less than 128 luma samples, an additional flag is signalled to indicate if a CIIP mode is applied to the current CU. In the CIIP mode, a prediction signal is obtained by combining an inter prediction signal with an intra prediction signal. The inter prediction signal in the CIIP mode is derived using the same inter prediction process as that applied in the regular merge mode; and the intra prediction signal in the CIIP mode is derived following the regular intra prediction process with a planar mode. Then, the intra prediction signal and the inter prediction signal are combined using weighted averaging, where a weight value is calculated depending on coding modes of top and left neighboring blocks of the current CU 1601 (as shown in FIG. 11) as follows:
If the top neighboring block is available and is intra coded, then isIntraTop is set to 1, otherwise isIntraTop is set to 0;
If the left neighboring block is available and is intra coded, then isIntraLeft is set to 1, otherwise isIntraLeft is set to 0;
If (isIntraLeft+isIntraTop) is equal to 2, then the weight value is set to 3;
Otherwise, if (isIntraLeft+isIntraTop) is equal to 1, then the weight value is set to 2;
Otherwise, the weight value is set to 1.
The prediction signal P_{CIIP} in the CIIP mode is derived as follows:

$${P}_{CIIP} = ( ( 4 - wt ) * {P}_{inter} + wt * {P}_{intra} + 2 ) >> 2 \qquad ( 1 )$$

Where Pᵢₙₜₑᵣ is the inter prediction signal in the CIIP mode, Pᵢₙₜᵣₐ is the intra prediction signal in the CIIP mode, wt is the weight value, and >> represents a right shift operation.

### Intra Block Copy in Versatile Video Coding (VVC)

Intra block copy (IBC) is a tool adopted in HEVC extensions on SCC. The IBC significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 subblocks. For the current block of a larger size, a hash key is determined to match that of the reference block when all the hash keys of all 4×4 subblocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signaled as IBC AMVP mode or IBC skip/merge mode as follows:

IBC skip/merge mode: a merge candidate index is used to indicate which of the block vectors in the list from neighboring candidate IBC coded blocks is used to predict the current block. The merge list consists of spatial, HMVP, and pairwise candidates.

IBC AMVP mode: block vector difference is coded in the same way as a motion vector difference. The block vector prediction method uses two candidates as predictors, one from left neighbor and one from above neighbor (if IBC coded). When either neighbor is not available, a default block vector will be used as a predictor. A flag is signaled to indicate the block vector predictor index.

### IBC Reference Region

To reduce memory consumption and decoder complexity, the IBC in VVC allows only the reconstructed portion of the predefined area including the region of current CTU and some region of the left CTU. FIG. 12 illustrates the reference region of IBC Mode, where each block represents 64×64 luma sample unit.

Depending on the location of the current coding CU location within the current CTU, the following applies:

If current block falls into the top-left 64×64 block of the current CTU, then in addition to the already reconstructed samples in the current CTU, it can also refer to the reference samples in the bottom-right 64×64 blocks of the left CTU, using CPR mode. The current block can also refer to the reference samples in the bottom-left 64×64 block of the left CTU and the reference samples in the top-right 64×64 block of the left CTU, using CPR mode.

If current block falls into the top-right 64×64 block of the current CTU, then in addition to the already reconstructed samples in the current CTU, if luma location (0, 64) relative to the current CTU has not yet been reconstructed, the current block can also refer to the reference samples in the bottom-left 64×64 block and bottom-right 64×64 block of the left CTU, using CPR mode; otherwise, the current block can also refer to reference samples in bottom-right 64×64 block of the left CTU.

If current block falls into the bottom-left 64×64 block of the current CTU, then in addition to the already reconstructed samples in the current CTU, if luma location (64, 0) relative to the current CTU has not yet been reconstructed, the current block can also refer to the reference samples in the top-right 64×64 block and bottom-right 64×64 block of the left CTU, using CPR mode. Otherwise, the current block can also refer to the reference samples in the bottom-right 64×64 block of the left CTU, using CPR mode.

If current block falls into the bottom-right 64×64 block of the current CTU, it can only refer to the already reconstructed samples in the current CTU, using CPR mode.

This restriction allows the IBC mode to be implemented using local on-chip memory for hardware implementations.

IBC Interaction with Other Coding Tools

The interaction between IBC mode and other inter coding tools in VVC, such as pairwise merge candidate, history based motion vector predictor (HMVP), combined intra/inter prediction mode (CIIP), merge mode with motion vector difference (MMVD), and geometric partitioning mode (GPM) are as follows:

IBC can be used with pairwise merge candidate and HMVP. Anew pairwise IBC merge candidate can be generated by averaging two IBC merge candidates. For HMVP, IBC motion is inserted into history buffer for future referencing.

IBC cannot be used in combination with the following inter tools: affine motion, CIIP, MMVD, and GPM.

IBC is not allowed for the chroma coding blocks when DUAL_TREE partition is used.

Unlike in the HEVC screen content coding extension, the current picture is no longer included as one of the reference pictures in the reference picture list 0 for IBC prediction. The derivation process of motion vectors for IBC mode excludes all neighboring blocks in inter mode and vice versa. The following IBC design aspects are applied:

IBC shares the same process as in regular MV merge including with pairwise merge candidate and history-based motion predictor, but disallows TMVP and zero vector because they are invalid for IBC mode.

Separate HMVP buffer (5 candidates each) is used for conventional MV and IBC.

Block vector constraints are implemented in the form of bitstream conformance constraint, the encoder needs to ensure that no invalid vectors are present in the bitstream, and merge shall not be used if the merge candidate is invalid (out of range or 0). Such bitstream conformance constraint is expressed in terms of a virtual buffer as described below.

For deblocking, IBC is handled as inter mode.

If the current block is coded using IBC prediction mode, AMVR does not use quarter-pel; instead, AMVR is signaled to only indicate whether MV is inter-pel or 4 integer-pel.

The number of IBC merge candidates can be signalled in the slice header separately from the numbers of regular, subblock, and geometric merge candidates.

A virtual buffer concept is used to describe the allowable reference region for IBC prediction mode and valid block vectors. Denote CTU size as ctbSize, the virtual buffer, ibcBuf, has width being wIbcBuf=128×128/ctbSize and height hIbcBuf=ctbSize. For example, for a CTU size of 128×128, the size of ibcBuf is also 128×128; for a CTU size of 64×64, the size of ibcBuf is 256×64; and a CTU size of 32×32, the size of ibcBuf is 512×32.

The size of a VPDU is min(ctbSize, 64) in each dimension, Wᵥ=min(ctbSize, 64).

The virtual IBC buffer, ibcBuf is maintained as follows.

At the beginning of decoding each CTU row, refresh the whole ibcBuf with an invalid value −1.

At the beginning of decoding a VPDU (xVPDU, yVPDU) relative to the top-left corner of the picture, set the ibcBuf[x][y]=−1, with x=xVPDU % wIbcBuf, . . . , xVPDU % wIbcBuf+Wy−1; y=yVPDU % ctbSize, . . . , yVPDU % ctbSize+Wᵥ−1.

After decoding a CU contains (x, y) relative to the top-left corner of the picture, set

$$ibcBuf [ x \% wIbcBuf ] [ y \% ctbSize ] = recSample [ x ] [ y ]$$

For a block covering the coordinates (x, y), if the following is true for a block vector by=(bv[0], bv[1]), then it is valid; otherwise, it is not valid:

ibcBuf[(x+bv[0])% wIbcBuf][(y+bv[1]) % ctbSize] shall not be equal to −1.

### Intra Block Copy in Enhanced Compression Model (ECM)

In ECM, IBC is improved from below aspects.

### IBC Merge/AMVP List Construction

The IBC merge/AMVP list construction is modified as follows:

Only if an IBC merge/AMVP candidate is valid, it can be inserted into the IBC merge/AMVP candidate list.

Above-right, bottom-left, and above-left spatial candidates and one pairwise average candidate can be added into the IBC merge/AMVP candidate list.

Template based adaptive reordering (ARMC-TM) is applied to IBC merge list.

The HMVP table size for IBC is increased to 25. After up to 20 IBC merge candidates are derived with full pruning, they are reordered together. After reordering, the first 6 candidates with the lowest template matching costs are selected as the final candidates in the IBC merge list.

The zero vectors' candidates to pad the IBC Merge/AMVP list are replaced with a set of BVP candidates located in the IBC reference region. A zero vector is invalid as a block vector in IBC merge mode, and consequently, it is discarded as BVP in the IBC candidate list.

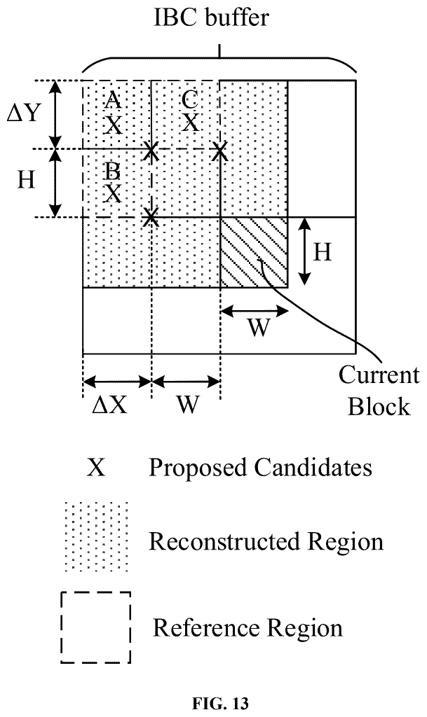

Three candidates are located on the nearest corners of the reference region, and three additional candidates are determined in the middle of the three sub-regions (A, B, and C), whose coordinates are determined by the width, and height of the current block and the ΔX and ΔY parameters, as is depicted in FIG. 13.

### Intra TMP Derived Block Vector Candidates for IBC

In this method, block vector (BV) derived from the intra template matching prediction (IntraTMP) is used for intra block copy (IBC). The stored IntraTMP BV of the neighbouring blocks along with IBC BV are used as spatial BV candidates in IBC candidate list construction.

IntraTMP block vector is stored in the IBC block vector buffer and, the current IBC block can use both IBC BV and IntraTMP BV of neighbouring blocks as BV candidate for IBC BV candidate list. IntraTMP block vectors are added to IBC block vector candidate list as spatial candidates.

IBC with Template Matching

Template Matching is used in IBC for both IBC merge mode and IBC AMVP mode.

The IBC-TM merge list is modified compared to the one used by regular IBC merge mode such that the candidates are selected according to a pruning method with a motion distance between the candidates as in the regular TM merge mode. The ending zero motion fulfillment is replaced by motion vectors to the left (−W, 0), top (0, −H) and top-left (−W, −H), where W is the width and H the height of the current CU.

In the IBC-TM merge mode, the selected candidates are refined with the Template Matching method prior to the RDO or decoding process. The IBC-TM merge mode has been put in competition with the regular IBC merge mode and a TM-merge flag is signaled.

In the IBC-TM AMVP mode, up to 3 candidates are selected from the IBC-TM merge list. Each of those 3 selected candidates are refined using the Template Matching method and sorted according to their resulting Template Matching cost. Only the 2 first ones are then considered in the motion estimation process as usual.

The Template Matching refinement for both IBC-TM merge and AMVP modes is quite simple since IBC motion vectors are constrained (i) to be integer and (ii) within a reference region as shown in FIG. 12. So, in IBC-TM merge mode, all refinements are performed at integer precision, and in IBC-TM AMVP mode, they are performed either at integer or 4-pel precision depending on the AMVR value. Such a refinement accesses only to samples without interpolation. In both cases, the refined motion vectors and the used template in each refinement step must respect the constraint of the reference region.

### IBC Reference Area

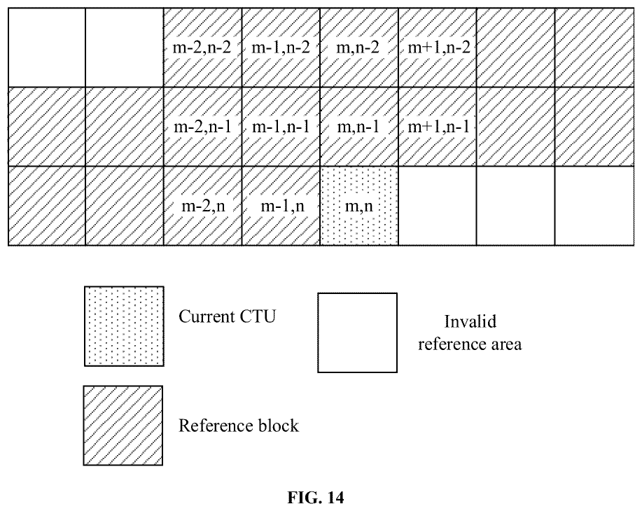

The reference area for IBC is extended to two CTU rows above. FIG. 14 illustrates the reference area for coding CTU (m,n). Specifically, for CTU (m,n) to be coded, the reference area includes CTUs with index (m−2,n−2) . . . (W,n−2),(0,n−1) . . . (W,n−1),(0,n) . . . (m,n), where W denotes the maximum horizontal index within the current tile, slice or picture. This setting ensures that for CTU size being 128, IBC does not require extra memory in the current ETM platform. The per-sample block vector search (or called local search) range is limited to [−(C<<1), C>>2] horizontally and [−C, C>>2] vertically to adapt to the reference area extension, where C denotes the CTU size.

IBC Merge Mode with Block Vector Differences

IBC merge mode with block vector differences is adopted in ECM. The distance set is {1-pel, 2-pel, 4-pel, 8-pel, 12-pel, 16-pel, 24-pel, 32-pel, 40-pel, 48-pel, 56-pel, 64-pel, 72-pel, 80-pel, 88-pel, 96-pel, 104-pel, 112-pel, 120-pel, 128-pel}, and the BVD directions are two horizontal and two vertical directions.

The base candidates are selected from the first five candidates in the reordered IBC merge list. And based on the SAD cost between the template (one row above and one column left to the current block) and its reference for each refinement position, all the possible MBVD refinement positions (20×4) for each base candidate are reordered. Finally, the top 8 refinement positions with the lowest template SAD costs are kept as available positions, consequently for MBVD index coding.

### IBC Adaptation for Camera-Captured Content

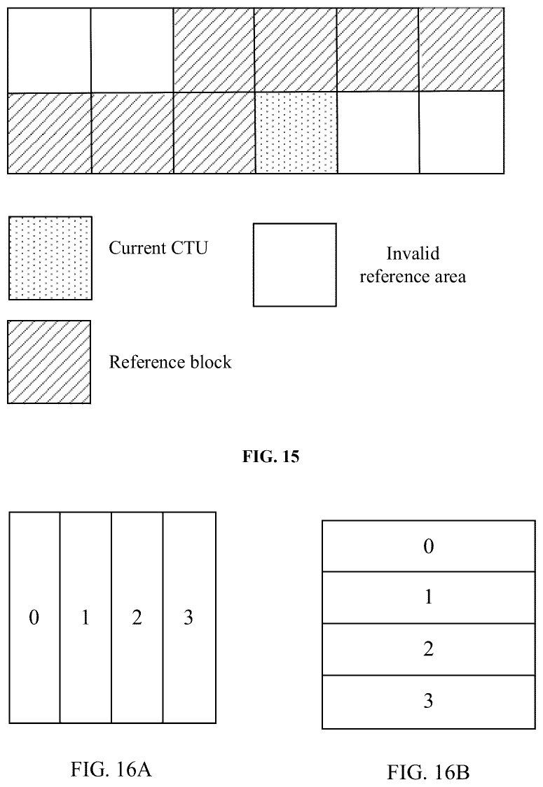

When adapt IBC for camera-captured content, IBC reference range is reduced from 2 CTU rows to 2×128 rows as shown in FIG. 15. At encoder side to reduce the complexity, the local search range is set to [−8,8] horizontally and [−8,8] vertically centered at the first block vector predictor of the current CU. This encoder modification is not applied to SCC sequences.

### Reconstruction-Reordered IBC (RR-IBC)

A Reconstruction-Reordered IBC (RR-IBC) mode is allowed for IBC coded blocks. When RR-IBC is applied, the samples in a reconstruction block are flipped according to a flip type of the current block. On the encoder side, the original block is flipped before motion search and residual calculation, while the prediction block is derived without flipping. On the decoder side, the reconstruction block is flipped back to restore the original block.

Two flip methods, horizontal flip, and vertical flip, are supported for RR-IBC coded blocks. A syntax flag is firstly signalled for an IBC AMVP coded block, indicating whether the reconstruction is flipped, and if it is flipped, another flag is further signaled specifying the flip type. For IBC merge, the flip type is inherited from neighbouring blocks, without syntax signalling. Considering the horizontal or vertical symmetry, the current block and the reference block are normally aligned horizontally or vertically. Therefore, when a horizontal flip is applied, the vertical component of the BV is not signaled and is inferred to be equal to 0. Similarly, the horizontal component of the BV is not signaled and is inferred to be equal to 0 when a vertical flip is applied.

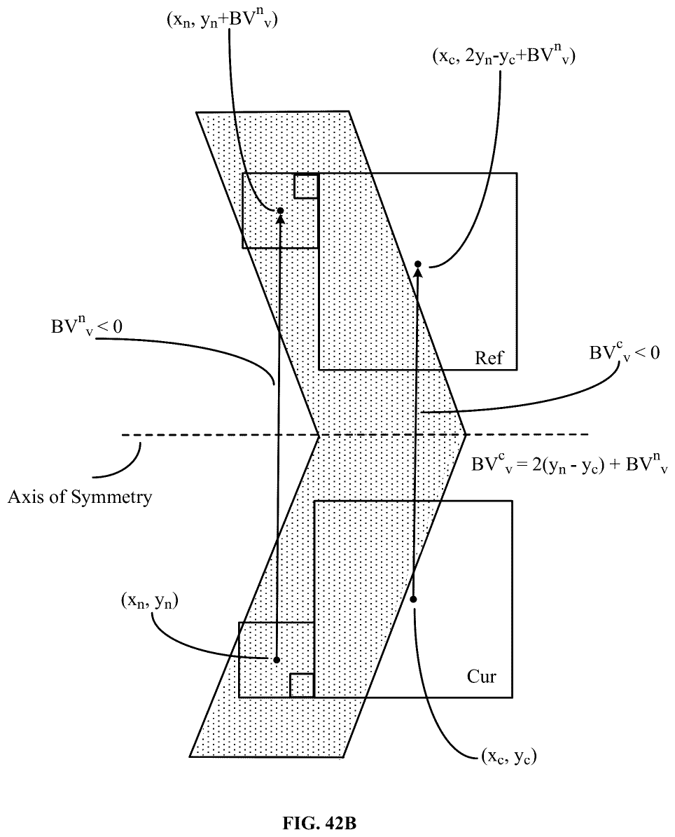

To better utilize the symmetry property, a flip-aware BV adjustment approach is applied to refine the block vector candidate. For example, as shown in FIG. 42A or FIG. 42B, (xnbr, ynbr) and (xcur, ycur) represent the coordinates of the center sample of the neighbouring block and the current block, respectively, BVnbr and BVcur denote the BV of the neighbouring block and the current block, respectively. Instead of directly inheriting the BV from a neighbouring block, the horizontal component of BVcur is calculated by adding a motion shift to the horizontal component of BVnbr (denoted as BVnbrh) in case the neighbouring block is coded with a horizontal flip, i.e., BVcurh=2(xnbr−xcur)+BVnbrh. Similarly, the vertical component of BVcur is calculated by adding a motion shift to the vertical component of BVnbr (denoted as BVnbrv) in case that the neighbouring block is coded with a vertical flip, i.e., BVcurv=2(ynbr−ycur)+BVnbrv.

IBC with Geometry Partitioning

Intra block copy with geometry partitioning mode (IBC-GPM) is a coding tool which divides a CU into two sub-partitions geometrically. The prediction signals of the two sub-partitions are generated using IBC and intra prediction. IBC-GPM can be applied to regular IBC merge mode or IBC TM merge mode. An intra prediction mode (IPM) candidate list is constructed using the same method as GPM with inter and intra prediction for intra prediction, and the IPM candidate list size is pre-defined as 3. There are 48 geometry partitioning modes in total, which are divided into two geometry partitioning mode sets as follows:

TABLE 3
Geometry partitioning modes in the first
geometry partitioning mode set

| ibc_gpm_partition_idx | 0 | 1 | 2 | 3 | 4 | 5 | 6 | 7 |
|---|---|---|---|---|---|---|---|---|
| angleIdx | 0 | 0 | 8 | 8 | 16 | 16 | 24 | 24 |
| distanceIdx | 1 | 3 | 1 | 3 | 1 | 3 | 1 | 3 |

TABLE 4
Geometry partitioning modes in the second
geometry partitioning mode set

| ibc_gpm_partition_idx | 0 | 1 | 2 | 3 | 4 | 5 | 6 | 7 | 8 | 9 |
|---|---|---|---|---|---|---|---|---|---|---|
| angleIdx | 2 | 2 | 2 | 3 | 3 | 3 | 4 | 4 | 4 | 5 |
| distanceIdx | 0 | 1 | 3 | 0 | 1 | 3 | 0 | 1 | 3 | 0 |
| ibc_gpm_partition_idx | 10 | 11 | 12 | 13 | 14 | 15 | 16 | 17 | 18 | 19 |
| angleIdx | 5 | 5 | 11 | 11 | 11 | 12 | 12 | 12 | 13 | 13 |
| distanceIdx | 1 | 3 | 0 | 1 | 3 | 0 | 1 | 3 | 0 | 1 |
| ibc_gpm_partition_idx | 20 | 21 | 22 | 23 | 24 | 25 | 26 | 27 | 28 | 29 |
| angleIdx | 13 | 14 | 14 | 14 | 18 | 18 | 19 | 19 | 20 | 20 |
| distanceIdx | 3 | 0 | 1 | 3 | 1 | 3 | 1 | 3 | 1 | 3 |
| ibc_gpm_partition_idx | 30 | 31 | 32 | 33 | 34 | 35 | 36 | 37 | 38 | 39 |
| angleIdx | 21 | 21 | 27 | 27 | 28 | 28 | 29 | 29 | 30 | 30 |
| distanceIdx | 1 | 3 | 1 | 3 | 1 | 3 | 1 | 3 | 1 | 3 |

When IBC-GPM is used, an IBC-GPM geometry partitioning mode set flag is signalled to indicate whether the first or the second geometry partitioning mode set is selected, followed by the geometry partitioning mode index. An IBC-GPM intra flag is signalled to indicate whether intra prediction is used for the first sub-partition. When intra prediction is used for a sub-partition, an intra prediction mode index is signalled. When IBC is used for a sub-partition, a merge index is signalled.

Combination of CIIP with TIMD and TM Merge

In CIIP mode, the prediction samples are generated by weighting an inter prediction signal predicted using CIIP-TM merge candidate and an intra prediction signal predicted using TIMD derived intra prediction mode. The method is only applied to coding blocks with an area less than or equal to 1024.

The TIMD derivation method is used to derive the intra prediction mode in CIIP. Specifically, the intra prediction mode with the smallest SATD values in the TIMD mode list is selected and mapped to one of the 67 regular intra prediction modes.

In addition, it is also proposed to modify the weights (wIntra, wInter) for the two tests if the derived intra prediction mode is an angular mode. For near-horizontal modes (2<=angular mode index<34), the current block is vertically divided as shown in FIG. 16A; for near-vertical modes (34<=angular mode index<=66), the current block is horizontally divided as shown in FIG. 16B.

The (wIntra, wInter) for different sub-blocks are shown in Table 5.

TABLE 5
The modified weights used for angular modes.

| The sub-block index | (wIntra, wInter) |
|---|---|
| 0 | (6, 2) |
| 1 | (5, 3) |
| 2 | (3, 5) |
| 3 | (2, 6) |

With CIIP-TM, a CIIP-TM merge candidate list is built for the CIIP-TM mode. The merge candidates are refined by template matching. The CIIP-TM merge candidates are also reordered by the ARMC method as regular merge candidates. The maximum number of CIIP-TM merge candidates is equal to two.

### Multi-Hypothesis Prediction (MHP)

In the multi-hypothesis inter prediction mode, one or more additional motion-compensated prediction signals are signaled, in addition to the conventional bi prediction signal. The resulting overall prediction signal is obtained by sample-wise weighted superposition. With the bi prediction signal p_{bi} and the first additional inter prediction signal/hypothesis h₃, the resulting prediction signal p₃ is obtained as follows:

$${p}_{3} = ( 1 - α ) {p}_{b i} + α {h}_{3} \qquad ( 2 )$$

The weighting factor α is specified by the new syntax element add_hyp_weight_idx, according to the mapping presented in Table 6:

TABLE 6
The mapping between add_hyp_weight_idx and α.

| add_hyp_weight_idx | α |
|---|---|
| 0 | ¼ |
| 1 | −⅛ |

Analogously to above, more than one additional prediction signal can be used. The resulting overall prediction signal is accumulated iteratively with each additional prediction signal.

$${p}_{n + 1} = ( 1 - {α}_{n + 1} ) {p}_{n} + {α}_{n + 1} {h}_{n + 1} \qquad ( 3 )$$

The resulting overall prediction signal is obtained as the last pₙ (i.e., the pₙ having the largest index n). Within this mode, up to two additional prediction signals can be used (i.e., n is limited to 2).

The motion parameters of each additional prediction hypothesis can be signaled either explicitly by specifying the reference index, the motion vector predictor index, and the motion vector difference, or implicitly by specifying a merge index. A separate multi-hypothesis merge flag distinguishes between these two signaling modes.

For inter AMVP mode, MHP is only applied if non-equal weight in BCW is selected in bi-prediction mode.

Combination of MHP and BDOF is possible, however the BDOF is only applied to the bi-prediction signal part of the prediction signal (i.e., the ordinary first two hypotheses).

### Geometric Partitioning Mode (GPM) in ECM

GPM with merge motion vector differences (MMVD)

GPM in VVC is extended by applying motion vector refinement on top of the existing GPM uni-directional MVs. A flag is first signalled for a GPM CU, to specify whether this mode is used. If the mode is used, each geometric partition of a GPM CU can further decide whether to signal MVD or not. If MVD is signalled for a geometric partition, after a GPM merge candidate is selected, the motion of the partition is further refined by the signalled MVDs information. All other procedures are kept the same as in GPM.

The MVD is signaled as a pair of distance and direction, similar as in MMVD. There are nine candidate distances (¼-pel, ½-pel, 1-pel, 2-pel, 3-pel, 4-pel, 6-pel, 8-pel, 16-pel), and eight candidate directions (four horizontal/vertical directions and four diagonal directions) involved in GPM with MMVD (GPM-MMVD). In addition, when pic_fpel_mmvd_enabled_flag is equal to 1, the MVD is left shifted by 2 as in MMVD.

GPM with template matching (TM)

Template matching is applied to GPM. When GPM mode is enabled for a CU, a CU-level flag is signaled to indicate whether TM is applied to both geometric partitions. Motion information for each geometric partition is refined using TM. When TM is chosen, a template is constructed using left, above or left and above neighboring samples according to partition angle, as shown in Table 7. The motion is then refined by minimizing the difference between the current template and the template in the reference picture using the same search pattern of merge mode with half-pel interpolation filter disabled.

TABLE 7
Template for the 1st and 2nd geometric partitions, where A represents using above samples,
L represents using left samples, and L + A represents using both left and above samples.

| Partition angle | 0 | 2 | 3 | 4 | 5 | 8 | 11 | 12 | 13 | 14 |
|---|---|---|---|---|---|---|---|---|---|---|
| 1st partition | A | A | A | A | L + A | L + A | L + A | L + A | A | A |
| 2nd partition | L + A | L + A | L + A | L | L | L | L | L + A | L + A | L + A |
| Partition angle | 16 | 18 | 19 | 20 | 21 | 24 | 27 | 28 | 29 | 30 |
| 1st partition | A | A | A | A | L + A | L + A | L + A | L + A | A | A |
| 2nd partition | L + A | L + A | L + A | L | L | L | L | L + A | L + A | L + A |

A GPM candidate list is constructed as follows:
1. Interleaved List-0 MV candidates and List-1 MV candidates are derived directly from the regular merge candidate list, where List-0 MV candidates are higher priority than List-1 MV candidates. A pruning method with an adaptive threshold based on the current CU size is applied to remove redundant MV candidates.
2. Interleaved List-1 MV candidates and List-0 MV candidates are further derived directly from the regular merge candidate list, where List-1 MV candidates are higher priority than List-0 MV candidates. The same pruning method with the adaptive threshold is also applied to remove redundant MV candidates.
3. Zero MV candidates are padded until the GPM candidate list is full.

The GPM-MMVD and GPM-TM are exclusively enabled to one GPM CU. This is done by firstly signaling the GPM-MMVD syntax. When both two GPM-MMVD control flags are equal to false (i.e., the GPM-MMVD are disabled for two GPM partitions), the GPM-TM flag is signaled to indicate whether the template matching is applied to the two GPM partitions. Otherwise (at least one GPM-MMVD flag is equal to true), the value of the GPM-TM flag is inferred to be false.

GPM with inter and intra prediction

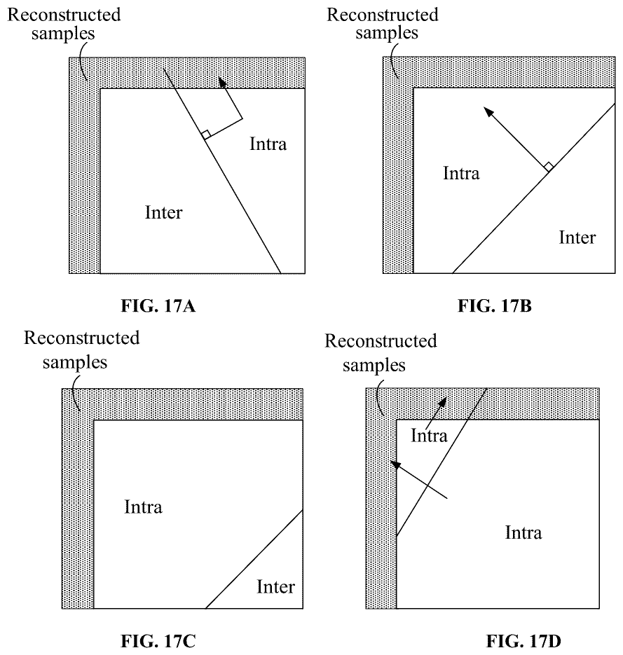

In GPM with inter and intra prediction, the final prediction samples are generated by weighting inter predicted samples and intra predicted samples for each GPM-separated region. The inter predicted samples are derived by inter GPM whereas the intra predicted samples are derived by an intra prediction mode (IPM) candidate list and an index signaled from the encoder. The IPM candidate list size is pre-defined as 3. The available IPM candidates are the parallel angular mode against the GPM block boundary (Parallel mode), the perpendicular angular mode against the GPM block boundary (Perpendicular mode), and the Planar mode as shown FIGS. 17A-17D, respectively. Furthermore, GPM with intra and intra prediction as shown FIG. 17D is restricted to reduce the signaling overhead for IPMs and avoid an increase in the size of the intra prediction circuit on the hardware decoder. In addition, a direct motion vector and IPM storage on the GPM-blending area is introduced to further improve the coding performance.

In DIMD and neighboring mode based IPM derivation Parallel mode is registered first. Therefore, max two IPM candidates derived from the decoder-side intra mode derivation (DIMD) method and/or the neighboring blocks can be registered if there is not the same IPM candidate in the list. As for the neighboring mode derivation, there are five positions for available neighboring blocks at most, but they are restricted by the angle of GPM block boundary as shown in Table 8, which are already used for GPM with template matching (GPM-TM).

TABLE 8
The position of available neighboring blocks for IPM candidate derivation based on the angle
of GPM block boundary. A and L denotes the above and left side of the prediction block.

| Angle of GPM | 0 | 2 | 3 | 4 | 5 | 8 | 11 | 12 | 13 | 14 |
|---|---|---|---|---|---|---|---|---|---|---|
| 1st partition | A | A | A | A | L + A | L + A | L + A | L + A | A | A |
| 2nd partition | L + A | L + A | L + A | L | L | L | L | L + A | L + A | L + A |
| Angle of GPM | 16 | 18 | 19 | 20 | 21 | 24 | 27 | 28 | 29 | 30 |
| 1st partition | A | A | A | A | L + A | L + A | L + A | L + A | A | A |
| 2nd partition | L + A | L + A | L + A | L | L | L | L | L + A | L + A | L + A |

GPM-intra can be combined with GPM with merge with motion vector difference (GPM-MMVD). TIMD is used for on IPM candidates of GPM-intra to further improve the coding performance. The Parallel mode can be registered first, then IPM candidates of TIMID, DIMD, and neighboring blocks.

### Template Matching Based Reordering for GPM Split Modes

In template matching based reordering for GPM split modes, given the motion information of the current GPM block, the respective TM cost values of GPM split modes are computed. Then, all GPM split modes are reordered in ascending ordering based on the TM cost values. Instead of sending GPM split mode, an index using Golomb-Rice code to indicate where the exact GPM split mode is located in the reordering list is signaled.

The reordering method for GPM split modes is a two-step process performed after the respective reference templates of the two GPM partitions in a coding unit are generated, as follows:
extending GPM partition edge into the reference templates of the two GPM partitions, resulting in 64 reference templates and computing the respective TM cost for each of the 64 reference templates;
reordering GPM split modes based on their TM cost values in ascending order and marking the best 32 as available split modes.

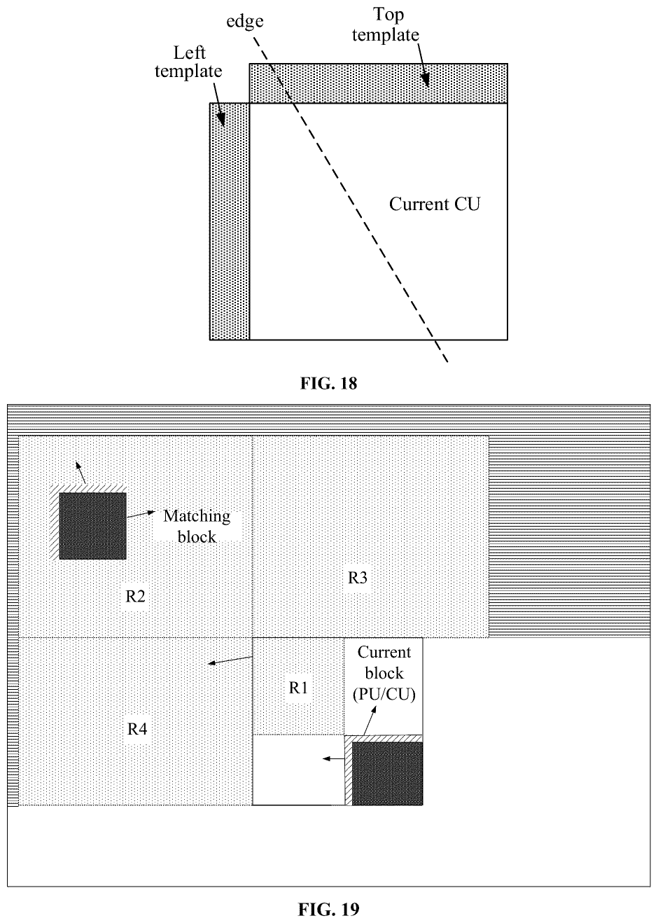

The edge on the template is extended from that of the current CU, as FIG. 18 illustrates, but GPM blending process is not used in the template area across the edge.

After ascending reordering using TM cost, an index is signaled.

Geometric Partitioning Mode (GPM) with Adaptive Blending

In VVC, the final prediction samples are generated with by blending the prediction of the two prediction signals using weighted average. Two integer blending matrices (W0 and W1) are used. The weights in the GPM blending matrices are derived from the ramp function based on the displacement from a predicted sample position to the GPM partitioning boundary. The blending area size is fixed to two (2 samples on each side of the GPM partition split boundary).

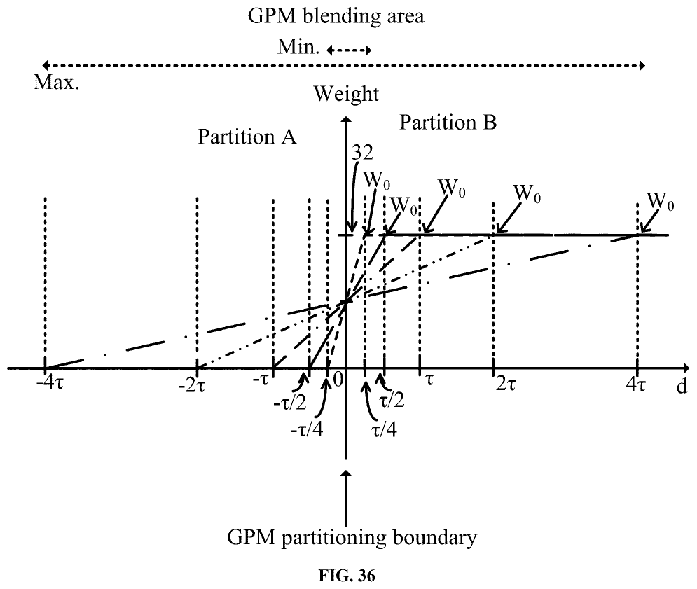

The blending process in ECM is improved by adding four extra blending area sizes (quarter, half, double, and quadrupole of the existing area size) as shown in FIG. 36. A CU level flag is coded to signal the selected blending area size is signalled. Furthermore, the extended weighting precision is utilized, in which the maximum value of the weighs is changed from 8 (in VVC) to 32 to accommodate the extended blending area sizes.

### Spatial Geometric Partitioning Mode (SGPM)

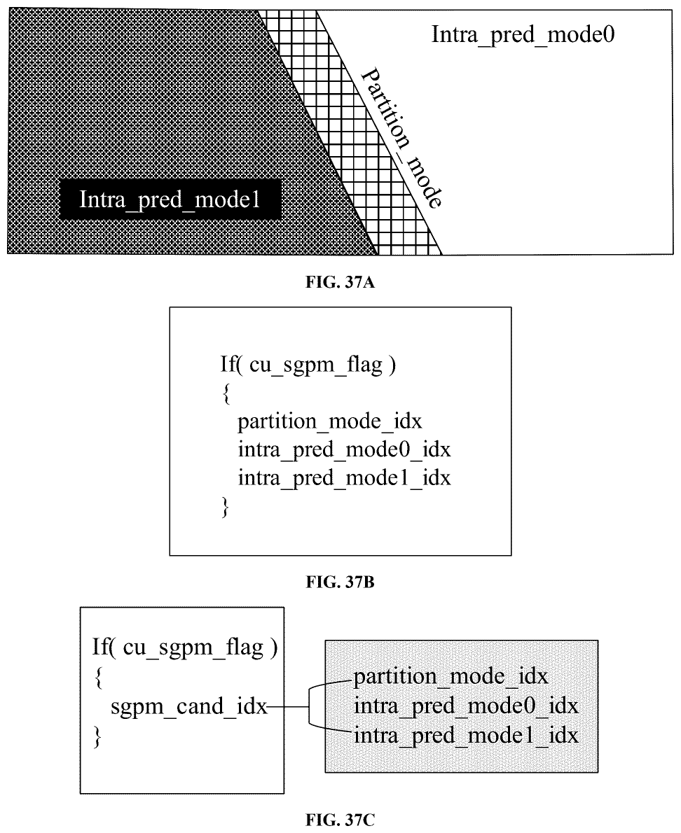

SGPM is an intra mode that resembles the inter coding tool of GPM, where the two prediction parts are generated from intra predicted process. In this mode, a candidate list is built with each entry containing one partition split and two intra prediction modes as shown in FIG. 37A-37C. 26 partition modes and 3 of intra prediction modes are used to form the combinations. The length of the candidate list is set equal to 16. The selected candidate index is signalled.

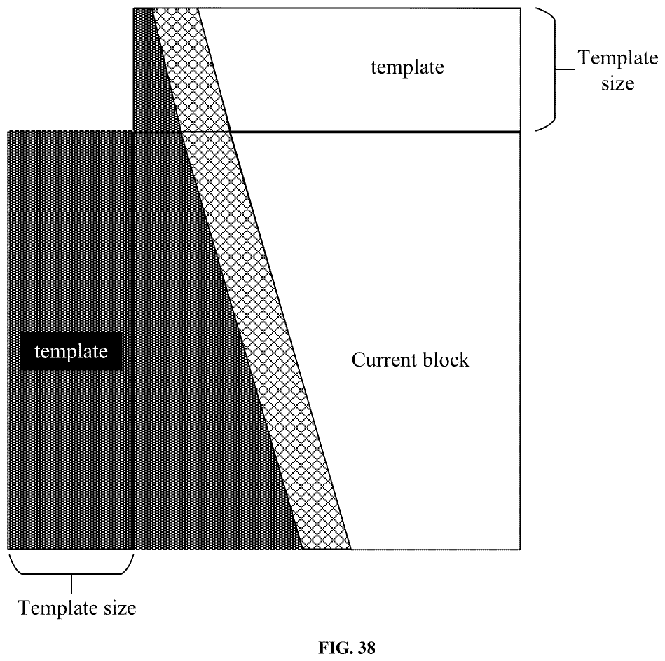

The list is reordered using template (FIG. 38) where SAD between the prediction and reconstruction of the template is used for ordering. In one example, the template size is fixed to 1. The template size may be set differently in some other examples.

For each partition mode, an IPM list is derived for each part using the same intra-inter GPM list derivation. The IPM list size is set to 3. In the list, TIMD derived mode is replaced by 2 derived modes with horizontal and vertical orientations.

The SGPM mode is applied with a restricted blocks size: 4<=width<=64, 4<=height<=64, width<height*8, height<width*8, width*height>=32.

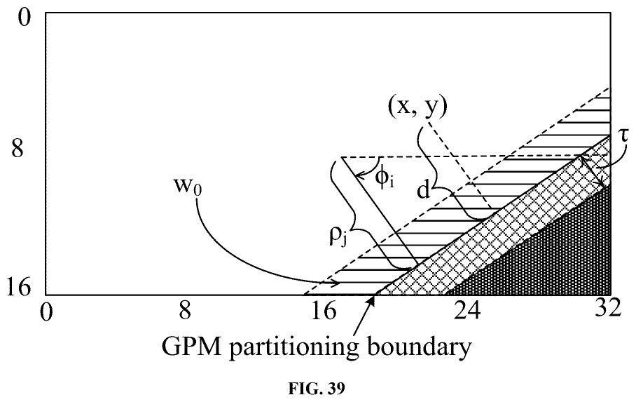

Adaptive blending is also used for spatial GPM, where blending depth T shown in FIG. 39 is derived as follows:
If min(width, height)==4, ½ τ is selected;
Else if min(width, height)==8, τ is selected;
else if min(width, height)==16, 2 τ is selected;
else if min(width, height)==32, 4 τ is selected;
else, 8 τ is selected.

### Intra Template Matching

Intra template matching prediction (Intra TMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

The prediction signal is generated by matching the L-shaped causal neighbor of the current block with another block in a predefined search area in FIG. 19 consisting of:
R1: current CTU
R2: top-left CTU
R3: above CTU
R4: left CTU
Sum of absolute differences (SAD) is used as a cost function.
   Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:

$$SearchRange\_w = a * BlkW$$

$$SearchRange\_h = a * BlkH$$

where ‘a’ is a constant that controls the gain/complexity trade-off. In practice, ‘a’ is equal to 5.

The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.

### Fusion for Template-Based Intra Mode Derivation (TIMD)

For each intra prediction mode in MPMs, The SATD between the prediction and reconstruction samples of the template is calculated. First two intra prediction modes with the minimum SATD are selected as the TIMD modes. These two TIMD modes are fused with the weights after applying PDPC process, and such weighted intra prediction is used to code the current CU. Position dependent intra prediction combination (PDPC) is included in the derivation of the TIMD modes.

The costs of the two selected modes are compared with a threshold, in the test the cost factor of 2 is applied as follows:

$$costMode 2 < 2 * costMode 1.$$

If this condition is true, the fusion is applied, otherwise the only model is used.

Weights of the modes are computed from their SATD costs as follows:

$$weight 1 = costMode 2 / ( costMode 1 + costMode 2 )$$

$$weight 2 = 1 - weight 1$$

The division operations are conducted using the same lookup table (LUT) based integerization scheme used by the CCLM.

### Local Illumination Compensation (LIC)

LIC is an inter prediction technique to model local illumination variation between current block and its prediction block as a function of that between current block template and reference block template. The parameters of the function can be denoted by a scale a and an offset β, which forms a linear equation, that is, α*p[x]+β to compensate illumination changes, where p[x] is a reference sample pointed to by MV at a location x on reference picture. When wrap around motion compensation is enabled, the MV shall be clipped with wrap around offset taken into consideration. Since a and p can be derived based on current block template and reference block template, no signaling overhead is required for them, except that an LIC flag is signaled for AMVP mode to indicate the use of LIC.

The local illumination compensation proposed in JVET-00066 is used for uni-prediction inter CUs with the following modifications.

Intra neighbor samples can be used in LIC parameter derivation;

LIC is disabled for blocks with less than 32 luma samples;

For both non-subblock and affine modes, LIC parameter derivation is performed based on the template block samples corresponding to the current CU, instead of partial template block samples corresponding to first top-left 16×16 unit;

Samples of the reference block template are generated by using MC with the block MV without rounding it to integer-pel precision.

### TM Based Reordering for MMVD and Affine MMVD

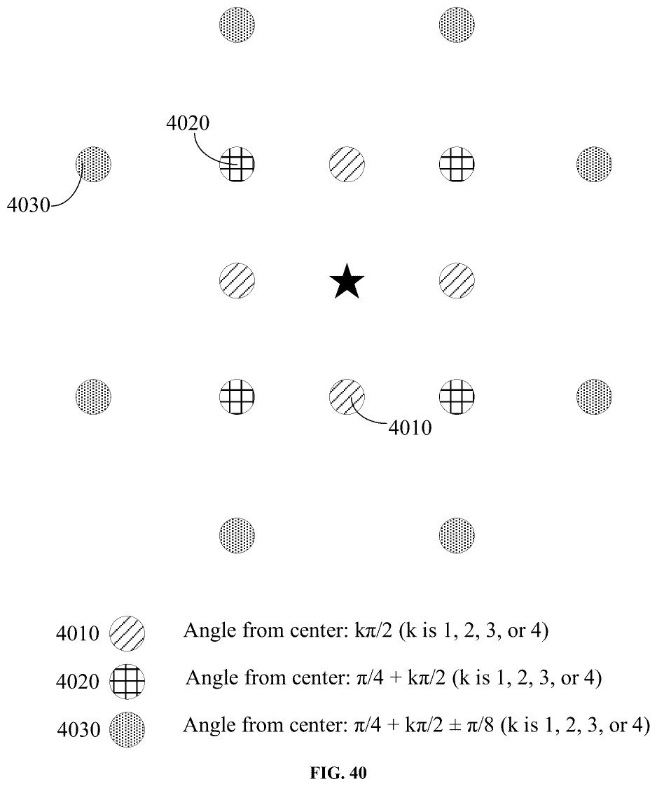

The MMVD offsets are extended for MMVD and affine MMVD modes. Additional refinement positions along k×π/8 diagonal angles are added shown in FIG. 40, thus increasing the number of directions from 4 to 16. Second, based on the SAD cost between the template (one row above and one column left to the current block) and its reference for each refinement position, all the possible MMVD refinement positions (16×6) for each base candidate are reordered. Finally, the top ⅛ refinement positions with the smallest template SAD costs are kept as available positions, consequently for MMVD index coding. The MMVD index is binarized by the rice code with the parameter equal to 2. The affine MMVD reordering is extended, in which additional refinement positions along k×π/4 diagonal angles are added. After reordering top ½ refinement positions with the smallest template SAD costs are kept.

The first N motion candidates in the candidate list before being reordered are utilized as the base candidates for MMVD and affine MMVD. N is equal to 3 for MMVD, and [1, 3] depending on the neighboring block affine flags for affine MMVD. Two ways of adding MMVD offsets are allowed, including the ‘two-side’ and ‘one-side’, depending on whether the offset of the other reference picture list is mirrored or directly set to zero. Which way is applied to one block is dependent on the TM cost.

### OBMC

When OBMC is applied, top and left boundary pixels of a CU are refined using neighboring block's motion information with a weighted prediction as described in JVET-L0101.

Conditions of not applying OBMC are as follows:
When OBMC is disabled at SPS level
When current block has intra mode or IBC mode
When current block applies LIC
When current luma block area is smaller or equal to 32

A subblock-boundary OBMC is performed by applying the same blending to the top, left, bottom, and right subblock boundary pixels using neighboring subblocks' motion information. It is enabled for the subblock based coding tools:
Affine AMVP modes;
Affine merge modes and subblock-based temporal motion vector prediction (SbTMVP);
Subblock-based bilateral matching.

When OBMC mode is used in CIP mode with LMCS, inter blending is performed prior to LMCS mapping of inter samples. LMCS is applied to blended inter samples which are combined with LMCS applied intra samples in CIIP mode,

$${Inter}_{predY}^{′} = \frac{( 128 - {w}_{1} ) \times {Inter}_{predY} + {w}_{1} \times {OBMC}_{predY}}{128}$$

$$PredY = \frac{( 4 - {w}_{0} ) \times FwdMap ( {Inter}_{predY}^{′} ) + {w}_{0} \times Intr {a}_{predY}}{4}$$

where Inter_{predY} represents the samples predicted by the motion of current block in the original domain, Intra_{predY} represents the samples predicted in the mapped domain, OBMC_{predY} represents the samples predicted by the motion of neighboring blocks in the original domain, and w₀ and wᵢ are the weights.

### Template Matching Based OBMC

In template matching based OBMC scheme, instead of directly using the weighted prediction, the prediction value of CU boundary samples derivation approach is decided according to the template matching costs, including using current block's motion information only, or using neighboring block's motion information as well with one of the blending modes.

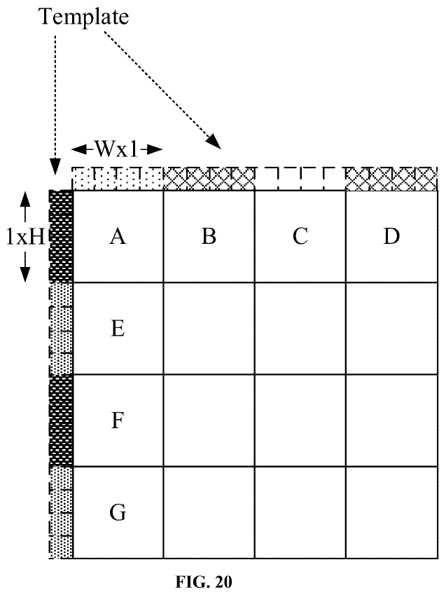

In this scheme for each block with a size of 4×4 at the top CU boundary, the above template size equals to 4×1. If N adjacent blocks have the same motion information, then the above template size is enlarged to 4N×1 since the MC operation can be processed at one time. For each left block with a size of 4×4 at the left CU boundary, the left template size equals to 1×4 or 1×4N (FIG. 20).

For each 4×4 top block (or N 4×4 blocks group), the prediction value of boundary samples is derived following the below steps.

Take block A as the current block and its above neighboring block AboveNeighbor_A for example. The operation for left blocks is conducted in the same manner.

First, three template matching costs (Cost1, Cost2, Cost3) are measured by SAD between the reconstructed samples of a template and its corresponding reference samples derived by MC process according to the following three types of motion information:

Cost1 is calculated according to A's motion information.

Cost2 is calculated according to AboveNeighbor_A's motion information.

Cost3 is calculated according to weighted prediction of A's and AboveNeighbor_A's motion information with weighting factors as ¾ and ¼ respectively.

Second, choose one approach to calculate the final prediction results of boundary samples by comparing Cost1, Cost2 and Cost 3.

The original MC result using current block's motion information is denoted as Pixel1, and the MC result using neighboring block's motion information is denoted as Pixel2. The final prediction result is denoted as NewPixel.

$$If Cost 1 is minimum , then NewPixel ( i , j ) = Pixel 1 ( i , j ) .$$

If (Cost2+(Cost2>>2)+(Cost2>>3))<=Cost1, then blending mode 1 is used.

For luma blocks, the number of blending pixel rows is 4.

$$NewPixel ( i , 0 ) = ( 26 \times Pixel 1 ( i , 0 ) + 6 \times Pixel 2 ( i , 0 ) + 16 ) >> 5$$

$$NewPixel ( i , 1 ) = ( 7 \times Pixel 1 ( i , 1 ) + Pixel 2 ( i , 1 ) + 4 ) >> 3$$

$$NewPixel ( 1 , 2 ) = ( 15 \times Pixel 1 ( 1 , 2 ) + Pixel 2 ( 1 , 2 ) + 8 ) >> 4$$

$$NewPixel ( i , 3 ) = ( 31 \times Pixel 1 ( 1 , 3 ) + Pixel 2 ( 1 , 3 ) + 16 ) >> 5$$

For chroma blocks, the number of blending pixel rows is 1.

$$NewPixel ( i , 0 ) = ( 26 \times Pixel 1 ( i , 0 ) + 6 \times Pixel 2 ( i , 0 ) + 16 ) >> 5$$

If Cost1<=Cost2, then blending mode 2 is used.

For luma blocks, the number of blending pixel rows is 2.

$$NewPixel ( i , 0 ) = ( 15 \times Pixel 1 ( i , 0 ) + Pixel 2 ( i , 0 ) + 8 ) >> 4$$

$$NewPixel ( i , 1 ) = ( 31 \times Pixel 1 ( i , 1 ) + Pixel 2 ( i , 1 ) + 16 ) >> 5$$

For chroma blocks, the number of blending pixel rows/columns is 1.

$$NewPixel ( i , 0 ) = ( 15 \times Pixel 1 ( i , 0 ) + Pixel 2 ( i , 0 ) + 8 ) >> 4$$

Otherwise, blending mode 3 is used.

For luma blocks, the number of blending pixel rows is 4.

$$NewPixel ( i , 1 ) = ( 7 \times Pixel 1 ( i , 1 ) + Pixel 2 ( i , 1 ) + 4 ) >> 3$$

$$NewPixel ( 1 , 2 ) = ( 15 \times Pixel 1 ( i , 2 ) + Pixel 2 ( i , 2 ) + 8 ) >> 4$$

$$NewPixel ( 1 , 3 ) = ( 31 \times Pixel 1 ( 1 , 3 ) + Pixel 2 ( 1 , 3 ) + 16 ) >> 5$$

For chroma blocks, the number of blending pixel rows is 1.

$$NewPixel ( i , 0 ) = ( 7 \times Pixel 1 ( i , 0 ) + Pixel 2 ( i , 0 ) + 4 ) >> 3$$

Currently, the IBC tool is not combined with the GPM tool. Thus, the present disclosure provides examples to combine them together, which may improve the prediction accuracy and improve the coding performance.

Currently, the coding block coded with IBC mode is not combined with the coding block coded with intra mode or inter mode. Thus, the present disclosure provides examples to combine them together, which may improve the prediction accuracy and improve the coding performance.

Currently, the weights of intra coded block and inter coded block in CIIP are predefined in a fixed manner. Thus, the present disclosure provides examples to adaptively decide the weights based on template matching methods, which may improve the prediction accuracy and improve the coding performance.

Currently, the block vector (BV) number in the IBC tool is singular. Thus, the present disclosure provides examples to increase the block vector (BV) number and the prediction results can be combined, which may improve the prediction accuracy and improve the coding performance.

Currently, the coding block coded with Intra TMP mode is not combined with the coding block coded with intra mode or inter mode. Thus, the present disclosure provides examples to combine them together, which may improve the prediction accuracy and improve the coding performance.

Currently, the Intra TMP tool is not combined with the GPM tool. Thus, the present disclosure provides examples to combine them together, which may improve the prediction accuracy and improve the coding performance.

Currently, the IBC tool is not combined with the TIMD tool. Thus, the present disclosure provides examples to combine them together, which may improve the prediction accuracy and improve the coding performance.

Currently, the Intra TMP tool is not combined with the TIMD tool. Thus, the present disclosure provides examples to combine them together, which may improve the prediction accuracy and improve the coding performance.

Currently, the Intra TMP tool is not combined with the LIC tool. Thus, the present disclosure provides examples to combine them together, which may improve the prediction accuracy and improve the coding performance.

Currently, the IBC tool is not combined with the OBMC tool. Thus, the present disclosure provides examples to combine them together, which may improve the prediction accuracy and improve the coding performance.

Currently, the Intra TMP tool is not combined with the OBMC tool. Thus, the present disclosure provides examples to combine them together, which may improve the prediction accuracy and improve the coding performance.

Currently, the candidate derivation process of IBC merge mode and IBC AMVP mode only uses adjacent neighboring blocks and partial non-adjacent neighboring blocks in the top-left area, it is thus provided in the present disclosure to further extend more non-adjacent neighboring blocks, which may improve the prediction accuracy and improve the coding performance.

Currently, the IBC mode usually uses a BV in block level to conduct motion compensation, it is thus provided in the present disclosure to further import a sub-block based IBC mode, which may improve the prediction accuracy and improve the coding performance.

Currently, the TM IBC mode and TM regular inter mode use both left and above templates to do motion refinement, it is thus provided in the present disclosure to further extend the template pattern, which may improve the prediction accuracy and improve the coding performance.

Currently, deblocking filter treats the block coded with IBC mode and the block coded with Intra TMP mode differently when obtaining the boundary strength. It is thus provided in the present disclosure to unify these two kinds of modes, which may improve the coding performance.

Currently, the Intra TMP tool is not combined with IBC tool, it is thus provided in the present disclosure to combine these two tools in a GPM or CIIP manner, which may improve the coding performance.

Currently, the MMVD candidates of GPM with MMVD mode are signalled similar to the MMVD design in VVC, it is thus provided in the present disclosure to reorder the MMVD candidates of GPM with MMVD mode based on template matching methods, which may improve the coding performance.

Currently, the IBC/regular inter/affine inter HMVP candidates are utilized just based on the coding order of the HMVP candidates, it is thus provided in the present disclosure to utilize the HMVP candidates based on the relative positon of the HMVP candidate to current coding block, which may improve the coding performance.

Currently, the intra prediction mode which the block vector of IBC or Intra TMP points to is saved in the memory, thus it is straightforward to use the saved intra prediction mode for intra MPM list construction.

In this disclosure, to address the issues as pointed out above, methods are provided to further improve the existing design of the IBC. In general, the main features of the proposed technologies in this disclosure are summarized as follows.

The IBC tool is combined with GPM tool, the combined form can be GPM with IBC and IBC prediction, GPM with IBC and Intra prediction or GPM with IBC and inter prediction.

As a simplified version of IBC tool combined with GPM tool, for a predefined direction (such as 45 degree), the upper left part is predicted with intra mode, the bottom right part is predicted with IBC mode, then they are average weighted to obtain the final prediction signal.

The IBC tool is combined with CIIP tool, where the IBC prediction is combined with intra prediction mode, or the IBC prediction is combined with inter prediction mode.

The weights of intra coded block and inter coded block in CIIP are adaptively decided based on template matching methods.

The IBC tool is combined with MHP tool, where more than one BV prediction are obtained and they are weighted averaged to obtain the final prediction signal.

The Intra TMP tool is combined with CIIP tool, where the Intra TMP is combined with intra prediction mode, or the Intra TMP is combined with inter prediction mode.

The Intra TMP tool is combined with GPM tool, the combined form can be GPM with Intra TMP and Intra TMP prediction, GPM with Intra TMP and Intra prediction or GPM with Intra TMP and inter prediction.

As a simplified version of Intra TMP tool combined with GPM tool, for a predefined direction (such as 45 degree), the upper left part is predicted with intra mode, the bottom right part is predicted with Intra TMP mode, then they are average weighted to obtain the final prediction signal.

The IBC tool is combined with TIMD tool, where IBC mode is used together with the intra prediction modes in MPMs to conduct TIMD fusion.

The Intra TMP tool is combined with TIMD tool, where Intra TMP mode is used together with the intra prediction modes in MPMs to conduct TIMD fusion.

The Intra TMP tool is combined with LIC tool, where the local illumination variation between current block and its Intra TMP prediction block is compensated with the LIC tool.

The IBC tool is combined with OBMC tool, where top and left boundary pixels of current block predicted with IBC are refined with OBMC tool.

The Intra TMP tool is combined with OBMC tool, where top and left boundary pixels of current block predicted with Intra TMP are refined with OBMC tool.

The candidate derivation process for IBC merge mode or IBC AMVP mode is extended by using not only adjacent neighboring blocks but also non-adjacent neighboring blocks.

The IBC mode is extended to sub-block level, where a sub-block in current block has its own BV to conduct motion compensation.

The template pattern of TM IBC mode and TM regular inter mode is extended, where only left template, only above template and so on are utilized to do motion refinement.

Deblocking filter treats the block coded with IBC mode and the block coded with Intra TMP mode equally when obtaining the boundary strength.

The IBC tool is combined with Intra TMP tool, where the combination form can be GPM with IBC and Intra TMP prediction, CIIP with IBC and Intra TMP prediction.

The MMVD candidates of GPM with MMVD mode are reordered based on template matching methods.

The IBC/regular inter/affine inter HMVP candidates are utilized based on the relative position of the HMVP candidate to the current coding block.

During the intra MPM list construction of current block, when one neighboring block is IBC coded or Intra TMP coded, the intra prediction mode which the block vector of IBC or Intra TMP points to is used to construct the intra MPM list of the current block.

In some examples, the disclosed methods may be applied independently or jointly.

GPM with IBC and IBC Prediction

According to one or more embodiments of the disclosure, the IBC tool is combined with GPM tool in the form of GPM with IBC and IBC prediction. Different methods may be used to achieve this goal.

In the first method, both “inter” parts of GPM with inter and inter prediction method in VVC is replaced with IBC. That means that two IBC merge prediction results are weighted averaged with each other according to a splitting line in the coding block. The weight can be obtained referring to GPM with inter and inter prediction method in VVC.

In the second method, both “inter” parts of GPM with inter and inter prediction method in ECM is replaced with IBC, where some template matching tools can be utilized to further improve the coding performance.

### Source of IBC Prediction Results

When combining the IBC tool with GPM tool in the form of GPM with IBC and IBC prediction, the IBC prediction results can be from the regular merge candidates, TM refined merge candidates, or merge candidates with block vector difference (MBVD).

In some examples, the regular merge candidates, the TM refined merge candidates, or the MBVD candidates may exist in the ECM. In the first method, the two IBC prediction results are from the same kind of merge candidates. For example, the two IBC prediction results are both from regular merge candidates, or both from TM refined merge candidates, or both from MBVD candidates, where the merge indices for the two IBC prediction results are different. When the two IBC prediction results are both from regular merge candidates or both from TM refined merge candidates, one flag which signals whether regular merge candidates or TM refined merge candidates are utilized is signalled into bitstream. This flag can be signalled with different methods. In the first method, in ECM, a TM merge flag is signalled into bitstream to indicate whether current block is code with IBC TM merge mode, this flag can be resused for GPM with IBC and IBC prediction. Specifically, after a TM merge flag is signalled, a flag which signals whether current block is coded with IBC-GPM is further signalled. Then, if the TM merge flag is true, the two IBC prediction results are both from TM refined merge candidates; if the TM merge flag is false, the two IBC prediction results are both from regular merge candidates. In this method, if the flag which signals whether current block is coded with IBC-GPM is true, the merge indexes of the two IBC merge candidates are signalled in the IBC-GPM syntax structure, which indicates that the merge indexes of the two IBC merge candidates need not to be signalled again in other place. In the second method, after a TM merge flag is signalled into bitstream to indicate whether current block is code with IBC TM merge mode, the flag which signals whether current block is coded with IBC-GPM is further signalled only when the TM merge flag is false. If the flag which signals whether current block is coded with IBC-GPM is true, another flag which signals whether the two IBC prediction results are both from TM refined merge candidates are further signalled. If this flag is true, it indicates the two IBC prediction results are both from TM refined merge candidates; if this flag is false, the two IBC prediction results are both from regular merge candidates.

In the second method, the two IBC prediction results are from different kinds of merge candidates. For example, one IBC prediction result is from regular merge candidates, and the other IBC prediction result is from TM refined merge candidates. In this example, a flag which signals whether the IBC prediction result of the first GPM partition is from regular merge candidates is signalled into bitstream. If this flag is true, the IBC prediction result of the first GPM partition is from regular merge candidates, the IBC prediction result of the second GPM partition is from TM refined merge candidates. If this flag is false, the IBC prediction result of the first GPM partition is from TM refined merge candidates, the IBC prediction result of the second GPM partition is from regular merge candidates. In this example, the merge indexes for the two IBC prediction results can be same or different.

In the third method, the two IBC prediction results can be from the same merge candidates, or from different kinds of merge candidates. For example, one IBC prediction result can be from regular merge candidates or TM refined merge candidates, and the other IBC prediction result can also be from regular merge candidates or TM refined merge candidates. In this example, for the first GPM partition, one flag which signals whether the IBC prediction result of this GPM partition is from regular merge candidates is first signalled. For the second GPM partition, one flag which signals whether the IBC prediction result of this GPM partition is from regular merge candidates is also signalled. If the two flags are both true or both false, which indicates that the two IBC prediction results are both from regular merge candidates or both from TM refined merge candidates, the merge indexes for the two IBC prediction results are different. If the first flag is true and the second flag is false or the first flag is false and the second flag is true, which indicates the IBC prediction result of the first GPM partition is from regular merge candidates and the IBC prediction result of the second GPM partition is from TM refined merge candidates, or the IBC prediction result of the first GPM partition is from TM refined merge candidates and the IBC prediction result of the second GPM partition is from regular merge candidates, the merge indexes for the two IBC prediction results can be same or different.

Interaction Between GPM with IBC and IBC Prediction and RR-IBC

For the interaction between the tool of GPM with IBC and IBC prediction and the tool of reconstruction-reordered IBC (RR-IBC), different methods can be utilized. In the first method, the two IBC prediction results can not be from the merge candidates coded with RR-IBC mode. To implement this, different methods can be utilized. In the first example, the IBC merge candidate list is scanned from the beginning to the end, if one merge candidate is coded with RR-IBC mode, it is moved to the end of the IBC merge candidate list, and the latter one merge candidate is moved forward accordingly. After reordering all the merge candidates or the maximum allowable number of merge candidates which are not coded with RR-IBC mode is reached, the scanning is terminated. Then, the reordered merge candidate list is utilized for generating the IBC prediction result of GPM with IBC and IBC prediction. In the second example, the IBC merge candidate list is unchanged and the merge candidates which are coded with RR-IBC mode is just skipped when generating the IBC prediction result of GPM with IBC and IBC prediction. In the second method, the two IBC prediction results can be from the merge candidates coded with RR-IBC mode or the merge candidates not coded with RR-IBC mode, there is no constraint when generating the IBC prediction result of GPM with IBC and IBC prediction.

GPM with IBC and IBC Prediction with TM

When TM refined merge candidates are utilized for GPM with IBC and IBC prediction, the TM refined merge candidates can be directly reused for GPM with IBC and IBC prediction, or similar to GPM with TM, different templates may be utilized for different parts of GPM partitions for a predefined GPM split mode. For example, for one GPM partition, a template is constructed using left, above or left and above neighboring samples according to GPM partition angle, as shown in Table 7. The block vector is then refined by minimizing the difference between the current template and the template in the reference area using the same search pattern of TM refined merge mode with half-pel interpolation filter disabled. In some embodiments, the provided methods presented in this section can be combined with the methods presented in section “Source of IBC prediction results” freely. For example, the two IBC prediction results are both from regular merge candidates or both from TM refined merge candidates, when the two IBC prediction results are both from TM refined merge candidates, the TM refined merge candidates can be directly reused, or different templates are utilized for different parts of GPM partitions for a predefined GPM split mode.

GPM with IBC and IBC Prediction with MBVD

When merge candidates with block vector difference (MBVD) are utilized for GPM with IBC and IBC, the reordered IBC MBVD candidates can be directly reused for GPM with IBC and IBC prediction, or similar to GPM with MMVD mode, the chosen MBVD candidate is signalled with one distance index and one direction index, or different templates may be utilized for reordering the MBVD candidates for different parts of GPM partitions for a predefined GPM split mode. When the MBVD candidates for different parts of GPM partitions are reordered, an index is signalled to represent the chosen MBVD candidate.

When merge candidates with block vector difference (MBVD) are utilized for GPM with IBC and IBC, different methods can be utilized to choose the IBC prediction results.

In the first method, the two IBC prediction results are both from the merge candidates refined with block vector difference (MBVD) or both from the regular merge candidates. In this method, one flag which signals whether MBVD is applied for GPM with IBC and IBC prediction needs to be signalled into bitstream. If this flag is true, the two IBC prediction results are both from the regular merge candidates refined with MBVD. If this flag is false, the two IBC prediction results are from the regular merge candidates.

In the second method, one IBC prediction result is from the merge candidates refined with block vector difference (MBVD), the other IBC prediction result is from the regular merge candidates. In this example, a flag which signals whether the IBC prediction result of the first GPM partition is from regular merge candidates is signalled into bitstream. If this flag is true, the IBC prediction result of the first GPM partition is from regular merge candidates, the IBC prediction result of the second GPM partition is from regular merge candidates refined with block vector difference. If this flag is false, the IBC prediction result of the first GPM partition is from regular merge candidates refined with block vector difference, the IBC prediction result of the second GPM partition is from regular merge candidates.

In the third method, one IBC prediction result can be from regular merge candidates or regular merge candidates refined with block vector difference, and the other IBC prediction result can also be from regular merge candidates or regular merge candidates refined with block vector difference. In this example, for the first GPM partition, one flag which signals whether the IBC prediction result of this GPM partition is from regular merge candidates is first signalled. For the second GPM partition, one flag which signals whether the IBC prediction result of this GPM partition is from regular merge candidates is also signalled. If the two flags are both true or both false, it indicates that the two IBC prediction results are both from regular merge candidates or both from regular merge candidates refined with block vector difference. If the first flag is true and the second flag is false or the first flag is false and the second flag is true, it indicates the IBC prediction result of the first GPM partition is from regular merge candidates and the IBC prediction result of the second GPM partition is from regular merge candidates refined with block vector difference, or the IBC prediction result of the first GPM partition is from regular merge candidates refined with block vector difference and the IBC prediction result of the second GPM partition is from regular merge candidates.

In above three methods, when the two IBC prediction results are both from the regular merge candidates, the merge indexes of the two IBC prediction results are different; when one IBC prediction result is from the merge candidates refined with block vector difference (MBVD), the other IBC prediction result is from the regular merge candidates, the merge indexes of the two IBC prediction results can be same or different, or must be different. When the two IBC prediction results are both from the regular merge candidates refined with block vector difference, the merge indexes of the two IBC prediction results are allowed to be the same when the MV refinements of two partitions are different, and disallowed to be the same when the two MV refinements are identical.

When combining the tool ‘GPM with IBC and IBC prediction with MBVD’ and the tool ‘GPM with IBC and IBC prediction with TM’, different methods can be utilized.

In the first method, the tool ‘GPM with IBC and IBC prediction with MBVD’ is applied after the tool ‘GPM with IBC and IBC prediction with TM’. In this method, only when the two IBC prediction results are both from regular merge candidates, the tool ‘GPM with IBC and IBC prediction with MBVD’ can be applied. For example, in the first step, the two IBC prediction results are only allowed to be both from regular merge candidates, or both from TM refined merge candidates. One flag which signals whether the two IBC prediction results are both from regular merge candidates is signalled. If this flag is false, which indicates that the two IBC prediction results are both from TM refined merge candidates, the process is terminated. If the flag is true, the second step can be applied. In the second step, one IBC prediction result is allowed to be from regular merge candidates or regular merge candidates refined with block vector difference, and the other IBC prediction result is also allowed to be from regular merge candidates or regular merge candidates refined with block vector difference. For the first GPM partition, one flag which signals whether the IBC prediction result of this GPM partition is from regular merge candidates is first signalled. For the second GPM partition, one flag which signals whether the IBC prediction result of this GPM partition is from regular merge candidates is also signalled.

In the second method, the tool ‘GPM with IBC and IBC prediction with MBVD’ is applied before the tool ‘GPM with IBC and IBC prediction with TM’. In this method, only when the two IBC prediction results are both from regular merge candidates, the tool ‘GPM with IBC and IBC prediction with TM’ can be applied. For example, in the first step, one IBC prediction result is allowed to be from regular merge candidates or regular merge candidates refined with block vector difference, and the other IBC prediction result is also allowed to be from regular merge candidates or regular merge candidates refined with block vector difference. For the first GPM partition, one flag which signals whether the IBC prediction result of this GPM partition is from regular merge candidates is first signalled. For the second GPM partition, one flag which signals whether the IBC prediction result of this GPM partition is from regular merge candidates is also signalled. If at least one flag is false, which indicates at least one IBC prediction result is from regular merge candidates refined with block vector difference, the process is terminated. If both flags are true, the second step can be applied. In the second step, the two IBC prediction results are only allowed to be both from regular merge candidates, or both from TM refined merge candidates. The flag which signals whether the two IBC prediction results are both from regular merge candidates is signalled.

Split Mode of GPM with IBC and IBC Prediction

When combining the IBC tool with GPM tool in the form of GPM with IBC and IBC prediction, different methods can be utilized to encode the GPM split mode.

In the first method, similar to GPM in VVC, all allowed split modes are coded with equal probability.

In the second method, all allowed GPM split modes are divided into several groups, and two indexes are coded to identify the transmitted GPM split mode, where the first index is used to signal which group is utilized, the second index is used to signal the specific index in the chosen group. For example, all allowed GPM split modes are divided into two groups, where the GPM split modes along horizontal or vertical directions constitute one group, the GPM split modes along other directions constitute the other group. A flag which is context coded or bypass coded is first coded to signal which group the transmitted GPM split mode belongs to, then an index which is coded with equal probability is coded to signal which index the transmitted GPM split mode belongs to in the chosen group. In another example, same to “IBC with Geometry Partitioning” tool presented in the background, all allowed GPM split modes are divided into two groups, the first group is constituted from Table 3, and the second group is constituted from Table 4, a flag which is context coded is first coded to signal which group the transmitted GPM split mode belongs to, then an index which is coded with equal probability is coded to signal which index the transmitted GPM split mode belongs to in the chosen group.

In the third method, TM based method is utilized to code the GPM split mode. In one example, similar to the GPM in ECM, TM based method is utilized to reorder all the allowed GPM split modes, then an index using Golomb-Rice code to indicate where the exact GPM split mode is located in the reordering list is signaled. In some examples, the reordering may be based on comparing template matching costs. In another example, after all allowed GPM split modes are divided into several groups, TM based method is utilized to reorder the GPM split modes in the chosen group, then an index using Golomb-Rice code to indicate where the exact GPM split mode is located in the reordering chosen group is signaled. For example, same to “IBC with Geometry Partitioning” tool presented in the background, all allowed GPM split modes are divided into two groups, the first group is constituted from Table 3, and the second group is constituted from Table 4, a flag which is context coded is first coded to signal which group the transmitted GPM split mode belongs to, then TM based method is utilized to reorder the GPM split modes in the chosen group, finally an index using Golomb-Rice code to indicate where the exact GPM split mode is located in the reordering chosen group is signaled.

In the fourth method, as both the GPM split mode and the two merge indexes of the two GPM split partitions need to be transmitted into bit steam, similar to spatial GPM, TM based method is utilized to reorder all the combinations of the GPM split mode and the two merge indexes of the two GPM split partitions, then an index using Golomb-Rice code to indicate where the exact combination of the GPM split mode and the corresponding two merge indexes of the two GPM split partitions is located in the reordering list is signaled.

Blending Methods of GPM with IBC and IBC Prediction

When combining the IBC tool with GPM tool in the form of GPM with IBC and IBC prediction, different methods can be used to blend the two GPM partitions.

In the first method, adaptive blending is utilized. For a CU coded with GPM with IBC and IBC prediction, different blending widths (For example, 5 different blending widths as shown in FIG. 36) are compared in a RDO process, and the index which signals the chosen blending width is transmitted into bit stream.

In the second method, the blending width can be chosen via a predefined criteria, then no index is needed to transmit into bit stream. In one example, similar the spatial GPM, the blending width is chosen according the width and height of current CU. In another example, similar to GPM in VVC, only one blending width which is equal to T as shown in FIG. 36 is utilized for all CU sizes. In the third example, only one blending width which is equal to ¼ τ as shown in FIG. 36 is utilized for all CU sizes.

In the third method, for different kinds of content, different blending methods are utilized. For example, for screen content, hard blending where the blending width is equal to ¼ τ is utilized, and no index needs to be transmitted into bit stream; for natural content, adaptive blending as presented in the first method is utilized, and the index which signals the chosen blending width is transmitted into bit stream.

In the fourth method, for different slice types, different blending methods are utilized. For example, for I slice, adaptive blending as presented in the first method is utilized; for P slice or B slice, hard blending where the blending width is equal to ¼ τ as shown in FIG. 36 is utilized. It should be noted, when adaptive blending is utilized only for I slice, the index which signals the chosen blending width is only transmitted into bitstream for I slice; for P slice or B slice, the index which signals the chosen blending width needs not to be transmitted into bitstream.

Span Motion for GPM with IBC and IBC Prediction

When combining the IBC tool with GPM tool in the form of GPM with IBC and IBC prediction, different methods can be used to span the motion information for the CU coded with GPM with IBC and IBC prediction. In some examples, spanning motion information of a sub-block refers to filling the motion information of the sub-block according to the subblock's central position in the current CU.

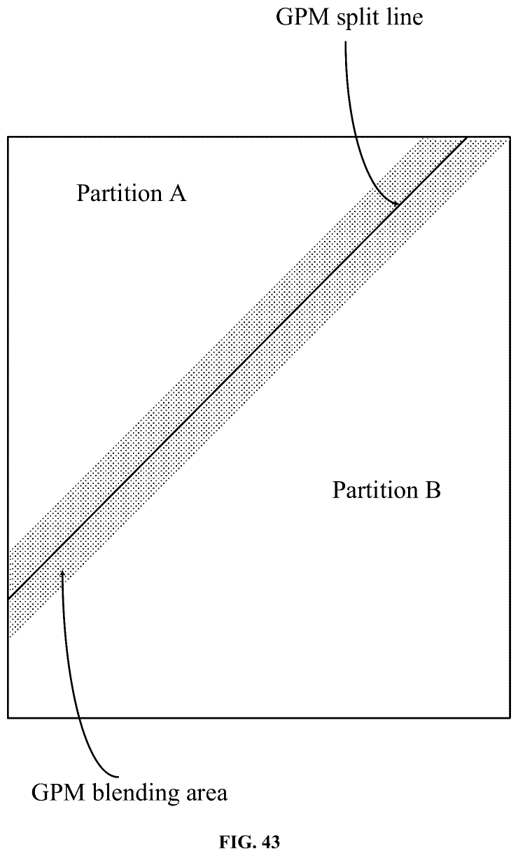

In the first method, as shown in FIG. 43, if the central positon of a sub-block (For example, 4×4) in current CU locates in GPM split partition A, then it is filled with the block vector of the IBC merge candidate of GPM split partition A; if the central positon of a sub-block (For example, 4×4) in current CU locates in GPM split partition B, then it is filled with the block vector of the IBC merge candidate of GPM split partition B. In some embodiments, partitions A and B in this method are adjusted divided by GPM split line, which means partitions A and B may both contain some blending area.

In the second method, as shown in FIG. 43, if the central positon of a sub-block (For example, 4×4) in current CU locates in the no blending area of GPM split partition A, then it is filled with the block vector of the IBC merge candidate of GPM split partition A; if the central positon of a sub-block (For example, 4×4) in current CU locates in the no blending area of GPM split partition B, then it is filled with the block vector of the IBC merge candidate of GPM split partition B. If the central position of a sub-block (For example, 4×4) in current CU locates in the blending area of GPM split partition, it is filled with the weighted average of the block vectors of the IBC merge candidates of the two GPM split partitions. For example, if the central position of a sub-block (For example, 4×4) in current CU locates in the blending area of GPM split partition, it is filled with the equally averaged block vectors of the IBC merge candidates of the two GPM split partitions.

In the third method, as shown in FIG. 43, the motion information of current CU is just all filled with the block vector of the IBC merge candidate of GPM split partition A or GPM split partition B no matter where the GPM split line locates.

Span Intra Prediction Mode for GPM with IBC and IBC Prediction

When combining the IBC tool with GPM tool in the form of GPM with IBC and IBC prediction, different methods can be used to span the intra prediction mode information for the CU coded with GPM with IBC and IBC prediction. In some examples, spanning intra prediction mode information of a sub-block refers to filling the intra prediction mode information of the sub-block according to the subblock's central position in the current CU.

In the first method, as shown in FIG. 43, if the central positon of a sub-block (For example, 4×4) in current CU locates in GPM split partition A, then it is filled with the intra prediction mode pointed by the block vector of the IBC merge candidate of GPM split partition A; if the central positon of a sub-block (For example, 4×4) in current CU locates in GPM split partition B, then it is filled with the intra prediction mode pointed by block vector of the IBC merge candidate of GPM split partition B. In some embodiments, partitions A and B in this method are justed divided by GPM split line, which means partitions A and B may both contain some blending area.

In the second method, as shown in FIG. 43, if the central positon of a sub-block (For example, 4×4) in current CU locates in the no blending area of GPM split partition A, then it is filled with the intra prediction mode pointed by the block vector of the IBC merge candidate of GPM split partition A; if the central positon of a sub-block (For example, 4×4) in current CU locates in the no blending area of GPM split partition B, then it is filled with the intra prediction mode pointed by the block vector of the IBC merge candidate of GPM split partition B. If the central position of a sub-block (For example, 4×4) in current CU locates in the blending area of GPM split partition, it is filled with the intra prediction mode pointed by weighted average of the block vectors of the IBC merge candidates of the two GPM split partitions, or it is filled with the weighted average of the intra prediction modes pointed by the block vectors of the IBC merge candidates of the two GPM split partitions. For example, if the central position of a sub-block (For example, 4×4) in current CU locates in the blending area of GPM split partition, it is filled with the intra prediction mode pointed by the equally averaged block vectors of the IBC merge candidates of the two GPM split partitions. In another example, if the central position of a sub-block (For example, 4×4) in current CU locates in the blending area of GPM split partition, it is filled with the equally averaged intra prediction modes pointed by the block vectors of the IBC merge candidates of the two GPM split partitions.

In the third method, as shown in FIG. 43, the intra prediction mode of current CU is just all filled with the intra prediction mode pointed by the block vector of the IBC merge candidate of GPM split partition A or GPM split partition B no matter where the GPM split line locates.

Application Channels for GPM with IBC and IBC Prediction

When combining the IBC tool with GPM tool in the form of GPM with IBC and IBC prediction, different methods can be used to apply GPM with IBC and IBC prediction to different channels.

In the first method, applying GPM with IBC and IBC prediction to different channels can be decided based on slice type. For example, for I slice, GPM with IBC and IBC prediction is only applied to luma channel of current CU; for P slice or B slice, GPM with IBC and IBC prediction is applied to both luma and chroma channels of current CU. In another example, for I slice, P slice or B slice, GPM with IBC and IBC prediction is only applied to luma channel of current CU. In the third example, for I slice, P slice or B slice, GPM with IBC and IBC prediction is applied to both luma and chroma channels of current CU.

Modes Setting for GPM with IBC and IBC Prediction

When combining the IBC tool with GPM tool in the form of GPM with IBC and IBC prediction, different methods can be utilized to set the modes of the CU coded with GPM with IBC and IBC prediction.

In the first method, as shown in FIG. 43, the merge index of the CU coded with GPM with IBC and IBC prediction is set to the merge index of the GPM split partition A, and the corresponding modes (such as IBC-LIC flag, RR-IBC type, etc.) of the CU coded with GPM with IBC and IBC prediction is set to the corresponding modes of the GPM split partition A. In the second method, as shown in FIG. 43, the merge index of the CU coded with GPM with IBC and IBC prediction is set to the merge index of the GPM split partition B, and the corresponding modes (such as IBC-LIC flag, RRIBC type, etc.) of the CU coded with GPM with IBC and IBC prediction is set to the corresponding modes of the GPM split partition B. In the third method, the modes of the CU coded with GPM with IBC and IBC prediction can be set to default values. For example, the IBC-LIC flag of the CU coded with GPM with IBC and IBC prediction is set to false, the RR-IBC type of the CU coded with GPM with IBC and IBC prediction is set to 0.

GPM with IBC and Intra Prediction

According to one or more embodiments of the disclosure, the IBC tool is combined with GPM tool in the form of GPM with IBC and intra prediction. Different methods may be used to achieve this goal.

In the first method, the “inter” part of GPM with inter and intra prediction method in ECM is replaced with IBC, where the IBC merge predicted results are weighted averaged with the intra prediction results to obtain the final prediction signal.

### Source of IBC Prediction Result

When combining the IBC tool with GPM tool in the form of GPM with IBC and intra prediction, the IBC prediction result can be from the regular merge candidates, TM refined merge candidates, or merge candidates with block vector difference (MBVD).

When TM refined merge candidates are utilized for GPM with IBC and intra prediction, the TM refined merge candidates can be directly reused for deriving the IBC prediction result for GPM with IBC and intra prediction, or similar to GPM with TM, different templates may be utilized for the IBC predicted GPM partition for a predefined GPM split mode. For example, for the IBC predicted GPM partition, a template is constructed using left, above or left and above neighboring samples according to GPM partition angle, as shown in Table 7. When using Table 7 to derive the template pattern, if the first GPM partition is predicted by IBC, then the template pattern of the first GPM partition is reused for the TM refined merge candidates; if the second GPM partition is predicted by IBC, then the template pattern of the second GPM partition is reused for the TM refined merge candidates. The block vector is then refined by minimizing the difference between the current template and the template in the reference area using the same search pattern of TM refined merge mode with half-pel interpolation filter disabled.

When merge candidates with block vector difference (MBVD) are utilized for GPM with IBC and intra prediction, the reordered IBC MBVD candidates can be directly reused for GPM with IBC and intra prediction, or similar to GPM with MMVD mode, the chosen MBVD candidate is signalled with one distance index and one direction index, or different templates may be utilized for reordering the MBVD candidates for the IBC predicted GPM partition for a predefined GPM split mode. When the MBVD candidates for the IBC predicted GPM partition are reordered, an index is signalled to represent the chosen MBVD candidate.

When combining the tool ‘GPM with IBC and intra prediction with MBVD’ and the tool ‘GPM with IBC and intra prediction with TM’, different methods can be utilized.

In the first method, the tool ‘GPM with IBC and intra prediction with MBVD’ is applied after the tool ‘GPM with IBC and intra prediction with TM’. In this method, only when the IBC prediction result is from regular merge candidates, the tool ‘GPM with IBC and intra prediction with MBVD’ can be applied. For example, in the first step, the IBC prediction result is only allowed to be from regular merge candidates or from TM refined merge candidates. One flag which signals whether the IBC prediction result is from regular merge candidates is first signalled. If the flag is false, which indicates that the IBC prediction result is from TM refined merge candidates, the process is terminated. If the flag is true, the second step can be applied. In the second step, the IBC prediction result is allowed to be from regular merge candidates or regular merge candidates refined with block vector difference. And the flag which signals whether the IBC prediction result of this GPM partition is from regular merge candidates is signalled.

In the second method, the tool ‘GPM with IBC and intra prediction with MBVD’ is applied before the tool ‘GPM with IBC and intra prediction with TM’. In this method, only when the IBC prediction result is from regular merge candidates, the tool ‘GPM with IBC and intra prediction with TM’ can be applied. For example, in the first step, the IBC prediction result is allowed to be from regular merge candidates or regular merge candidates refined with block vector difference. One flag which signals whether the IBC prediction result is from regular merge candidates is signalled. If the flag is false, which indicates the IBC prediction result is from regular merge candidates refined with block vector difference, the process is terminated. If the flag is true, the second step can be applied. In the second step, the IBC prediction result is only allowed to be from regular merge candidates or TM refined merge candidates. The flag which signals whether the IBC prediction result is from regular merge candidates is signalled.

Split Mode of GPM with IBC and Intra Prediction

When combining the IBC tool with GPM tool in the form of GPM with IBC and intra prediction, different methods can be utilized to encode the GPM split mode.

In the first method, similar to GPM in VVC, all allowed split modes are coded with equal probability.

In the second method, all allowed GPM split modes are divided into several groups, and two indexes are coded to identify the transmitted GPM split mode, where the first index is used to signal which group is utilized, the second index is used to signal the specific index in the chosen group. For example, all allowed GPM split modes are divided into two groups, where the GPM split modes along horizontal or vertical directions constitute one group, the GPM split modes along other directions constitute the other group. A flag which is context coded or bypass coded is first coded to signal which group the transmitted GPM split mode belongs to, then an index which is coded with equal probability is coded to signal which index the transmitted GPM split mode belongs to in the chosen group.

In the third method, TM based method is utilized to code the GPM split mode. In one example, similar to the GPM in ECM, TM based method is utilized to reorder all the allowed GPM split modes, then an index using Golomb-Rice code to indicate where the exact GPM split mode is located in the reordering list is signaled. In another example, after all allowed GPM split modes are divided into several groups, TM based method is utilized to reorder the GPM split modes in the chosen group, then an index using Golomb-Rice code to indicate where the exact GPM split mode is located in the reordering chosen group is signaled. For example, same to “IBC with Geometry Partitioning” tool presented in the background, all allowed GPM split modes are divided into two groups, the first group is constituted from Table 3, and the second group is constituted from Table 4, a flag which is context coded is first coded to signal which group the transmitted GPM split mode belongs to, then TM based method is utilized to reorder the GPM split modes in the chosen group, finally an index using Golomb-Rice code to indicate where the exact GPM split mode is located in the reordering chosen group is signaled.

In the fourth method, as both the GPM split mode and the IBC merge index and intra prediction mode index of the two GPM split partitions need to be transmitted into bit steam, similar to spatial GPM, TM based method is utilized to reorder all the combinations of the GPM split mode and the IBC merge index and intra prediction mode index of the two GPM split partitions, then an index using Golomb-Rice code to indicate where the exact combination of the GPM split mode and the corresponding IBC merge index and intra prediction mode index of the two GPM split partitions is located in the reordering list is signaled.

Blending Methods of GPM with IBC and Intra Prediction

When combining the IBC tool with GPM tool in the form of GPM with IBC and intra prediction, different methods can be used to blend the two GPM partitions.

In the first method, adaptive blending is utilized. For a CU coded with GPM with IBC and IBC prediction, different blending widths (For example, 5 different blending widths as shown in FIG. 36) are compared in a RDO process, and the index which signals the chosen blending width is transmitted into bit stream.

In the second method, the blending width can be chosen via a predefined criteria, then no index is needed to transmit into bit stream. In one example, similar the spatial GPM, the blending width is chosen according the width and height of current CU. In another example, similar to GPM in VVC, only one blending width which is equal to T as shown in FIG. 36 is utilized for all CU sizes. In the third example, only one blending width which is equal to ¼ τ as shown in FIG. 36 is utilized for all CU sizes.

In the third method, for different kinds of content, different blending methods are utilized. For example, for screen content, hard blending where the blending width is equal to ¼ τ is utilized, and no index is needed to transmit into bit stream; for natural content, adaptive blending as presented in the first method is utilized, and the index which signals the chosen blending width is transmitted into bit stream.

In the fourth method, for different slice types, different blending methods are utilized. For example, for I slice, adaptive blending as presented in the first method is utilized; for P slice or B slice, hard blending where the blending width is equal to ¼ τ as shown in FIG. 36 is utilized. It should be noted, when adaptive blending is utilized only for I slice, the index which signals the chosen blending width is only transmitted into bitstream for I slice; for P slice or B slice, the index which signals the chosen blending width needs not to be transmitted into bitstream.

Span Motion and Intra Prediction Mode for GPM with IBC and Intra Prediction

When combining the IBC tool with GPM tool in the form of GPM with IBC and intra prediction, different methods can be used to span the motion and intra prediction mode information for the CU coded with GPM with IBC and intra prediction. In some examples, spanning motion information of a sub-block refers to filling the motion information of the sub-block according to the subblock's central position in the current CU. In some examples, spanning intra prediction mode information of a sub-block refers to filling the intra prediction mode information of the sub-block according to the subblock's central position in the current CU.

In the first method, as shown in FIG. 43, if the central positon of a sub-block (For example, 4×4) in current CU locates in GPM split partition A, if the GPM split partition A is predicted by IBC, then the motion information of this sub-block is filled with the block vector of the IBC merge candidate of GPM split partition A, and the intra prediction mode information of this sub-block is filled with the intra prediction mode pointed by the block vector of the IBC merge candidate of GPM split partition A; if the GPM split partition A is predicted by intra, the motion information of this sub-block is null, and the intra prediction mode information of this sub-block is filled with the intra prediction mode of GPM split partition A. If the central positon of a sub-block (For example, 4×4) in current CU locates in GPM split partition B, if the GPM split partition B is predicted by IBC, then the motion information of this sub-block is filled with the block vector of the IBC merge candidate of GPM split partition B, and the intra prediction mode information of this sub-block is filled with the intra prediction mode pointed by the block vector of the IBC merge candidate of GPM split partition B; if the GPM split partition B is predicted by intra, the motion information of this sub-block is null, and the intra prediction mode information of this sub-block is filled with the intra prediction mode of GPM split partition B. In some embodiments, if one GPM partition is predicted by IBC, then the other GPM partition must be predicted by intra.

In the second method, as shown in FIG. 43, the motion information of current CU is just all filled with the block vector of the IBC merge candidate of GPM split partition which is predicted by IBC, and the intra prediction mode information of current CU is just all filled with the intra prediction mode pointed by the block vector of the IBC merge candidate of GPM split partition which is predicted by IBC, or the intra prediction mode information of current CU is just all filled with the intra prediction mode of GPM split partition which is predicted by intra.

Unification of GPM with Intra and Intra Prediction, GPM with IBC and Intra Prediction, and GPM with IBC and IBC Prediction

According to one or more embodiments of the disclosure, the coding tools of GPM with intra and intra prediction, GPM with IBC and intra prediction, and GPM with IBC and IBC prediction are unified into one set of syntax elements.

Several syntax elements of GPM are coded into the bitstream using entropy coding. In the high-level syntax (HLS), the GPM enabling flag and the maximum number of IBC GPM merge candidates and the maximum number of intra GPM mode candidates are coded in the sequence parameter set (SPS). The GPM enabling flag is coded with fixed-length code, whereas the maximum number of IBC GPM merge candidates is signaled relative to the maximum number of regular IBC merge candidates and coded with 0-th order exponential-Golomb code.

At the CU level, the GPM syntax elements are signaled inside the merge data syntax. Specifically, a flag which signals whether a CU is GPM coded is first coded into bit stream. If this flag is true, the GPM split mode is transmitted into bit stream. For one GPM split partition, a flag which signals whether this GPM split partition is intra coded is first coded into bit stream. If this flag is true, the intra mode index is transmitted into bit stream; else, the IBC merge index is transmitted into bit stream. For the other GPM split partition, same syntax elements are transmitted. In some embodiments, when the two GPM split partitions are both intra coded or both IBC coded, the intra mode index or IBC merge index of the two GPM split partitions are different.

When only GPM with IBC and intra prediction and GPM with IBC and IBC prediction are enabled, the syntax elements at the CU level can be simplified as follows: a flag which signals whether a CU is GPM coded is first coded into bit stream. If this flag is true, the GPM split mode is transmitted into bit stream. For the first GPM split partition, a flag which signals whether this GPM split partition is intra coded is first coded into bit stream. If this flag is true, the intra mode index is transmitted into bit stream; else, the IBC merge index is transmitted into bit stream. For the second GPM split partition, if the flag which signals whether the first GPM split partition is intra coded is true, the IBC merge index of the second GPM split partition is transmitted into bit stream; if the flag which signals whether the first GPM split partition is intra coded is false, another flag which signals whether the second GPM split partition is intra coded is coded into bitstream. If the flag which signals whether the second GPM split partition is intra coded is true, the intra mode index of the second GPM split partition is transmitted into bit stream, otherwise, the IBC merge index of the second GPM split partition is transmitted into bit stream. In some embodiments, when the two GPM split partitions are both IBC coded, the IBC merge index of the two GPM split partitions are different. To present the syntax elements clear, the syntax elements table is presented as follow:

```
merge_data( ) {
...
  ibc_gpm_flag
  if(ibc_gpm_flag){
      merge_gpm_partition_idx
      gpm_idx0_intra_flag
    If(!gpm_idx0_intra_flag)
        gpm_idx1_intra_flag
      If(gpm_idx0_intra_flag){
        gpm_idx0_intra_index
    }
    else{
        if(MaxNumIBCGpmMergeCand > =2)
            ibc_merge_gpm_idx0
          }
      if(gpm_idx1_intra_flag){
        gpm_idx1_intra_index
      }
    else{
        if(gpm_idx0_intra_flag) {
            if(MaxNumIBCGpmMergeCand > =2)
              ibc_merge_gpm_idx1
          }
      else{
              if(MaxNumIBCGpmMergeCand > 2)
                ibc_merge_gpm_idx1
      }
    }
```

To signal the IBC merge index, different methods can be utilized. For example, the IBC merge index is binarized with O-th order truncated Rice code and coded using one single context model that is initialized with the same initial value of the regular IBC merge index. In some embodiments, when the two GPM split partitions are both IBC coded, the used GPM merge indexes GPM_idx0,1 are derived from the signaled syntax elements by

$$GPM\_idx0 = ibc\_merge \_gpm \_idx0$$

$$and$$

$$GPM\_idx1 = ibc\_merge \_gpm \_idx1 + ( ibc\_merge \_gpm \_idx1 > GPM\_idx0 ) ? 1 : 0$$

because the two mBC merge indexes are not allowed to be identical
GPM with IBC and Inter Prediction

According to one or more embodiments of the disclosure, the IBC tool is combined with GPM tool in the form of GPM with IBC and inter prediction. Different methods may be used to achieve this goal.

In the first method, one “inter” part of GPM with inter and inter prediction method in VVC is replaced with IBC, where the IBC merge predicted results are weighted averaged with the inter merge prediction results to obtain the final prediction signal.

In the second method, one “inter” part of GPM with inter and inter prediction method in ECM is replaced with IBC, where some template matching tools can be utilized to further improve the coding performance.

### Simplified IBC and Intra Prediction Combination in GPM Form

According to the one or more embodiments of the disclosure, the IBC tool is combined with GPM tool in the form of simplified GPM with IBC and intra prediction, such as IBC and intra prediction is combined at a certain splitting mode, which can save the bits overhead of the splitting representation. Different methods may be used to achieve this goal.

In the first method, aiming at one splitting line, such as 45 degree, the upper left parts of the coding block is coded with intra prediction mode, and the bottom right parts of the coding block is coded with IBC prediction mode, then they are averaged in GPM form to obtain the final prediction signal.

### Combined IBC-Intra/Inter Prediction

According to one or more embodiments of the disclosure, the coding block coded with IBC mode are combined with the coding block coded with intra mode or inter mode. Different methods may be used to achieve this goal.

In the first method, the decoder/encoder may combine the coding block coded with IBC mode with the coding block coded with intra mode. Various methods can be utilized in this combination. In one example, similar to the CIIP technology in VVC, the coding block coded with IBC merge mode is regarded as the coding block coded with inter merge mode, and it is combined with the coding block coded with planar intra prediction mode. In another example, similar to the Combination of CIIP with TIMD and TM merge technology in ECM, the coding block coded with IBC merge-TM mode is combined with the coding block coded with TIMID derived intra prediction mode.

When combining the coding block coded with IBC mode with the coding block coded with intra mode, the weights may be designed similar to the CIIP technology in VVC and the Combination of CIIP with TIMD and TM merge technology in ECM, i.e. 1) the weights for both IBC coded block and intra coded block are bigger than zero and less than one, or the weights for intra coded block gradually change from one to zero from one area to another area in current block (vice versa for the weights for IBC coded block); 2) the weights for IBC coded block and intra coded block may be decided based on coding modes of neighboring blocks and intra mode of current block; 3) the weights for IBC coded block and intra coded block may be uniform in the whole current block or different in different positions of current block.

For example, the weights for IBC coded block and intra coded block may be decided as follows: When the up and left neighboring blocks of current block are both intra coded and the intra mode of current block is planar mode, the weights for IBC coded block and intra coded block are ¼ and ¾ in the whole current block. When the up and left neighboring blocks of current block are both IBC coded and the intra mode of current block is planar mode, the weights for IBC coded block and intra coded block are ¾ and ¼ in the whole current block. When one up or left neighboring block is IBC coded, the other neighboring block is intra coded, and the intra mode of current block is planar mode, the weights for IBC coded block and intra coded block are ½ and ½ in the whole current block.

When the intra mode of current block is near horizontal angular modes (2<=angular mode index<34), the current block is vertically divided as shown in FIG. 16A; when the intra mode of current block is near vertical angular modes (34<=angular mode index<=66), the current block is horizontally divided as shown in FIG. 16B. The weights for IBC coded block (wIBC) and intra coded block (wIntra) for different sub-blocks are shown in Table 9. Besides, the weights for IBC coded block and intra coded block may be decided in a CIIP-PDPC version. In this version, the intra mode of current block is set to planar mode, the weights for intra coded block gradually decrease when the combination position moves from top left to bottom right in current block, and vice versa for the weights for IBC coded block.

TABLE 9
The modified weights used for angular modes.

| The sub- | (wIntra, |
|---|---|
| block index | wIBC) |
| 0 | (6, 2) |
| 1 | (5, 3) |
| 2 | (3, 5) |
| 3 | (2, 6) |

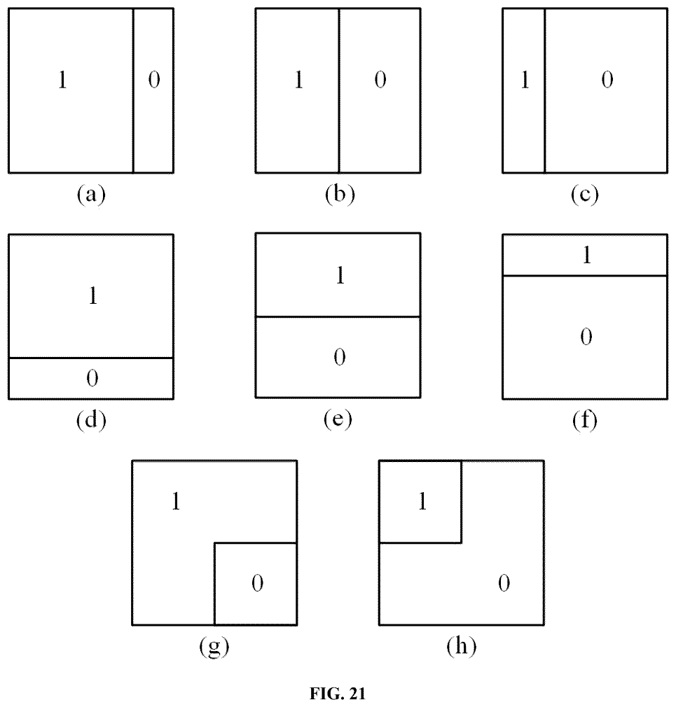

When combining the coding block coded with IBC mode with the coding block coded with intra mode, the weights may also be designed in a mask version, i.e. the weights for IBC coded block and intra coded block may be one or zero for different areas of current block. The specific weights for IBC coded block and intra coded block may be decided based on coding modes of neighboring blocks and intra mode of current block. For example, the weights for IBC coded block and intra coded block may be decided as follows: when the intra mode of current block is near horizontal angular modes (2<=angular mode index<34), if the up and left neighboring blocks of current block are both intra coded, the weights for intra coded block is one in the left ¾ area of current block and zero in the right ¼ area of current block as shown in FIG. 21 (a), and vice versa for the weights for IBC coded block; if only one neighboring block is intra coded, the weights for intra coded block is one in the left ½ area of current block and zero in the right ½ area of current block as shown in FIG. 21 (b), and vice versa for the weights for IBC coded block; if none of the up and left neighboring blocks of current block are intra coded, the weights for intra coded block is one in the left ¼ area of current block and zero in the right ¾ area of current block as shown in FIG. 21 (c), and vice versa for the weights for IBC coded block.

When the intra mode of current block is near vertical angular modes (34<=angular mode index<=66), if the up and left neighboring blocks of current block are both intra coded, the weights for intra coded block is one in the top ¾ area of current block and zero in the bottom ¼ area of current block as shown in FIG. 21 (d), and vice versa for the weights for IBC coded block; if only one neighboring block is intra coded, the weights for intra coded block is one in the top ½ area of current block and zero in the bottom ½ area of current block as shown in FIG. 21 (e), and vice versa for the weights for IBC coded block; if none of the up and left neighboring blocks of current block are intra coded, the weights for intra coded block is one in the top ¼ area of current block and zero in the bottom ¾ area of current block as shown in FIG. 21 (f), and vice versa for the weights for IBC coded block.

When the intra mode of current block is planar mode, if the up and left neighboring blocks of current block are both intra coded, the weights for intra coded block is one in the top left ¾ area (horizontal index is smaller than ½ width of current block or vertical index is smaller than ½ height of current block) of current block and zero in the right bottom ¼ area (horizontal index is equal or bigger than ½ width of current block and vertical index is equal or bigger than ½ height of current block) of current block as shown in FIG. 21 (g), and vice versa for the weights for IBC coded block; if only up neighboring block is intra coded, the weights for intra coded block is one in the top ½ area of current block and zero in the bottom ½ area of current block as shown in FIG. 21 (e), and vice versa for the weights for IBC coded block; if only left neighboring block is intra coded, the weights for intra coded block is one in the left ½ area of current block and zero in the right ½ area of current block as shown in FIG. 21 (b), and vice versa for the weights for IBC coded block; if none of the up and left neighboring blocks of current block are intra coded, the weights for intra coded block is one in the top left ¼ area (horizontal index is smaller than ½ width of current block and vertical index is smaller than ½ height of current block) of current block and zero in the bottom right ¾ area (horizontal index is equal or bigger than ½ width of current block or vertical index is equal or bigger than ½ height of current block) of current block as shown in FIG. 21 (h), and vice versa for the weights for IBC coded block.

The above two weights design methods may be utilized independently or combined together. For example, when the intra mode of current block is planar mode, if none of the up and left neighboring blocks of current block are intra coded, the weights for IBC coded block and intra coded block may be designed similar to the CIIP technology in VVC. In other conditions, the weights for IBC coded block and intra coded block may be designed in a mask version.

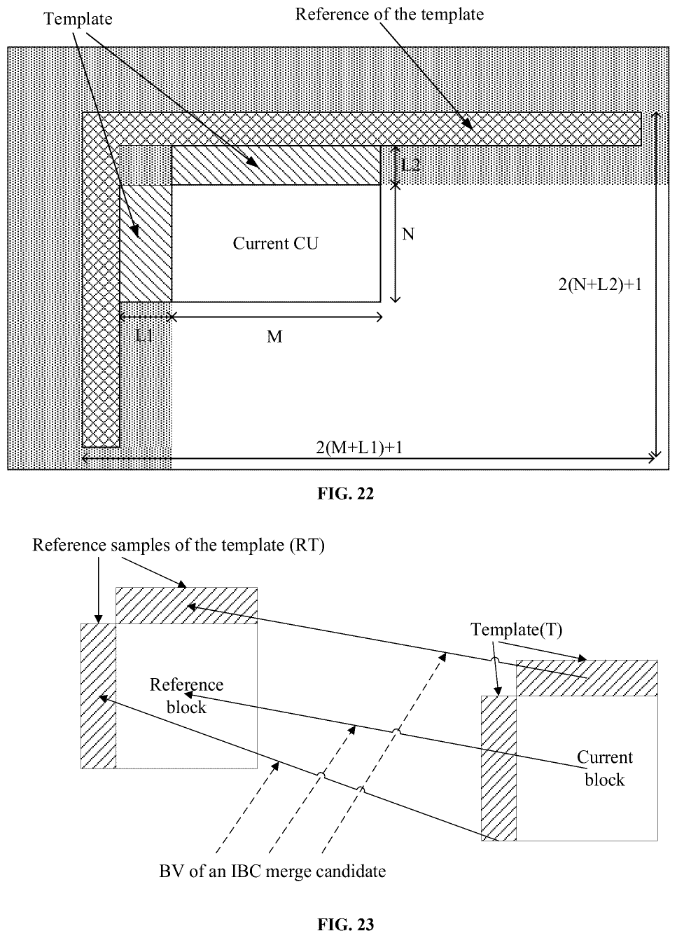

When combining the coding block coded with IBC mode with the coding block coded with intra mode, the weights may also be designed based on template matching methods, where the sum of absolute difference (SAD), sum of square difference (SSD) or sum of absolute transformed difference (SATD) between the prediction and reconstruction samples of the current block template may be utilized to compute the weights for IBC coded block and intra coded block. The SATD is a block matching criterion widely used in scenarios such as fractional motion estimation for video compression. For example, the weights for IBC coded block and intra coded block may be decided as follows: For intra coded block, as shown in FIG. 22, the SATD between the prediction and reconstruction samples of current block template is calculated as SATDᵢₙₜᵣₐ, where the prediction samples of current block template are intra predicted using the reference samples of the template with the intra mode of current block. For IBC coded block, as shown in FIG. 23, the SATD between the prediction and reconstruction samples of current block template is calculated as SATD_{IBC}, where the prediction samples of current block template are predicted using the reference samples pointed by the block vector of current block. The weights for IBC coded block W_{IBC} and intra coded block wᵢₙₜᵣₐ are decided as follows:

$${w}_{IBC} = \frac{{SATD}_{intra}}{{SATD}_{IBC} + {SATD}_{intra}}$$

$${w}_{intra} = \frac{{SATD}_{IBC}}{{SATD}_{IBC} + {SATD}_{intra}}$$

When utilizing the template of current block for computing the weights of IBC coded block and intra coded block, both left and top template may be utilized if they are available, or only left template or only top template is utilized if it is available. The utilization of both left and top template, only top template or only left template may be decided in a Rate-Distortion Optimization (RDO) process or in a predefined criteria. The RDO technique generally minimizes the amount of distortion (loss of video quality) against the amount of data required to encode the video. For a predefined criteria, for example, if the intra mode of current block is planar mode or DC mode, both left and top template are utilized; if the intra mode of current block is near horizontal angular modes (2<=angular mode index<34), only left template is utilized; if the intra mode of current block is near vertical angular modes (34<=angular mode index<=66), only top template is utilized.

When combining the coding block coded with IBC mode with the coding block coded with intra mode, the weights derived based on template matching methods can be compared with the weights derived refer to CIIP in ECM (or the weights designed in a mask version) in a RDO process, which means a flag in coding block level needs to be transmitted into bit stream to signal which method is utilized; or the weights derived based on template matching methods can be used to replace total or partial of the weights derived refer to CIIP in ECM (or the weights designed in a mask version). For example, if the intra mode of current block is planar mode or DC mode, the weights of intra coded block and IBC coded block are decided based on template matching methods; otherwise, the weights are decided refer to CIIP in ECM (or in a mask version).

In the second method, the decoder/encoder may combine the coding block coded with IBC mode with the coding block coded with inter mode. Various methods may be utilized in this combination. In one example, similar to the CIIP technology in VVC, the coding block coded with IBC merge mode is regarded as the coding block coded with planar intra mode, and it is combined with the coding block coded with inter merge mode. In another example, the coding block coded with IBC merge mode is regarded as the coding block coded with inter merge mode, and it is combined with the coding block coded with inter merge mode by equally averaging.

In the third method, the decoder/encoder may combine the coding block coded with IBC mode with the coding block coded with intra mode and the coding block coded with inter mode. Various methods may be utilized in this combination. In one example, the coding block coded with IBC mode, the coding block coded with intra mode, and the coding block coded with inter mode are directly combined by equally averaging. In another example, firstly the coding block coded with IBC mode is separately combined with the coding block coded with intra mode and inter mode as presented in the first and second method. Then, the separate combined results are combined by equally averaging.

### CIIP Improvement

When designing the weights of intra coded block and inter coded block in CIIP, the weights can be designed based on template matching methods, where the sum of absolute difference (SAD), sum of square difference (SSD) or sum of absolute transformed difference (SATD) between the prediction and reconstruction samples of the current block template can be utilized to compute the weights for intra coded block and inter coded block. For example, the weights for intra coded block and inter coded block can be decided as follows: For intra coded block, as shown in FIG. 22, the SATD between the prediction and reconstruction samples of current block template is calculated as SATDᵢₙₜᵣₐ, where the prediction samples of current block template is intra predicted using the reference samples of the template with the intra mode of current block. For inter coded block, as shown in FIG. 23 (where “BV of an IBC merge candidate” in the figure is replaced by “MV of an inter merge candidate”), the SATD between the prediction and reconstruction samples of current block template is calculated as SATDᵢₙₜₑᵣ, where the prediction samples of current block template is predicted using the reference samples of the template with the motion vector of current block. The weights for inter coded block wᵢₙₜₑᵣ and intra coded block wᵢₙₜᵣₐ are decided as follow:

$${w}_{inter} = \frac{{SATD}_{intra}}{{SATD}_{inter} + {SATD}_{intra}}$$

$${w}_{intra} = \frac{{SATD}_{inter}}{{SATD}_{inter} + {SATD}_{intra}}$$

When utilizing the template of current block for computing the weights of inter coded block and intra coded block, both left and top template can be utilized if they are available, or only left template or only top template is utilized if it is available. The utilization of both left and top template, only top template or only left template can be decided in a RDO process or in a predefined criteria. For example, if the intra mode of current block is planar mode or DC mode, both left and top template are utilized; if the intra mode of current block is near horizontal angular modes (2<=angular mode index<34), only left template is utilized; if the intra mode of current block is near vertical angular modes (34<=angular mode index<=66), only top template is utilized.

When utilizing the template matching based methods to derive the weights of intra coded block and inter coded block in CIIP, the weights derived based on template matching methods can be compared with the weights derived based on original methods in a RDO process, which means a flag in coding block level needs to be transmitted into bit stream to signal which method is utilized; or the weights derived based on template matching methods can be used to replace total or partial of the weights derived based on original methods. For example, if the intra mode of current block is planar mode or DC mode, the weights of intra coded block and inter coded block in CIIP are decided based on template matching methods; otherwise, the weights are decided based on original methods.

### Multiple Hypothesis IBC Prediction

According to the one or more embodiments of the disclosure, the block vector (BV) number in IBC tool is increased to 2 or more, and 2 or more hypothesis are combined to obtain the final prediction result. Different methods may be used to achieve this goal.

In the first method, the decoder/encoder may combine 2 hypothesis corresponding to 2 BVs to obtain the final prediction result. Various methods may be utilized to achieve this goal. In one example, the 2 BVs corresponding the smallest and the second smallest rate distortion metrics in IBC AMVP mode are equally averaged to obtain the final prediction result. In another example, the prediction result corresponding to IBC AMVP mode and the prediction result corresponding to IBC merge mode are equally averaged to obtain the final prediction result.

In the second method, the decoder/encoder may combine more hypothesis corresponding to more BVs to obtain the final prediction result. Various methods may be utilized to achieve this goal. In one example, the iterative accumulation method proposed in Multi-hypothesis prediction (MHP) technology is utilized to obtain the final prediction result. In another example, all the BVs corresponding the smallest, the second smallest, the third smallest, . . . , rate distortion metrics in IBC AMVP mode are equally averaged to obtain the final prediction result.

### Prediction Block Candidate Derivation

In some embodiments, the prediction block candidates are searched and selected according to the criterion of minimizing template matching cost, i.e., the top N candidates which lead to the minimum BV matching cost are selected. The BV matching cost can be not limited to SAD (sum of absolute difference) and SSE (sum of square error).

In some embodiments, the prediction block candidates may be selected according to the predefine mode, i.e., planar mode.

In some embodiments, the prediction block candidates may be selected according to the neighbor predefine mode, i.e., top predefine mode, left predefine mode.

### Fixed Multi-Hypothesis IBC

In this embodiment, the weighting factors to generate the final prediction block are predefined and fixed at both the encoder and decoder side. As an example, equal weighting factors can be used, i.e., 1/N for all the candidate blocks.

### Adaptive Multi-Hypothesis IBC

To adapt to the diverse characteristics of video content, adaptive multi-hypothesis IBC methods are also provided.

In some embodiments, the weighting factors may be derived based on the BV matching costs. Denote the BV matching costs of the N candidates as C₁, C₂, . . . , C_{N}, the weighting factors are calculated as follow.

$${ω}_{i} = \frac{1}{N - 1} - \frac{{C}_{i}}{( N - 1 ) {\sum }_{k = 1}^{N} {C}_{k}} , i = 1 , 2 , … , N \qquad ( 4 )$$

In some embodiments, the BV matching cost can be measured with (but not limited to) SAD and SSE.

In yet another embodiment, the weighting factors may be derived/switched based on the block size or syntax element signaled in SPS/DPS/VPS/SEI/APS/PPS/PH/SH/Region/CTU/CU/Subblock/Sample levels.

In yet another embodiment, the weighting factors may be derived at the encoder side and then signaled in the bitstream to the decoder. Denote the N prediction block candidates as P₁, P₂, . . . , P_{N} and the current block as X, then the weighting factors can be solved by the following equation:

$${\sum }_{i = 1}^{N} {ω}_{i} {P}_{i} = X \qquad ( 5 )$$

Equation (5) may be solved using Wiener-Hopf equations as ALF. The derived filter coefficients are then quantized to integer type and signaled in the block level.

In yet another embodiment, the weighting factors may be derived at the encoder side and then signaled in the bitstream to the decoder. Denote the N prediction block candidates as P₁, P₂, . . . , P_{N} and the current block as X, then the weighting factors may be solved by the following equation:

$${\sum }_{i = 1}^{N} {ω}_{i} {P}_{i} = X \qquad ( 6 )$$

Equation (6) may be solved using LDL decomposition or Gaussian elimination.

In yet another embodiment, the weighting factors are derived based on the templates and the derived weighting factors are applied to the prediction block candidates to generate the final prediction block. Denote the templates of the prediction candidates as T₁, T₂, . . . , T_{N} and the current block as T, then the weighting factors can be derived using the following equation:

$${\sum }_{i = 1}^{N} {ω}_{i} {T}_{i} = T \qquad ( 7 )$$

Equation (7) may be solved using Wiener-Hopf equations. Then the final prediction block can be calculated as

$${\sum }_{i = 1}^{N} {ω}_{i} {P}_{i} ,$$

where Pᵢ represents the i-th prediction block candidate.

IBC mode exploits the nonlocal correlation to improve the prediction accuracy, in which similar blocks are searched and used to generate the final prediction block. In this embodiment, it is provided to combine the nonlocal mean filtering and multi-hypothesis IBC, which is described as follow. In the first step, N prediction block candidates are searched and identified as conducted in the IBC. In the second step, the weighting factor is calculated as follows.

$${ω}_{i} = \frac{1}{Z [ i ]} {e}^{- \frac{{D}_{i}}{{h}^{2}}} \qquad ( 8 )$$

Where Dᵢ is used to measure the distance between the template of the i-th prediction block candidate and the template of the current block, h is used as the degree of weighting and Z[i] is the normalization constant:

$$Z [ i ] = {\sum }_{i = I}^{N} {e}^{- \frac{{D}_{i}}{{h}^{2}}} \qquad ( 9 )$$

To calculate the weighting factor in equation (8), the strength of weighting should be determined first. In this disclosure, several methods are provided to decide the weighting strength.

In the first method, a weighting strength candidate list including some typical weighting strength values is defined and fixed at both encoder and decoder side. At the encoder side, the weighting strength values are checked using rate distortion optimization and the optimal weighting strength value is identified and signaled in the bitstream to the decoder side.

In the second method, the weighting strength value is estimated using the template of the prediction block candidates and the template of the current block. Denote the templates of the prediction candidates as T₁, T₂, . . . , T_{N} and the current block as T. Then the weighting strength value can be solved using the following equation:

$${\sum }_{i = 1}^{N} {ω}_{i} {T}_{i} = {\sum }_{i = 1}^{N} \frac{1}{Z [ i ]} {e}^{- \frac{{D}_{i}}{{h}^{2}}} {T}_{i} = T \qquad ( 10 )$$

In the third method, the weighting strength value can be estimated using the QP value and variance of the template of the current block, i.e., the relationship between the weighting strength value, QP value and the template variance can be fitted offline.

To better exploit the nonlocal correlation in the IBC, in this embodiment singular value decomposition (SVD) is utilized to generate the final prediction block from the prediction block candidates. The width and height of the current block are denoted as W and H, the area of the current block is denoted as d=H×W.

Step1. K prediction block candidates yᵢ are searched and identified as conducted in the FIBC.

Step2. The K prediction block candidates of the current block y construct the block group G and are arranged as a matrix:

$${Y}_{G} = [ {y}_{G}^{( 1 )} , {y}_{G}^{( 2 )} , … , {y}_{G}^{( K )} ] \qquad ( 11 )$$

Where Y_{G} is a matrix with size of d×K by arranging every candidate in group G as a column vector.

Step3. Perform SVD decomposition on the matrix Y_{G}.

$$S VD ( {Y}_{G} ) = {U}_{G} {Λ}_{G} {V}_{G}^{*} \qquad ( 12 )$$

Step4. Apply soft-thresholding operation on the singular value matrix Λ_{G}.

$${Λ}_{{G}_{i} , τ} = softTh ( {Λ}_{G} , τ ) \qquad ( 13 )$$

Where softTh( ) is a function which shrinks the diagonal elements of Λ_{G} with the threshold i. For the k-th diagonal element in Λ_{G}, it is shrunken by the nonlinear function D_{τ(k)} at level τ(k):

$${D}_{τ ( k )} : {λ}_{k , τ ( k )} = max ( \vert {λ}_{k} \vert - τ ( k ) , 0 ) \qquad ( 14 )$$

Λ_{G,τ} is the matrix composed of the shrunken singular values, Λ_{k,τ(k)} at diagonal positions.

Step5. Perform inverse SVD to obtain the filtered patch group.

$${\hat{X}}_{G} = {U}_{G} {Λ}_{G , τ} {V}_{G}^{*} \qquad ( 15 )$$

One of the key steps is to determine the thresholding values for each diagonal elements in step 4. In the present disclosure, the thresholding values are calculated as follows. The threshold is estimated for each group of image patches with the following equation:

$${τ}_{G} ( k ) = c \times \frac{{σ}_{n , G}^{2}}{{σ}_{x , G , k}} \qquad ( 16 )$$

Where σ_{n,G} is the standard deviation of noise, and σ_{x,G,k} is the standard deviation of the original block in the k-th dimension of SVD space for group G. The deviation of the original block in SVD space is estimated as follow.

$${σ}_{x , G , k} = \sqrt{max ( \frac{{λ}_{G , k}^{2}}{min ( d , K )} - ω \times {σ}_{n , G}^{2} , 0 )} \qquad ( 17 )$$

Where

$${λ}_{G , k}^{2}$$

is the k-th singular value of Y_{G}_{ᵢ}. When σ_{x,G,k} is zero, the soft-thresholding operation is skipped. In addition, the deviation of noise is estimated with the deviation of the predicted block using a power function which is parameterized with α and β.

$${σ}_{n} = α \times {σ}_{y}^{β} \qquad ( 18 )$$

Where σ_{y} is calculated as follows,

$$\begin{matrix}{σ}_{y} = \frac{1}{K} {\sum }_{k = 0}^{K} \sqrt[2]{{\sum }_{i = 1}^{{p}^{2}} \frac{{( {y}_{k} ( i ) - {μ}_{k} )}^{2}}{{p}^{2}} ,} & {μ}_{k} = \frac{1}{{p}^{2}} {\sum }_{i = 1}^{{p}^{2}} {y}_{k} ( i )\end{matrix} \qquad ( 19 )$$

Here yₖ(i) represents the i-th pixel of prediction block candidate vector yₖ.

### Multi-Hypothesis IBC Signaling

In this disclosure, the proposed multi-hypothesis IBC can be utilized as a replacement of the current IBC mode or the encoder can adaptively select IBC mode or multi-hypothesis IBC mode.

In some embodiments, the multi-hypothesis IBC may be used as a replacement of the current IBC mode, i.e., always using multiple hypothesis for prediction.

In yet another embodiment, one of the multi-hypothesis IBC methods in the above sections is used jointly with the current IBC mode. A flag is signaled in the bitstream to indicate whether multi-hypothesis IBC mode is applied to the CU.

In yet another embodiment, more than one multi-hypothesis IBC methods in the above sections are used jointly with the current IBC mode. A flag is firstly signaled in the bitstream to indicate whether multi-hypothesis IBC mode is applied. Then an index is signaled to indicate which of the multi-hypothesis IBC methods is applied to the CU.

In yet another embodiment, multi-hypothesis IBC method in the above sections is used jointly with the current IBC mode. The multi-hypothesis IBC may be used as a replacement of the current IBC mode according to certain coded information of the current block, e.g., SAD (sum of absolute difference), SSE (sum of square error), quantization parameter (QP) associated with the TB/CB and/or the slice, the neighbor prediction modes of the CU (e.g., IBC mode or intra or inter) and/or the slice type (e.g. I slice, P slice or B slice).

### Combined Intra TMP-Intra/Inter Prediction

According to one or more embodiments of the disclosure, the coding block coded with Intra TMP mode are combined with the coding block coded with intra mode or inter mode. Different methods may be used to achieve this goal.

In the first method, the decoder/encoder may combine the coding block coded with Intra TMP mode with the coding block coded with intra mode. Various methods may be utilized in this combination. In one example, similar to the CIIP technology in VVC, the coding block coded with Intra TMP mode is regarded as the coding block coded with inter merge mode, and it is combined with the coding block coded with planar intra prediction mode. In another example, similar to the Combination of CIIP with TIMD and TM merge technology in ECM, the coding block coded with Intra TMP mode is combined with the coding block coded with TIMD derived intra prediction mode.

When combining the coding block coded with Intra TMP mode with the coding block coded with intra mode, the weights can be decided refer to the weights design of the CIIP technology in VVC or ECM, or the weights can also be designed based on template matching methods, where the sum of absolute difference (SAD), sum of square difference (SSD) or sum of absolute transformed difference (SATD) between the prediction and reconstruction samples of the current block template can be utilized to compute the weights for Intra TMP coded block and intra coded block. For example, the weights for Intra TMP coded block and intra coded block can be decided as follows: For intra coded block, as shown in FIG. 22, the SATD between the prediction and reconstruction samples of current block template is calculated as SATDᵢₙₜᵣₐ, where the prediction samples of current block template are intra predicted using the reference samples of the template with the intra mode of current block. For Intra TMP coded block, the SATD between the prediction and reconstruction samples of current block template is calculated as SATD_{IntraTMP}, where the prediction samples of current block template are predicted using the reference samples pointed by a block vector of the first block. The weights for Intra TMP coded block w_{IntraTMP} and intra coded block wᵢₙₜᵣₐ are decided as follow:

$$\begin{matrix}{w}_{IntraTMP} = \frac{S A T {D}_{intra}}{S A T {D}_{IntraTMP} + S A T {D}_{intra}} \\ {w}_{intra} = \frac{S A T {D}_{IntraTMP}}{S A T {D}_{IntraTMP} + S A T {D}_{intra}}\end{matrix}$$

When utilizing the template of current block for computing the weights of Intra TMP coded block and intra coded block, both left and top template can be utilized if they are available, or only left template or only top template is utilized if it is available. The utilization of both left and top template, only top template or only left template can be decided in a RDO process or in a predefined criteria. For example, if the intra mode of current block is planar mode or DC mode, both left and top template are utilized; if the intra mode of current block is near horizontal angular modes (2<=angular mode index<34), only left template is utilized; if the intra mode of current block is near vertical angular modes (34<=angular mode index<=66), only top template is utilized.

When combining the coding block coded with Intra TMP mode with the coding block coded with intra mode, the weights derived based on template matching methods can be compared with the weights derived refer to CIIP in ECM in a RDO process, which means a flag in coding block level needs to be transmitted into bit stream to signal which method is utilized; or the weights derived based on template matching methods can be used to replace total or partial of the weights derived refer to CIIP in ECM. For example, if the intra mode of current block is planar mode or DC mode, the weights of intra coded block and IBC coded block are decided based on template matching methods; otherwise, the weights are decided refer to CIIP in ECM.

In the second method, the decoder/encoder may combine the coding block coded with Intra TMP mode with the coding block coded with inter mode. Various methods may be utilized in this combination. In one example, similar to the CIIP technology in VVC, the coding block coded with Intra TMP mode is regarded as the coding block coded with planar intra mode, and it is combined with the coding block coded with inter merge mode. In another example, the coding block coded with Intra TMP mode is regarded as the coding block coded with inter merge mode, and it is combined with the coding block coded with inter merge mode by equally averaging.

In the third method, the decoder/encoder may combine the coding block coded with Intra TMP mode with the coding block coded with intra mode and the coding block coded with inter mode. Various methods may be utilized in this combination. In one example, the coding block coded with Intra TMP mode, the coding block coded with intra mode, and the coding block coded with inter mode are directly combined by equally averaging. In another example, firstly the coding block coded with Intra TMP mode is separately combined with the coding block coded with intra mode and inter mode as presented in the first and second method. Then, the separate combined results are combined by equally averaging.

GPM with Intra TMP and Intra TMP Prediction

According to one or more embodiments of the disclosure, the Intra TMP tool is combined with GPM tool in the form of GPM with Intra TMP and Intra TMP prediction. Different methods may be used to achieve this goal.

In the first method, both “inter” parts of GPM with inter and inter prediction method in VVC is replaced with Intra TMP. That means that two Intra TMP prediction results are weighted averaged with each other according to a splitting line in the coding block. The weight may be obtained referring to GPM with inter and inter prediction method in VVC.

In the second method, both “inter” parts of GPM with inter and inter prediction method in ECM is replaced with Intra TMP, where some template matching tools may be utilized to further improve the coding performance.

GPM with Intra TMP and Intra Prediction

According to one or more embodiments of the disclosure, the Intra TMP tool is combined with GPM tool in the form of GPM with Intra TMP and intra prediction. Different methods may be used to achieve this goal.

In the first method, the “inter” part of GPM with inter and intra prediction method in ECM is replaced with Intra TMP, where the Intra TMP predicted results are weighted averaged with the intra prediction results to obtain the final prediction signal.

GPM with Intra TMP and Inter Prediction

According to one or more embodiments of the disclosure, the Intra TMP tool is combined with GPM tool in the form of GPM with Intra TMP and inter prediction. Different methods may be used to achieve this goal.

In the first method, one “inter” part of GPM with inter and inter prediction method in VVC is replaced with Intra TMP, where the Intra TMP predicted results are weighted averaged with the inter merge prediction results to obtain the final prediction signal.

In the second method, one “inter” part of GPM with inter and inter prediction method in ECM is replaced with Intra TMP, where some template matching tools may be utilized to further improve the coding performance.

### Simplified Intra TMP and Intra Prediction Combination in GPM Form

According to one or more embodiments of the disclosure, the Intra TMP tool is combined with GPM tool in the form of simplified GPM with Intra TMP and intra prediction, such as Intra TMP and intra prediction is combined at a certain splitting mode, which may save the bits overhead of the splitting representation. Different methods may be used to achieve this goal.

In the first method, aiming at one splitting line, such as 45 degree, the upper left parts of the coding block is coded with intra prediction mode, and the bottom right parts of the coding block is coded with Intra TMP prediction mode, then they are averaged in GPM form to obtain the final prediction signal.

Combine IBC with TIMD Mode

According to the one or more embodiments of the disclosure, the IBC tool is combined with TIMD tool. Different methods may be used to achieve this goal.

In the first method, the IBC mode is regarded as one intra prediction mode added in the MPM list, then the IBC mode is compared with other intra prediction modes in the MPM list using template matching cost, finally two modes with the minimum and second minimum costs are fused using TIMD method to obtain the final prediction result.

In the second method, first the regular TIMD prediction result is obtained, then the template matching cost of the IBC mode and the regular TIMD prediction result are calculated, finally the IBC mode and the regular TIMD prediction result are fused using TIMD method to obtain the final prediction result.

Combine Intra TMP with TIMD Mode

According to the one or more embodiments of the disclosure, the Intra TMP tool is combined with TIMD tool. Different methods may be used to achieve this goal.

In the first method, the Intra TMP mode is regarded as one intra prediction mode added in the MPM list, then the Intra TMP mode is compared with other intra prediction modes in the MPM list using template matching cost, finally two modes with the minimum and second minimum costs are fused using TIMD method to obtain the final prediction result.

In the second method, first the regular TIMD prediction result is obtained, then the template matching cost of the Intra TMP mode and the regular TIMD prediction result are calculated, finally the Intra TMP mode and the regular TIMD prediction result are fused using TIMD method to obtain the final prediction result.

Combine Intra TMP with LIC

According to the one or more embodiments of the disclosure, the Intra TMP tool is combined with LIC tool. Different methods may be used to achieve this goal.

In the first method, the Intra TMP mode is regarded as inter mode, and LIC is used to model local illumination variation between current block and its Intra TMP prediction block as a function of that between current block template and reference block template. The function is a linear equation as used in the regular LIC method.

Combine IBC with OBMC

According to the one or more embodiments of the disclosure, the IBC tool is combined with OBMC tool. Different methods may be used to achieve this goal.

In the first method, the IBC mode is regarded as inter mode, and the regular OBMC method is applied to refine the top and left boundary pixels of an IBC coded CU using neighboring block's block vector information with a weighted prediction.

In the second method, the IBC mode is regarded as inter mode, and the template matching based OBMC method is applied to refine the top and left boundary pixels of an IBC coded CU using template matching based methods.

In some embodiments, when combining IBC with OBMC, for a CU coded with IBC mode, when using regular OBMC method or template matching based OBMC method to refine the top and left boundary pixels of current CU using neighboring block's shift information, neighboring block can be coded with IBC mode or Intra TMP mode.

Combine Intra TMP with OBMC

According to the one or more embodiments of the disclosure, the Intra TMP tool is combined with OBMC tool. Different methods may be used to achieve this goal.

In the first method, the Intra TMP mode is regarded as inter mode, and the regular OBMC method is applied to refine the top and left boundary pixels of an Intra TMP coded CU using neighboring block's block vector information with a weighted prediction.

In the second method, the Intra TMP mode is regarded as inter mode, and the template matching based OBMC method is applied to refine the top and left boundary pixels of an Intra TMP coded CU using template matching based methods.

In some embodiments, when combining Intra TMP with OBMC, for a CU coded with Intra TMP mode, when using regular OBMC method or template matching based OBMC method to refine the top and left boundary pixels of current CU using neighboring block's shift information, neighboring block can be coded with Intra TMP mode or IBC mode.

### Non-Adjacent Candidates Derivation for IBC AMVP or Merge Mode

According to the one or more embodiments of the disclosure, the candidate derivation process for IBC merge mode or IBC AMVP mode is extended by using not only adjacent neighboring blocks but also non-adjacent neighboring blocks. The related contents are summarized as sections “Candidate scanning and candidate pruning”, “Candidate reordering”, “Motion information storage”, “Scope of application” and “application block size” and presented as follow:

### Candidate Scanning and Candidate Pruning

For candidate scanning, non-adjacent neighboring blocks are scanned and selected by following below methods:

### Scanning Area and Distance:

In one or more embodiments, non-adjacent neighboring blocks may be scanned from left area and above area of the current coding block. The scanning distance may be defined as the number of coding blocks from the scanning position to the left side or top side of the current coding blocks.

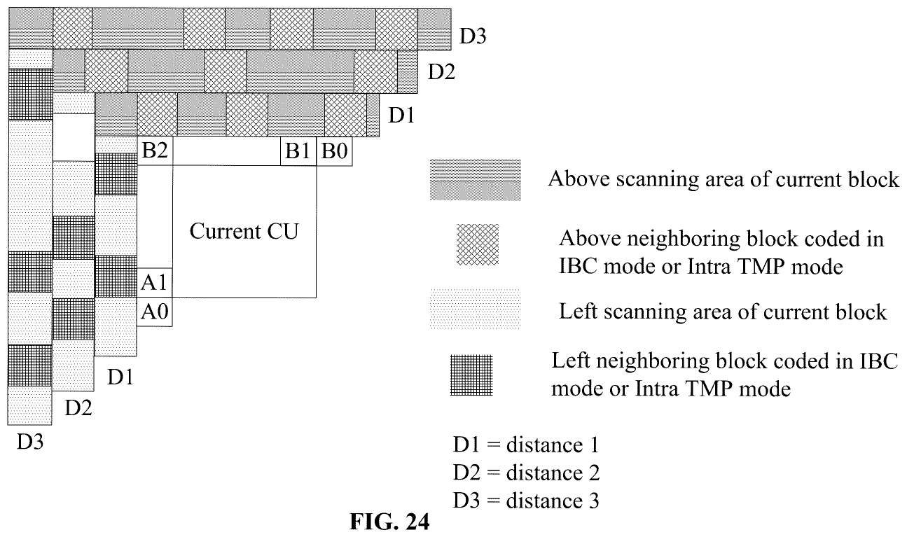

As shown in the FIG. 24, on either the left or above of the current coding block, multiple lines of non-adjacent neighboring blocks may be scanned. The distance shown in the FIG. 24 represents the number of coding blocks from each candidate position to the left side or top side of the current block. For example, the area with “distance 2” on the left side of the current block indicates that the candidate neighboring blocks located in this area are 2 blocks away from the current block. Similar indications may be applied to other scanning areas with different distances.

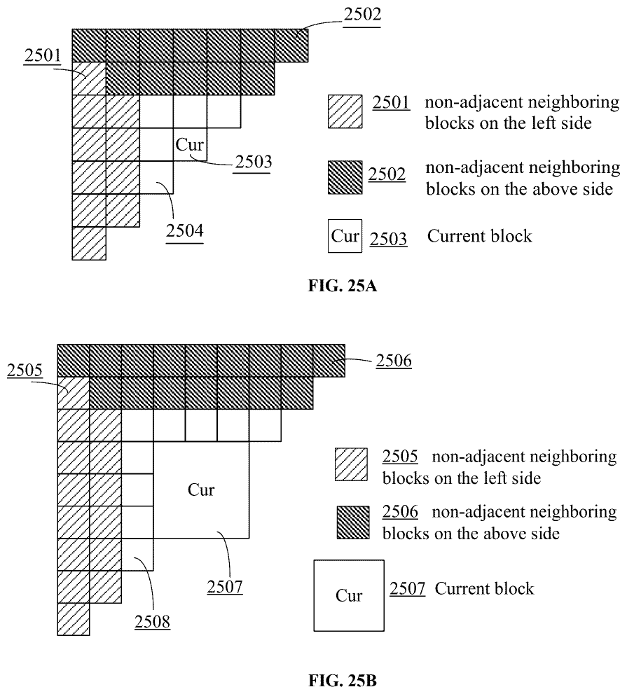

In one or more embodiments, the non-adjacent neighboring blocks at each distance may have the same block size as the current coding block, as shown in the FIG. 25A. Note that when the non-adjacent neighboring blocks at each distance have the same block size as the current coding block, the value of the block size is adaptively changed according to the partition granularity at each different area in an image.

In some embodiments, the non-adjacent neighboring blocks at each distance may have a different block size as the current coding block, as shown in the FIG. 25B. Note that when the non-adjacent neighboring blocks at each distance have a different block size as the current coding block, the value of the block size may be predefined as a constant value, such as 4×4, 8×8 or 16×16.

Based on the defined scanning distance, the total size of the scanning area on either the left or above of the current coding clock may be determined by a configurable distance value. In one or more embodiments, the maximum scanning distance on the left side and above side may use a same value or different values. For example, the maximum distance on both the left side and above side shares a same value of 2. The maximum scanning distance value(s) may be determined by the encoder side and signaled in a bitstream. Alternatively, the maximum scanning distance value(s) may be predefined as fixed value(s), such as the value of 2 or 4. When the maximum scanning distance is predefined as the value of 4, it indicates that the scanning process is terminated when the candidate list is full or all the non-adjacent neighboring blocks with at most distance 4 have been scanned, whichever comes first.

In one or more embodiments, within each scanning area at a specific distance, the starting and ending neighboring blocks may be position dependent.

In one or more embodiments, for the left side scanning areas, the starting neighboring blocks may be the adjacent bottom-left block of the starting neighboring block of the adjacent scanning area with smaller distance. For example, as shown in the FIG. 24, the starting neighboring block of the “distance 2” scanning area on the left side of the current block is the adjacent bottom-left neighboring block of the starting neighboring block of the “distance 1” scanning area. The ending neighboring blocks may be the adjacent left block of the ending neighboring block of the above scanning area with smaller distance. For example, as shown in the FIG. 24, the ending neighboring block of the “distance 2” scanning area on the left side of the current block is the adjacent left neighboring block of the ending neighboring block of the “distance 1” scanning area above the current block.

Similarly, for the above side scanning areas, the starting neighboring blocks may be the adjacent top-right block of the starting neighboring block of the adjacent scanning area with smaller distance. The ending neighboring blocks may be the adjacent top-left block of the ending neighboring block of the adjacent scanning area with smaller distance.

In one or more embodiments, within each scanning area at a specific distance, the sampling interval between the starting and ending neighboring blocks may be position dependent. In one or more embodiments, the sampling interval between the starting and ending neighboring blocks is smaller in a scanning area with smaller distance. For example, as shown in the FIG. 24, every neighboring block between the starting and ending neighboring blocks is scanned in the scanning area with “distance 1”, every 2 neighboring block between the starting and ending neighboring blocks is scanned in the scanning area with “distance 2”. In one or more embodiments, the sampling interval between the starting and ending neighboring blocks may be same or different for different side scanning areas at a specific distance. For example, the sampling interval between the starting and ending neighboring blocks is same for left and above side scanning areas at a specific distance.

### Scanning Order:

When the neighboring blocks are scanned in the non-adjacent areas, certain order or/and rules may be followed to determine the selections of the scanned neighboring blocks.

In one or more embodiments, the left area may be scanned first, and then followed by scanning the above areas. As shown in the FIG. 24, three lines of non-adjacent areas (e.g., from distance 1 to distance 3) on the left side may be scanned first, then followed by scanning the three lines of non-adjacent areas above the current block.

In some embodiments, the left areas and above areas may be scanned alternatively. For example, as shown in the FIG. 24, the left scanning area with “distance 1” is scanned first, then followed by the scanning the above area with “distance 1”.

For scanning areas located on the same side (e.g., left or above areas), the scanning order is from the areas with small distance to the areas with large distance. This order may be flexibly combined with other embodiments of scanning order. For example, the left and above areas may be scanned alternatively, and the order for same side areas is scheduled to be from small distance to large distance.

Within each scanning area at a specific distance, a scanning order may be defined. In one or more embodiments, for the left scanning areas, the scanning may be started from the bottom neighboring block to the top neighboring block. For the above scanning areas, the scanning may be started from the right block to the left block.

In one or more embodiments, the non-adjacent areas along one direction may be scanned first, and then followed by scanning non-adjacent areas along other directions. Within one direction, a scanning order may be defined. In one or more embodiments, within each direction, the scanning may be started from smaller distance to larger distance.

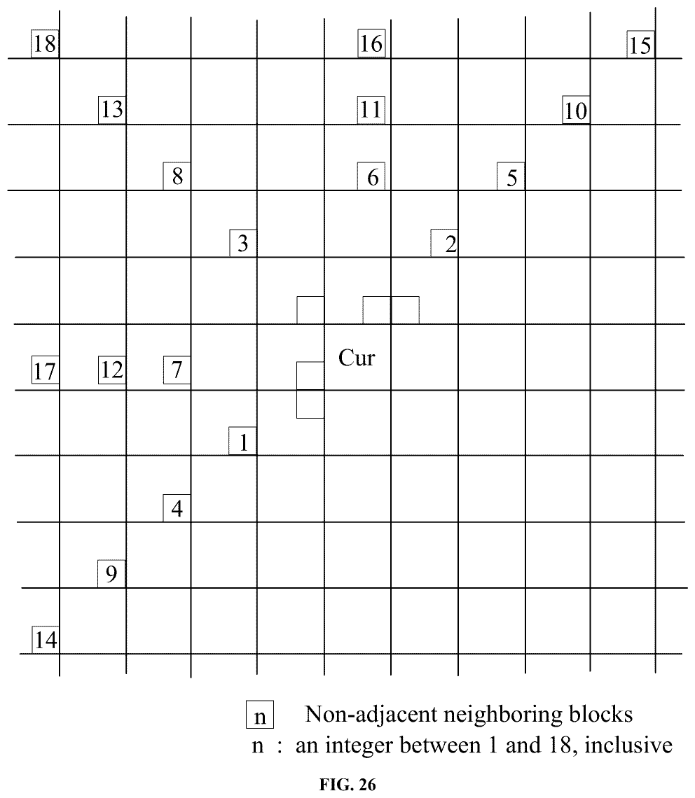

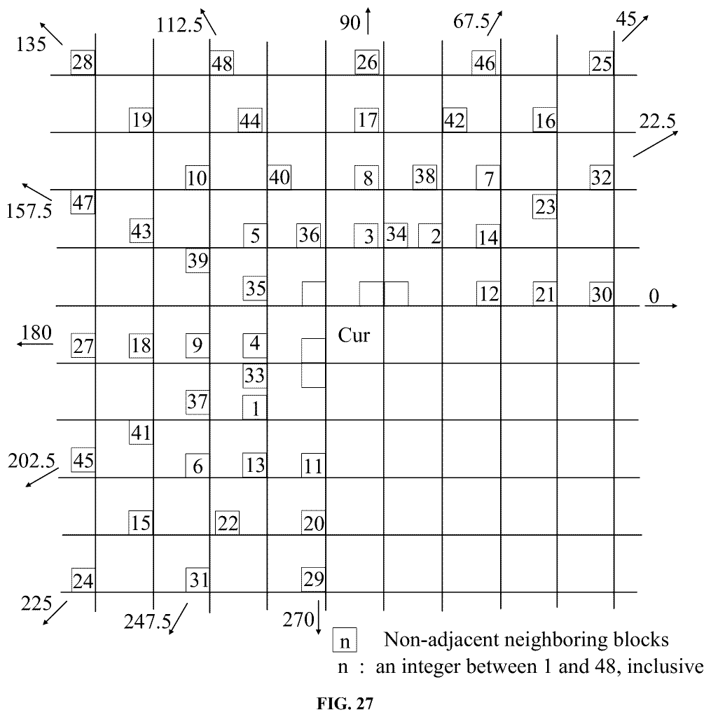

In some embodiments, the non-adjacent areas along different directions may be scanned alternatively. For example, as shown in the FIGS. 26-27, the non-adjacent areas with smaller distance along direction with degree value 225 of angle is scanned first, then the non-adjacent areas with smaller distance along direction with degree value 45, 90, 180, 135 of angles are scanned successively. After that, the non-adjacent areas with larger distance along direction with degree value 225 of angle is scanned, followed by the non-adjacent areas with larger distance along direction with degree value 45, 90, 180, 135 of angles.

In some examples, a total of 18 blocks are scanned, as shown in FIG. 26, where scanned blocks are indicated by a boxed integer n, where n is in the range from 1 to 18, inclusive, and where n represents the scanning order.

In some examples, a total of 48 blocks are scanned, as shown in FIG. 27, where scanned blocks are indicated by a boxed integer n, where n is in the range from 1 to 48, and where n represents the scanning order, inclusive; in these examples, degree values of 270, 0, 247.5, 22.5, 202.5, 67.5, 157.5, and 112.5 may be additionally used for determining the scanning order.

### Scanning Termination:

For non-adjacent candidates, the neighboring blocks coded with IBC mode or Intra TMP mode are defined as qualified candidates.

In one or more embodiments, the scanning process may be performed interactively. For example, the scanning performed in a specific area at a specific distance may be stopped at the instance when first X qualified candidates are identified, where X is a predefined positive value. For example, as shown in the FIG. 24, the scanning in the left scanning area with distance 1 may be stopped when the first one or more qualified candidates are identified. Then the next iteration of scanning process is started by targeting at another scanning area, which is regulated by a pre-defined scanning order/rule.

In one or more embodiments, the X may be defined for each distance. For example, at each distance, X is set to be 1, which means the scanning is terminated for each distance if the first qualified candidate is found and the scanning process is restarted from a different distance of the same area or the same or different distance of a different area. Note that the value of X may be set as the same value or different values for different distances. If the maximum number of qualified candidates are found from all allowable distances (e.g., regulated by a maximum distance) of an area, the scanning process for one area is completely terminated.

In another embodiment, the X may be defined for an area. For example, X is set to be 3, which means the scanning is terminated for the whole area (e.g., left or above area of the current block) if the first 3 qualified candidates are found and the scanning process is restarted from the same or different distance of another area. Note that the value of X may be set as the same value or different values for different areas. If the maximum number of qualified candidates are found from all areas, the whole scanning process is completely terminated.

The values of X may be defined for both distance and areas. For example, for each area (e.g., left or above area of the current block), X is set to 3, and for each distance, X is set to 1. The values of X may be set as the same value or different values for different areas and distances.

In some embodiments, the scanning process may be performed continuously. For example, the scanning performed in a specific area at a specific distance may be stopped at the instance when all covered neighboring blocks are scanned and no more qualified candidates are identified or the maximum allowable number of candidates is reached. The maximum allowable number of candidates can be set according to different methods. In one example, the maximum allowable number of candidates are set to a predefined value, where the predefined value may be set to the maximum allowable size of IBC merge candidate list (equal to 28 in ECM), or the maximum allowable size of IBC merge candidate list minus 1, or other values. In another example, the maximum allowable number of candidates may be set to different values depending on the coding condition, and this value is transmitted into bit stream.

During the candidate scanning process, each candidate non-adjacent neighboring block is determined and scanned by following the above proposed scanning methods. For easier implementation, each candidate non-adjacent neighboring block may be indicated or located by a specific scanning position. For example, bottom-right positions are used for both above and left non-adjacent neighboring blocks.

After a qualified candidate is identified following above process, this candidate may go through a similarity check against all existing candidates that are already in the candidate list. The details of similarity check can refer to the similarity check rules already existed in current IBC candidates derivation. If the newly qualified candidate is found to be similar with any existing candidate in the candidate list, this newly qualified candidate is removed/pruned.

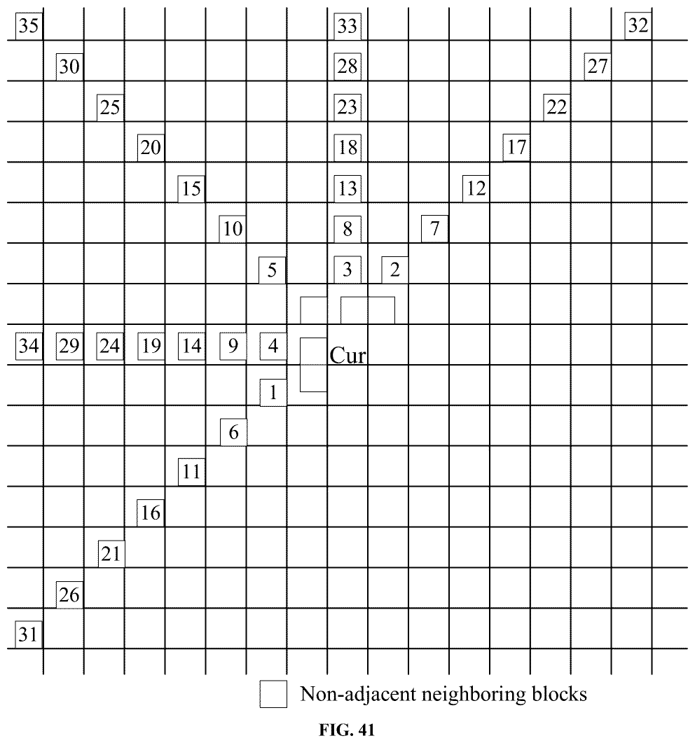

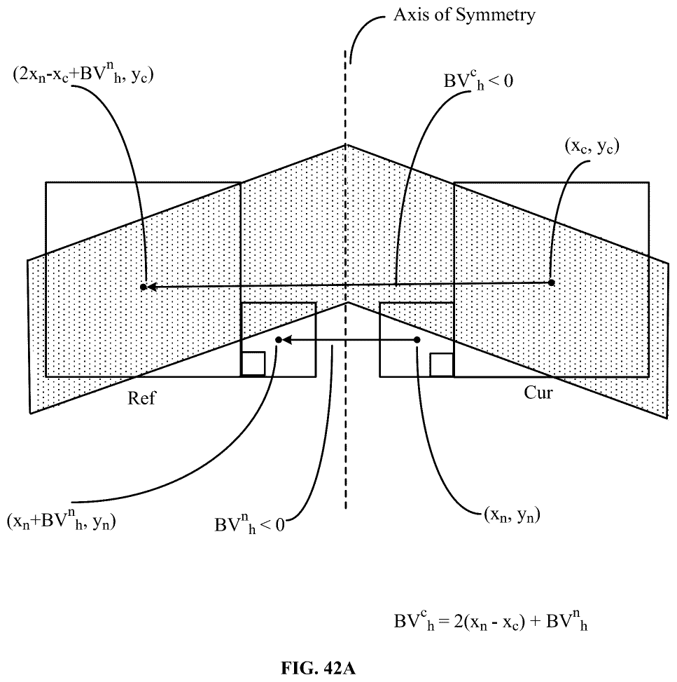

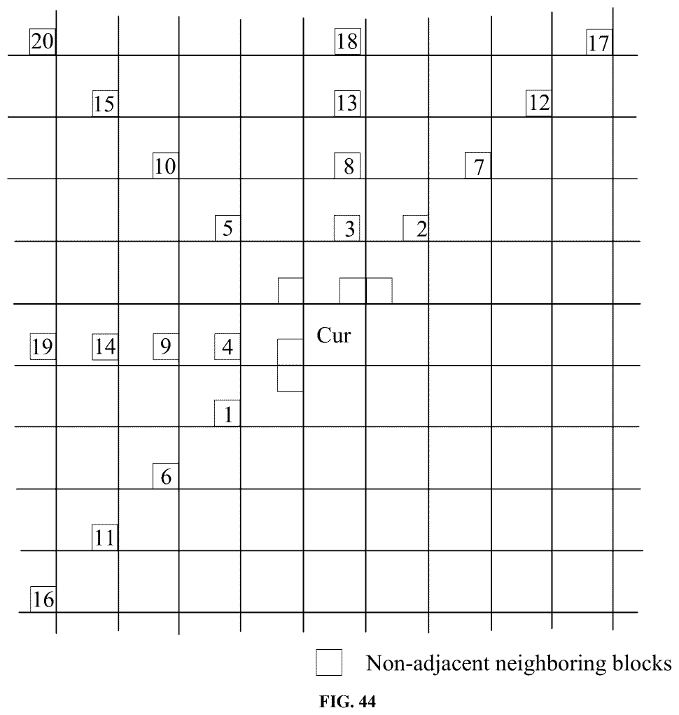

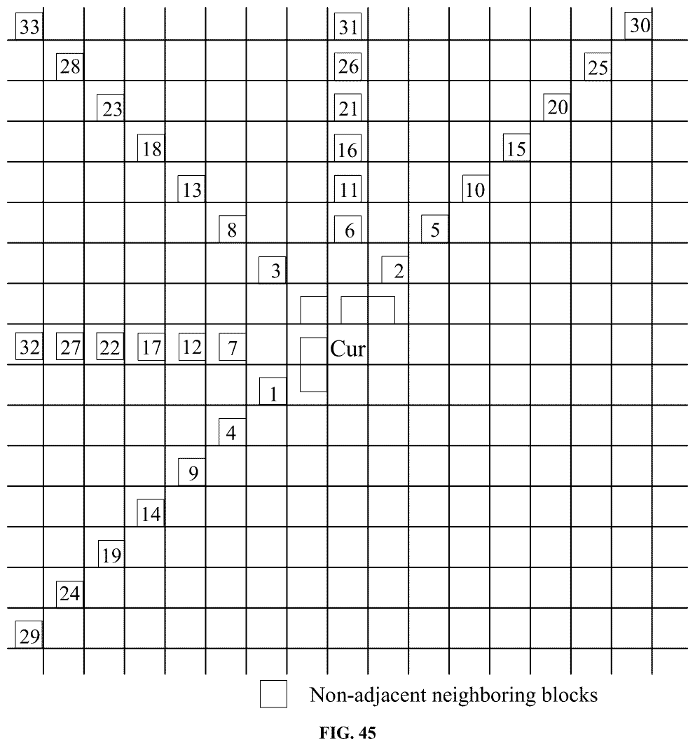

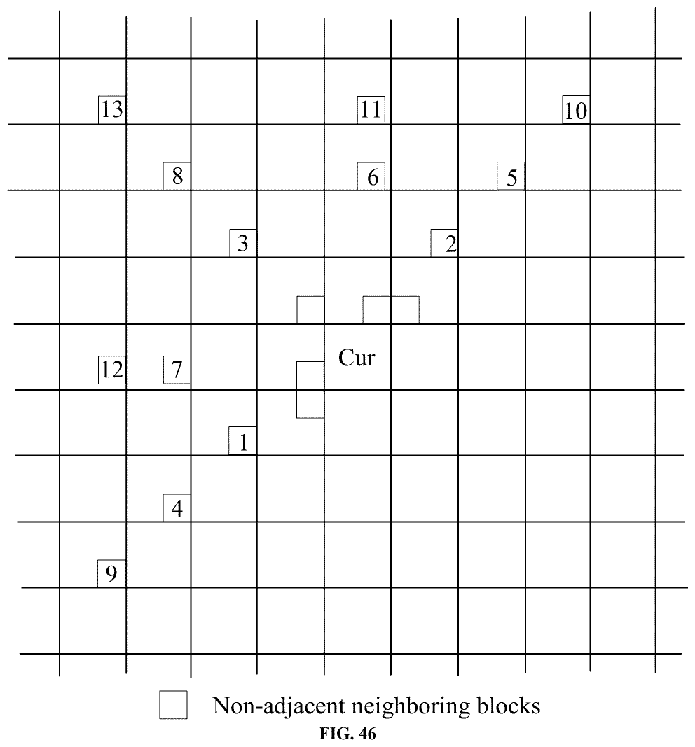

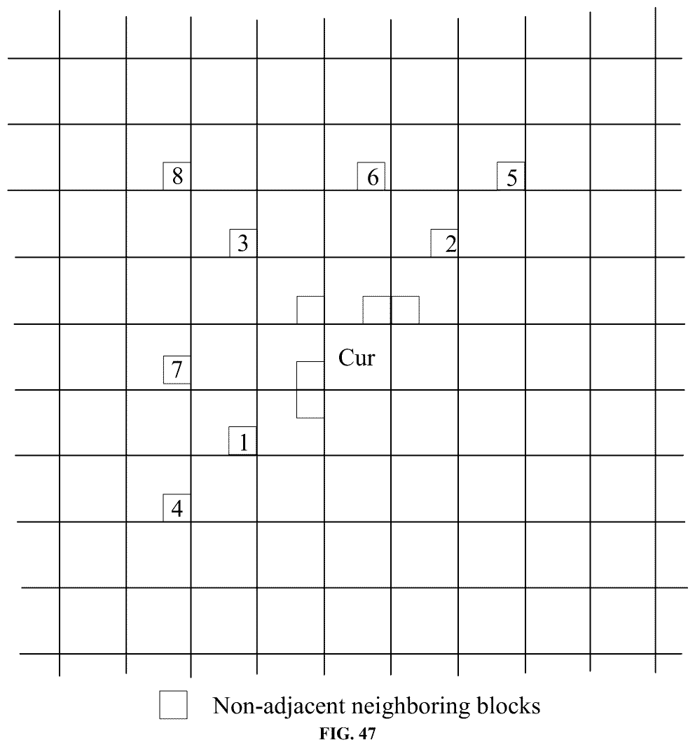

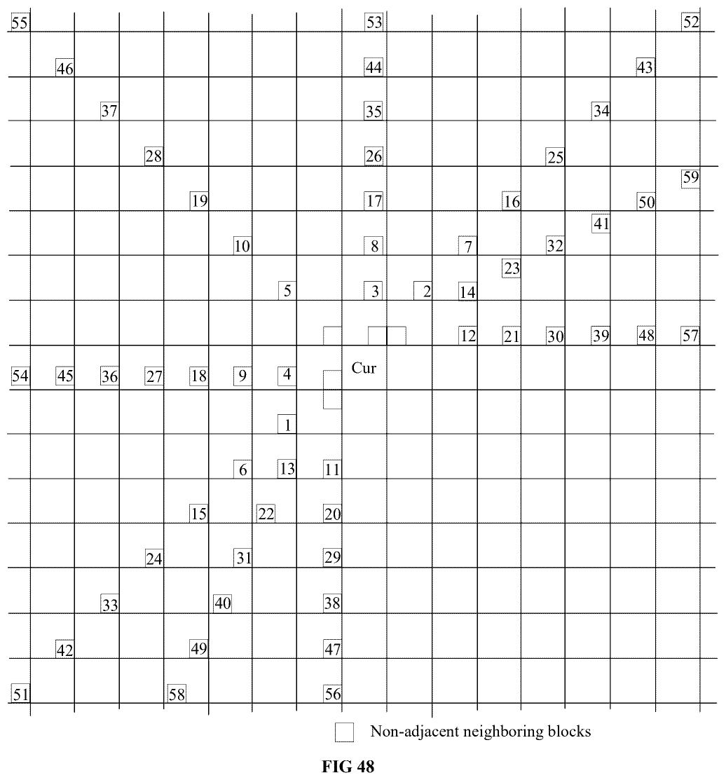

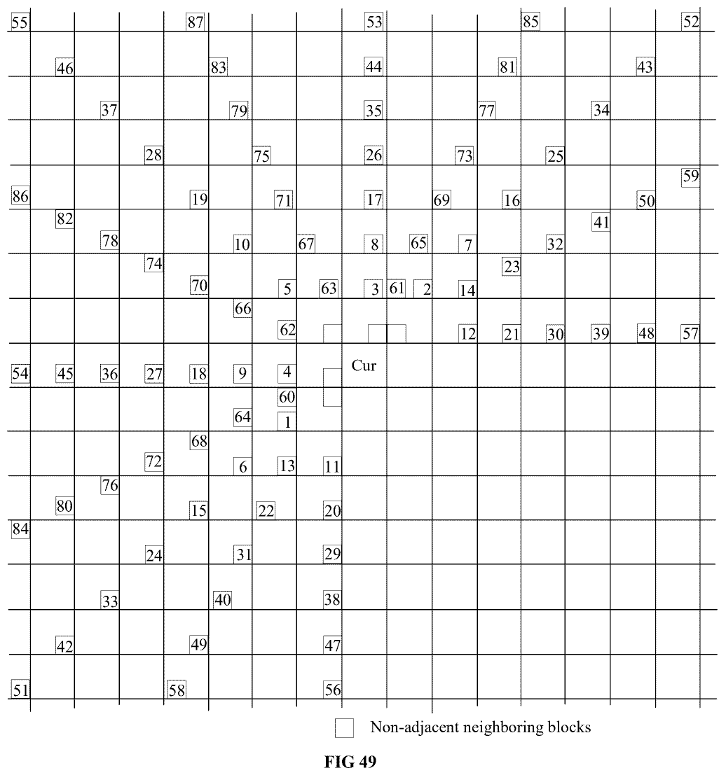

In some embodiments, above candidate scanning and candidate pruning process may be same or different for IBC AMVP and merge candidates derivation. For example, the candidate scanning and pruning process presented in FIG. 26 may be used for both IBC AMVP and merge candidates derivation. In another example, the candidate scanning and pruning process presented in FIG. 26 may be used for IBC AMVP candidates derivation, the candidate scanning and pruning process presented in FIG. 27 may be used for IBC merge candidates derivation. In a third example, the candidate scanning and pruning process presented in FIG. 26 may be used for IBC AMVP candidates derivation, the candidate scanning and pruning process presented in FIG. 41 may be used for IBC merge candidates derivation. In the fourth example, the candidate scanning and pruning process presented in FIG. 44 may be used for IBC AMVP candidates derivation, the candidate scanning and pruning process presented in FIG. 41 may be used for IBC merge candidates derivation. In the fifth example, the candidate scanning and pruning process presented in FIG. 26 may be used for IBC AMVP candidates derivation, the candidate scanning and pruning process presented in FIG. 45 may be used for IBC merge candidates derivation. In the sixth example, the candidate scanning and pruning process presented in FIG. 46 may be used for IBC AMVP candidates derivation, the candidate scanning and pruning process presented in FIG. 41 may be used for IBC merge candidates derivation. In the seventh example, the candidate scanning and pruning process presented in FIG. 47 may be used for IBC AMVP candidates derivation, the candidate scanning and pruning process presented in FIG. 41 may be used for IBC merge candidates derivation. In the eighth example, the candidate scanning and pruning process presented in FIG. 26 may be used for IBC AMVP candidates derivation, the candidate scanning and pruning process presented in FIG. 48 may be used for IBC merge candidates derivation. In the ninth example, the candidate scanning and pruning process presented in FIG. 26 may be used for IBC AMVP candidates derivation, the candidate scanning and pruning process presented in FIG. 49 may be used for IBC merge candidates derivation. In the tenth example, the candidate scanning and pruning process presented in FIG. 41 may be used for both IBC AMVP and merge candidates derivation. In the eleventh example, the candidate scanning and pruning process presented in FIG. 41 may be used for IBC merge candidates derivation, and the IBC AMVP candidates derivation is unchanged. In above examples, FIG. 26, FIG. 27, FIG. 41, FIG. 44, FIG. 45, FIG. 46, FIG. 47, FIG. 48 and FIG. 49 present the examples of scanning area, scanning distance, and scanning order information. For scanning termination, in one example, the scanning performed in a specific area at a specific distance is stopped at the instance when all covered neighboring blocks are scanned and no more qualified candidates are identified or the maximum allowable number of IBC merge candidates is reached. In another example, the scanning performed in a specific area at a specific distance is stopped at the instance when all covered neighboring blocks are scanned and no more qualified candidates are identified or the maximum allowable number of IBC merge candidates minus 1 is reached. To describe FIG. 26, FIG. 41 and FIG. 44 clearer, the non-adjacent neighboring blocks at each distance have the same block size as the current coding block in FIG. 26, FIG. 41 and FIG. 44, the maximum scanning distance on the left side and above side is set to 4 (the adjacent neighboring blocks is not counted) in FIG. 26 and FIG. 44, and the maximum scanning distance on the left side and above side is set to 7 (the adjacent neighboring blocks is not counted) in FIG. 41, bottom-right scanning positions are used for the non-adjacent neighboring blocks along bottom left, above right and above left direction in FIG. 26, FIG. 41 and FIG. 44, the bottom-middle (with the horizontal index equal to half of the block width, the vertical index equal to the vertical index of the non-adjacent neighboring block along above right direction in the same scanning distance) scanning positions are used for the non-adjacent neighboring blocks along above direction in FIG. 26, FIG. 41 and FIG. 44, the middle-right (with the vertical index equal to half of the block height, the horizontal index equal to the horizontal index of the non-adjacent neighboring block along bottom left direction in the same scanning distance) scanning positions are used for the non-adjacent neighboring blocks along left direction in FIG. 26, FIG. 41 and FIG. 44.

### Candidate Reordering

When inserting the non-adjacent spatial candidates into the IBC candidate list, all non-adjacent spatial candidates may be grouped as a whole to insert to different positions of the IBC candidate list, or non-adjacent spatial candidates may be divided into several subgroups and each subgroup is inserted into different positions of the IBC candidate list.

In one or more embodiments, the non-adjacent spatial candidates may be inserted into the IBC candidate list by following the order below:
1. Spatial BVP from adjacent spatial neighbors
2. Spatial BVP from non-adjacent spatial neighbors
3. History-based BVP from an FIFO table
4. Pairwise average BVP
5. BVP candidates located in the IBC reference region as shown in FIG. 13
6. Zero BVP

In another embodiment, the non-adjacent spatial candidates may be inserted into the IBC candidate list by following the order below:
1. Spatial BVP from adjacent spatial neighbors
2. History-based BVP from an FIFO table
3. Spatial BVP from non-adjacent spatial neighbors
4. Pairwise average BVP
5. BVP candidates located in the IBC reference region as shown in FIG. 13
6. Zero BVP

In another embodiment, the non-adjacent spatial candidates may be inserted into the IBC candidate list by following the order below:
1. Spatial BVP from adjacent spatial neighbors
2. The first X spatial BVP from non-adjacent spatial neighbors
3. History-based BVP from an FIFO table
4. Other Y spatial BVP from non-adjacent spatial neighbors
5. Pairwise average BVP
6. BVP candidates located in the IBC reference region as shown in FIG. 13
7. Zero BVP

Where the value of X and Y may be a predefined fixed value such as the value of 2, or a signaled value (sequence/slice/block/CTU level signaled parameters) received by the decoder, or a configurable value at the encoder/decoder, or a dynamically decided value (e.g., X<=3, Y<=3) according to the number of available neighbors on the left and above of each individual coding block, or any combination of methods determining the value of X and Y In one example, the value of X may be the same as the value of Y In another example, the value of X may be different from the value of Y

As the candidates put in the later positions of the IBC candidate list may cost higher signaling overhead if selected and signaled by the encoder, the order of the above different categories of candidates may be designed in different methods below:

In one or more embodiments, the order of the candidates remains the same as the above insertion order. An adaptive reordering method may be applied to reorder the candidates afterwards; the adaptive reordering method may be template matching based methods (ARMC).

In one or more embodiments, before inserting the non-adjacent spatial candidates into IBC candidate list, an adaptive reordering method may be first applied to the derived non-adjacent spatial candidates (the adaptive reordering method may be template matching based methods (ARMC)), then the first X candidates may be inserted into the IBC candidate list based on above inserting methods.

The value of X may be a predefined fixed value such as the value of 2, or a signaled value (sequence/slice/block/CTU level signaled parameters) received by the decoder, or a configurable value at the encoder/decoder, or a dynamically decided value (e.g., X<=3) according to the number of available neighbors on the left and above of each individual coding block, or any combination of methods determining the value of X.

The above reordering methods may be selected and applied according to different factors: In one or more embodiments, the reordering methods may be selected based on the types of the video frames/slices. For example, for low-delay pictures or slices, all the non-adjacent spatial candidates may be placed after all the adjacent spatial candidates. While for non-low-delay pictures or slices, the first X non-adjacent spatial candidates may be placed after the adjacent spatial candidates, and the remaining non-adjacent spatial candidates may be placed after the history-based BVP candidates.

In some embodiments, above candidate reordering process may be same or different for IBC AMVP and merge candidate list derivation. For example, for both IBC AMVP and merge candidate list derivation, all the non-adjacent spatial candidates are placed after all the adjacent spatial candidates. In another example, for IBC AMVP candidate list derivation, all the non-adjacent spatial candidates are placed after all the adjacent spatial candidates; for IBC merge candidate list derivation, the first X non-adjacent spatial candidates may be placed after the adjacent spatial candidates, and the remaining non-adjacent spatial candidates may be placed after the history-based BVP candidates. In the third example, for IBC merge candidate list derivation, all the non-adjacent spatial candidates are placed after all the adjacent spatial candidates; for IBC AMVP candidate list derivation, all the non-adjacent spatial candidates are placed after the history-based BVP candidates.

### Motion Information Storage

When non-adjacent spatial neighbors are scanned based on above provided candidate derivation methods, the selected non-adjacent spatial neighbors may be IBC coded blocks or Intra TMP coded blocks. In the case of both IBC coded blocks and Intra TMP coded blocks, the motion information may include translational BVs.

For either IBC-coded blocks or Intra-TMP-coded blocks, the motion information of these blocks may need to be saved in a memory once these blocks have been coded. In order to save memory usage, the non-adjacent spatial neighbors may be restricted to a certain area.

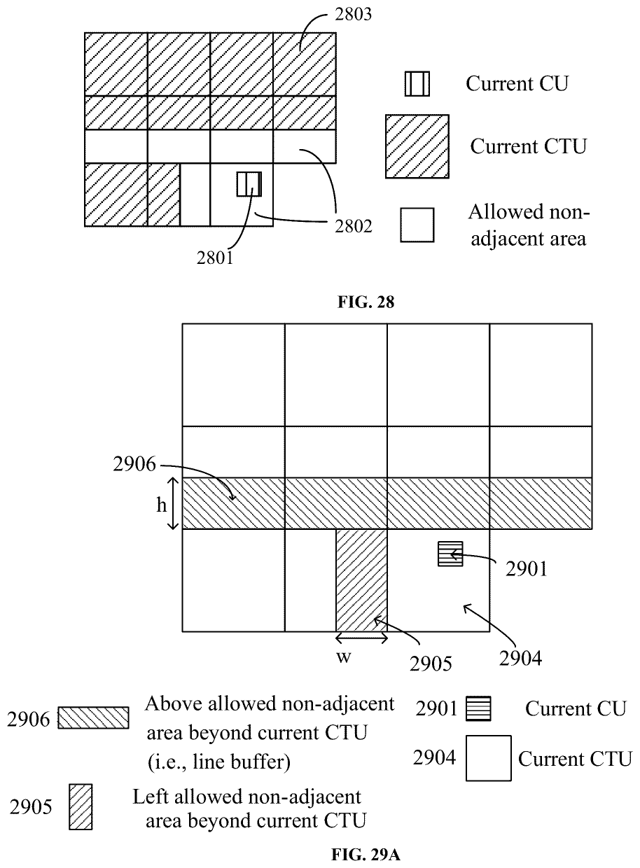

As shown in the FIG. 28, the allowed non-adjacent area for scanning non-adjacent spatial neighboring blocks may be restricted to a limited area size.

In one or more embodiments, the restricted area may be applied to IBC or Intra TMP spatial neighboring blocks.

The size of the allowed non-adj area may be defined according to the size of current coding tree unit (CTU), e.g., integer (e.g., 1 or 2 or other integer) or fractional number (e.g., 0.5 or 0.25 or other fractional number) of current CTU size.

The size of the allowed non-adj area may be defined according to a fixed number of pixels or samples, e.g., 128 samples on the above of the current CTU or/and on the left of the current CTU.

The size (e.g., according to the CTU size or number of samples) may be a prefixed value or a signaled value determined at the encoder and carried in the bit-stream.

The size of the restricted area may be separately defined for top and left non-adjacent neighboring blocks. In some examples, non-adjacent neighboring blocks may be non-adjacent spatial neighbors, top non-adjacent neighboring blocks may be top non-adjacent spatial neighbors, and left non-adjacent neighboring blocks may be left non-adjacent spatial neighbors.

In one example, the above non-adjacent neighboring blocks may be restricted to be within the current CTU, or outside of the current CTU but within at most fixed number samples/pixels away from the top of the current CTU such that no additional line buffer is needed for saving the motion information of above non-adjacent neighboring blocks. For example, the fixed number may be defined as 8, if 8 sample rows of neighboring area away from the current CTU top is already covered by the existing line buffer. In another example, the left non-adjacent neighboring blocks may be restricted to be within the current CTU, or outside of the current CTU but within a predefined or a signaled number of samples/pixels away from the left boundary of the current CTU.

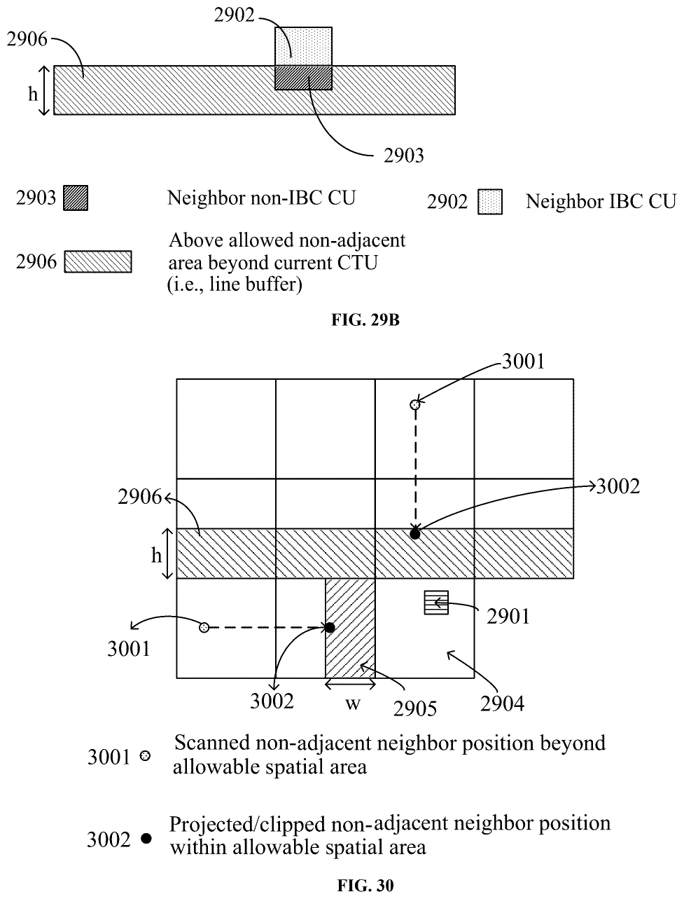

As shown in FIGS. 29A-29B, the allowed non-adjacent area (for either non-adjacent IBC neighbors or Intra TMP neighbors) above the current CU may have large memory cost if the allowed non-adjacent area is beyond the current CTU. In this case, the actual memory cost is proportionally increased with the picture width and the maximum allowable scanning distance in the vertical direction. To reduce the line buffer (i.e., the above non-adjacent area beyond the current CTU) cost, the height of the above non-adjacent area outside of the current CTU may be limited to a value of h (as shown in FIG. 29A). Note that this value of h may be configurable or signaled to decoder. In case the IBC motion and Intra TMP motion are stored in a separate buffer, for the example shown in the FIG. 29B, there may be different methods to save the motion in the line buffer: In one method, the line buffer used to store IBC motion may indicate that the buffer area where the CU B is located is set to be invalid since CU B is not IBC CU. In another method, the line buffer used to store IBC motion may indicate that the buffer area where the CU B is located is set to be valid and the IBC motion is copied from CU A, since CU A is CU B's adjacent IBC neighbor.

In the example of FIGS. 29A-29B, the height value h and width value w may be set to be multiples of 4 for easier implementation. In one embodiment, the value h and w may be set to be the minimum value (e.g., 4) of an IBC CU.

When the allowed non-adjacent area for scanning non-adjacent spatial neighboring blocks is restricted to a limited area size, such as the examples in FIGS. 28 and 29, the scanned non-adjacent neighbor position may be out of the allowed non-adjacent area. In this case, different methods may be used to solve this issue:

In one method, the scanning process may indicate that this scanned position has no valid neighbor information.

In another method, the scanning process may project or clip this out-of-range position to another position which is within the allowed non-adjacent area. As shown in the example of FIG. 30, there are two positions (i.e., the two spots 3001) out of the range of the allowable non-adjacent area. These two positions are projected/clipped to another two positions which are at the same vertical/horizontal coordinate but within the allowable non-adjacent area, respectively. The projected/clipped new position may be located on the boundary of the allowable non-adjacent area which is closest to the original position. In case the allowed non-adjacent area beyond the current CTU is set to be has a value w and h set to the minimum value (e.g., 4) of an IBC CU, the projected/clipped new position may be interchangeably set to be on the one boundary or the other boundary because the buffer is so small that the motion information from only one CU may be stored and in this case there is no difference to be clipped to one boundary side or the other side.

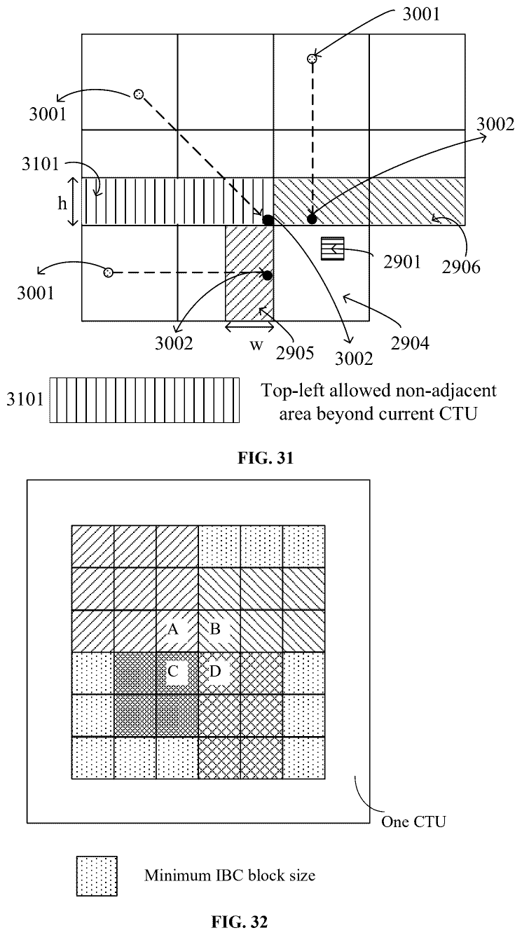

In another method, the allowed non-adjacent spatial area may include three regions. As shown in FIG. 31, the three regions are the spatial areas located on the top-left, left, and above area outside of the current CTU and adjacent to the current CTU. The height of the top-left region and above region in the allowed non-adjacent spatial area is defined as h, while the width may depend on the picture width. The width of the left allowed non-adjacent spatial area is defined as w, while the height is equal to the height of the current CTU. As shown in FIG. 31, if the scanned non-adjacent position (one of the spots 3001 in FIG. 31) is beyond the allowed spatial area, the projected/clipped new position (one of the spots 3002 corresponding to the one of the spots 3001 by the dotted arrow in FIG. 31) may be defined in different ways. For the top-left non-adjacent area, the projected/clipped new position is always the pixel position adjacent to the top-left position of the current CTU. For example, if the top-left position of the current CTU is (ctu_x, ctu_y), the projected/clipped new position is (ctu_x−1, ctu_y−1). For the above non-adjacent area, the projected/clipped new position has the same horizontal coordinate, but the vertical coordinate becomes (ctu_y−1). For the left non-adjacent area, the projected/clipped new position has the same vertical coordinate, but the horizontal coordinate becomes (ctu_x−1).

When motion information of an IBC-coded block is saved in memory, the motion information may be saved at the granularity of minimum IBC block size (e.g., an 4×4 block). In case the current IBC-coded block is a coding unit with larger size than the minimum IBC block, the motion information may be saved in different methods. In one or more embodiments, the motion information saved at each minimum IBC block (e.g. 4×4 block) within the current block is just a repeated copy of the motion information of the current block.

Alternatively or additionally, the motion information of an IBC-coded block may be saved at a different granularity a×b (e.g., 8×8 or 8×16 or 16×8 or 16×16 granularity etc.) instead of the minimum IBC block size (e.g., 4×4 granularity), where the granularity values of the a and b may be configurable or decided at the encoder then signaled to the decoder. Without loss of generality, it takes a granularity of 8×8 (e.g., a=b=8) as an illustrative example. If further assumes that the minimum IBC block size is 4×4, it indicates that each 8×8 block may only save one set of IBC motion information, which represents one single IBC model, even though the four 4×4 sub-blocks within this 8×8 block may be from more than one IBC blocks, which is shown in the FIG. 32. In FIG. 32, the four 4×4 sub-blocks A, B, C and D form an 8×8 block/area, and only one IBC model information is saved. However, the four 4×4 sub-blocks are from four different IBC blocks, which represent four IBC models and include four sets of IBC motion information. In this case, there may be different ways to derive and save one single set of IBC information:

In one or more embodiments, one of the multiple sets of available IBC motion information may be selected and saved. In one example, the IBC motion information at one fixed or configurable position (e.g., the top-left minimum IBC block) is selected for motion storage. In another example, an averaged IBC motion information of multiple models may be calculated for motion storage.

The IBC motion information at a selected neighboring IBC block may be simplified/compressed before storage. In one embodiment, each saved BV may be compressed before storage to further reduce the memory size. One example is to use general techniques for data compression. For example, it is provided to save a compounded value from one exponent and mantissa to approximately represent each saved BV.

The above provided methods may be applied for motion information storage in any combinations. For example, the defined restricted area for non-adjacent neighboring blocks may be combined with the usage of compressed IBC motion information.

### Scope of Application

The above provided methods in sections “Candidate scanning and candidate pruning”, “Candidate reordering” and “Motion information storage” mainly aim to derive spatial non-adjacent candidates for IBC AMVP or merge mode. When temporal candidates are also utilized for IBC AMVP or merge mode, the temporal candidates can also utilize the non-adjacent neighboring blocks in the collocated pictures. Different from spatial non-adjacent candidates which are mainly extracted from left and above areas of current block, the temporal non-adjacent candidates may be extracted from left, above, right, below and collocated areas of current block. Besides, the above provided methods in sections “Candidate scanning and candidate pruning”, “Candidate reordering” and “Motion information storage” may also be applied to temporal non-adjacent candidates for IBC AMVP or merge mode in a similar manner.

### Application Block Size

The above provided methods in sections “Candidate scanning and candidate pruning,” “Candidate reordering,” “Motion information storage” and “Scope of application” for deriving spatial/temporal non-adjacent candidates for IBC AMVP or merge mode may be applied to different combinations of block size. The application block size for spatial/temporal adjacent candidates and the application block size for spatial/temporal non-adjacent candidates may be same or different. In a first example, both spatial adjacent candidates and spatial non-adjacent candidates are only applied to the coding block whose area is bigger than 16. In a second example, both spatial adjacent candidates and spatial non-adjacent candidates are applied to all the coding block sizes. In a third example, spatial adjacent candidates are applied to the coding block whose area is bigger than 16, spatial non-adjacent candidates are applied to all the coding block sizes. In a fourth example, spatial adjacent candidates are applied to all the coding block sizes, spatial non-adjacent candidates are applied to the coding block whose area is bigger than 16. In above four application block size examples, for scanning area, scanning distance and scanning order, in one example, the spatial non-adjacent candidates are derived according to the candidate scanning and pruning process presented in FIG. 26 for IBC AMVP mode and IBC merge mode. In another example, the spatial non-adjacent candidates are derived according to the candidate scanning and pruning process presented in FIG. 26 for IBC AMVP mode and the candidate scanning and pruning process presented in FIG. 41 for IBC merge mode. In above four application block size examples, for scanning termination, in one example, the scanning performed in a specific area at a specific distance is stopped at the instance when all covered neighboring blocks are scanned and no more qualified candidates are identified or the maximum allowable number of IBC merge candidates is reached. In another example, the scanning performed in a specific area at a specific distance is stopped at the instance when all covered neighboring blocks are scanned and no more qualified candidates are identified or the maximum allowable number of IBC merge candidates minus 1 is reached. The above application block size examples, scanning area, scanning distance, and scanning order examples, and scanning termination examples can be combined freely, which may constitute different examples of the whole scheme of IBC with non-adjacent candidates.

### Sub-Block Based IBC Mode

According to the one or more embodiments of the disclosure, the IBC mode is extended to sub-block level, where a sub-block in current block may have its own BV to do motion compensation. Different example methods may be used to achieve this goal.

In the first example method, as shown in FIG. 33, the BV of the sub-block in current block is obtained by reusing the BV of the sub-block of the collocated block in the collocated picture. If the BV of one sub-block in the collocated block can not be obtained, such as the sub-block is intra coded, the BV of the sub-block can be set to the BV of the collocated block. Besides the collocated block in the collocated picture, the block in other positions can also be utilized to obtain the sub-block level BV, where other positions can be obtained refer to temporal non-adjacent candidates. In addition, the BV of the sub-block of the collocated block or other positions in the collocated picture can be refined with template matching methods.

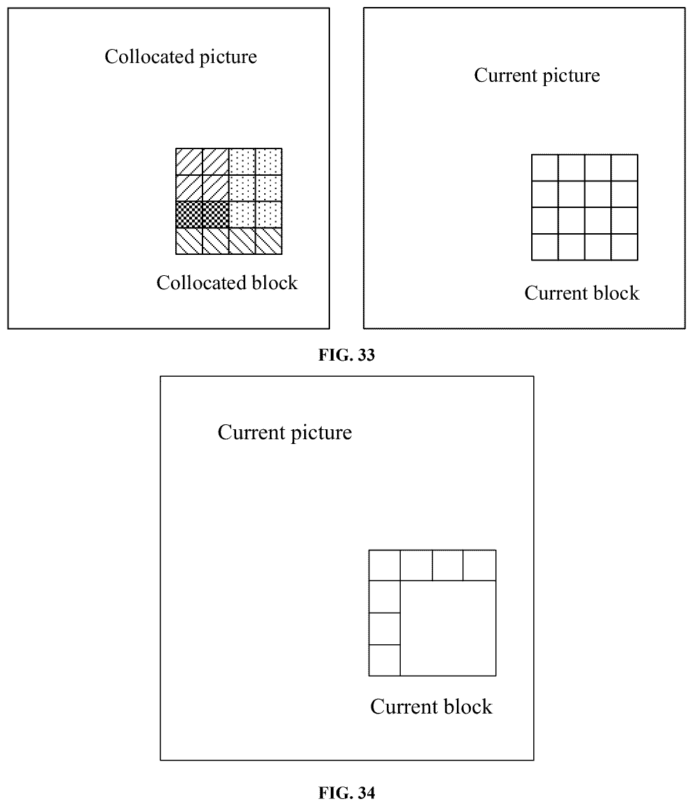

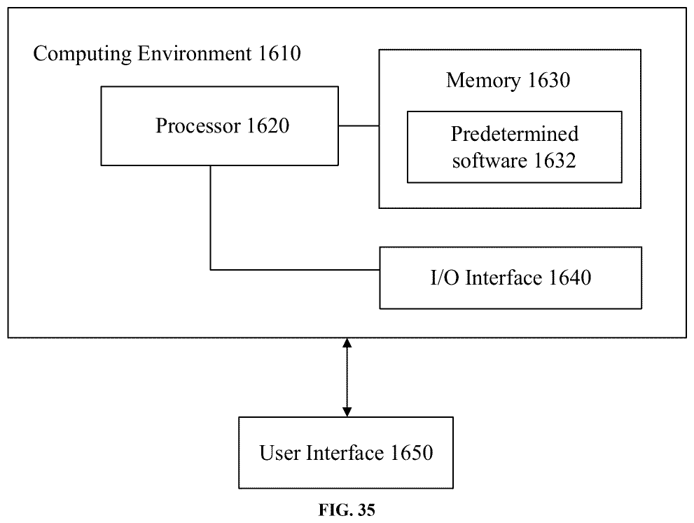

In the second example method, as shown in FIG. 34, the BV of the left or above sub-block in current block is obtained by refining the BV of current block with template matching methods. The BV of current block may be obtained by regular IBC mode, TM IBC mode or other modes. For the left sub-block in current block, only left template can be utilized to refine the BV of the sub-block. For the above sub-block in current block, only above template can be utilized to refine the BV of the sub-block. For the top-left sub-block in current block, both left and above templates can be utilized to refine the BV of the sub-block.

### Multiple Template Patterns for TM IBC Mode and TM Regular Mode

According to the one or more embodiments of the disclosure, the template pattern for TM IBC mode and TM regular mode is extended by importing more kinds of templates. Different methods may be used to achieve this goal.

In the first method, besides currently used template pattern which uses both above and left templates, other template patterns such as only using left template, only using above template and so on can also be used for TM IBC mode or TM regular inter mode. When more than one template pattern are used for TM IBC mode or TM regular inter mode, which template pattern is finally utilized for current block can be decided based on a predefined criteria or flags which are transmitted into bit stream.

### IBC and Intra TMP for Deblocking Filter Boundary Strength Derivation

According to the one or more embodiments of the disclosure, deblocking filter treats the block coded with IBC mode and the block coded with Intra TMP mode equally when obtaining the boundary strength. Different methods may be used to achieve this goal.

In the first method, the block coded with IBC mode and the block coded with Intra TMP mode are both regarded as the block coded with intra mode when obtaining the boundary strength for deblocking filter. Then, the boundary strength decision criteria for the block coded with intra mode can be applied to the block coded with IBC mode and the block coded with Intra TMP mode. For example, if two neighboring blocks are both coded with IBC mode or Intra TMP mode, or one of two neighboring blocks is coded with IBC mode or Intra TMP mode, the boundary strength is set to a predetermined positive integer, for example, 2.

In the second method, the block coded with IBC mode and the block coded with Intra TMP mode are both regarded as the block coded with inter mode when obtaining the boundary strength for deblocking filter. Then, the boundary strength decision criteria for the block coded with inter mode can be applied to the block coded with IBC mode and the block coded with Intra TMP mode. For example, if two neighboring blocks are both coded with IBC mode, or two neighboring blocks are both coded with Intra TMP mode, or one of two neighboring blocks is coded with IBC mode, the other is coded with Intra TMP mode, if the two block vectors of the two neighboring blocks are different (or the absolute difference of horizontal component or vertical component of the two block vectors is bigger than a threshold, (for example, half pixel)), the boundary strength is set to a predetermined positive integer, for example, 1. In another example, if the difference of the two block vectors of the two neighboring blocks is bigger, then the boundary strength is set to larger value.

In the third method, when the block coded with IBC mode or the block coded with Intra TMP mode is combined with an intra tool, such as combining IBC with intra prediction, GPM with IBC and intra prediction, combining Intra TMP with intra prediction, GPM with Intra TMP and intra prediction, and son on, the block is regarded as the block coded with intra mode when obtaining the boundary strength for deblocking filter.

In the fourth method, when the block coded with IBC mode or the block coded with Intra TMP mode is combined with an inter tool, such as combining IBC with inter prediction, GPM with IBC and inter prediction, combining Intra TMP with inter prediction, GPM with Intra TMP and inter prediction, and son on, the block is regarded as the block coded with inter mode when obtaining the boundary strength for deblocking filter.

### Combination of IBC and Intra TMP

According to one or more embodiments of the disclosure, the IBC tool is combined with Intra TMP tool. Different methods may be used to achieve this goal.

In the first method, the IBC tool is combined with Intra TMP tool in the form of GPM with IBC and Intra TMP prediction. In one example, both “inter” parts of GPM with inter and inter prediction method in VVC is replaced with IBC and Intra TMP prediction, respectively. That means that the IBC prediction result and Intra TMP prediction result are weighted averaged with each other according to a splitting line in the coding block. The weight may be obtained referring to GPM with inter and inter prediction method in VVC. In the another example, both “inter” parts of GPM with inter and inter prediction method in ECM is replaced with IBC and Intra TMP prediction, where some template matching tools may be utilized to further improve the coding performance.

In the second method, the IBC tool is combined with Intra TMP tool in the form of CIIP with IBC and Intra TMP prediction. In one example, fixed weight is utilized for weighting IBC prediction result and Intra TMP prediction result, where the specific weight value depends on the coding modes of neighboring blocks. In another example, the fixed weight value is obtained based on template matching methods.

TM Based Reordering for MMVD Candidates of GPM with MMVD Mode

According to one or more embodiments of the disclosure, template matching (TM) based methods are used to reordering the MMVD candidates of GPM with MMVD mode. Different methods may be used to achieve this goal.

In the first method, similar to GPM with template matching, different templates are utilized to reorder the MMVD candidates of different parts of the GPM partitions for a predefined split mode. After reordering, an index is signalled to represent the chosen MMVD candidate for a part of GPM partition.

In the second method, one kind of template is utilized to reorder the MMVD candidates of different parts of the GPM partitions for different split modes. After reordering, an index is signalled to represent the chosen MMVD candidate for a part of GPM partition.

### IBC/Regular Inter/Affine Inter HMVP Candidates Utilization

According to one or more embodiments of the disclosure, the IBC/regular inter/affine inter HMVP candidates are utilized based on the relative position of the HMVP candidate to the current block. Different methods may be used to achieve this goal.

In the first method, when coding current block, all the IBC/regular inter/affine inter HMVP candidates are first divided into several groups according to the distance between the central position of the HMVP candidate and central positon of current block. For example, with some predefined thresholds T₁, T₂, . . . , T_{N}, the HMVP candidates with distance less than T₁ are divided into group 1, the HMVP candidates with distance equal to or bigger than T₁ but less than T₂ are divided into group 2, . . . , the HMVP candidates with distance equal to or bigger than T_{N-1} but less than T_{N} are divided into group N. The specific value of the predefined thresholds can be set with different methods. For example, T₁ is set to the max value of the height and width of current block. T₂ is set to 2 times of T₁, . . . , T_{N} is set to N times of T₁. Then, with a predefined scanning order in every divided group, the first Mᵢ valid candidates are chosen. The predefined scanning order can be defined in different methods, for example, the HMVP candidates in every divided group are scanned in the following order: left direction, above direction, bottom left direction, above right direction, above left direction. The value of Mᵢ can be set same in all divided groups, or different in different divided groups. Finally, the chosen candidates in every divided groups are added into IBC/regular inter/affine inter candidate list in the order from the smaller distance to the bigger distance.

In the second method, after all the IBC/regular inter/affine inter HMVP candidates are divided into several groups according to the distance between the central position of the HMVP candidate and central positon of current block, the first Mᵢ valid candidates in every divided group are chosen based on template matching methods. Specifically, the HMVP candidates in every divided group are reordered based on template matching methods, then the first Mᵢ valid candidates with minimum template matching costs are chosen. Finally, the chosen candidates in every divided groups are added into IBC/regular inter/affine inter candidate list in the order from the smaller distance to the bigger distance.

When utilizing the IBC/regular inter/affine inter HMVP candidates based on the coding order of the HMVP candidates (original scheme in VVC or ECM) or based on the relative position of the HMVP candidate to the current block (the provided scheme), the number of the HMVP candidates may be further enlarged. Different methods may be used to achieve this goal. In one example, same to the original design in VVC or ECM, there is only one HMVP table to save the HMVP candidates, but the size of the HMVP table is further enlarged. In another example, there are several HMVP tables to save the HMVP candidates, different HMVP tables may be assigned for different CTUs, or different HMVP tables may be assigned for different areas of the coding picture. For example, there are 5 HMVP tables, with one is assigned for current CTU, one is assigned for the neighboring left CTU, one is assigned for the neighboring above CTU, one is assigned for the neighboring above right CTU, one is assigned for the neighboring above left CTU. The HMVP table size may be set to a same number for different HMVP tables, or different numbers for different HMVP tables.

When managing the IBC HMVP candidates, the coding block coded with both IBC mode or Intra TMP mode may be added to IBC HMVP table, or only the coding block coded with IBC mode may be added into the IBC HMVP table. When adding one coding block into IBC HMVP table, the coding block with all block sizes may be added into IBC HMVP table, or only the coding block whose area is bigger than 16 may be added into the IBC HMVP table.

### Intra MPM List Construction Related to IBC or Intra TMP Coded Block

According to one or more embodiments of the disclosure, during the intra MPM list construction of the current block, when one neighboring block is IBC coded or Intra TMP coded, the intra prediction mode which the block vector of IBC or Intra TMP points to is used to construct the intra MPM list of the current block. Different methods may be used to achieve this goal.

In a first method, when the current block is coded with regular intra mode, multiple reference line intra mode, GPM with inter and intra mode, spatial GPM mode, or GPM with IBC and intra mode, to construct the intra MPM list of the current block, when one neighboring block is IBC coded or Intra TMP coded, the intra prediction mode which the block vector of IBC or Intra TMP points to is used, rather than setting the Intra prediction mode of the IBC or Intra TMP coded block to planar mode.

FIG. 35 shows a computing environment (or a computing device) 1610 coupled with a user interface 1650. The computing environment 1610 may be part of a data processing server. In some embodiments, the computing device 1610 can perform any of various methods or processes (such as encoding/decoding methods or processes) as described hereinbefore in accordance with various examples of the present disclosure. The computing environment 1610 includes a processor 1620, a memory 1630, and an Input/Output (I/O) interface 1640.

The processor 1620 typically controls overall operations of the computing environment 1610, such as the operations associated with display, data acquisition, data communications, and image processing. The processor 1620 may include one or more processors to execute instructions to perform all or some of the steps in the above-described methods. Moreover, the processor 1620 may include one or more modules that facilitate the interaction between the processor 1620 and other components. The processor may be a Central Processing Unit (CPU), a microprocessor, a single chip machine, a Graphical Processing Unit (GPU), or the like.

The memory 1630 is configured to store various types of data to support the operation of the computing environment 1610. The memory 1630 may include predetermined software 1632. Examples of such data includes instructions for any applications or methods operated on the computing environment 1610, video datasets, image data, etc. The memory 1630 may be implemented by using any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The I/O interface 1640 provides an interface between the processor 1620 and peripheral interface modules, such as a keyboard, a click wheel, buttons, and the like. The buttons may include but are not limited to, a home button, a start scan button, and a stop scan button. The I/O interface 1640 can be coupled with an encoder and decoder.

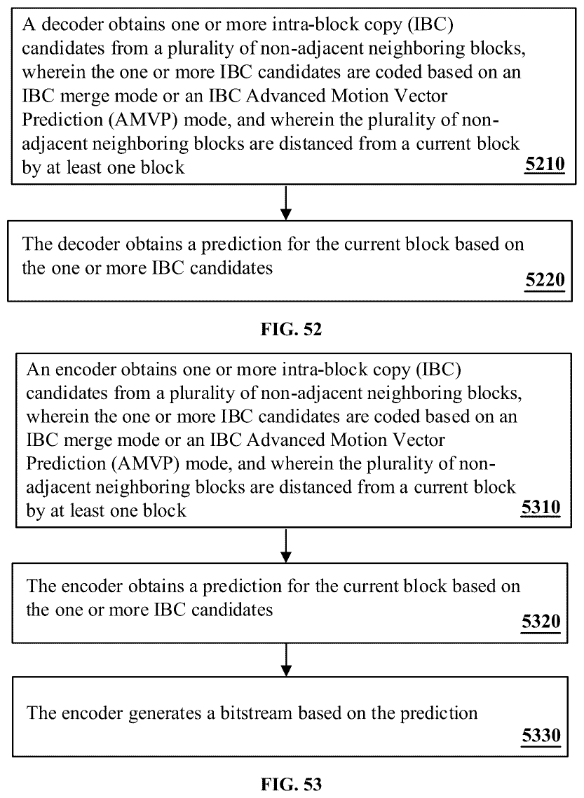

FIG. 52 is a flowchart illustrating a method for video decoding according to an example of the present disclosure.

In Step S210, the processor 1620, at the side of a decoder, may obtain one or more intra-block copy (IBC) candidates from a plurality of non-adjacent neighboring blocks, where the one or more IBC candidates are coded based on an IBC merge mode or an IBC Advanced Motion Vector Prediction (AMVP) mode, and where the plurality of non-adjacent neighboring blocks are distanced from a current block by at least one block.

In Step S220, the processor 1620 may obtain a prediction for the current block based on the one or more IBC candidates.

In some examples, to obtain, at the side of the decoder, the one or more IBC candidates, the processor 1620 may obtain the one or more IBC candidates according to a scanning rule.

In some examples, to obtain the one or more IBC candidates according to a scanning rule, the processor 1620 may determine the scanning rule based on at least one scanning area, at least one scanning distance, and a scanning order.

In some examples, the at least one scanning distance indicates a number of blocks away from a side of the current block. In some examples, one of the plurality of non-adjacent neighboring blocks located at one of the at least one scanning distance has a same size as the current block. In some examples, one of the plurality of non-adjacent neighboring blocks located at one of the at least one scanning distance has a different size than the current block.

In some examples, the processor 1620 may further determine the at least one scanning area according to the at least one scanning distance. In some examples, the at least one scanning area comprises a first scanning area and a second scanning area, the first scanning area is determined according to a first scanning distance indicating a first maximum number of blocks away from a first side of the current block, and the second scanning area is determined according to a second scanning distance indicating a second maximum number of blocks away from a second side of the current block, and the first scanning distance is same as or different from the second scanning distance. In some examples, the processor 1620 may further receive the first scanning distance and the second scanning distance signaled in a bitstream. In some examples, the processor 1620 may further predetermine the first scanning distance or the second scanning distance as a fixed value.

In some examples, the processor 1620 may further, at the side of the decoder and in response to determining that the first scanning distance or the second scanning distance equals to a fixed size, terminate scanning in the at least one scanning area in response to satisfying a condition of: a size of a candidate list including the one or more IBC candidates being the fixed size; or all non-adjacent neighboring blocks within the first scanning distance or the second scanning distance been scanned.

In some examples, the first scanning area includes a first starting neighboring block and a first ending neighboring block, and the second scanning area includes a second starting neighboring block and a second ending neighboring block; and the first scanning distance is greater than the second scanning distance.

In some examples, the first starting neighboring block is an adjacent bottom-left neighboring block of the second starting neighboring block; and the first ending neighboring block is an adjacent left neighboring block of the second ending neighboring block. In some examples, the first starting neighboring block is an adjacent top-right neighboring block of the second starting neighboring block; and the first ending neighboring block is an adjacent top-left neighboring block of the second ending neighboring block. In some examples, the first scanning distance is 2, and the second scanning distance is 1.

In some examples, the first scanning area comprises a first sampling interval, and the second scanning area comprises a second sampling interval; and a first length of the first sampling interval is larger than a second length of the second sampling interval. In some examples, the first scanning distance is 2, the second scanning distance is 1, the first length of the first sampling interval is 2, and the second length of the second sampling interval is 1.

In some examples, the first scanning area is a left scanning area disposed to the left of the current block, and the second scanning area is a top scanning area disposed above the current block; and the first scanning distance is equal to the second scanning distance. In some examples, the first scanning area includes a first sampling interval, and the second scanning area includes a second sampling interval; and a first length of the first sampling interval is same as or different from a second length of the second sampling interval.

In some examples, the at least one scanning area comprises a left scanning area disposed to the left of the current block and a top scanning area disposed above the current block. In some examples, to determine the scanning rule based on the at least one scanning area, the at least one scanning distance, and the scanning order, the processor may, at the side of the decoder, scan the left scanning area before the top scanning area, or scan the left scanning area and the top scanning area alternatively.

In some examples, the left scanning area includes a first left scanning area, a second left scanning area, and a third left scanning area; the top scanning area includes a first top scanning area, a second top scanning area, and a third top scanning area; the first left scanning area and the first top scanning area correspond to a first scanning distance, the second left scanning area and the second top scanning area correspond to a second scanning distance, and the third left scanning area and the second top scanning area correspond to a third scanning distance; each of the at least one scanning distance indicates a number of blocks away from a side of the current block; the first scanning distance is smaller than the second scanning distance, and the second scanning distance is smaller than the third scanning distance; to scan the left scanning area before the top scanning area, the processor 1620 may perform in sequential order: scanning the first left scanning area; scanning the second top scanning area; scanning the third left scanning area; scanning the first top scanning area; scanning the second left scanning area; and scanning the third top scanning area; and to scan the left scanning area and the top scanning area alternatively, the processor 1602 may perform in sequential order: scanning the first left scanning area; scanning the first top scanning area; scanning the second left scanning area; scanning the second top scanning area; scanning the third left scanning area; and scanning the third top scanning area.

In some examples, the first scanning distance is 1, the second scanning distance is 2, and the third scanning distance is 3.

In some examples, the left scanning area includes a bottom neighboring block and a top neighboring block; the top scanning area includes a right neighboring block and a left neighboring block; and to determining the scanning rule based on the at least one scanning area, the at least one scanning distance, and the scanning order, the processor 1620 may, at the side of the decoder, scan from the bottom neighboring block to the top neighboring block and scan from the right neighboring block to the left neighboring block.

In some examples, to determine the scanning rule based on the at least one scanning area, the at least one scanning distance, and the scanning order, the processor 1620 may, at the side of the decoder and in response to determining that the first scanning distance is smaller than the second scanning distance, scan the first scanning area before scanning the second scanning area.

In some examples, to determine the scanning rule based on the at least one scanning area, the at least one scanning distance, and the scanning order, the processor 1620 may, at the side of the decoder, within each of the at least one scanning area corresponding to each of the at least one scanning distance, scanning a plurality of blocks according to an order of a plurality of degree values; where the plurality of degree values correspond to a plurality of directions, and the at least one scanning distance comprises at least four distances.

In some examples, the at least four distances comprise 2, 3, 4, and 5. In some examples, the order of the plurality of degree values comprises: 225, 45, 90, 180, and 135; and a total of at least 18 blocks are scanned. In some examples, the order of the plurality of degree values comprises: 225, 45, 90, 180, 135, 270, 0, 247.5, 22.5, 202.5, 67.5, 157.5, and 112.5; and a total of at least 48 blocks are scanned.

In some examples, to obtain the one or more IBC candidates according to the scanning rule, the processor 1620 may, at the side of the decoder, in response to a quantity of one or more qualified candidates being identified, terminate a scanning process; and set the one or more IBC candidates as the one or more qualified candidates, where the one or more qualified candidates are coded in one of the IBC mode or intra template matching prediction (TMP) mode.

In some examples, the at least one scanning area includes a left scanning area, the at least one scanning distance includes 1; where the quantify of the one or more qualified candidates is a predefined positive value; and to obtain the one or more IBC candidates according to the scanning rule, the processor 1620 may, at the side of the decoder, further scan a scanning area other than the left scanning area according to a predefined scanning rule.

In some examples, the processor 1620 may further: for each of the at least one scanning distance, set the quantity of the one or more qualified candidates to be a same integer; or in response to determining that the at least one scanning distance includes a first scanning distance and a second scanning distance and the first scanning distance is different from the second scanning distance, set a first quantity of the one or more qualified candidates corresponding to the first scanning distance and a second quantity of the one or more qualified candidates corresponding to the second scanning distance; where the processor 1620 may, in response to determining that a maximum quantity of the one or more qualified candidates have been identified, further terminate the scanning process. In some examples, the maximum quantity is 3.

In some examples, the at least one scanning area includes a left scanning area, and the at least one scanning distance further includes a third scanning distance; where the processor 1620 may further set a third quantity of the one or more qualified candidates corresponding to the third scanning distance; and where the first quantity, the second quantity, and the third quantity all equal to 1.

In some examples, to obtain the one or more IBC candidates according to the scanning rule, the processor 1620 may further locate at least one non-adjacent candidate block by a specific scanning position. In some examples, the specific scanning position is a bottom-right position.

In some examples, to obtain the one or more IBC candidates according to the scanning rule, the processor 1620 may further obtain, at the side of the decoder, a first IBC candidate and a second IBC candidate; perform a similarity check between the first IBC candidate and the second IBC candidate; and in response to determining that the first IBC candidate is similar to the second IBC candidate, prune one of the first IBC candidate and the second IBC candidate.

In some examples, to determine the scanning rule based on the at least one scanning area, the at least one scanning distance, and the scanning order, the processor 1620 may, at the side of the decoder and within each of the at least one scanning area corresponding to each of the at least one scanning distance, scan a plurality of blocks according to an order of a plurality of degree values; where the plurality of degree values correspond to a plurality of directions, the at least one scanning distance comprises 2, 3, 4, and 5, and the processor 1620 may, in response to determining the one or more IBC candidates are coded based on the IBC AMVP mode, further set the order of the plurality of degree values to comprise 225, 45, 90, 180, and 135, and scanning a total of at least 18 blocks; or in response to determining the one or more IBC candidates are coded based on the IBC merge mode, further set the order of the plurality of degree values to comprise 225, 45, 90, 180, 135, 270, 0, 247.5, 22.5, 202.5, 67.5, 157.5, and 112.5, and scanning a total of at least 48 blocks.

In some examples, the processor 1620 may further obtain, at the side of the decoder, a group of non-adjacent spatial candidates, or a first subgroup of non-adjacent spatial candidates and a second subgroup of non-adjacent spatial candidates; obtain a first position of an IBC candidate list and a second position of the IBC candidate list; and perform: inserting the group of non-adjacent spatial candidates to the first position and the second position; or inserting the first subgroup of non-adjacent spatial candidates to the first position, and the second subgroup of non-adjacent spatial candidates to the second position; where to obtain the one or more IBC candidates according to the scanning rule, the processor 1620 may set the one or more IBC candidates as IBC candidates in the IBC candidate list.

In some examples, to insert the first subgroup of non-adjacent spatial candidates to the first position, and the second subgroup of non-adjacent spatial candidates to the second position, the processor 1620 may, at the side of the decoder, perform one of following acts: inserting non-adjacent spatial candidates in a first order as follows: spatial block vector prediction (BVP) from adjacent spatial neighbors; spatial BVP from non-adjacent spatial neighbors; history-based BVP from an FIFO table; pairwise average BVP; BVP candidates located in an IBC reference region; and zero BVP; or obtaining a first quantify of the spatial BVP from the non-adjacent spatial neighbors and a second quantity of the spatial BVP from the non-adjacent spatial neighbors, then inserting, by the decoder, the non-adjacent spatial candidates in a second order as follows: the spatial block vector prediction (BVP) from the adjacent spatial neighbors; the first quantity of the spatial BVP from the non-adjacent spatial neighbors; the history-based BVP from the FIFO table; the second quantity of the spatial BVP from the non-adjacent spatial neighbors; the pairwise average BVP; the BVP candidates located in the IBC reference region; and the zero BVP.

In some examples, the processor 1620 may, at the side of the decoder, further determine the first quantity and the second quantity by at least one of: setting the first quantity as a first predefined value and the second quantity as a second predefined value; receiving the first quantity and the second quantity signaled in a bitstream; or dynamically determining the first quantity and the second quantity according to a number of available neighbors on a left side or an above side of the current block. In some examples, the processor 1620 may, at the side of the decoder, further dynamically reorder the IBC candidate list according to a template matching based method. In some examples, the template matching based method may include Adaptive Reordering of Merge Candidates (ARMC).

In some examples, the processor 1620 may further select the inserting order according to a type of video frames or a type of video slices. In some examples, the inserting order refers to an order in which the processor 1620 may, at the side of the decoder, insert at least one group of non-adjacent spatial candidates into different positions of the IBC candidate list. In some examples, the at least one group of non-adjacent spatial candidates may include the first subgroup of non-adjacent spatial candidates and the second subgroup of non-adjacent spatial candidates. In some examples, to select the inserting order according to a type of video frames or a type of video slices, the processor 1620 may, at the side of the decoder, perform one of following acts: in response to determining that the type of video frames or the type of video slices is low-delay, inserting the non-adjacent spatial candidates in the first order; or in response to determining that the type of video frames or the type of video slices is non-low-delay, inserting the non-adjacent spatial candidates in the second order.

In some examples, the processor 1620 may, at the side of the decoder, further select the inserting order according to a coding mode of the one or more IBC candidates. In some examples, the inserting order refers to an order in which the processor 1620 may, at the side of the decoder, insert at least one group of non-adjacent spatial candidates into different positions of the IBC candidate list. In some examples, the at least one group of non-adjacent spatial candidates may include the first subgroup of non-adjacent spatial candidates and the second subgroup of non-adjacent spatial candidates. In some examples, to select the inserting order according to a coding mode of the one or more IBC candidates, the processor 1620 may, at the side of the decoder, perform one of following acts: in response to determining that the coding mode of the one or more IBC candidates is the IBC AMVP mode, inserting the non-adjacent spatial candidates in the first order; or in response to determining that the coding mode of the one or more IBC candidates is the IBC merge mode, inserting the non-adjacent spatial candidates in the second order.

In some examples, the processor 1620 may, at the side of the decoder, further scan one or more non-adjacent spatial neighbors, where the non-adjacent spatial neighbors are coded in one of the IBC mode or intra Template Mapping Prediction (TMP) mode, and motion information of the non-adjacent spatial neighbors includes one or more translational block vectors (BVs); and to obtain the one or more IBC candidates according to the scanning rule, the processor 1620 may obtain the one or more IBC candidates based on a result of scanning of the one or more non-adjacent spatial neighbors.

In some examples, the processor 1620 may, at the side of the decoder, further save the motion information in a memory, after the one or more non-adjacent spatial neighbors are coded. In some examples, the processor 1620 may, at the side of the decoder, restrict the one or more non-adjacent spatial neighbors to an allowed area. In some examples, the processor 1620 may, at the side of the decoder, further determine a size limit. In some examples, the allowed area is determined according to the size limit. In some examples, to determine the size limit, the processor 1620 may determine the size limit according to one of following quantities: a size of a current coding tree unit (CTU); a fixed number of pixels; or a fixed number of samples. In some examples, to determine the size limit, the processor 1620 may perform one of following acts: setting the size limit as a prefixed value; or receiving the size limit signaled in a bitstream.

In some examples, to determine the size limit, the processor 1620 may determine a first size limit for top non-adjacent spatial neighbors, and determining a second size limit for left non-adjacent spatial neighbors; and to determine the allowed area according to the size limit, the processor 1620 may determine a first allowed area for the top non-adjacent spatial neighbors according to the first size limit, and determine a second allowed area for the left non-adjacent spatial neighbors according to the second size limit.

In some examples, the first allowed area includes one of following areas: a current coding tree unit (CTU), or outside the current CTU and within a fixed number of samples or pixels away from a top side of the current CTU. In some examples, the the second allowed area includes one of following areas: a current coding tree unit (CTU), or outside the current CTU and within a fixed number of samples or pixels away from a left side of the current CTU; where the fixed number includes one of following numbers: a predefined number of the samples or the pixels, or a number of the samples or the pixels signaled in a bitstream.

In some examples, the fixed number of the samples or the pixels away from the top side of the current CTU is configurable or signaled in a bitstream; and to save, at the side of the decoder, the motion information in the memory, the processor 1620 may save a first motion in a first buffer, and saving a second motion in a second buffer, where the first motion corresponds to the non-adjacent spatial neighbors coded in the IBC mode, and where the second motion corresponds to the non-adjacent spatial neighbors coded in the TMP mode.

In some examples, the first buffer indicates at least one of following properties: an invalidity of a first coding unit (CU); or a validity of the first CU, and that the first motion is copied from a second CU, where the second CU is an adjacent IBC neighbor of the first CU. In some examples, the fixed number is a multiple of 4.

In some examples, in response to determining that a first position of a scanned non-adjacent spatial neighbor is out of the allowed area, the processor 1620 may, at the side of the decoder, further perform one of following steps: indicating that the scanned non-adjacent spatial neighbor has no valid neighbor information; or projecting or clipping the first position to a second position, wherein the second position is within the allowed area. In some examples, the second position is within one of a left boundary or a top boundary of the allowed area, where a first distance from the one of the left boundary or the top boundary to the first position is smaller than a second distance from the other of the left boundary or the top boundary to the first position. In some examples, the allowed area comprises a first allowed region, a second allowed region, and a third allowed region; a first height of the first allowed region and a second height of the second allowed region are equal to a height of a current coding tree unit (CTU); the first region is located on a top-left area out of the current CTU, the second region is located on a top area out of the current CTU, and the third region is located on a left area of the current CTU; and the second position comprises one of following positions: a pixel position adjacent to a top-left position of the current CTU; a pixel position adjacent to a top position of the current CTU; or a pixel position adjacent to a left position of the current CTU.

In some examples, to save, at the side of the decoder, the motion information in the memory, the processor 1620 may save the motion information at a granularity of a minimum IBC block size. In some examples, the processor 1620 may, in response to determining that the current block is coded in the IBC mode and that a size of the current block is greater than the minimum IBC block size, further repeat motion information of the current block.

In some examples, to save, at the side of the decoder, the motion information in the memory, the processor 1620 may save the motion information at a granularity other than a minimum IBC block size. In some examples, the granularity is a configurable value or a value signaled in a bitstream, a first motion information of a first subblock of the granularity is from a first IBC block, a second motion information of a second subblock of the granularity is from a second IBC block, and the first information and the second information represents a same IBC model.

In some examples, the processor 1620 may further select the motion information from a plurality of sets of available motion information. In some examples, to select the motion information from a plurality of sets of available motion information, the processor 1620 may perform one of following acts: selecting the motion information at a fixed position; selecting the motion information at a configurable position; or calculating an average motion information of a plurality of models, and selecting the average information as the motion information.

In some examples, the processor 1620 may further simplify or compress the motion information. In some examples, to compress the motion information, the processor 1620 may compress each of the one or more translational BVs. In some examples, to compress each of the one or more translational BVs, the processor 1620 may save a compounded value from an exponent and a mantissa corresponding to the each of the one or more translational BVs.

In some examples, the one or more IBC candidates may include one or more temporal candidates. In some examples, the processor 1620 may further obtain the one or more temporal candidates from one of following areas: left area of the current block, above area of the current block, right area of the current block, below area of the current block, or collocated area of the current block.

FIG. 53 is a flowchart illustrating a method for video encoding corresponding to the method for video decoding as shown in FIG. 52.

In Step S310, the processor 1620, at the side of an encoder, may obtain one or more intra-block copy (IBC) candidates from a plurality of non-adjacent neighboring blocks, where the one or more IBC candidates are coded based on an IBC merge mode or an IBC Advanced Motion Vector Prediction (AMVP) mode, and where the plurality of non-adjacent neighboring blocks are distanced from a current block by at least one block.

In Step S320, the processor 1620 may obtain a prediction for the current block based on the one or more IBC candidates.

In Step S330, the processor 1620 may generate a bitstream based on the prediction.

In some examples, to obtain, at the side of the encoder, the one or more IBC candidates, the processor 1620 may obtain the one or more IBC candidates according to a scanning rule.

In some examples, to obtain the one or more IBC candidates according to a scanning rule, the processor 1620 may determine the scanning rule based on at least one scanning area, at least one scanning distance, and a scanning order.

In some examples, the at least one scanning distance indicates a number of blocks away from a side of the current block. In some examples, one of the plurality of non-adjacent neighboring blocks located at one of the at least one scanning distance has a same size as the current block. In some examples, one of the plurality of non-adjacent neighboring blocks located at one of the at least one scanning distance has a different size than the current block.

In some examples, the processor 1620 may further determine the at least one scanning area according to the at least one scanning distance. In some examples, the at least one scanning area comprises a first scanning area and a second scanning area, the first scanning area is determined according to a first scanning distance indicating a first maximum number of blocks away from a first side of the current block, and the second scanning area is determined according to a second scanning distance indicating a second maximum number of blocks away from a second side of the current block, and the first scanning distance is same as or different from the second scanning distance. In some examples, the processor 1620 may further signal the first scanning distance and the second scanning distance in a bitstream. In some examples, the processor 1620 may further predetermine the first scanning distance or the second scanning distance as a fixed value.

In some examples, the processor 1620 may further, at the side of the encoder and in response to determining that the first scanning distance or the second scanning distance equals to a fixed size, terminate scanning in the at least one scanning area in response to satisfying a condition of: a size of a candidate list including the one or more IBC candidates being the fixed size; or all non-adjacent neighboring blocks within the first scanning distance or the second scanning distance been scanned.

In some examples, the first scanning area includes a first starting neighboring block and a first ending neighboring block, and the second scanning area includes a second starting neighboring block and a second ending neighboring block; and the first scanning distance is greater than the second scanning distance.

In some examples, the first starting neighboring block is an adjacent bottom-left neighboring block of the second starting neighboring block; and the first ending neighboring block is an adjacent left neighboring block of the second ending neighboring block. In some examples, the first starting neighboring block is an adjacent top-right neighboring block of the second starting neighboring block; and the first ending neighboring block is an adjacent top-left neighboring block of the second ending neighboring block. In some examples, the first scanning distance is 2, and the second scanning distance is 1.

In some examples, the first scanning area comprises a first sampling interval, and the second scanning area comprises a second sampling interval; and a first length of the first sampling interval is bigger than a second length of the second sampling interval. In some examples, the first scanning distance is 2, the second scanning distance is 1, the first length of the first sampling interval is 2, and the second length of the second sampling interval is 1.

In some examples, the first scanning area is a left scanning area disposed to the left of the current block, and the second scanning area is a top scanning area disposed above the current block; and the first scanning distance is equal to the second scanning distance. In some examples, the first scanning area includes a first sampling interval, and the second scanning area includes a second sampling interval; and a first length of the first sampling interval is same as or different from a second length of the second sampling interval.

In some examples, the at least one scanning area comprises a left scanning area disposed to the left of the current block and a top scanning area disposed above the current block. In some examples, to determine the scanning rule based on the at least one scanning area, the at least one scanning distance, and the scanning order, the processor may, at the side of the encoder, scan the left scanning area before the top scanning area, or scan the left scanning area and the top scanning area alternatively.

In some examples, the left scanning area includes a first left scanning area, a second left scanning area, and a third left scanning area; the top scanning area includes a first top scanning area, a second top scanning area, and a third top scanning area; the first left scanning area and the first top scanning area correspond to a first scanning distance, the second left scanning area and the second top scanning area correspond to a second scanning distance, and the third left scanning area and the second top scanning area correspond to a third scanning distance; each of the at least one scanning distance indicates a number of blocks away from a side of the current block; the first scanning distance is smaller than the second scanning distance, and the second scanning distance is smaller than the third scanning distance; to scan the left scanning area before the top scanning area, the processor 1620 may perform in sequential order: scanning the first left scanning area; scanning the second top scanning area; scanning the third left scanning area; scanning the first top scanning area; scanning the second left scanning area; and scanning the third top scanning area; and to scan the left scanning area and the top scanning area alternatively, the processor 1602 may perform in sequential order: scanning the first left scanning area; scanning the first top scanning area; scanning the second left scanning area; scanning the second top scanning area; scanning the third left scanning area; and scanning the third top scanning area.

In some examples, the first scanning distance is 1, the second scanning distance is 2, and the third scanning distance is 3.

In some examples, the left scanning area includes a bottom neighboring block and a top neighboring block; the top scanning area includes a right neighboring block and a left neighboring block; and to determining the scanning rule based on the at least one scanning area, the at least one scanning distance, and the scanning order, the processor 1620 may, at the side of the encoder, scan from the bottom neighboring block to the top neighboring block and scan from the right neighboring block to the left neighboring block.

In some examples, to determine the scanning rule based on the at least one scanning area, the at least one scanning distance, and the scanning order, the processor 1620 may, at the side of the encoder and in response to determining that the first scanning distance is smaller than the second scanning distance, scan the first scanning area before scanning the second scanning area.

In some examples, to determine the scanning rule based on the at least one scanning area, the at least one scanning distance, and the scanning order, the processor 1620 may, at the side of the encoder, within each of the at least one scanning area corresponding to each of the at least one scanning distance, scanning a plurality of blocks according to an order of a plurality of degree values; where the plurality of degree values correspond to a plurality of directions, and the at least one scanning distance comprises at least four distances.

In some examples, the at least four distances comprise 2, 3, 4, and 5. In some examples, the order of the plurality of degree values comprises: 225, 45, 90, 180, and 135; and a total of at least 18 blocks are scanned. In some examples, the order of the plurality of degree values comprises: 225, 45, 90, 180, 135, 270, 0, 247.5, 22.5, 202.5, 67.5, 157.5, and 112.5; and a total of at least 48 blocks are scanned.

In some examples, to obtain the one or more IBC candidates according to the scanning rule, the processor 1620 may, at the side of the encoder, in response to a quantity of one or more qualified candidates being identified, terminate a scanning process; and set the one or more IBC candidates as the one or more qualified candidates, where the one or more qualified candidates are coded in one of the IBC mode or intra template matching prediction (TMP) mode.

In some examples, the at least one scanning area includes a left scanning area, the at least one scanning distance includes 1; where the quantify of the one or more qualified candidates is a predefined positive value; and to obtain the one or more IBC candidates according to the scanning rule, the processor 1620 may, at the side of the encoder, further scan a scanning area other than the left scanning area according to a predefined scanning rule.

In some examples, the processor 1620 may further: for each of the at least one scanning distance, set the quantity of the one or more qualified candidates to be a same integer; or in response to determining that the at least one scanning distance includes a first scanning distance and a second scanning distance and the first scanning distance is different from the second scanning distance, set a first quantity of the one or more qualified candidates corresponding to the first scanning distance and a second quantity of the one or more qualified candidates corresponding to the second scanning distance; where the processor 1620 may, in response to determining that a maximum quantity of the one or more qualified candidates have been identified, further terminate the scanning process. In some examples, the maximum quantity is 3.

In some examples, the at least one scanning area includes a left scanning area, and the at least one scanning distance further includes a third scanning distance; where the processor 1620 may further set a third quantity of the one or more qualified candidates corresponding to the third scanning distance; and where the first quantity, the second quantity, and the third quantity all equal to 1.

In some examples, to obtain the one or more IBC candidates according to the scanning rule, the processor 1620 may further locate at least one non-adjacent candidate block by a specific scanning position. In some examples, the specific scanning position is a bottom-right position.

In some examples, to obtain the one or more IBC candidates according to the scanning rule, the processor 1620 may further obtain, at the side of the encoder, a first IBC candidate and a second IBC candidate; perform a similarity check between the first IBC candidate and the second IBC candidate; and in response to determining that the first IBC candidate is similar to the second IBC candidate, prune one of the first IBC candidate and the second IBC candidate.

In some examples, to determine the scanning rule based on the at least one scanning area, the at least one scanning distance, and the scanning order, the processor 1620 may, at the side of the encoder and within each of the at least one scanning area corresponding to each of the at least one scanning distance, scan a plurality of blocks according to an order of a plurality of degree values; where the plurality of degree values correspond to a plurality of directions, the at least one scanning distance comprises 2, 3, 4, and 5, and the processor 1620 may, in response to determining the one or more IBC candidates are coded based on the IBC AMVP mode, further set the order of the plurality of degree values to comprise 225, 45, 90, 180, and 135, and scanning a total of at least 18 blocks; or in response to determining the one or more IBC candidates are coded based on the IBC merge mode, further set the order of the plurality of degree values to comprise 225, 45, 90, 180, 135, 270, 0, 247.5, 22.5, 202.5, 67.5, 157.5, and 112.5, and scanning a total of at least 48 blocks.

In some examples, the processor 1620 may further obtain, at the side of the encoder, a group of non-adjacent spatial candidates, or a first subgroup of non-adjacent spatial candidates and a second subgroup of non-adjacent spatial candidates; obtain a first position of an IBC candidate list and a second position of the IBC candidate list; and perform: inserting the group of non-adjacent spatial candidates to the first position and the second position; or inserting the first subgroup of non-adjacent spatial candidates to the first position, and the second subgroup of non-adjacent spatial candidates to the second position; where to obtain the one or more IBC candidates according to the scanning rule, the processor 1620 may set the one or more IBC candidates as IBC candidates in the IBC candidate list.

In some examples, to insert the first subgroup of non-adjacent spatial candidates to the first position, and the second subgroup of non-adjacent spatial candidates to the second position, the processor 1620 may, at the side of the encoder, perform one of following acts: inserting non-adjacent spatial candidates in a first order as follows: spatial block vector prediction (BVP) from adjacent spatial neighbors; spatial BVP from non-adjacent spatial neighbors; history-based BVP from an FIFO table; pairwise average BVP; BVP candidates located in an IBC reference region; and zero BVP; or obtaining a first quantify of the spatial BVP from the non-adjacent spatial neighbors and a second quantity of the spatial BVP from the non-adjacent spatial neighbors, then inserting, by the encoder, the non-adjacent spatial candidates in a second order as follows: the spatial block vector prediction (BVP) from the adjacent spatial neighbors; the first quantity of the spatial BVP from the non-adjacent spatial neighbors; the history-based BVP from the FIFO table; the second quantity of the spatial BVP from the non-adjacent spatial neighbors; the pairwise average BVP; the BVP candidates located in the IBC reference region; and the zero BVP.

In some examples, the processor 1620 may, at the side of the encoder, further determine the first quantity and the second quantity by at least one of: setting the first quantity as a first predefined value and the second quantity as a second predefined value; signaling the first quantity and the second quantity in a bitstream; or dynamically determining the first quantity and the second quantity according to a number of available neighbors on a left side or an above side of the current block. In some examples, the processor 1620 may, at the side of the encoder, further dynamically reorder the IBC candidate list according to a template matching based method. In some examples, the template matching based method may include Adaptive Reordering of Merge Candidates (ARMC).

In some examples, the processor 1620 may further select the inserting order according to a type of video frames or a type of video slices. In some examples, the inserting order refers to an order in which the processor 1620 may, at the side of the encoder, insert at least one group of non-adjacent spatial candidates into different positions of the IBC candidate list. In some examples, the at least one group of non-adjacent spatial candidates may include the first subgroup of non-adjacent spatial candidates and the second subgroup of non-adjacent spatial candidates. In some examples, to select the inserting order according to a type of video frames or a type of video slices, the processor 1620 may, at the side of the encoder, perform one of following acts: in response to determining that the type of video frames or the type of video slices is low-delay, inserting the non-adjacent spatial candidates in the first order; or in response to determining that the type of video frames or the type of video slices is non-low-delay, inserting the non-adjacent spatial candidates in the second order.

In some examples, the processor 1620 may, at the side of the encoder, further select the inserting order according to a coding mode of the one or more IBC candidates. In some examples, the inserting order refers to an order in which the processor 1620 may, at the side of the encoder, insert at least one group of non-adjacent spatial candidates into different positions of the IBC candidate list. In some examples, the at least one group of non-adjacent spatial candidates may include the first subgroup of non-adjacent spatial candidates and the second subgroup of non-adjacent spatial candidates. In some examples, to select the inserting order according to a coding mode of the one or more IBC candidates, the processor 1620 may, at the side of the encoder, perform one of following acts: in response to determining that the coding mode of the one or more IBC candidates is the IBC AMVP mode, inserting the non-adjacent spatial candidates in the first order; or in response to determining that the coding mode of the one or more IBC candidates is the IBC merge mode, inserting the non-adjacent spatial candidates in the second order.

In some examples, the processor 1620 may, at the side of the encoder, further scan one or more non-adjacent spatial neighbors, where the non-adjacent spatial neighbors are coded in one of the IBC mode or intra Template Mapping Prediction (TMP) mode, and motion information of the non-adjacent spatial neighbors includes one or more translational block vectors (BVs); and to obtain the one or more IBC candidates according to the scanning rule, the processor 1620 may obtain the one or more IBC candidates based on a result of scanning of the one or more non-adjacent spatial neighbors.

In some examples, the processor 1620 may, at the side of the encoder, further save the motion information in a memory, after the one or more non-adjacent spatial neighbors are coded. In some examples, the processor 1620 may, at the side of the encoder, restrict the one or more non-adjacent spatial neighbors to an allowed area. In some examples, the processor 1620 may, at the side of the encoder, further determine a size limit. In some examples, the allowed area is determined according to the size limit. In some examples, to determine the size limit, the processor 1620 may determine the size limit according to one of following quantities: a size of a current coding tree unit (CTU); a fixed number of pixels; or a fixed number of samples. In some examples, to determine the size limit, the processor 1620 may perform one of following acts: setting the size limit as a prefixed value; or signaling the size limit in a bitstream.

In some examples, to determine the size limit, the processor 1620 may determine a first size limit for top non-adjacent spatial neighbors, and determine a second size limit for left non-adjacent spatial neighbors; and to determine the allowed area according to the size limit, the processor 1620 may determine a first allowed area for the top non-adjacent spatial neighbors according to the first size limit, and determine a second allowed area for the left non-adjacent spatial neighbors according to the second size limit.

In some examples, the first allowed area includes one of following areas: a current coding tree unit (CTU), or outside the current CTU and within a fixed number of samples or pixels away from a top side of the current CTU. In some examples, the the second allowed area includes one of following areas: a current coding tree unit (CTU), or outside the current CTU and within a fixed number of samples or pixels away from a left side of the current CTU; where the fixed number includes one of following numbers: a predefined number of the samples or the pixels, or a number of the samples or the pixels signaled in a bitstream.

In some examples, the fixed number of the samples or the pixels away from the top side of the current CTU is configurable or signaled in a bitstream; and to save, at the side of the encoder, the motion information in the memory, the processor 1620 may save a first motion in a first buffer, and saving a second motion in a second buffer, where the first motion corresponds to the non-adjacent spatial neighbors coded in the IBC mode, and where the second motion corresponds to the non-adjacent spatial neighbors coded in the TMP mode.

In some examples, the first buffer indicates at least one of following properties: an invalidity of a first coding unit (CU); or a validity of the first CU, and that the first motion is copied from a second CU, where the second CU is an adjacent IBC neighbor of the first CU. In some examples, the fixed number is a multiple of 4.

In some examples, in response to determining that a first position of a scanned non-adjacent spatial neighbor is out of the allowed area, the processor 1620 may, at the side of the encoder, further perform one of following steps: indicating that the scanned non-adjacent spatial neighbor has no valid neighbor information; or projecting or clipping the first position to a second position, wherein the second position is within the allowed area. In some examples, the second position is within one of a left boundary or a top boundary of the allowed area, where a first distance from the one of the left boundary or the top boundary to the first position is smaller than a second distance from the other of the left boundary or the top boundary to the first position. In some examples, the allowed area comprises a first allowed region, a second allowed region, and a third allowed region; a first height of the first allowed region and a second height of the second allowed region are equal to a height of a current coding tree unit (CTU); the first region is located on a top-left area out of the current CTU, the second region is located on a top area out of the current CTU, and the third region is located on a left area of the current CTU; and the second position comprises one of following positions: a pixel position adjacent to a top-left position of the current CTU; a pixel position adjacent to a top position of the current CTU; or a pixel position adjacent to a left position of the current CTU.

In some examples, to save, at the side of the encoder, the motion information in the memory, the processor 1620 may save the motion information at a granularity of a minimum IBC block size. In some examples, the processor 1620 may, in response to determining that the current block is coded in the IBC mode and that a size of the current block is greater than the minimum IBC block size, further repeat motion information of the current block.

In some examples, to save, at the side of the encoder, the motion information in the memory, the processor 1620 may save the motion information at a granularity other than a minimum IBC block size. In some examples, the granularity is a configurable value or a value signaled in a bitstream, a first motion information of a first subblock of the granularity is from a first IBC block, a second motion information of a second subblock of the granularity is from a second IBC block, and the first information and the second information represents a same IBC model.

In some examples, the processor 1620 may further select the motion information from a plurality of sets of available motion information. In some examples, to select the motion information from a plurality of sets of available motion information, the processor 1620 may perform one of following acts: selecting the motion information at a fixed position; selecting the motion information at a configurable position; or calculating an average motion information of a plurality of models, and selecting the average information as the motion information.

In some examples, the processor 1620 may further simplify or compress the motion information. In some examples, to compress the motion information, the processor 1620 may compress each of the one or more translational BVs. In some examples, to compress each of the one or more translational BVs, the processor 1620 may save a compounded value from an exponent and a mantissa corresponding to the each of the one or more translational BVs.

In some examples, the one or more IBC candidates may include one or more temporal candidates. In some examples, the processor 1620 may further obtain the one or more temporal candidates from one of following areas: left area of the current block, above area of the current block, right area of the current block, below area of the current block, or collocated area of the current block.

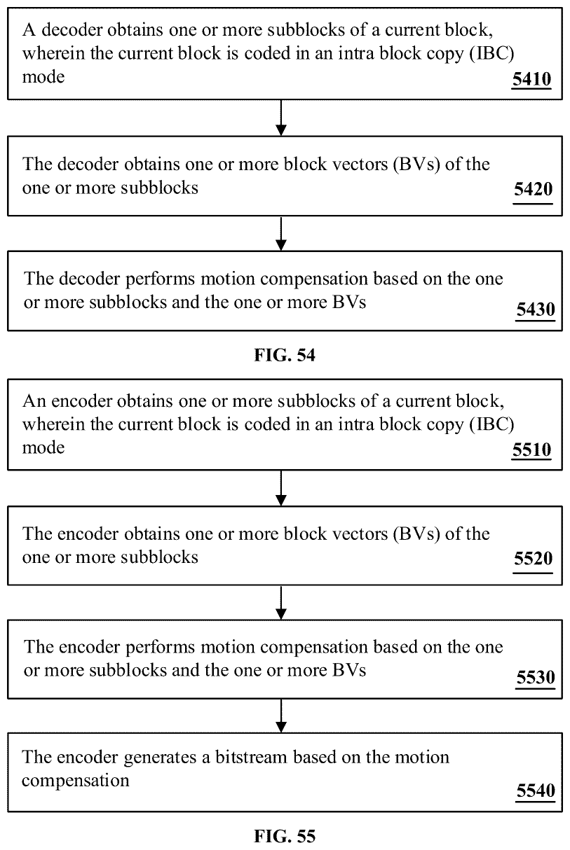

FIG. 54 is a flowchart illustrating a method for video decoding according to an example of the present disclosure.

In Step S410, the processor 1620 may, at the side of a decoder, obtain one or more subblocks of a current block, wherein the current block is coded in an intra block copy (IBC) mode.

In Step S420, the processor 1620 may obtain one or more block vectors (BVs) of the one or more subblocks.

In Step S430, the processor 1620 may perform motion compensation based on the one or more subblocks and the one or more BVs.

In some examples, to obtain the one or more BVs of the one or more subblocks, the processor 1620 may, at the side of the decoder, obtain, in a collocated picture, a collocated block of the current block, and one or more subblocks of the collocated block; in response to determining that one of the BVs of the one or more subblocks of the collocated block is unavailable, set the one of the BVs of the one or more subblocks of the current block as a BV of the collocated block; and in response to determining that the BVs of the one or more subblocks of the collocated block are available, set the BVs of the one or more subblocks of the current block as corresponding BVs of the one or more subblocks of the collocated block. In some examples, the one or more BVs of the one or more subblocks includes: a first BV of a left subblock of the current block, a second BV of a top subblock of the current block, and a third BV of a top-left subblock of the current block. In some examples, the processor 1620 may further obtain the first BV based on a left template, obtain the second BV based on a top template; and obtain the third BV based on one of the left template or the top template.

FIG. 55 is a flowchart illustrating a method for video encoding corresponding to the method for video decoding as shown in FIG. 54.

In Step S510, the processor 1620 may, at the side of an encoder, obtain one or more subblocks of a current block, wherein the current block is coded in an intra block copy (IBC) mode.

In Step S520, the processor 1620 may obtain one or more block vectors (BVs) of the one or more subblocks.

In Step S530, the processor 1620 may perform motion compensation based on the one or more subblocks and the one or more BVs.

In Step S540, the processor 1620 may generate a bitstream based on the motion compensation.

In some examples, to obtain the one or more BVs of the one or more subblocks, the processor 1620 may, at the side of the encoder, obtain, in a collocated picture, a collocated block of the current block, and one or more subblocks of the collocated block; in response to determining that one of the BVs of the one or more subblocks of the collocated block is unavailable, set the one of the BVs of the one or more subblocks of the current block as a BV of the collocated block; and in response to determining that the BVs of the one or more subblocks of the collocated block are available, set the BVs of the one or more subblocks of the current block as corresponding BVs of the one or more subblocks of the collocated block. In some examples, the one or more BVs of the one or more subblocks includes: a first BV of a left subblock of the current block, a second BV of a top subblock of the current block, and a third BV of a top-left subblock of the current block. In some examples, the processor 1620 may further obtain the first BV based on a left template, obtain the second BV based on a top template; and obtain the third BV based on one of the left template or the top template.

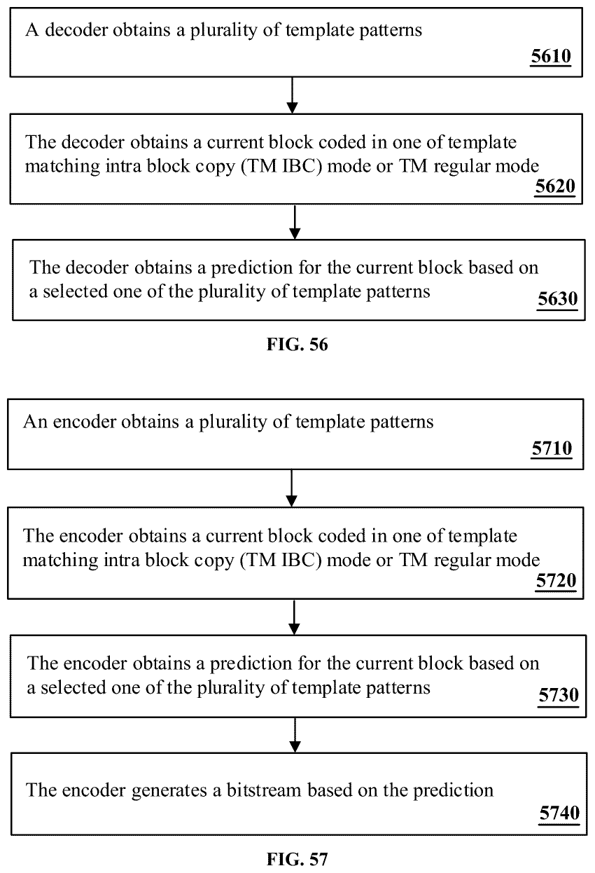

FIG. 56 is a flowchart illustrating a method for video decoding according to an example of the present disclosure.

In Step S610, the processor 1620 may, at the side of a decoder, obtain a plurality of template patterns.

In Step S620, the processor may obtain a current block coded in one of template matching intra block copy (TM IBC) mode or TM regular mode.

In Step S630, the processor 1620 may obtain a prediction for the current block based on a selected one of the plurality of template patterns.

In some examples, the plurality of template patterns may include: both above and left templates, left templates only, or above templates only. In some examples, the processor 1620 may determine the selected one of the plurality of template patterns based on a predefined criteria, or a flag signaled in a bitstream. In some examples, the flag is configured to indicate the selected one of the plurality of template patterns.

FIG. 57 is a flowchart illustrating a method for video encoding corresponding to the method for video decoding as shown in FIG. 56.

In Step S710, the processor 1620 may, at the side of an encoder, obtain a plurality of template patterns. In some examples, the plurality of template patterns may include: both above and left templates, left templates only, or above templates only.

In Step S720, the processor may obtain a current block coded in one of template matching intra block copy (TM IBC) mode or TM regular mode.

In Step S730, the processor 1620 may obtain a prediction for the current block based on a selected one of the plurality of template patterns.

In Step S740, the processor 1620 may generate a bitstream based on the prediction.

In some examples, the plurality of template patterns may include: both above and left templates, left templates only, or above templates only. In some examples, the processor 1620 may determine a selected one of the plurality of template patterns based on a predefined criteria, or signal a flag in a bitstream; in some examples, the flag is configured to indicate the selected one of the plurality of template patterns.

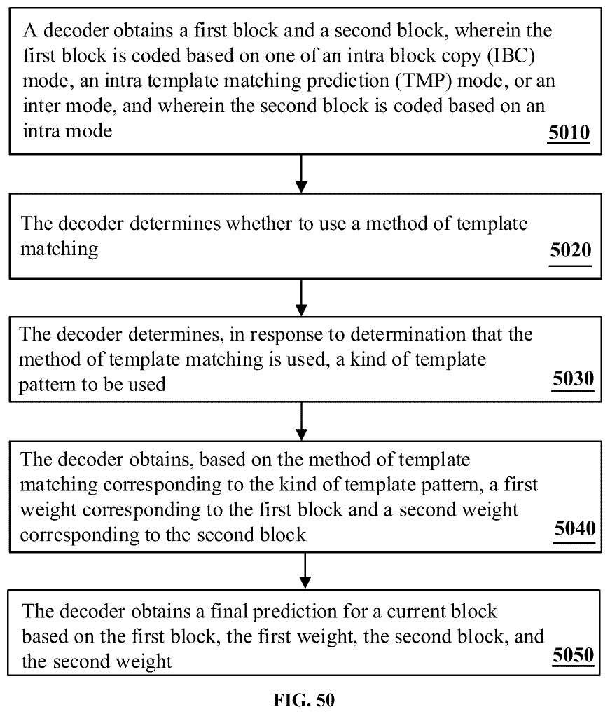

FIG. 50 is a flowchart illustrating a method for video decoding according to an example of the present disclosure.

In Step S010, the processor 1620, at the side of a decoder, may obtain a first block and a second block, where the first block is coded based on one of an intra block copy (IBC) mode, an intra template matching prediction (TMP) mode, or an inter mode, and where the second block is coded based on an intra mode.

In Step S020, the processor 1620 may determine whether to use a method of template matching.

In Step S030, the processor 1620 may, in response to determination that the method of template matching is used, determine a kind of template pattern to be used. In some examples, the kind of template pattern may be one of both above and left templates, left templates only, or above templates only.

In Step S040, the processor 1620 may, based on the method of template matching corresponding to the kind of template pattern, obtain a first weight corresponding to the first block and a second weight corresponding to the second block.

In Step S050, the processor 1620 may obtain a final prediction for a current block based on the first block, the first weight, the second block, and the second weight.

In some examples, in Step S020, the processor 1620 may, at the side of the decoder, receive a flag indicating whether to use the method of template matching, wherein the flag is signaled in a bitstream; or determine, based on a predefined criteria, whether to use the method of template matching. In Some examples, in Step S030, the processor 1620 may, at the side of the decoder, receive an index indicating the kind of template pattern to be used, wherein the index is signaled in the bitstream; or determine, based on the predefined criteria, the kind of template pattern to be used. In some examples, the method of template matching is used to obtain the first weight and the second weight in response to determination that an intra mode of the current block is a planar mode or a direct current (DC) mode.

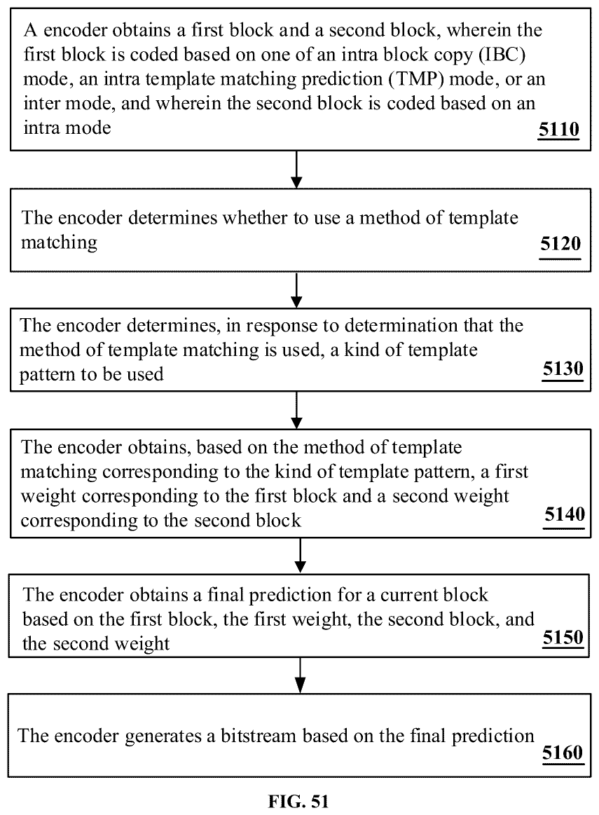

FIG. 51 is a flowchart illustrating a method for video encoding corresponding to the method for video decoding as shown in FIG. 50.

In Step S110, the processor 1620, at the side of an encoder, may obtain a first block and a second block, where the first block is coded based on one of an intra block copy (IBC) mode, an intra template matching prediction (TMP) mode, or an inter mode, and where the second block is coded based on an intra mode.

In Step S120, the processor 1620 may determine whether to use a method of template matching.

In Step S130, the processor 1620 may, in response to determination that the method of template matching is used, determine a kind of template pattern to be used. In some examples, the kind of template pattern may be one of both above and left templates, left templates only, or above templates only.

In Step S140, the processor 1620 may, based on the method of template matching corresponding to the kind of template pattern, obtain a first weight corresponding to the first block and a second weight corresponding to the second block.

In Step S150, the processor 1620 may obtain a final prediction for a current block based on the first block, the first weight, the second block, and the second weight.

In Step S160, the processor 1620 may generate a bitstream based on the final prediction.

In some examples, in Step S120, the processor 1620 may, at the side of the encoder, signal, in a bitstream, a flag indicating whether to use the method of template matching; or determine, based on a predefined criteria, whether to use the method of template matching. In Some examples, in Step S130, the processor 1620 may, at the side of the encoder, signal, in the bitstream, an index indicating the kind of template pattern to be used; or determine, based on the predefined criteria, the kind of template pattern to be used. In some examples, the method of template matching is used to obtain the first weight and the second weight in response to determination that an intra mode of the current block is a planar mode or a direct current (DC) mode, use the method of template matching to obtain the first weight and the second weight.

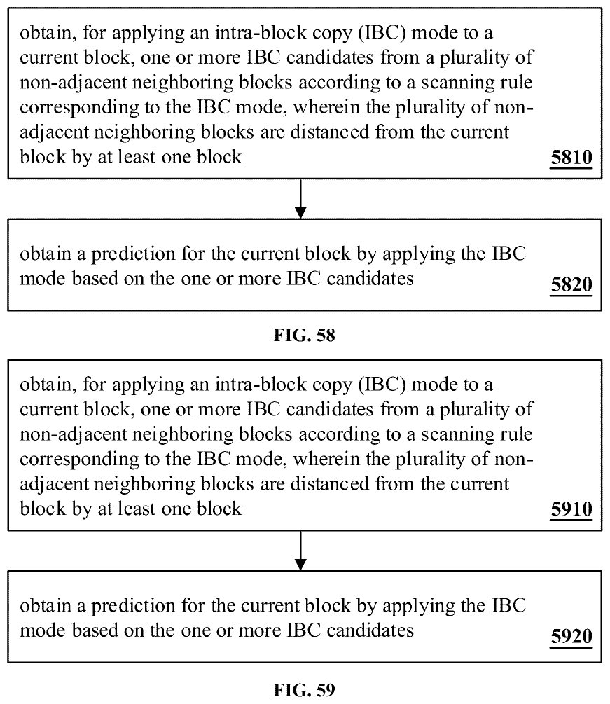

FIG. 58 is a flowchart illustrating a method for video decoding according to an example of the present disclosure.

In Step S810, the processor 1620 may, at the side of a decoder, obtain, for applying an intra-block copy (IBC) mode to a current block, one or more IBC candidates from a plurality of non-adjacent neighboring blocks according to a scanning rule corresponding to the IBC mode, wherein the plurality of non-adjacent neighboring blocks are distanced from the current block by at least one block.

In Step S820, the processor 1620 may, at the side of the decoder, obtain a prediction for the current block by applying the IBC mode based on the one or more IBC candidates.

In one or more examples, the scanning rule includes: determining at least one scanning area according to a max scanning distance indicating a maximum number of blocks away from a side of the current block; and determining a scanning position in a scanning area according to a direction of the scanning area relative to the current block.

In one or more examples, the method further includes determining, by the decoder, the max scanning distance as 4 blocks away from a left side or an above side of the current block; or determining, by the decoder, the max scanning distance as 7 blocks away from a left side or an above side of the current block.

In one or more examples, determining the max scanning distance as 7 blocks away from a left side or an above side of the current block includes: in response to determining to apply an IBC merge mode to the current block, determining the max scanning distance as 7 blocks away from a left side or an above side of the current block.

In one or more examples, determining the max scanning distance as 4 blocks away from a left side or an above side of the current block includes: in response to determining to apply an IBC Adaptive Motion Vector Prediction (AMVP) mode to the current block, determining the max scanning distance as 4 blocks away from a left side or an above side of the current block.

In one or more examples, determining the scanning position in the scanning area according to the direction of the scanning area relative to the current block includes: in response to determining that the scanning area is located along a bottom left, above right, or above left direction relative to the current block, determining the scanning position as a bottom-right scanning position in the scanning area; in response to determining that the scanning area is located along an above direction relative to the current block, determining the scanning position as a bottom-middle scanning position in the scanning area; or in response to determining that the scanning area is located along a left direction relative to the current block, determining the scanning position as a middle-right scanning position in the scanning area.

In one or more examples, the scanning rule further includes: terminating scanning in the at least one scanning area in response to satisfying a condition that: a list size of a candidate list including the one or more IBC candidates has reached a fixed size; or all non-adjacent neighboring blocks within the max scanning distance have been scanned.

FIG. 59 is a flowchart illustrating a method for video encoding corresponding to the method for video decoding as shown in FIG. 58.

In Step S910, the processor 1620 may, at the side of an encoder, obtain, for applying an intra-block copy (IBC) mode to a current block, one or more IBC candidates from a plurality of non-adjacent neighboring blocks according to a scanning rule corresponding to the IBC mode, wherein the plurality of non-adjacent neighboring blocks are distanced from the current block by at least one block.

In Step S920, the processor 1620 may, at the side of the encoder, obtain a prediction for the current block by applying the IBC mode based on the one or more IBC candidates.

In one or more examples, the scanning rule includes: determining at least one scanning area according to a max scanning distance indicating a maximum number of blocks away from a side of the current block; and determining a scanning position in a scanning area according to a direction of the scanning area relative to the current block.

In one or more examples, the method further includes determining, by the encoder, the max scanning distance as 4 blocks away from a left side or an above side of the current block; or determining, by the encoder, the max scanning distance as 7 blocks away from a left side or an above side of the current block.

In one or more examples, determining the max scanning distance as 7 blocks away from a left side or an above side of the current block includes: in response to determining to apply an IBC merge mode to the current block, determining the max scanning distance as 7 blocks away from a left side or an above side of the current block.

In one or more examples, determining the max scanning distance as 4 blocks away from a left side or an above side of the current block includes: in response to determining to apply an IBC Adaptive Motion Vector Prediction (AMVP) mode to the current block, determining the max scanning distance as 4 blocks away from a left side or an above side of the current block.

In one or more examples, determining the scanning position in the scanning area according to the direction of the scanning area relative to the current block includes: in response to determining that the scanning area is located along a bottom left, above right, or above left direction relative to the current block, determining the scanning position as a bottom-right scanning position in the scanning area; in response to determining that the scanning area is located along an above direction relative to the current block, determining the scanning position as a bottom-middle scanning position in the scanning area; or in response to determining that the scanning area is located along a left direction relative to the current block, determining the scanning position as a middle-right scanning position in the scanning area.

In one or more examples, the scanning rule further includes: terminating scanning in the at least one scanning area in response to satisfying a condition that: a list size of a candidate list including the one or more IBC candidates has reached a fixed size; or all non-adjacent neighboring blocks within the max scanning distance have been scanned.

FIG. 60 is a flowchart illustrating a method for video decoding according to an example of the present disclosure.

In Step 6010, the processor 1620 may, at the side of a decoder, obtain, for applying an intra-block copy (IBC) mode to a current block, one or more IBC candidates from a plurality of neighboring blocks according to a size of the current block.

In Step 6020, the processor 1620 may, at the side of the decoder, obtain a prediction for the current block by applying the IBC mode based on the one or more IBC candidates.

In one or more examples, obtaining the one or more IBC candidates from the plurality of neighboring blocks according to the size of the current block includes: in response to determining that the size of the current block is greater than a predefined size, obtaining the one or more IBC candidates by scanning a plurality of non-adjacent neighboring blocks and a plurality of adjacent blocks; in response to determining the size of the current block as any size, obtaining the one or more IBC candidates by at least scanning a plurality of non-adjacent neighboring blocks or a plurality of adjacent blocks; in response to determining that the size of the current block is greater than a predefined size, obtaining the one or more IBC candidates by scanning a plurality of adjacent blocks; or in response to determining that the size of the current block is greater than a predefined size, obtaining the one or more IBC candidates by scanning a plurality of non-adjacent blocks, wherein the plurality of non-adjacent neighboring blocks are distanced from the current block by at least one block.

In one or more examples, the plurality of non-adjacent neighboring blocks are configured to be scanned by the decoder according to a scanning rule corresponding to the IBC mode.

In one or more examples, the scanning rule includes: determining, by the decoder, at least one scanning area according to a max scanning distance indicating a maximum number of blocks away from a side of the current block; and determining, by the decoder, a scanning position in a scanning area according to a direction of the scanning area relative to the current block.

In one or more examples, the method further includes determining, by the decoder, the max scanning distance as 4 blocks away from a left side or an above side of the current block; or determining, by the decoder, the max scanning distance as 7 blocks away from a left side or an above side of the current block.

In one or more examples, determining the max scanning distance as 7 blocks away from a left side or an above side of the current block includes: in response to determining to apply an IBC merge mode to the current block, determining the max scanning distance as 7 blocks away from a left side or an above side of the current block.

In one or more examples, determining the max scanning distance as 4 blocks away from a left side or an above side of the current block includes: in response to determining to apply an IBC AMVP mode to the current block, determining the max scanning distance as 4 blocks away from a left side or an above side of the current block.

In one or more examples, determining the scanning position in the scanning area according to the direction of the scanning area relative to the current block includes: in response to determining that the scanning area is located along a bottom left, above right, or above left direction relative to the current block, determining the scanning position as a bottom-right scanning position in the scanning area; in response to determining that the scanning area is located along an above direction relative to the current block, determining the scanning position as a bottom-middle scanning position in the scanning area; or in response to determining that the scanning area is located along a left direction relative to the current block, determining the scanning position as a middle-right scanning position in the scanning area.

In one or more examples, the scanning rule further includes: terminating scanning in the at least one scanning area in response to satisfying a condition that: a list size of a candidate list including the one or more IBC candidates has reached a fixed size; or all non-adjacent neighboring blocks within the max scanning distance have been scanned.

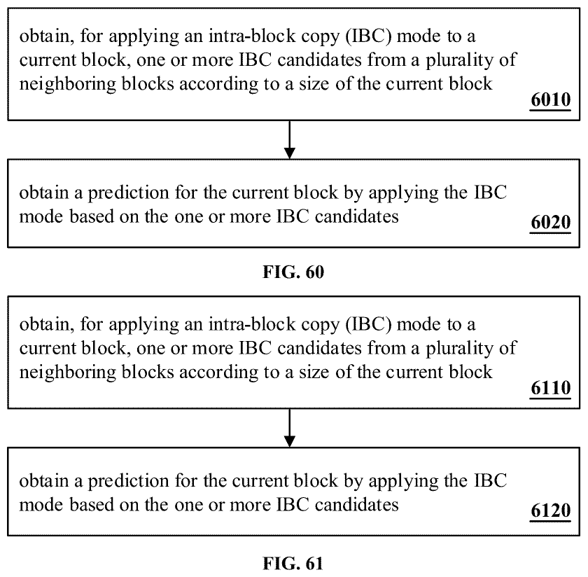

FIG. 61 is a flowchart illustrating a method for video encoding corresponding to the method for video decoding as shown in FIG. 60.

In Step 6110, the processor 1620 may, at the side of an encoder, obtain, for applying an intra-block copy (IBC) mode to a current block, one or more IBC candidates from a plurality of neighboring blocks according to a size of the current block.

In Step 6120, the processor 1620 may, at the side of the encoder, obtain a prediction for the current block by applying the IBC mode based on the one or more IBC candidates.

In one or more examples, obtaining the one or more IBC candidates from the plurality of neighboring blocks according to the size of the current block includes: in response to determining that the size of the current block is greater than a predefined size, obtaining the one or more IBC candidates by scanning a plurality of non-adjacent neighboring blocks and a plurality of adjacent blocks; in response to determining the size of the current block as any size, obtaining the one or more IBC candidates by at least scanning a plurality of non-adjacent neighboring blocks or a plurality of adjacent blocks; in response to determining that the size of the current block is greater than a predefined size, obtaining the one or more IBC candidates by scanning a plurality of adjacent blocks; or in response to determining that the size of the current block is greater than a predefined size, obtaining the one or more IBC candidates by scanning a plurality of non-adjacent blocks, wherein the plurality of non-adjacent neighboring blocks are distanced from the current block by at least one block.

In one or more examples, the plurality of non-adjacent neighboring blocks are configured to be scanned by the encoder according to a scanning rule corresponding to the IBC mode.

In one or more examples, the scanning rule includes: determining, by the encoder, at least one scanning area according to a max scanning distance indicating a maximum number of blocks away from a side of the current block; and determining, by the encoder, a scanning position in a scanning area according to a direction of the scanning area relative to the current block.

In one or more examples, the method further includes determining, by the encoder, the max scanning distance as 4 blocks away from a left side or an above side of the current block; or determining, by the encoder, the max scanning distance as 7 blocks away from a left side or an above side of the current block.

In one or more examples, determining the max scanning distance as 7 blocks away from a left side or an above side of the current block includes: in response to determining to apply an IBC merge mode to the current block, determining the max scanning distance as 7 blocks away from a left side or an above side of the current block.

In one or more examples, determining the max scanning distance as 4 blocks away from a left side or an above side of the current block includes: in response to determining to apply an IBC AMVP mode to the current block, determining the max scanning distance as 4 blocks away from a left side or an above side of the current block.

In one or more examples, determining the scanning position in the scanning area according to the direction of the scanning area relative to the current block includes: in response to determining that the scanning area is located along a bottom left, above right, or above left direction relative to the current block, determining the scanning position as a bottom-right scanning position in the scanning area; in response to determining that the scanning area is located along an above direction relative to the current block, determining the scanning position as a bottom-middle scanning position in the scanning area; or in response to determining that the scanning area is located along a left direction relative to the current block, determining the scanning position as a middle-right scanning position in the scanning area.

In one or more examples, the scanning rule further includes: terminating scanning in the at least one scanning area in response to satisfying a condition that: a list size of a candidate list including the one or more IBC candidates has reached a fixed size; or all non-adjacent neighboring blocks within the max scanning distance have been scanned.

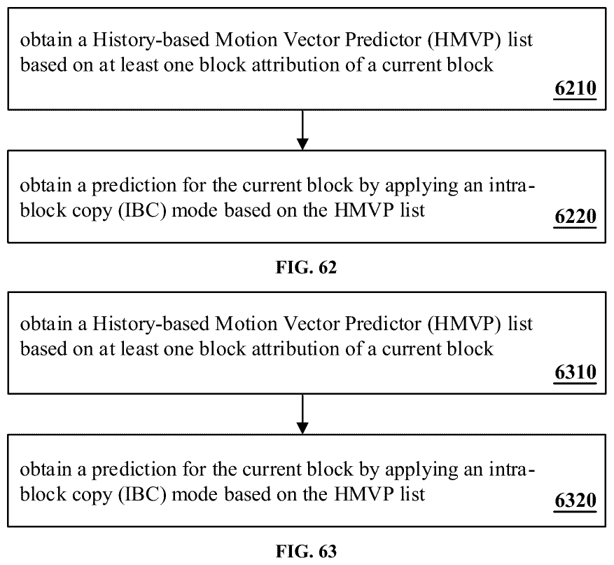

FIG. 62 is a flowchart illustrating a method for video decoding according to an example of the present disclosure.

In Step 6210, the processor 1620 may, at the side of a decoder, obtain a History-based Motion Vector Predictor (HMVP) list based on at least one block attribution of a current block.

In Step 6220, the processor 1620 may, at the side of the decoder, obtain a prediction for the current block by applying an intra-block copy (IBC) mode based on the HMVP list.

In one or more examples, the at least one block attribution includes any one or any combination of: a block location, a block size, or a picture area of the current block.

In one or more examples, obtaining the HMVP list based on the at least one block attribution of the current block includes: obtaining different HMVP lists for different coding tree blocks having different block locations or located in different picture areas.

In one or more examples, the different HMVP lists have a same list size or different list sizes.

In one or more examples, the HMVP list includes any one or any combination of: a block decoded with an IBC mode; a block decoded with an intra template matching prediction (TMP) mode; or a block decoded with a block size larger than a predefined size.

FIG. 63 is a flowchart illustrating a method for video encoding corresponding to the method for video decoding as shown in FIG. 62.

In Step 6310, the processor 1620 may, at the side of an encoder, obtain a History-based Motion Vector Predictor (HMVP) list based on at least one block attribution of a current block.

In Step 6320, the processor 1620 may, at the side of the encoder, obtain a prediction for the current block by applying an intra-block copy (IBC) mode based on the HMVP list.

In one or more examples, the at least one block attribution includes any one or any combination of: a block location, a block size, or a picture area of the current block.

In one or more examples, obtaining the HMVP list based on the at least one block attribution of the current block includes: obtaining different HMVP lists for different coding tree blocks having different block locations or located in different picture areas.

In one or more examples, the different HMVP lists have a same list size or different list sizes.

In one or more examples, the HMVP list includes any one or any combination of: a block encoded with an IBC mode; a block encoded with an intra template matching prediction (TMP) mode; or a block encoded with a block size larger than a predefined size.

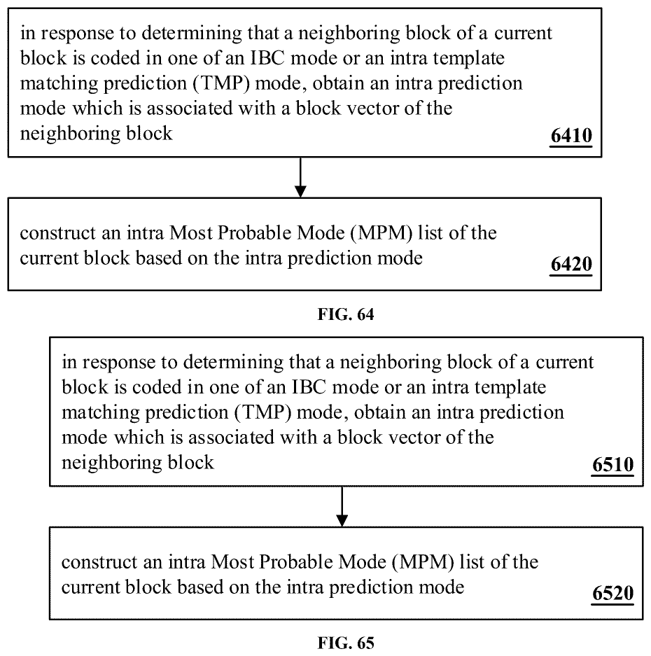

FIG. 64 is a flowchart illustrating a method for video decoding according to an example of the present disclosure.

In Step 6410, the processor 1620 may, at the side of a decoder, in response to determining that a neighboring block of a current block is coded in one of an IBC mode or an intra template matching prediction (TMP) mode, obtain an intra prediction mode which is associated with a block vector of the neighboring block.

In Step 6420, the processor 1620 may, at the side of the decoder, construct an intra Most Probable Mode (MPM) list of the current block based on the intra prediction mode.

FIG. 65 is a flowchart illustrating a method for video encoding corresponding to the method for video decoding as shown in FIG. 64.

In Step 6510, the processor 1620 may, at the side of an encoder, in response to determining that a neighboring block of a current block is coded in one of an IBC mode or an intra template matching prediction (TMP) mode, obtain an intra prediction mode which is associated with a block vector of the neighboring block.

In Step 6520, the processor 1620 may, at the side of the encoder, construct an intra Most Probable Mode (MPM) list of the current block based on the intra prediction mode.

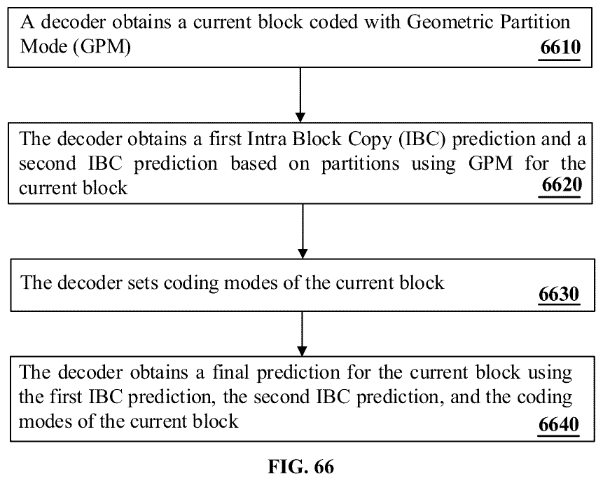

FIG. 66 is a flowchart illustrating a method for video decoding according to an example of the present disclosure.

In Step 6610, the processor 1620 may, at the side of a decoder, obtain a current block coded with Geometric Partition Mode (GPM).

In Step 6620, the processor 1620 may, at the side of the decoder, obtain a first Intra Block Copy (IBC) prediction and a second IBC prediction based on partitions using GPM for the current block.

In Step 6630, the processor 1620 may, at the side of the decoder, receive coding modes of the current block. In some examples, coding modes are related to or represented by syntax elements.

In Step 6640, the processor 1620 may, at the side of the decoder, obtain a final prediction for the current CU using the first IBC prediction, the second IBC prediction, and the coding modes of the current block.

In some examples, the current block includes a first GPM split partition and a second GPM split partition, and in Step 6620, the processor 1620 may, at the side of the decoder, obtain the first IBC prediction corresponding to the first GPM split partition, and obtain the second IBC prediction corresponding to the second GPM split partition.

In one or more examples, the coding modes of the current block comprise an IBC local illumination compensation (IBC-LIC) flag of the current block or a Reconstruction-Reordered IBC (RR-IBC) type of the current block; and in Step 6630, the processor 1620 may, at the side of the decoder, receive the coding modes of the current block as one of following: first coding modes of the first GPM split partition, or second coding modes of the second GPM split partition, or default values.

In one or more examples, a merge index of the current block is set to be a first merge index of the first GPM split partition, and in Step 6630, the processor 1620 may, at the side of the decoder, receive the coding modes of the current block as the first coding modes of the first GPM split partition. In one or more examples, a merge index of the current block is set to be a second merge index of the second GPM split partition, and in Step 6630, the processor 1620 may, at the side of the decoder, receive the coding modes of the current block as the second coding modes of the second GPM split partition.

In one or more examples, in Step 6630, the processor 1620 may, at the side of the decoder, receive the IBC-LIC flag of the current block as a first constant, or receive the RR-IBC type of the current block as a second constant. In one or more examples, the first constant may be false; in one or more examples, the second constant may be 0.

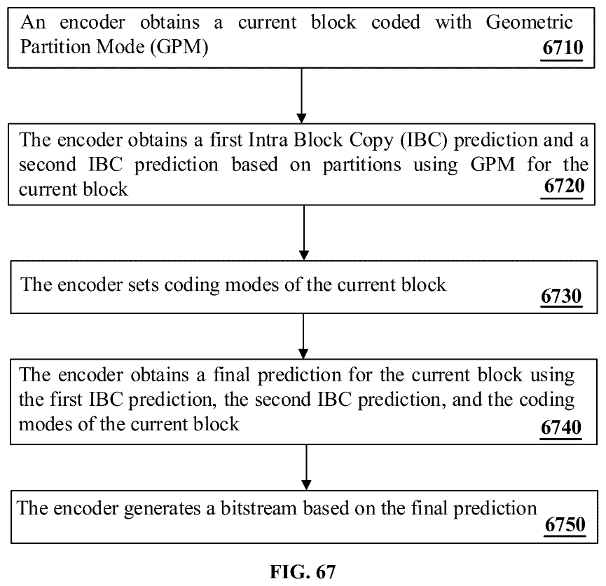

FIG. 67 is a flowchart illustrating a method for video encoding corresponding to the method for video decoding as shown in FIG. 66.

In Step 6710, the processor 1620 may, at the side of an encoder, obtain a current block coded with Geometric Partition Mode (GPM).

In Step 6720, the processor 1620 may, at the side of the encoder, obtain a first Intra Block Copy (IBC) prediction and a second IBC prediction based on partitions using GPM for the current block.

In Step 6730, the processor 1620 may, at the side of the encoder, set coding modes of the current block. In some examples, coding modes are related to or represented by syntax elements.

In Step 6740, the processor 1620 may, at the side of the encoder, obtain a final prediction for the current CU using the first IBC prediction, the second IBC prediction, and the coding modes of the current block.

In Step 6750, the processor 1620 may, at the side of the encoder, generate a bitstream based on the final prediction.

In some examples, the current block includes a first GPM split partition and a second GPM split partition, and in Step 6720, the processor 1620 may, at the side of the encoder, obtain the first IBC prediction corresponding to the first GPM split partition, and obtain the second IBC prediction corresponding to the second GPM split partition.

In one or more examples, the coding modes of the current block comprise an IBC local illumination compensation (IBC-LIC) flag of the current block or a Reconstruction-Reordered IBC (RR-IBC) type of the current block; and in Step 6730, the processor 1620 may, at the side of the encoder, set the coding modes of the current block to be one of following: first coding modes of the first GPM split partition, or second coding modes of the second GPM split partition, or default values.

In one or more examples, a merge index of the current block is set to be a first merge index of the first GPM split partition, and in Step 6730, the processor 1620 may, at the side of the encoder, set the coding modes of the current block to be the first coding modes of the first GPM split partition. In one or more examples, a merge index of the current block is set to be a second merge index of the second GPM split partition, and in Step S130, the processor 1620 may, at the side of the encoder, set the coding modes of the current block to be the second coding modes of the second GPM split partition.

In one or more examples, in Step 6730, the processor 1620 may, at the side of the encoder, set the IBC-LIC flag of the current block to be a first constant, or set the RR-IBC type of the current block to be a second constant. In one or more examples, the first constant may be false; in one or more examples, the second constant may be 0.

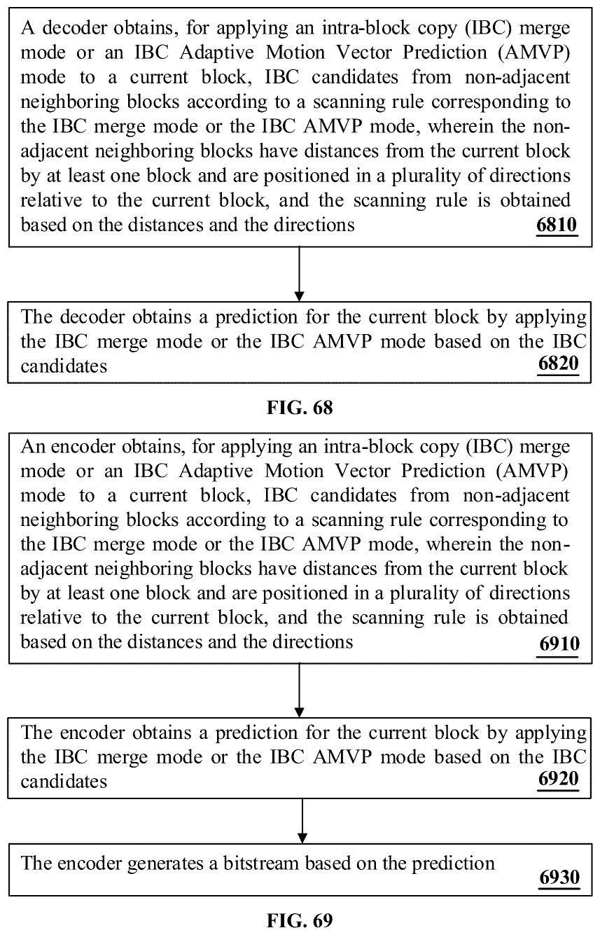

FIG. 68 is a flowchart illustrating a method for video decoding according to an example of the present disclosure.

In Step 6810, the processor 1620 may, at the side of a decoder and for applying an intra-block copy (IBC) merge mode or an IBC Adaptive Motion Vector Prediction (AMVP) mode to a current block, obtain IBC candidates from non-adjacent neighboring blocks according to a scanning rule corresponding to the IBC merge mode or the IBC AMVP mode, where the non-adjacent neighboring blocks have distances from the current block by at least one block and are positioned in a plurality of directions relative to the current block, and the scanning rule is obtained based on the distances and the directions.

In Step 6820, the processor 1620 may, at the side of the decoder, obtain a prediction for the current block by applying the IBC merge mode or the IBC AMVP mode based on the IBC candidates.

In some examples, in response to determining to apply the IBC merge mode to the current block, the IBC candidates are IBC merge candidates; in response to determining to apply the IBC AMVP mode to the current block, the IBC candidates are IBC AMVP candidates; and the scanning rule includes: determining a plurality of scanning areas according to a range of scanning distances indicating a range of numbers of blocks away from a side of the current block, and determining a plurality of scanning positions in each of the plurality of scanning areas according to the plurality of directions relative to the current block, the plurality of directions being measured by a plurality of angles relative to a horizontal right direction of the current block.

In some examples, the range of scanning distances is from 1 to 7, or from 1 to 4, or from 1 to 3, or from 1 to 2; and the plurality of angles relative to the horizontal right direction of the current block includes 5 angles each being a multiple of 45 degrees, or 9 angles each being a multiple of 22.5 degrees, or 13 angles each being a multiple of 22.5 degrees.

In one or more examples, in response to determining to apply the IBC merge mode to the current block, the processor 1620 may, to determine the plurality of scanning areas according to the range of scanning distances and to determine the plurality of scanning positions in each of the plurality of scanning areas according to the plurality of directions relative to the current block, determine the range of scanning distances to be from 1 to 7, and determine the plurality of angles to comprise 5 angles each being a multiple of 45 degrees.

In at least one example, in response to determining to apply the IBC AMVP mode to the current block, the processor 1620 may, to determine the plurality of scanning areas according to the range of scanning distances and to determine the plurality of scanning positions in each of the plurality of scanning areas according to the plurality of directions relative to the current block, determine the range of scanning distances to be from 1 to 4, and determine the plurality of angles to comprise 5 angles each being a multiple of 45 degrees.

In at least one example, in response to determining to apply the IBC AMVP mode to the current block, the processor 1620 may, to determine the plurality of scanning areas according to the range of scanning distances and to determine the plurality of scanning positions in each of the plurality of scanning areas according to the plurality of directions relative to the current block, determine the range of scanning distances to be from 1 to 3, and determine the plurality of angles to comprise 5 angles each being a multiple of 45 degrees.

In at least one example, in response to determining to apply the IBC AMVP mode to the current block, the processor 1620 may, to determine the plurality of scanning areas according to the range of scanning distances and to determine the plurality of scanning positions in each of the plurality of scanning areas according to the plurality of directions relative to the current block, determine the range of scanning distances to be from 1 to 2, and determine the plurality of angles to comprise 5 angles each being a multiple of 45 degrees.

In at least one example, in response to determining to apply the IBC AMVP mode to the current block, the processor 1620 may, to determine the plurality of scanning areas according to the range of scanning distances and to determine the plurality of scanning positions in each of the plurality of scanning areas according to the plurality of directions relative to the current block, determine the range of scanning distances to be from 1 to 7, and determine the plurality of angles to comprise 5 angles each being a multiple of 45 degrees.

In one or more examples, in response to determining to apply the IBC AMVP mode to the current block, the processor 1620 may, to determine the plurality of scanning areas according to the range of scanning distances and to determine the plurality of scanning positions in each of the plurality of scanning areas according to the plurality of directions relative to the current block, determine the range of scanning distances to be from 1 to 4, and determine the plurality of angles to comprise 5 angles each being a multiple of 45 degrees; where, in response to determining to apply the IBC AMVP mode to the current block and determining that an angle relative to the horizontal right direction of the current block is 90 degrees or 180 degrees in a scanning area, the scanning rule further includes: determining a minimum scanning distance to be 2 for the scanning area.

In at least one example, in response to determining to apply the IBC merge mode to the current block, the processor 1620 may, to determine the plurality of scanning areas according to the range of scanning distances and to determine the plurality of scanning positions in each of the plurality of scanning areas according to the plurality of directions relative to the current block, determine the range of scanning distances to be from 1 to 7, and determining the plurality of angles to comprise 5 angles each being a multiple of 45 degrees; where, in response to determining to apply the IBC merge mode to the current block and determining that an angle relative to the horizontal right direction of the current block is 90 degrees or 180 degrees in a scanning area, the scanning rule further includes: determining a minimum scanning distance to be 2 for the scanning area.

In at least one example, in response to determining to apply the IBC merge mode to the current block, the processor 1620 may, to determine the plurality of scanning areas according to the range of scanning distances and to determine the plurality of scanning positions in each of the plurality of scanning areas according to the plurality of directions relative to the current block, determine the range of scanning distances to be from 1 to 7, and determine the plurality of angles to comprise 9 angles each being a multiple of 22.5 degrees.

In at least one example, in response to determining to apply the IBC merge mode to the current block, the processor 1620 may, to determine the plurality of scanning areas according to the range of scanning distances and to determine the plurality of scanning positions in each of the plurality of scanning areas according to the plurality of directions relative to the current block, determine the range of scanning distances to be from 1 to 7, and determine the plurality of angles to comprise 13 angles each being a multiple of 22.5 degrees.

FIG. 69 is a flowchart illustrating a method for video encoding corresponding to the method for video decoding as shown in FIG. 68.

In Step 6910, the processor 1620 may, at the side of an encoder and for applying an intra-block copy (IBC) merge mode or an IBC Adaptive Motion Vector Prediction (AMVP) mode to a current block, obtain IBC candidates from non-adjacent neighboring blocks according to a scanning rule corresponding to the IBC merge mode or the IBC AMVP mode, where the non-adjacent neighboring blocks have distances from the current block by at least one block and are positioned in a plurality of directions relative to the current block, and the scanning rule is obtained based on the distances and the directions.

In Step 6920, the processor 1620 may, at the side of the encoder, obtain a prediction for the current block by applying the IBC merge mode or the IBC AMVP mode based on the IBC candidates.

In Step 6930, the processor 1620 may, at the side of the encoder, generate a bitstream based on the prediction.

In some examples, in response to determining to apply the IBC merge mode to the current block, the IBC candidates are IBC merge candidates; in response to determining to apply the IBC AMVP mode to the current block, the IBC candidates are IBC AMVP candidates; and the scanning rule includes: determining a plurality of scanning areas according to a range of scanning distances indicating a range of numbers of blocks away from a side of the current block, and determining a plurality of scanning positions in each of the plurality of scanning areas according to the plurality of directions relative to the current block, the plurality of directions being measured by a plurality of angles relative to a horizontal right direction of the current block.

In some examples, the range of scanning distances is from 1 to 7, or from 1 to 4, or from 1 to 3, or from 1 to 2; and the plurality of angles relative to the horizontal right direction of the current block includes 5 angles each being a multiple of 45 degrees, or 9 angles each being a multiple of 22.5 degrees, or 13 angles each being a multiple of 22.5 degrees.

In one or more examples, in response to determining to apply the IBC merge mode to the current block, the processor 1620 may, to determine the plurality of scanning areas according to the range of scanning distances and to determine the plurality of scanning positions in each of the plurality of scanning areas according to the plurality of directions relative to the current block, determine the range of scanning distances to be from 1 to 7, and determine the plurality of angles to comprise 5 angles each being a multiple of 45 degrees.

In at least one example, in response to determining to apply the IBC AMVP mode to the current block, the processor 1620 may, to determine the plurality of scanning areas according to the range of scanning distances and to determine the plurality of scanning positions in each of the plurality of scanning areas according to the plurality of directions relative to the current block, determine the range of scanning distances to be from 1 to 4, and determine the plurality of angles to comprise 5 angles each being a multiple of 45 degrees.

In at least one example, in response to determining to apply the IBC AMVP mode to the current block, the processor 1620 may, to determine the plurality of scanning areas according to the range of scanning distances and to determine the plurality of scanning positions in each of the plurality of scanning areas according to the plurality of directions relative to the current block, determine the range of scanning distances to be from 1 to 3, and determine the plurality of angles to comprise 5 angles each being a multiple of 45 degrees.

In at least one example, in response to determining to apply the IBC AMVP mode to the current block, the processor 1620 may, to determine the plurality of scanning areas according to the range of scanning distances and to determine the plurality of scanning positions in each of the plurality of scanning areas according to the plurality of directions relative to the current block, determine the range of scanning distances to be from 1 to 2, and determine the plurality of angles to comprise 5 angles each being a multiple of 45 degrees.

In at least one example, in response to determining to apply the IBC AMVP mode to the current block, the processor 1620 may, to determine the plurality of scanning areas according to the range of scanning distances and to determine the plurality of scanning positions in each of the plurality of scanning areas according to the plurality of directions relative to the current block, determine the range of scanning distances to be from 1 to 7, and determine the plurality of angles to comprise 5 angles each being a multiple of 45 degrees.

In one or more examples, in response to determining to apply the IBC AMVP mode to the current block, the processor 1620 may, to determine the plurality of scanning areas according to the range of scanning distances and to determine the plurality of scanning positions in each of the plurality of scanning areas according to the plurality of directions relative to the current block, determine the range of scanning distances to be from 1 to 4, and determine the plurality of angles to comprise 5 angles each being a multiple of 45 degrees; where, in response to determining to apply the IBC AMVP mode to the current block and determining that an angle relative to the horizontal right direction of the current block is 90 degrees or 180 degrees in a scanning area, the scanning rule further includes: determining a minimum scanning distance to be 2 for the scanning area.

In at least one example, in response to determining to apply the IBC merge mode to the current block, the processor 1620 may, to determine the plurality of scanning areas according to the range of scanning distances and to determine the plurality of scanning positions in each of the plurality of scanning areas according to the plurality of directions relative to the current block, determine the range of scanning distances to be from 1 to 7, and determining the plurality of angles to comprise 5 angles each being a multiple of 45 degrees; where, in response to determining to apply the IBC merge mode to the current block and determining that an angle relative to the horizontal right direction of the current block is 90 degrees or 180 degrees in a scanning area, the scanning rule further includes: determining a minimum scanning distance to be 2 for the scanning area.

In at least one example, in response to determining to apply the IBC merge mode to the current block, the processor 1620 may, to determine the plurality of scanning areas according to the range of scanning distances and to determine the plurality of scanning positions in each of the plurality of scanning areas according to the plurality of directions relative to the current block, determine the range of scanning distances to be from 1 to 7, and determine the plurality of angles to comprise 9 angles each being a multiple of 22.5 degrees.

In at least one example, in response to determining to apply the IBC merge mode to the current block, the processor 1620 may, to determine the plurality of scanning areas according to the range of scanning distances and to determine the plurality of scanning positions in each of the plurality of scanning areas according to the plurality of directions relative to the current block, determine the range of scanning distances to be from 1 to 7, and determine the plurality of angles to comprise 13 angles each being a multiple of 22.5 degrees.

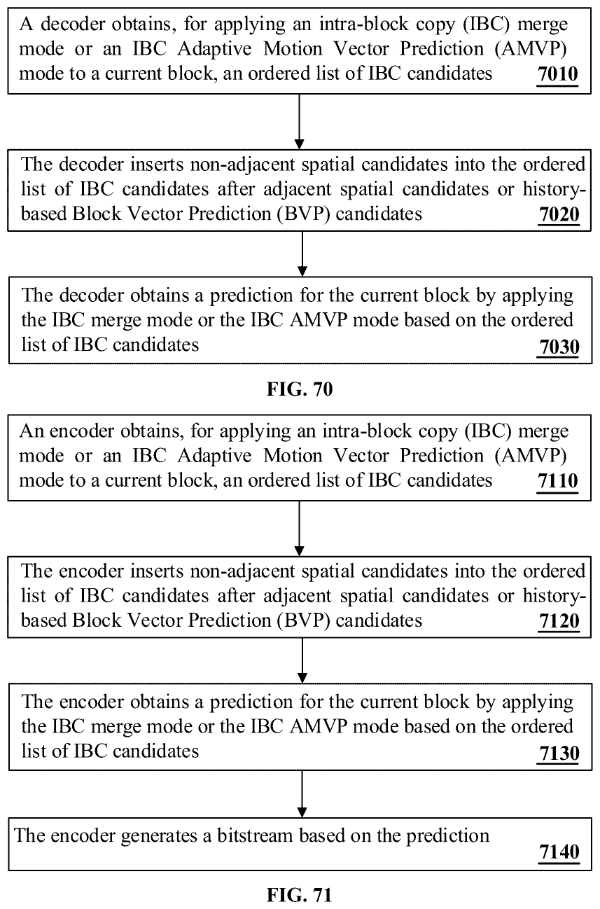

FIG. 70 is a flowchart illustrating a method for video decoding according to an example of the present disclosure.

In Step 7010, the processor 1620 may, at the side of a decoder and for applying an intra-block copy (IBC) merge mode or an IBC Adaptive Motion Vector Prediction (AMVP) mode to a current block, obtain an ordered list of IBC candidates.

In Step 7020, the processor 1620 may, at the side of the decoder, insert non-adjacent spatial candidates into the ordered list of IBC candidates after adjacent spatial candidates or history-based Block Vector Prediction (BVP) candidates.

In Step 7030, the processor 1620 may, at the side of the decoder, obtain a prediction for the current block by applying the IBC merge mode or the IBC AMVP mode based on the ordered list of IBC candidates.

In some examples, in response to determining to apply the IBC merge mode to the current block, the non-adjacent spatial candidates include non-adjacent spatial IBC merge candidates, and in Step 7020, the processor 1620 may, at the side of the decoder, insert the non-adjacent spatial IBC merge candidates into the ordered list of IBC candidates after adjacent spatial IBC merge candidates.

In some examples, in response to determining to apply the IBC AMVP mode to the current block, the non-adjacent spatial candidates include non-adjacent spatial IBC AMVP candidates, and in Step 7020, the processor 1620 may, at the side of the decoder, insert the non-adjacent spatial IBC AMVP candidates into the ordered list of IBC candidates after the history-based BVP candidates.

In some examples, the non-adjacent spatial candidates include one or more spatial BVPs from non-adjacent spatial neighboring blocks, and the adjacent spatial candidates include one or more spatial BVPs from adjacent spatial neighboring blocks.

In one or more examples, in Step 7020, the processor 1620 may, at the side of the decoder, insert the one or more spatial BVPs from the adjacent spatial neighboring blocks into the ordered list of IBC candidates, insert the history-based BVP candidates from a first-in-first-out (FIFO) table into the ordered list of IBC candidates, and insert the one or more spatial BVPs from the non-adjacent spatial neighboring blocks into the ordered list of IBC candidates.

In one or more examples, after inserting the one or more spatial BVPs from the non-adjacent spatial neighboring blocks into the ordered list of IBC candidates, the processor 1620 may further, at the side of the decoder, insert one or more pairwise average BVPs into the ordered list of IBC candidates, insert BVP candidates located in an IBC reference region into the ordered list of IBC candidates; and insert a zero BVP into the ordered list of IBC candidates.

FIG. 71 is a flowchart illustrating a method for video encoding corresponding to the method for video decoding as shown in FIG. 70.

In Step 7110, the processor 1620 may, at the side of an encoder and for applying an intra-block copy (IBC) merge mode or an IBC Adaptive Motion Vector Prediction (AMVP) mode to a current block, obtain an ordered list of IBC candidates.

In Step 7120, the processor 1620 may, at the side of the encoder, insert non-adjacent spatial candidates into the ordered list of IBC candidates after adjacent spatial candidates or history-based Block Vector Prediction (BVP) candidates.

In Step 7130, the processor 1620 may, at the side of the encoder, obtain a prediction for the current block by applying the IBC merge mode or the IBC AMVP mode based on the ordered list of IBC candidates.

In Step 7140, the processor 1620 may, at the side of the encoder, generate a bitstream based on the prediction.

In some examples, in response to determining to apply the IBC merge mode to the current block, the non-adjacent spatial candidates include non-adjacent spatial IBC merge candidates, and in Step 7120, the processor 1620 may, at the side of the encoder, insert the non-adjacent spatial IBC merge candidates into the ordered list of IBC candidates after adjacent spatial IBC merge candidates.

In some examples, in response to determining to apply the IBC AMVP mode to the current block, the non-adjacent spatial candidates include non-adjacent spatial IBC AMVP candidates, and in Step 7120, the processor 1620 may, at the side of the encoder, insert the non-adjacent spatial IBC AMVP candidates into the ordered list of IBC candidates after the history-based BVP candidates.

In some examples, the non-adjacent spatial candidates include one or more spatial BVPs from non-adjacent spatial neighboring blocks, and the adjacent spatial candidates include one or more spatial BVPs from adjacent spatial neighboring blocks.

In one or more examples, in Step 7120, the processor 1620 may, at the side of the encoder, insert the one or more spatial BVPs from the adjacent spatial neighboring blocks into the ordered list of IBC candidates, insert the history-based BVP candidates from a first-in-first-out (FIFO) table into the ordered list of IBC candidates, and insert the one or more spatial BVPs from the non-adjacent spatial neighboring blocks into the ordered list of IBC candidates.

In one or more examples, after inserting the one or more spatial BVPs from the non-adjacent spatial neighboring blocks into the ordered list of IBC candidates, the processor 1620 may further, at the side of the encoder, insert one or more pairwise average BVPs into the ordered list of IBC candidates, insert BVP candidates located in an IBC reference region into the ordered list of IBC candidates; and insert a zero BVP into the ordered list of IBC candidates.

In some examples, there is provided an apparatus for video coding. The apparatus includes a processor 1620 and a memory 1640 configured to store instructions executable by the processor; where the processor, upon execution of the instructions, is configured to perform any method as illustrated in FIGS. 50-71.

In an embodiment, there is also provided a non-transitory computer-readable storage medium comprising a plurality of programs, for example, in the memory 1630, executable by the processor 1620 in the computing environment 1610, for performing the above-described methods and/or storing a bitstream generated by the encoding method described above or a bitstream to be decoded by the decoding method described above. In one example, the plurality of programs may be executed by the processor 1620 in the computing environment 1610 to receive (for example, from the video encoder 20 in FIG. 2) a bitstream or data stream including encoded video information (for example, video blocks representing encoded video frames, and/or associated one or more syntax elements, etc.), and may also be executed by the processor 1620 in the computing environment 1610 to perform the decoding method described above according to the received bitstream or data stream. In another example, the plurality of programs may be executed by the processor 1620 in the computing environment 1610 to perform the encoding method described above to encode video information (for example, video blocks representing video frames, and/or associated one or more syntax elements, etc.) into a bitstream or data stream, and may also be executed by the processor 1620 in the computing environment 1610 to transmit the bitstream or data stream (for example, to the video decoder 30 in FIG. 3). Alternatively, the non-transitory computer-readable storage medium may have stored therein a bitstream or a data stream comprising encoded video information (for example, video blocks representing encoded video frames, and/or associated one or more syntax elements etc.) generated by an encoder (for example, the video encoder 20 in FIG. 2) using, for example, the encoding method described above for use by a decoder (for example, the video decoder 30 in FIG. 3) in decoding video data. The non-transitory computer-readable storage medium may be, for example, a ROM, a Random Access Memory (RAM), a CD-ROM, a magnetic tape, a floppy disc, an optical data storage device or the like.

In an embodiment, there is provided a bitstream generated by the encoding method described above or a bitstream to be decoded by the decoding method described above. In an embodiment, there is provided a bitstream comprising encoded video information generated by the encoding method described above or encoded video information to be decoded by the decoding method described above.

In an embodiment, the is also provided a computing device comprising one or more processors (for example, the processor 1620); and the non-transitory computer-readable storage medium or the memory 1630 having stored therein a plurality of programs executable by the one or more processors, where the one or more processors, upon execution of the plurality of programs, are configured to perform the above-described methods.

In an embodiment, there is also provided a computer program product having instructions for storage or transmission of a bitstream comprising encoded video information generated by the encoding method described above or encoded video information to be decoded by the decoding method described above. In an embodiment, there is also provided a computer program product comprising a plurality of programs, for example, in the memory 1630, executable by the processor 1620 in the computing environment 1610, for performing the above-described methods. For example, the computer program product may include the non-transitory computer-readable storage medium.

In an embodiment, the computing environment 1610 may be implemented with one or more ASICs, DSPs, Digital Signal Processing Devices (DSPDs), Programmable Logic Devices (PLDs), FPGAs, GPUs, controllers, micro-controllers, microprocessors, or other electronic components, for performing the above methods.

In an embodiment, there is also provided a method of storing a bitstream, comprising storing the bitstream on a digital storage medium, where the bitstream includes encoded video information generated by the encoding method described above or encoded video information to be decoded by the decoding method described above.

In an embodiment, there is also provided a method for transmitting a bitstream generated by the encoder described above. In an embodiment, there is also provided a method for receiving a bitstream to be decoded by the decoder described above.

The description of the present disclosure has been presented for purposes of illustration and is not intended to be exhaustive or limited to the present disclosure. Many modifications, variations, and alternative implementations will be apparent to those of ordinary skill in the art having the benefit of the teachings presented in the foregoing descriptions and the associated drawings.

Unless specifically stated otherwise, an order of steps of the method according to the present disclosure is only intended to be illustrative, and the steps of the method according to the present disclosure are not limited to the order specifically described above, but may be changed according to practical conditions. In addition, at least one of the steps of the method according to the present disclosure may be adjusted, combined or deleted according to practical requirements.

The examples were chosen and described in order to explain the principles of the disclosure and to enable others skilled in the art to understand the disclosure for various implementations and to best utilize the underlying principles and various implementations with various modifications as are suited to the particular use contemplated. Therefore, it is to be understood that the scope of the disclosure is not to be limited to the specific examples of the implementations disclosed and that modifications and other implementations are intended to be included within the scope of the present disclosure.

Various aspects of the present invention may be appreciated from the following Enumerated Example Embodiments(EEEs):

EEE 1. A method for video decoding, comprising obtaining, by a decoder for applying an intra-block copy (IBC) mode to a current block, one or more IBC candidates from a plurality of non-adjacent neighboring blocks according to a scanning rule corresponding to the IBC mode, wherein the plurality of non-adjacent neighboring blocks are distanced from the current block by at least one block; and obtaining, by the decoder, a prediction for the current block by applying the IBC mode based on the one or more IBC candidates.

EEE 2. The method of EEE 1, wherein the scanning rule comprises: determining at least one scanning area according to a max scanning distance indicating a maximum number of blocks away from a side of the current block; and determining a scanning position in a scanning area according to a direction of the scanning area relative to the current block.

EEE 3. The method of EEE 2, further comprising: determining, by the decoder, the max scanning distance as 4 blocks away from a left side or an above side of the current block; or determining, by the decoder, the max scanning distance as 7 blocks away from a left side or an above side of the current block.

EEE 4. The method of EEE 3, wherein determining the max scanning distance as 7 blocks away from a left side or an above side of the current block comprises: in response to determining to apply an IBC merge mode to the current block, determining the max scanning distance as 7 blocks away from a left side or an above side of the current block.

EEE 5. The method of EEE 3, wherein determining the max scanning distance as 4 blocks away from a left side or an above side of the current block comprises: in response to determining to apply an IBC Adaptive Motion Vector Prediction (AMVP) mode to the current block, determining the max scanning distance as 4 blocks away from a left side or an above side of the current block.

EEE 6. The method of EEE 2, wherein determining the scanning position in the scanning area according to the direction of the scanning area relative to the current block comprises: in response to determining that the scanning area is located along a bottom left, above right, or above left direction relative to the current block, determining the scanning position as a bottom-right scanning position in the scanning area; in response to determining that the scanning area is located along an above direction relative to the current block, determining the scanning position as a bottom-middle scanning position in the scanning area; or in response to determining that the scanning area is located along a left direction relative to the current block, determining the scanning position as a middle-right scanning position in the scanning area.

EEE 7. The method of EEE 2, wherein the scanning rule further comprises: terminating scanning in the at least one scanning area in response to satisfying a condition that: a list size of a candidate list comprising the one or more IBC candidates has reached a fixed size; or all non-adjacent neighboring blocks within the max scanning distance have been scanned.

EEE 8. A method for video decoding, comprising: obtaining, by a decoder for applying an intra-block copy (IBC) mode to a current block, one or more IBC candidates from a plurality of neighboring blocks according to a size of the current block; and obtaining, by the decoder, a prediction for the current block by applying the IBC mode based on the one or more IBC candidates.

EEE 9. The method of EEE 8, wherein obtaining the one or more IBC candidates from the plurality of neighboring blocks according to the size of the current block comprises:
in response to determining that the size of the current block is greater than a predefined size, obtaining the one or more IBC candidates by scanning a plurality of non-adjacent neighboring blocks and a plurality of adjacent blocks; in response to determining the size of the current block as any size, obtaining the one or more IBC candidates by at least scanning a plurality of non-adjacent neighboring blocks or a plurality of adjacent blocks; in response to determining that the size of the current block is greater than a predefined size, obtaining the one or more IBC candidates by scanning a plurality of adjacent blocks; or in response to determining that the size of the current block is greater than a predefined size, obtaining the one or more IBC candidates by scanning a plurality of non-adjacent blocks, wherein the plurality of non-adjacent neighboring blocks are distanced from the current block by at least one block.

EEE 10. The method of EEE 9, wherein the plurality of non-adjacent neighboring blocks are configured to be scanned by the decoder according to a scanning rule corresponding to the IBC mode.

EEE 11. The method of EEE 10, wherein the scanning rule comprises:
determining, by the decoder, at least one scanning area according to a max scanning distance indicating a maximum number of blocks away from a side of the current block; and determining, by the decoder, a scanning position in a scanning area according to a direction of the scanning area relative to the current block.

EEE 12. The method of EEE 11, further comprising: determining, by the decoder, the max scanning distance as 4 blocks away from a left side or an above side of the current block; or determining, by the decoder, the max scanning distance as 7 blocks away from a left side or an above side of the current block.

EEE 13. The method of EEE 12, wherein determining the max scanning distance as 7 blocks away from a left side or an above side of the current block comprises:
in response to determining to apply an IBC merge mode to the current block, determining the max scanning distance as 7 blocks away from a left side or an above side of the current block.

EEE 14. The method of EEE 12, wherein determining the max scanning distance as 4 blocks away from a left side or an above side of the current block comprises:
in response to determining to apply an IBC AMVP mode to the current block, determining the max scanning distance as 4 blocks away from a left side or an above side of the current block.

EEE 15. The method of EEE 11, wherein determining the scanning position in the scanning area according to the direction of the scanning area relative to the current block comprises: in response to determining that the scanning area is located along a bottom left, above right, or above left direction relative to the current block, determining the scanning position as a bottom-right scanning position in the scanning area; in response to determining that the scanning area is located along an above direction relative to the current block, determining the scanning position as a bottom-middle scanning position in the scanning area; or in response to determining that the scanning area is located along a left direction relative to the current block, determining the scanning position as a middle-right scanning position in the scanning area.

EEE 16. The method of EEE 11, wherein the scanning rule further comprises:
terminating scanning in the at least one scanning area in response to satisfying a condition that: a list size of a candidate list comprising the one or more IBC candidates has reached a fixed size; or all non-adjacent neighboring blocks within the max scanning distance have been scanned.

EEE 17. A method for video encoding, comprising: obtaining, by an encoder for applying an intra-block copy (IBC) mode to a current block, one or more IBC candidates from a plurality of non-adjacent neighboring blocks according to a scanning rule corresponding to the IBC mode, wherein the plurality of non-adjacent neighboring blocks are distanced from the current block by at least one block; and obtaining, by the encoder, a prediction for the current block by applying the IBC mode based on the one or more IBC candidates.

EEE 18. The method of EEE 17, wherein the scanning rule comprises: determining at least one scanning area according to a max scanning distance indicating a maximum number of blocks away from a side of the current block; and determining a scanning position in a scanning area according to a direction of the scanning area relative to the current block.

EEE 19. The method of EEE 18, further comprising: determining, by the encoder, the max scanning distance as 4 blocks away from a left side or an above side of the current block; or determining, by the encoder, the max scanning distance as 7 blocks away from a left side or an above side of the current block.

EEE 20. The method of EEE 19, wherein determining the max scanning distance as 7 blocks away from a left side or an above side of the current block comprises: in response to determining to apply an IBC merge mode to the current block, determining the max scanning distance as 7 blocks away from a left side or an above side of the current block.

EEE 21. The method of EEE 19, wherein determining the max scanning distance as 4 blocks away from a left side or an above side of the current block comprises: in response to determining to apply an IBC Adaptive Motion Vector Prediction (AMVP) mode to the current block, determining the max scanning distance as 4 blocks away from a left side or an above side of the current block.

EEE 22. The method of EEE 18, wherein determining the scanning position in the scanning area according to the direction of the scanning area relative to the current block comprises: in response to determining that the scanning area is located along a bottom left, above right, or above left direction relative to the current block, determining the scanning position as a bottom-right scanning position in the scanning area; in response to determining that the scanning area is located along an above direction relative to the current block, determining the scanning position as a bottom-middle scanning position in the scanning area; or in response to determining that the scanning area is located along a left direction relative to the current block, determining the scanning position as a middle-right scanning position in the scanning area.

EEE 23. The method of EEE 18, wherein the scanning rule further comprises:
terminating scanning in the at least one scanning area in response to satisfying a condition that: a list size of a candidate list comprising the one or more IBC candidates has reached a fixed size; or all non-adjacent neighboring blocks within the max scanning distance have been scanned.

EEE 24. A method for video encoding, comprising: obtaining, by an encoder for applying an intra-block copy (IBC) mode to a current block, one or more IBC candidates from a plurality of neighboring blocks according to a size of the current block; and obtaining, by the encoder, a prediction for the current block by applying the IBC mode based on the one or more IBC candidates.

EEE 25. The method of EEE 24, wherein obtaining the one or more IBC candidates from the plurality of neighboring blocks according to the size of the current block comprises: in response to determining that the size of the current block is greater than a predefined size, obtaining the one or more IBC candidates by scanning a plurality of non-adjacent neighboring blocks and a plurality of adjacent blocks; in response to determining the size of the current block as any size, obtaining the one or more IBC candidates by at least scanning a plurality of non-adjacent neighboring blocks or a plurality of adjacent blocks; in response to determining that the size of the current block is greater than a predefined size, obtaining the one or more IBC candidates by scanning a plurality of adjacent blocks; or in response to determining that the size of the current block is greater than a predefined size, obtaining the one or more IBC candidates by scanning a plurality of non-adjacent blocks, wherein the plurality of non-adjacent neighboring blocks are distanced from the current block by at least one block.

EEE 26. The method of EEE 25, wherein the plurality of non-adjacent neighboring blocks are configured to be scanned by the encoder according to a scanning rule corresponding to the IBC mode.

EEE 27. The method of EEE 26, wherein the scanning rule comprises: determining, by the encoder, at least one scanning area according to a max scanning distance indicating a maximum number of blocks away from a side of the current block; and determining, by the encoder, a scanning position in a scanning area according to a direction of the scanning area relative to the current block.

EEE 28. The method of EEE 27, further comprising: determining, by the encoder, the max scanning distance as 4 blocks away from a left side or an above side of the current block; or determining, by the encoder, the max scanning distance as 7 blocks away from a left side or an above side of the current block.

EEE 29. The method of EEE 28, wherein determining the max scanning distance as 7 blocks away from a left side or an above side of the current block comprises: in response to determining to apply an IBC merge mode to the current block, determining the max scanning distance as 7 blocks away from a left side or an above side of the current block.

EEE 30. The method of EEE 28, wherein determining the max scanning distance as 4 blocks away from a left side or an above side of the current block comprises:
in response to determining to apply an IBC AMVP mode to the current block, determining the max scanning distance as 4 blocks away from a left side or an above side of the current block.

EEE 31. The method of EEE 27, wherein determining the scanning position in the scanning area according to the direction of the scanning area relative to the current block comprises: in response to determining that the scanning area is located along a bottom left, above right, or above left direction relative to the current block, determining the scanning position as a bottom-right scanning position in the scanning area; in response to determining that the scanning area is located along an above direction relative to the current block, determining the scanning position as a bottom-middle scanning position in the scanning area; or in response to determining that the scanning area is located along a left direction relative to the current block, determining the scanning position as a middle-right scanning position in the scanning area.

EEE 32. The method of EEE 27, wherein the scanning rule further comprises:
terminating scanning in the at least one scanning area in response to satisfying a condition that: a list size of a candidate list comprising the one or more IBC candidates has reached a fixed size; or all non-adjacent neighboring blocks within the max scanning distance have been scanned.

EEE 33. A method for video decoding, comprising: obtaining, by a decoder, a History-based Motion Vector Predictor (HMVP) list based on at least one block attribution of a current block; and obtaining, by the decoder, a prediction for the current block by applying an intra-block copy (IBC) mode based on the HMVP list.

EEE 34. The method of EEE 33, wherein the at least one block attribution comprises any one or any combination of: a block location, a block size, or a picture area of the current block.

EEE 35. The method of EEE 33, wherein obtaining the HMVP list based on the at least one block attribution of the current block comprises: obtaining different HMVP lists for different coding tree blocks having different block locations or located in different picture areas.

EEE 36. The method of EEE 35, wherein the different HMVP lists have a same list size or different list sizes.

EEE 37. The method of EEE 33, wherein the HMVP list comprises any one or any combination of: a block decoded with an IBC mode; a block decoded with an intra template matching prediction (TMP) mode; or a block decoded with a block size larger than a predefined size.

EEE 38. A method for video encoding, comprising: obtaining, by an encoder, a History-based Motion Vector Predictor (HMVP) list based on at least one block attribution of a current block; and obtaining, by the encoder, a prediction for the current block by applying an intra-block copy (IBC) mode based on the HMVP list.

EEE 39. The method of EEE 38, wherein the at least one block attribution comprises any one or any combination of: a block location, a block size, or a picture area of the current block.

EEE 40. The method of EEE 38, wherein obtaining the HMVP list based on the at least one block attribution of the current block comprises: obtaining different HMVP lists for different coding tree blocks having different block locations or located in different picture areas.

EEE 41. The method of EEE 40, wherein the different HMVP lists have a same list size or different list sizes.

EEE 42. The method of EEE 38, wherein the HMVP list comprises any one or any combination of: a block encoded with an IBC mode; a block encoded with an intra template matching prediction (TMP) mode; or a block encoded with a block size larger than a predefined size.

EEE 43. A method for video decoding, comprising: in response to determining that a neighboring block of a current block is coded in one of an IBC mode or an intra template matching prediction (TMP) mode, obtaining, by a decoder, an intra prediction mode which is associated with a block vector of the neighboring block; and constructing, by the decoder, an intra Most Probable Mode (MPM) list of the current block based on the intra prediction mode.

EEE 44. A method for video encoding, comprising: in response to determining that a neighboring block of a current block is coded in one of an IBC mode or an intra template matching prediction (TMP) mode, obtaining, by an encoder, an intra prediction mode which is associated with a block vector of the neighboring block; and constructing, by the encoder, an intra Most Probable Mode (MPM) list of the current block based on the intra prediction mode.

EEE 45. An apparatus for video decoding, comprising: one or more processors; and a memory coupled to the one or more processors and configured to store instructions executable by the one or more processors, wherein the one or more processors, upon execution of the instructions, are configured to perform the method in any one of EEEs 1-16, 33-37, or 43.

EEE 46. A non-transitory computer-readable storage medium for storing computer-executable instructions that, when executed by one or more computer processors, cause the one or more computer processors to perform the method in any one of EEEs 1-16, 33-37, or 43.

EEE 47. An apparatus for video encoding, comprising: one or more processors; and a memory coupled to the one or more processors and configured to store instructions executable by the one or more processors, wherein the one or more processors, upon execution of the instructions, are configured to perform the method in any one of EEEs 17-32, 38-42, or 44.

EEE 48. A non-transitory computer-readable storage medium for storing computer-executable instructions that, when executed by one or more computer processors, cause the one or more computer processors to perform the method in any one of EEEs 17-32, 38-42, or 44.

EEE 49. A non-transitory computer-readable storage medium for storing a bitstream to be decoded by the method in any one of EEEs 1-16, 33-37, or 43.

EEE 50. A non-transitory computer-readable storage medium for storing a bitstream generated by the method in any one of EEEs 17-32, 38-42, or 44.

EEE 51. A method for video decoding, comprising: obtaining, by a decoder, a current block coded with Geometric Partition Mode (GPM); obtaining, by the decoder, a first Intra Block Copy (IBC) prediction and a second IBC prediction based on partitions using GPM for the current block; receiving, by the decoder, coding modes of the current block; and obtaining, by the decoder, a final prediction for the current block using the first IBC prediction, the second IBC prediction, and the coding modes of the current block.

EEE 52. The method of EEE 51, wherein the current block comprises a first GPM split partition and a second GPM split partition; and wherein obtaining, by the decoder, the first IBC prediction and the second IBC prediction based on the partitions using the GPM for the current block comprises: obtaining the first IBC prediction corresponding to the first GPM split partition, and obtaining the second IBC prediction corresponding to the second GPM split partition.

EEE 53. The method of EEE 52, wherein the coding modes of the current block comprise an IBC local illumination compensation (IBC-LIC) flag of the current block or a Reconstruction-Reordered IBC (RR-IBC) type of the current block; and wherein receiving, by the decoder, the coding modes of the current block comprises: receiving the coding modes of the current block as one of following: first coding modes of the first GPM split partition, or second coding modes of the second GPM split partition, or default values.

EEE 54. The method of EEE 53, wherein a merge index of the current block is set to be a first merge index of the first GPM split partition; and wherein receiving, by the decoder, the coding modes of the current block comprises: receiving the coding modes of the current block as the first coding modes of the first GPM split partition.

EEE 55. The method of EEE 53, wherein a merge index of the current block is set to be a second merge index of the second GPM split partition; and wherein receiving, by the decoder, the coding modes of the current block comprises: receiving the coding modes of the current block as the second coding modes of the second GPM split partition.

EEE 56. The method of EEE 53, wherein receiving, by the decoder, the coding modes of the current block comprises: receiving the IBC-LIC flag of the current block as a first constant, or receiving the RR-IBC type of the current block as a second constant.

EEE 57. A method for video encoding, comprising: obtaining, by an encoder, a current block coded with Geometric Partition Mode (GPM); obtaining, by the encoder, a first Intra Block Copy (IBC) prediction and a second IBC prediction based on partitions using GPM for the current block; setting, by the encoder, coding modes of the current block; obtaining, by the encoder, a final prediction for the current block using the first IBC prediction, the second IBC prediction, and the coding modes of the current block; and generating, by the encoder, a bitstream based on the final prediction.

EEE 58. The method of EEE 57, wherein the current block comprises a first GPM split partition and a second GPM split partition; and wherein obtaining, by the encoder, the first IBC prediction and the second IBC prediction based on the partitions using the GPM for the current block comprises: obtaining the first IBC prediction corresponding to the first GPM split partition, and obtaining the second IBC prediction corresponding to the second GPM split partition.

EEE 59. The method of EEE 58, wherein the coding modes of the current block comprise an IBC local illumination compensation (IBC-LIC) flag of the current block or a Reconstruction-Reordered IBC (RR-IBC) type of the current block; and wherein setting, by the encoder, the coding modes of the current block comprises: setting the coding modes of the current block to be one of following: first coding modes of the first GPM split partition, or second coding modes of the second GPM split partition, or default values.

EEE 60. The method of EEE 59, wherein a merge index of the current block is set to be a first merge index of the first GPM split partition; and wherein setting, by the encoder, the coding modes of the current block comprises: setting the coding modes of the current block to be the first coding modes of the first GPM split partition.

EEE 61. The method of EEE 59, wherein a merge index of the current block is set to be a second merge index of the second GPM split partition; and wherein setting, by the encoder, the coding modes of the current block comprises: setting the coding modes of the current block to be the second coding modes of the second GPM split partition.

EEE 62. The method of EEE 59, wherein setting, by the encoder, the coding modes of the current block comprises: setting the IBC-LIC flag of the current block to be a first constant, or setting the RR-IBC type of the current block to be a second constant.

EEE 63. A method for video decoding, comprising: obtaining, by a decoder for applying an intra-block copy (IBC) merge mode or an IBC Adaptive Motion Vector Prediction (AMVP) mode to a current block, IBC candidates from non-adjacent neighboring blocks according to a scanning rule corresponding to the IBC merge mode or the IBC AMVP mode, wherein the non-adjacent neighboring blocks have distances from the current block by at least one block and are positioned in a plurality of directions relative to the current block, and the scanning rule is obtained based on the distances and the directions; and obtaining, by the decoder, a prediction for the current block by applying the IBC merge mode or the IBC AMVP mode based on the IBC candidates.

EEE 64. The method of EEE 63, wherein in response to determining to apply the IBC merge mode to the current block, the IBC candidates are IBC merge candidates; wherein in response to determining to apply the IBC AMVP mode to the current block, the IBC candidates are IBC AMVP candidates; and wherein the scanning rule comprises: determining a plurality of scanning areas according to a range of scanning distances indicating a range of numbers of blocks away from a side of the current block; and determining a plurality of scanning positions in each of the plurality of scanning areas according to the plurality of directions relative to the current block, the plurality of directions being measured by a plurality of angles relative to a horizontal right direction of the current block.

EEE 65. The method of EEE 64, wherein the range of scanning distances is from 1 to 7, or from 1 to 4, or from 1 to 3, or from 1 to 2; and wherein the plurality of angles relative to the horizontal right direction of the current block comprises 5 angles each being a multiple of 45 degrees, or 9 angles each being a multiple of 22.5 degrees, or 13 angles each being a multiple of 22.5 degrees.

EEE 66. The method of EEE 65, wherein in response to determining to apply the IBC merge mode to the current block, determining the plurality of scanning areas according to the range of scanning distances and determining the plurality of scanning positions in each of the plurality of scanning areas according to the plurality of directions relative to the current block comprise: determining the range of scanning distances to be from 1 to 7, and determining the plurality of angles to comprise 5 angles each being a multiple of 45 degrees.

EEE 67. The method of EEE 66, wherein in response to determining to apply the IBC AMVP mode to the current block, determining the plurality of scanning areas according to the range of scanning distances and determining the plurality of scanning positions in each of the plurality of scanning areas according to the plurality of directions relative to the current block comprise: determining the range of scanning distances to be from 1 to 4, and determining the plurality of angles to comprise 5 angles each being a multiple of 45 degrees.

EEE 68. The method of EEE 65, wherein in response to determining to apply the IBC AMVP mode to the current block, determining the plurality of scanning areas according to the range of scanning distances and determining the plurality of scanning positions in each of the plurality of scanning areas according to the plurality of directions relative to the current block comprise: determining the range of scanning distances to be from 1 to 4, and determining the plurality of angles to comprise 5 angles each being a multiple of 45 degrees; and wherein in response to determining to apply the IBC AMVP mode to the current block and determining that an angle relative to the horizontal right direction of the current block is 90 degrees or 180 degrees in a scanning area, the scanning rule further comprises: determining a minimum scanning distance to be 2 for the scanning area.

EEE 69. The method of EEE 68, wherein in response to determining to apply the IBC merge mode to the current block, determining the plurality of scanning areas according to the range of scanning distances and determining the plurality of scanning positions in each of the plurality of scanning areas according to the plurality of directions relative to the current block comprise: determining the range of scanning distances to be from 1 to 7, and determining the plurality of angles to comprise 5 angles each being a multiple of 45 degrees; and wherein in response to determining to apply the IBC merge mode to the current block and determining that an angle relative to the horizontal right direction of the current block is 90 degrees or 180 degrees in a scanning area, the scanning rule further comprises: determining the minimum scanning distance to be 2 for the scanning area.

EEE 70. The method of EEE 66, wherein in response to determining to apply the IBC AMVP mode to the current block, determining the plurality of scanning areas according to the range of scanning distances and determining the plurality of scanning positions in each of the plurality of scanning areas according to the plurality of directions relative to the current block comprise: determining the range of scanning distances to be from 1 to 3, and determining the plurality of angles to comprise 5 angles each being a multiple of 45 degrees.

EEE 71. The method of EEE 66, wherein in response to determining to apply the IBC AMVP mode to the current block, determining the plurality of scanning areas according to the range of scanning distances and determining the plurality of scanning positions in each of the plurality of scanning areas according to the plurality of directions relative to the current block comprise: determining the range of scanning distances to be from 1 to 2, and determining the plurality of angles to comprise 5 angles each being a multiple of 45 degrees.

EEE 72. The method of EEE 68, wherein in response to determining to apply the IBC merge mode to the current block, determining the plurality of scanning areas according to the range of scanning distances and determining the plurality of scanning positions in each of the plurality of scanning areas according to the plurality of directions relative to the current block comprise: determining the range of scanning distances to be from 1 to 7, and determining the plurality of angles to comprise 9 angles each being a multiple of 22.5 degrees.

EEE 73. The method of EEE 68, wherein in response to determining to apply the IBC merge mode to the current block, determining the plurality of scanning areas according to the range of scanning distances and determining the plurality of scanning positions in each of the plurality of scanning areas according to the plurality of directions relative to the current block comprise: determining range of scanning distances to be from 1 to 7, and determining the plurality of angles to comprise 13 angles each being a multiple of 22.5 degrees.

EEE 74. The method of EEE 66, wherein in response to determining to apply the IBC AMVP mode to the current block, determining the plurality of scanning areas according to the range of scanning distances and determining the plurality of scanning positions in each of the plurality of scanning areas according to the plurality of directions relative to the current block comprise: determining range of scanning distances to be from 1 to 7, and determining the plurality of angles to comprise 5 angles each being a multiple of 45 degrees.

EEE 75. A method for video encoding, comprising: obtaining, by an encoder for applying an intra-block copy (IBC) merge mode or an IBC Adaptive Motion Vector Prediction (AMVP) mode to a current block, IBC candidates from non-adjacent neighboring blocks according to a scanning rule corresponding to the IBC merge mode or the IBC AMVP mode, wherein the non-adjacent neighboring blocks have distances from the current block by at least one block and are positioned in a plurality of directions relative to the current block, and the scanning rule is obtained based on the distances and the directions; obtaining, by the encoder, a prediction for the current block by applying the IBC merge mode or the IBC AMVP mode based on the IBC candidates; and generating, by the encoder, a bitstream based on the prediction.

EEE 76. The method of EEE 75, wherein in response to determining to apply the IBC merge mode to the current block, the IBC candidates are IBC merge candidates; wherein in response to determining to apply the IBC AMVP mode to the current block, the IBC candidates are IBC AMVP candidates; and wherein the scanning rule comprises: determining a plurality of scanning areas according to a range of scanning distances indicating a range of numbers of blocks away from a side of the current block; and determining a plurality of scanning positions in each of the plurality of scanning areas according to the plurality of directions relative to the current block, the plurality of directions being measured by a plurality of angles relative to a horizontal right direction of the current block.

EEE 77. The method of EEE 76, wherein the range of scanning distances is from 1 to 7, or from 1 to 4, or from 1 to 3, or from 1 to 2; and wherein the plurality of angles relative to the horizontal right direction of the current block comprises 5 angles each being a multiple of 45 degrees, or 9 angles each being a multiple of 22.5 degrees, or 13 angles each being a multiple of 22.5 degrees.

EEE 78. The method of EEE 77, wherein in response to determining to apply the IBC merge mode to the current block, determining the plurality of scanning areas according to the range of scanning distances and determining the plurality of scanning positions in each of the plurality of scanning areas according to the plurality of directions relative to the current block comprise: determining the range of scanning distances to be from 1 to 7, and determining the plurality of angles to comprise 5 angles each being a multiple of 45 degrees.

EEE 79. The method of EEE 78, wherein in response to determining to apply the IBC AMVP mode to the current block, determining the plurality of scanning areas according to the range of scanning distances and determining the plurality of scanning positions in each of the plurality of scanning areas according to the plurality of directions relative to the current block comprise: determining the range of scanning distances to be from 1 to 4, and determining the plurality of angles to comprise 5 angles each being a multiple of 45 degrees.

EEE 80. The method of EEE 77, wherein in response to determining to apply the IBC AMVP mode to the current block, determining the plurality of scanning areas according to the range of scanning distances and determining the plurality of scanning positions in each of the plurality of scanning areas according to the plurality of directions relative to the current block comprise: determining the range of scanning distances to be from 1 to 4, and determining the plurality of angles to comprise 5 angles each being a multiple of 45 degrees; and wherein in response to determining to apply the IBC AMVP mode to the current block and determining that an angle relative to the horizontal right direction of the current block is 90 degrees or 180 degrees in a scanning area, the scanning rule further comprises: determining a minimum scanning distance to be 2 for the scanning area.

EEE 81. The method of EEE 80, wherein in response to determining to apply the IBC merge mode to the current block, determining the plurality of scanning areas according to the range of scanning distances and determining the plurality of scanning positions in each of the plurality of scanning areas according to the plurality of directions relative to the current block comprise: determining the range of scanning distances to be from 1 to 7, and determining the plurality of angles to comprise 5 angles each being a multiple of 45 degrees; and wherein in response to determining to apply the IBC merge mode to the current block and determining that an angle relative to the horizontal right direction of the current block is 90 degrees or 180 degrees in a scanning area, the scanning rule further comprises: determining the minimum scanning distance to be 2 for the scanning area.

EEE 82. The method of EEE 78, wherein in response to determining to apply the IBC AMVP mode to the current block, determining the plurality of scanning areas according to the range of scanning distances and determining the plurality of scanning positions in each of the plurality of scanning areas according to the plurality of directions relative to the current block comprise: determining the range of scanning distances to be from 1 to 3, and determining the plurality of angles to comprise 5 angles each being a multiple of 45 degrees.

EEE 83. The method of EEE 78, wherein in response to determining to apply the IBC AMVP mode to the current block, determining the plurality of scanning areas according to the range of scanning distances and determining the plurality of scanning positions in each of the plurality of scanning areas according to the plurality of directions relative to the current block comprise: determining the range of scanning distances to be from 1 to 2, and determining the plurality of angles to comprise 5 angles each being a multiple of 45 degrees.

EEE 84. The method of EEE 80, wherein in response to determining to apply the IBC merge mode to the current block, determining the plurality of scanning areas according to the range of scanning distances and determining the plurality of scanning positions in each of the plurality of scanning areas according to the plurality of directions relative to the current block comprise: determining the range of scanning distances to be from 1 to 7, and determining the plurality of angles to comprise 9 angles each being a multiple of 22.5 degrees.

EEE 85. The method of EEE 80, wherein in response to determining to apply the IBC merge mode to the current block, determining the plurality of scanning areas according to the range of scanning distances and determining the plurality of scanning positions in each of the plurality of scanning areas according to the plurality of directions relative to the current block comprise: determining range of scanning distances to be from 1 to 7, and determining the plurality of angles to comprise 13 angles each being a multiple of 22.5 degrees.

EEE 86. The method of EEE 78, wherein in response to determining to apply the IBC AMVP mode to the current block, determining the plurality of scanning areas according to the range of scanning distances and determining the plurality of scanning positions in each of the plurality of scanning areas according to the plurality of directions relative to the current block comprise: determining range of scanning distances to be from 1 to 7, and determining the plurality of angles to comprise 5 angles each being a multiple of 45 degrees.

EEE 87. A method for video decoding, comprising: obtaining, by a decoder for applying an intra-block copy (IBC) merge mode or an IBC Adaptive Motion Vector Prediction (AMVP) mode to a current block, an ordered list of IBC candidates; inserting, by the decoder, non-adjacent spatial candidates into the ordered list of IBC candidates after adjacent spatial candidates or history-based Block Vector Prediction (BVP) candidates; and obtaining, by the decoder, a prediction for the current block by applying the IBC merge mode or the IBC AMVP mode based on the ordered list of IBC candidates.

EEE 88. The method of EEE 87, wherein in response to determining to apply the IBC merge mode to the current block, the non-adjacent spatial candidates comprise non-adjacent spatial IBC merge candidates; and wherein inserting, by the decoder, the non-adjacent spatial candidates into the ordered list of IBC candidates after the adjacent spatial candidates or the history-based BVP candidates comprises: inserting the non-adjacent spatial IBC merge candidates into the ordered list of IBC candidates after adjacent spatial IBC merge candidates.

EEE 89. The method of EEE 87, wherein in response to determining to apply the IBC AMVP mode to the current block, the non-adjacent spatial candidates comprise non-adjacent spatial IBC AMVP candidates; and wherein inserting, by the decoder, the non-adjacent spatial candidates into the ordered list of IBC candidates after the adjacent spatial candidates or the history-based BVP candidates comprises: inserting the non-adjacent spatial IBC AMVP candidates into the ordered list of IBC candidates after the history-based BVP candidates.

EEE 90. The method of EEE 87, wherein the non-adjacent spatial candidates comprise one or more spatial BVPs from non-adjacent spatial neighboring blocks, and the adjacent spatial candidates comprise one or more spatial BVPs from adjacent spatial neighboring blocks.

EEE 91. The method of EEE 90, wherein inserting, by the decoder, the non-adjacent spatial candidates into the ordered list of IBC candidates after the adjacent spatial candidates or the history-based BVP candidates comprises following acts in sequential order: inserting the one or more spatial BVPs from the adjacent spatial neighboring blocks into the ordered list of IBC candidates; inserting the history-based BVP candidates from a first-in-first-out (FIFO) table into the ordered list of IBC candidates; and inserting the one or more spatial BVPs from the non-adjacent spatial neighboring blocks into the ordered list of IBC candidates.

EEE 92. The method of EEE 91, wherein after inserting the one or more spatial BVPs from the non-adjacent spatial neighboring blocks into the ordered list of IBC candidates, the method further comprises following acts in sequential order: inserting one or more pairwise average BVPs into the ordered list of IBC candidates; inserting BVP candidates located in an IBC reference region into the ordered list of IBC candidates; and inserting a zero BVP into the ordered list of IBC candidates.

EEE 93. A method for video encoding, comprising: obtaining, by an encoder for applying an intra-block copy (IBC) merge mode or an IBC Adaptive Motion Vector Prediction (AMVP) mode to a current block, an ordered list of IBC candidates; inserting, by the encoder, non-adjacent spatial candidates into the ordered list of IBC candidates after adjacent spatial candidates or history-based Block Vector Prediction (BVP) candidates; obtaining, by the encoder, a prediction for the current block by applying the IBC merge mode or the IBC AMVP mode based on the ordered list of IBC candidates; and generating, by the encoder, a bitstream based on the prediction.

EEE 94. The method of EEE 93, wherein in response to determining to apply the IBC merge mode to the current block, the non-adjacent spatial candidates comprise non-adjacent spatial IBC merge candidates; and wherein inserting, by the encoder, the non-adjacent spatial candidates into the ordered list of IBC candidates after the adjacent spatial candidates or the history-based BVP candidates comprises: inserting the non-adjacent spatial IBC merge candidates into the ordered list of IBC candidates after adjacent spatial IBC merge candidates.

EEE 95. The method of EEE 93, wherein in response to determining to apply the IBC AMVP mode to the current block, the non-adjacent spatial candidates comprise non-adjacent spatial IBC AMVP candidates; and wherein inserting, by the encoder, the non-adjacent spatial candidates into the ordered list of IBC candidates after the adjacent spatial candidates or the history-based BVP candidates comprises: inserting the non-adjacent spatial IBC AMVP candidates into the ordered list of IBC candidates after the history-based BVP candidates.

EEE 96. The method of EEE 93, wherein the non-adjacent spatial candidates comprise one or more spatial BVPs from non-adjacent spatial neighboring blocks, and the adjacent spatial candidates comprise one or more spatial BVPs from adjacent spatial neighboring blocks.

EEE 97. The method of EEE 96, wherein inserting, by the encoder, the non-adjacent spatial candidates into the ordered list of IBC candidates after the adjacent spatial candidates or the history-based BVP candidates comprises following acts in sequential order: inserting the one or more spatial BVPs from the adjacent spatial neighboring blocks into the ordered list of IBC candidates; inserting the history-based BVP candidates from a first-in-first-out (FIFO) table into the ordered list of IBC candidates; and inserting the one or more spatial BVPs from the non-adjacent spatial neighboring blocks into the ordered list of IBC candidates.

EEE 98. The method of EEE 97, wherein after inserting the one or more spatial BVPs from the non-adjacent spatial neighboring blocks into the ordered list of IBC candidates, the method further comprises following acts in sequential order: inserting one or more pairwise average BVPs into the ordered list of IBC candidates; inserting BVP candidates located in an IBC reference region into the ordered list of IBC candidates; and inserting a zero BVP into the ordered list of IBC candidates.

EEE 99. An apparatus for video decoding, comprising: one or more processors; and a memory coupled to the one or more processors and configured to store instructions executable by the one or more processors, wherein the one or more processors, upon execution of the instructions, are configured to perform the method in any one of EEEs 51-56, 63-74, or 87-92.

EEE 100. An apparatus for video encoding, comprising: one or more processors; and a memory coupled to the one or more processors and configured to store instructions executable by the one or more processors, wherein the one or more processors, upon execution of the instructions, are configured to perform the method in any one of EEEs 57-62, 75-86, or 93-98.

EEE 101. A non-transitory computer-readable storage medium for storing computer-executable instructions that, when executed by one or more computer processors, cause the one or more computer processors to perform the method in any one of EEEs 51-56, 63-74, or 87-92.

EEE 102. A non-transitory computer-readable storage medium for storing computer-executable instructions that, when executed by one or more computer processors, cause the one or more computer processors to perform the method in any one of EEEs 57-62, 75-86, or 93-98.

EEE 103. A non-transitory computer-readable storage medium for storing a bitstream to be decoded by the method in any one of EEEs 51-56, 63-74, or 87-92.

EEE 104. A non-transitory computer-readable storage medium for storing a bitstream generated by the method in any one of EEEs 57-62, 75-86, or 93-98.

EEE 105. A method for storing a bitstream, comprising storing the bitstream on a non-transitory computer-readable storage medium, wherein the bitstream comprises encoded video information generated by the method in any one of EEEs 57-62, 75-86, or 93-98.

EEE 106. A method for storing a bitstream, comprising storing the bitstream on a non-transitory computer-readable storage medium, wherein the bitstream comprises encoded video information to be decoded by the method in any one of EEEs 51-56, 63-74, or 87-92.

EEE 107. A method for transmitting a bitstream, comprising transmitting the bitstream generated by the method in any one of EEEs 57-62, 75-86, or 93-98.

EEE 108. A method for receiving a bitstream, comprising receiving the bitstream to be decoded by the method in any one of EEEs 51-56, 63-74, or 87-92.

What is claimed is:

1. A method of video coding, comprising:
obtaining one or more intra-block copy (IBC) candidates from a plurality of non-adjacent neighboring blocks, wherein the one or more IBC candidates are coded based on an IBC merge mode or an IBC Advanced Motion Vector Prediction (AMVP) mode, and wherein the plurality of non-adjacent neighboring blocks are distanced from a current block by at least one block; and
obtaining a prediction for the current block based on the one or more IBC candidates.

2. The method of claim 1, wherein obtaining the one or more IBC candidates comprises:
obtaining the one or more IBC candidates according to a scanning rule, wherein the scanning rule comprises at least one of the following:
at least one scanning area;
at least one scanning distance, wherein the at least one scanning distance indicates a number of blocks away from a side of the current block; or
a scanning order.

3. The method of claim 2, wherein one of the plurality of non-adjacent neighboring blocks located at one of the at least one scanning distance has a same size as the current block; or
wherein one of the plurality of non-adjacent neighboring blocks located at one of the at least one scanning distance has a different size than the current block.

4. The method of claim 2, further comprising:
determining the at least one scanning area according to the at least one scanning distance;
wherein the at least one scanning area comprises at least one of a first scanning area or a second scanning area;
wherein the first scanning area is determined according to a first scanning distance indicating a first maximum number of blocks away from a first side of the current block, and the second scanning area is determined according to a second scanning distance indicating a second maximum number of blocks away from a second side of the current block; and
wherein the first scanning distance is same as or different from the second scanning distance, the at least one of the first scanning distance or the second scanning distance is received in a bitstream or predetermined as a fixed value.

5. The method of claim 4, further comprising:
in response to determining that the first scanning distance or the second scanning distance equals to a fixed size, terminating scanning in the at least one scanning area in response to satisfying a condition of:
a size of a candidate list including the one or more IBC candidates being equal to the fixed size; or
all non-adjacent neighboring blocks within the first scanning distance or the second scanning distance having been scanned.

6. The method of claim 4, wherein the first scanning area comprises a first starting neighboring block and a first ending neighboring block, and the second scanning area comprises a second starting neighboring block and a second ending neighboring block;
wherein the first scanning distance is greater than the second scanning distance.

7. The method of claim 4, wherein the first scanning area comprises a first sampling interval, and the second scanning area comprises a second sampling interval; and
wherein a first length of the first sampling interval is same as or different from a second length of the second sampling interval.

8. The method of claim 2, wherein the scanning order comprises:
scanning a first scanning area before a second scanning area, wherein the at least one scanning area comprises the first scanning area and the second scanning area; or
scanning the first scanning area and the second scanning area alternatively; or
scanning from a first sub-area with small distance to a second sub-area with large distance, wherein the first sub-area and the second sub-area are located on a same side scanning area, the same side scanning area is the first scanning area or the second scanning area; or
scanning at least one scanning area along scanning directions with a plurality of degree values.

9. The method of claim 8, wherein scanning the at least one scanning area along the scanning directions with the plurality of degree values comprises:
within each of the at least one scanning area corresponding to each of the at least one scanning distance, scanning a plurality of blocks according to the scanning directions with the plurality of degree values.

10. The method of claim 9, wherein the at least one scanning distance comprises 2, 3, 4, and 5;
wherein the plurality of degree values comprises: 225, 45, 90, 180, and 135; and a total of at least 18 blocks are scanned; or,
wherein the plurality of degree values comprises: 225, 45, 90, 180, 135, 270, 0, 247.5, 22.5, 202.5, 67.5, 157.5, and 112.5; and a total of at least 48 blocks are scanned.

11. The method of claim 2, wherein obtaining the one or more IBC candidates according to the scanning rule further comprises:
in response to a quantity of one or more qualified candidates being identified, terminating a scanning process; and
setting the one or more IBC candidates as the one or more qualified candidates;
wherein the one or more qualified candidates are coded in one of the IBC mode or intra template matching prediction (TMP) mode.

12. The method of claim 2, wherein obtaining the one or more IBC candidates according to the scanning rule further comprises:
obtaining a first IBC candidate and a second IBC candidate;
performing a similarity check between the first IBC candidate and the second IBC candidate; and
in response to determining that the first IBC candidate is similar to the second IBC candidate, pruning one of the first IBC candidate and the second IBC candidate.

13. The method of claim 2, wherein the one or more IBC candidates are included in an IBC candidate list;
the method further comprising:
obtaining at least one group of non-adjacent spatial candidates, wherein the at least one group comprises one group including all the non-adjacent spatial candidates, or wherein the at least one group comprises subgroups including a part of the non-adjacent spatial candidates;
inserting the at least one group into different positions of the IBC candidate list.

14. The method of claim 13, wherein inserting the at least one group of the non-adjacent spatial candidates into the different positions of the IBC candidate list comprises one of the following acts:
inserting the non-adjacent spatial candidates in a first order as follows:
spatial block vector prediction (BVP) from adjacent spatial neighbors; spatial BVP from non-adjacent spatial neighbors; history-based BVP from a First-In-First-Out (FIFO) table; pairwise average BVP; BVP candidates located in an IBC reference region; and zero BVP; or
obtaining a first quantify of the spatial BVP from the non-adjacent spatial neighbors and a second quantity of the spatial BVP from the non-adjacent spatial neighbors, and inserting the non-adjacent spatial candidates in a second order as follows:
the BVP from the adjacent spatial neighbors; the first quantity of the spatial BVP from the non-adjacent spatial neighbors; the history-based BVP from the FIFO table; the second quantity of the spatial BVP from the non-adjacent spatial neighbors; the pairwise average BVP; the BVP candidates located in the IBC reference region; and the zero BVP.

15. The method of claim 14,
wherein inserting the non-adjacent spatial candidates in the first order comprises:
in response to determining that a type of video frames or a type of video slices is low-delay, inserting the non-adjacent spatial candidates in the first order; or
in response to determining that a coding mode of the one or more IBC candidates is the IBC AMVP mode, inserting, the non-adjacent spatial candidates in the first order; or
wherein inserting the non-adjacent spatial candidates in the second order comprises:
in response to determining that the type of video frames or the type of video slices is non-low-delay, inserting the non-adjacent spatial candidates in the second order; or
in response to determining that the coding mode of the one or more IBC candidates is the IBC merge mode, inserting, the non-adjacent spatial candidates in the second order.

16. The method of claim 14, wherein the first quantity and the second quantity are respectively set as a first predefined value and a second predefined value; or
wherein the first quantity and the second quantity are dynamically determined according to a number of available neighbors on a predefined side of the current block.

17. An apparatus for video coding, comprising:
one or more processors; and
a memory coupled to the one or more processors and configured to store instructions executable by the one or more processors,
wherein the one or more processors, upon execution of the instructions, are configured to perform operations comprising:
obtaining one or more intra-block copy (IBC) candidates from a plurality of non-adjacent neighboring blocks, wherein the one or more IBC candidates are coded based on an IBC merge mode or an IBC Advanced Motion Vector Prediction (AMVP) mode, and wherein the plurality of non-adjacent neighboring blocks are distanced from a current block by at least one block; and
obtaining a prediction for the current block based on the one or more IBC candidates.

18. A non-transitory computer-readable storage medium storing a bitstream generated by operations comprising:
obtaining one or more intra-block copy (IBC) candidates from a plurality of non-adjacent neighboring blocks, wherein the one or more IBC candidates are coded based on an IBC merge mode or an IBC Advanced Motion Vector Prediction (AMVP) mode, and wherein the plurality of non-adjacent neighboring blocks are distanced from a current block by at least one block; and
obtaining a prediction for the current block based on the one or more IBC candidates.

19. A method for storing a bitstream, comprising:
performing the method of video coding according to claim 1 to generate a bitstream; and
storing the bitstream.

20. A method for transmitting a bitstream, comprising:
performing the method of video coding according to claim 1 to generate a bitstream; and
transmitting the bitstream.
